(19) United States
(12) Patent Application Publication
(10) Pub. No.: US 2005/0069827 A1
(43) Pub. Date: Mar. 31, 2005

(54) Photosensitive silver halide emulsion, silver halide photographic photosensitive material, photothermographic material and image-forming method

(76) Inventors: Fumito Nariyuki, Kanagawa (JP); Hiroyuki Mifune, Kanagawa (JP); Kazutaka Takahashi, Kanagawa (JP); Takayoshi Mori, Kanagawa (JP)

Correspondence Address: TAIYO CORPORATION, 2111 JEFFERSON DAVIS HIGHWAY, #412, NORTH, ARLINGTON, VA, 22202, US

(21) Appl. No.: 10/923,891

(22) Filed: Aug. 24, 2004

(30) Foreign Application Priority Data
Aug. 28, 2003 (JP) 2003-209325
Aug. 28, 2003 (JP) 2003-209326
Sep. 22, 2003 (JP) 2003-329798

(51) Int. Cl. G03C 1/00

(52) U.S. Cl. 430/619

(57) ABSTRACT

The present invention a photothermographic material including: a support; and an image-forming layer containing a photosensitive silver halide, a non-photosensitive organic silver salt, a reducing agent for silver ions and a binder on at least one side of the support, wherein the photosensitive silver halide includes tabular grains with an average silver iodide content of 40 mol % or more, an average thickness whitin the range of 0.001 to 0.5 μm and an average aspect ratio of 2 or more.

### CROSS-REFERENCE TO RELATED APPLICATION

This application claims priority under 35 USC 119 from Japanese Patent Application Nos. 2003-209325, 2003-209326 and 2003-329798, the disclosures of which are incorporated by reference herein.

### BACKGROUND OF THE INVENTION

1. Field of the Invention

The present invention relates to a photosensitive silver halide emulsion, a silver halide photographic photosensitive material, a photothermographic material and an image-forming method. Particularly, the invention relates to a photosensitive silver halide emulsion, a silver halide photographic photosensitive material, a photothermographic material and an image-forming method using a silver halide emulsion with a high content of silver iodide. Further, the invention relates to a photosensitive silver halide emulsion, a silver halide photographic photosensitive material, a photothermographic material and an image-forming method in which sensitivity is largely improved, fogging is reduced, and image storability after development is excellent.

2. Description of the Related Art

Recently, in the fields of medical services and printing and plate making, dry processing for photographic development is strongly desired from the viewpoints of environmental conservation and space saving. In these fields, digitalization has proceeded and systems have rapidly spread in which information is imported into a computer, stored, processed if necessary, output to a photosensitive material at a location where it is required by a laser image setter or laser imager after being sent by transmission, and developed to form an image. It is required that the photosensitive material be capable of recording by laser exposure with high illumination intensity and that it forms a clear black image having high resolution and sharpness. As recording materials for such digital imaging, various hard copy systems using pigment or dye such as an ink jet printer and an electrophotographic system are in circulation as general image-forming systems. However, they are not satisfactory with respect to image quality (sharpness, graininess, gradation, and color tone) which determines diagnostic capability, and recording speed (sensitivity), in the case of a medical image. Thus, they have not reached a level capable of replacing conventional wet development medical silver salt film.

A thermal image-forming system using organic silver salt is already known. A photosensitive material used in the system includes an image-forming layer in which a reducible silver salt (for example, an organic silver salt), a photosensitive silver halide and, according to need, a color toning agent for controlling color tone of silver are dispersed in a matrix of a binder.

A photothermographic material is heated to a high temperature (for example, 80° C. or higher) after image exposure to form a black silver image through an oxidation-reduction reaction between a silver halide or a reducible silver salt (functioning as an oxidizing agent) and a reducing agent. The oxidation-reduction reaction is accelerated by catalytic action of a latent image of silver halide generated by exposure. As a result, a black silver image is formed in the exposed area. The photothermographic material is disclosed in many documents and FUJI MEDICAL DRY IMAGER FM-DPL has been placed on the market as a practical image-forming system for medical services.

Such an image-forming system using an organic silver salt has essentially two main problems, since it is not subjected to a fixing process, thereby allowing silver halide to remain in a film even after development.

One of the problems is deterioration of image storability, particularly that of printout when exposed to light after development processing. As a technique to improve the printout, a method using silver iodide is known. Compared with silver bromide or silver iodobromide containing 5 mol % of iodine or less, silver iodide has a property of being less susceptive to printout, which suggests the possibility of providing fundamental resolution of the problem. However, the silver iodide grain known until now has very low sensitivity which does not reach sensitivity that is usable for actual systems. Further, there is an inherent problem such that when a means for preventing recombination of a photoelectron and a positive hole is provided in order to increase sensitivity, the property of excellent printout is lost.

As for a means for increasing sensitivity of a silver iodide photographic emulsion, sensitization by dipping it in an aqueous solution of a halogen receptor such as sodium nitrite, pyrogallol or hydroquinone, or an aqueous solution of silver nitrate, or by conducting sulfur sensitization at pAg 7.5 has been known in academic literatures. However, the sensitization effect of these halogen receptors is very slight and extremely insufficient in photothermographic material, which is the subject of the invention.

Another problem is deterioration of image quality due to light scattering by residual silver halide, resulting in white turbidity of a film to make it translucent to opaque. In order to solve this problem, a means was adopted as a practical means such that photosensitive silver halide was made into fine grains (in a practical region, from 0.15 μm to 0.08 μm) and the addition amount thereof was reduced as far as possible to decrease white turbidity caused by silver halide. However, the compromise further reduces sensitivity, and does not completely correct the white turbidity, leaving the film opaque to give a haze thereto.

In the case of wet development processing, residual silver halide is removed by processing with a fixing liquid containing a solvent for silver halide after development processing. As for the solvent for silver halide, various inorganic and organic compounds that can form a complex with a silver ion are known.

In dry thermal development processing, it was attempted in the past to incorporate similar fixing means. For example, a method, in which a compound capable of forming a complex with a silver ion is incorporated in the film to make silver halide soluble by thermal development (usually called “fixing”), has been proposed (refer to Japanese Patent Application (JP-A) No. 8-76317). However, the method is related to silver bromide or silver chlorobromide and further requires post-heating for fixation in which a heating condition of a high temperature in the range of 155° C. to 160° C. is necessary, making the system difficult to fix. Further, a method, in which a separate sheet (fixing sheet) containing a compound capable of forming a complex with a silver ion is prepared to dissolve and remove residual silver halide by laminating the sheet on a photothermographic material that has been thermally developed to form an image and heating the laminate, has been proposed (refer to JP-A No. 9-166845). However, since the system includes two sheets, there are drawbacks from a practical standpoint such that processing becomes complicated to make securing stable action of the process difficult, and that waste material is generated after the processing since it is necessary to dispose the fixing sheet.

As an additional fixing method in thermal development, a method has been proposed in which a fixing agent for silver halide is incorporated in microcapsules to allow the fixing agent to be released and act due to the thermal development (refer to JP-A No. 8-82886). However, it is difficult to achieve a design that makes the fixing agent release effectively. Another method has been proposed in which fixation is conducted by using a fixing solution after thermal development (refer to JP-A Nos. 51-104826 and 62-133454). However, since wet processing is required, the method is unsuitable for totally dry processing.

As described above, every conventionally known method for improving turbidity of the film has a large adverse effect to make practical use thereof difficult.

In addition, it is known that a higher sensitivity can be obtained in the liquid development system by depositing a silver salt on a host silver halide grain by epitaxial growth or introducing dislocation lines on silver halide.

However, in silver halide photosensitive material in the liquid development system, generally, silver images are formed by reducing silver halide by a developing agent (reducing agent) contained in a processing solution, or color images are formed by using an oxidized developing agent which is a by-product, that is, a fundamental reaction is reduction of silver halide by a developing agent.

On the other hand, in photothermographic material, silver halide forms only a latent image by exposure and silver halide itself is not reduced by a reducing agent. What is reduced in the material is silver ions supplied from a non-photosensitive organic silver salt. As for a reducing agent also, an ionic reducing agent such as hydroquinone or p-phenylenediamines is used in the case of liquid development, but a hindered phenol derivative generally known as a radical reactive agent is used in the case of photothermographic material.

Thus, mechanisms of development reactions (reducing reaction) in liquid development processing photosensitive material and photothermographic material are completely different from each other, and compounds used are also completely different from each other. Accordingly, it cannot be supposed that compounds that are effective in liquid development processing will be directly effective for photothermographic material. When a compound is applied to photothermographic material, it can never be predicted whether the same effect will be given or whether a completely different effect can be expected from the compound. Further, it could never be conceived of applying the compound to photothermographic material using a high silver iodide content emulsion, and therefore speculation of the effect thereof was also impossible.

On the other hand, it has been proposed to attempt to apply the above-described photothermographic material to a photosensitive material for photographing. A photosensitive material for photographing here means one on which an image is recorded by surface exposure instead of scan exposure in which image information is written by laser light. Conventionally, such a photosensitive material has been generally used in the field of wet developing photosensitive material. Direct or indirect X-ray film and mammography film for medical application, various plate making films for printing, recording film for industrial application and film for photographing by a general camera are known. For example, patent documents disclose a double-side-coated type photothermographic material for X-rays utilizing a blue fluorescent intensifying screen (for example, refer to Japanese Patent No. 3229344), a photothermographic material utilizing tabular grains of silver iodobromide (for example, refer to JP-A No. 59-142539), and a photosensitive material for medical services in which tabular gains containing a high content of silver chloride with a (100) principal plane are coated on both sides of a support (for example, refer to JP-A No. 10-282606). Further, double-side-coated type photothermographic materials are also disclosed in other patent documents. However, in these prior examples, use of fine grain silver halide with a size of 0.1 μm or less results in low sensitivity, although it is not accompanied by deterioration of haze, to make practical use for photographing almost impossible. On the other hand, use of silver halide gains having a size of 0.3 μm or more results in significant degradation of image quality caused by deterioration of haze and print out due to residual silver halide to make practical use almost impossible.

A photosensitive material using tabular silver iodide grains as silver halide grains is known in the field of wet developing (for example, refer to JP-A Nos. 59-119344 and 59-119350). However, there is no example of application in photothermographic material. The reason is, as described above, due to low sensitivity, lack of effective means for sensitization and a further higher technical barrier in thermal development.

In order to use as such a photosensitive material for photographing, photothermographic material is required to have a further higher sensitivity, and a further higher level in image quality such as haze of an obtained image.

A technique is disclosed (JP-A No. 62-133454) in which a silver salt such as silver chloride or silver bromide is epitaxially grown on tabular silver iodide grains to be used for multicolor image color silver halide salt photosensitive material. Further, the specification discloses that the silver halide is subjected to chalcogen sensitization, gold-chalcogen sensitization or reduction sensitization. However, the specification only discloses use of the tabular silver iodide grains in wet processing color silver salt photosensitive material, and there is no description or disclosure about photothermographic material.

Accordingly, a silver halide emulsion, a silver halide photographic photosensitive material, a photothermographic material and an image-forming method with high sensitivity, low fog and excellent image storability are required, the silver halide emulsion, the silver halide photographic photosensitive material, the photothermographic material and the image-forming method utilizing a high content of silver iodide.

Moreover, there is a need for a photothermographic material with low haze and an image-forming method.

### SUMMARY OF THE INVENTION

A first aspect of the present invention provides a photothermographic material including: a support; and an image-forming layer containing a photosensitive silver halide, a non-photosensitive organic silver salt, a reducing agent for silver ions and a binder on at least one side of the support, wherein the photosensitive silver halide includes tabular grains with an average silver iodide content of 40 mol % or more, an average thickness within a range of 0.001 to 0.5 μm and an average aspect ratio of 2 or more.

A second aspect of the invention provides a method for forming an image on the photothermographic material, the method including: disposing the photothermographic material between a pair of X-ray intensifying screens to obtain an assembly for image formation; arranging a subject between the assembly and an X-ray source; irradiating the subject with X-rays having an energy level in a range of 25 kVp to 125 kVp; removing the photothermographic material from the assembly; and heating the removed photothermographic material at a temperature in a range of 90° C. to 180° C.

### BRIEF DESCRIPTION OF THE DRAWING

FIG. 1 shows an emission spectrum of fluorescent intensifying screen A.

### DETAILED DESCRIPTION OF THE INVENTION

Hereinafter, the invention will be described in detail.

1. Photosensitive Silver Halide Emulsion

1-1 Photosensitive Silver Halide

1) Halogen Composition

It is important that a photosensitive silver halide used in the invention should have a high silver iodide content within the range of 40 mol % to 100 mol %. Residual portion in the silver halide composition is not particularly restricted, and can be selected from silver halide such as silver chloride, and silver bromide, and organic silver salt such as silver thiocyanate and silver phosphate. Among them, silver bromide and/or silver chloride is particularly preferable. Use of the silver halide having a high silver iodide content allows design of a preferable photothermographic material with an excellent image storability, especially with significantly small increase in fogging caused by light exposure after development.

Further, the silver iodide content is preferably in the range of 80 mol % to 100 mol %, and more preferably in the range of 90 mol % to 100 mol % from the viewpoint of image storability with respect to light exposure after development.

The distribution of halogen composition of each grain may be uniform, or the halogen composition may stepwise change or may continuously change in each grain. Further, silver halide grains with a core/shell structure can also be preferably used. The structure is preferably a two- or five-layered structure. Core/shell grains with a two- to four-layered structure can be more preferably used. Grains having a core/shell structure in which the core has a high silver iodide content or in which the shell has a high silver iodide content can also be preferably used.

The tabular grains in the invention preferably has an epitaxial junction, in which silver chloride or silver bromide is localized, at the surfaces thereof.

The halogen composition in the epitaxial portion may be uniform or the halogen composition in the spatial portion may stepwise change or continuously change. The ratio of the silver iodide content in the epitaxial portion to the host tabular grain is preferably 1/2 or less, more preferably 1/3 or less, still more preferably 1/5 or less and most preferably 1/10 or less. In this case, it is preferable that the silver iodide content in the epitaxial portion is smaller than that in the host tabular grain.

In the halogen composition other than the silver iodide in the epitaxial portion, it is preferable that the content of silver bromide or silver chloride is high. More preferably, the silver bromide content in the epitaxial portion is 60 mol % or more, still more preferably 80% or more and most preferably 90 mol % or more.

In the invention, the silver iodide can have an arbitrary content of β-phase and gamma phase. The β-phase indicates a high silver iodide structure with wurtzite structure of hexagonal system. The gamma phase indicates a high silver iodide structure with zinc blend structure of cubic system. The gamma phase content herein means that determined by using a technique proposed by C. R. Berry. In the technique, determination is conducted on the basis of the ratio of peaks according to silver iodide β-phases (100), (101) and (002), and gamma phase (111) in powder X-ray diffraction method. The details of the technique is described in, for example, Physical Review Vol. 161, No. 3, pp 848-851 (1967).

2) Grain Shape

The silver halide grains in the invention are tabular grains.

The tabular grains in the invention are preferably formed by a nucleus forming process and a grain growing process. In the grain growing process, silver halide fine particles having a size smaller than the average thickness of the tabular grains to be formed are preferably added to a reaction system. In this case, adding the silver halide fine particles having the size smaller than the average thickness is preferably conducted such that the amount of the silver halide fine particles added are 10 mol % or more of the entire silver amount the tabular grains. The average grain size of the silver halide fine particles added in the grain growing process is 0.0005 to 0.04 μm and more preferably 0.0005 μm to 0.025 μm.

The average aspect ratio of the tabular grains is preferably 2 or more, more preferably from 2 to 50, still more preferably from 8 to 50, and furthermore preferably from 12 to 50. Alternatively, the aspect ratio of the tabular grains is preferably 2 or more, more preferably 5 or more, and still more preferably 8 or more. Alternatively, the average aspect ratio of the tabular grains in the invention is preferably 5 to 70.

Alternatively, at least a part of the tabular grains, the entire projected area of which part corresponds to 50% or more of the entire projected area of all the tabular grains, preferably has an aspect ratio of 2 or more, and more preferably are grains in which silver salt has been deposited on silver halide tabular grains having an aspect ratio in the range of 2 to 100 by epitaxial growth.

Alternatively, at least a part of the tabular grains, the entire projected area of which part corresponds to 50% or more of the entire projected area of all the tabular grains, preferably has an aspect ratio of 3 to 100 and more preferably has an aspect ratio in the range of 5 to 50.

The average thickness of the tabular grains is preferably 0.001 to 0.5 μm, more preferably 0.01 to 0.5 μm, still more preferably 0.02 to 0.2 μm, and most preferably 0.02 to 0.1 μm. The average thickness of the tabular grains is 0.001 to 0.2 μm, more preferably 0.001 to 0.1 μm and still more preferably 0.001 to 0.05 μm.

Alternatively, the average thickness of the silver halide grains in the invention is within the range from 20 nm less than to 20 nm more than a thickness at which reflectance becomes maximum in the wavelength range in which the silver halide emulsion has sensitivity. The average thickness is preferably within the range from 15 nm less than to 15 nm more than the thickness, and more preferably within the range from 10 nm less than to 10 nm more than the thickness. In the silver halide grains of high silver iodide content in the invention, a particularly high sensitivity can be obtained by setting the average thickness in this specific range.

In the silver halide tabular grains with a high silver iodide content, reflectance to incident light depends on an exposure wavelength (incident light wavelength) and the thicknesses of the silver halide grains. Thicknesses which result in maximum reflectance exists periodically. When the photographic material of the invention including grains which has a high silver iodide content is exposed to light in the wavelength range in which the grains have intrinsically sensitivity (λ=350 to 450 nm), a first thickness range effective in the invention is the range of less than 0.1 μm, and a second thickness range is the range of 0.1 μm to 0.2 μm. Although the effective thickness depends on the silver iodide content, in pure silver iodide, the first thickness range is the range whose center is 0.046 μm, and the second thickness region is the range whose center is 0.14 μm.

Further, when the grains are subjected to spectral sensitization in a specific region of spectrum, wavelengths at which the reflectance becomes maximum there exist. The thicknesses effective for the wavelengths are different from each other. For example, when the center of exposure wavelength is 550 nm, the thickness range whose center is 0.063 μm is preferable. When the center of exposure wavelength is 650 nm, the thickness range whose center is 0.077 μm is preferable.

The silver halide grains of the invention having a high silver iodide content may have any grain size. In the invention, the average sphere equivalent diameter is preferably in the range of 0.2 to 10.0 μm, more preferably in the range of 0.3 to 5.0 μm, still more preferably in the range of 0.35 to 3.0 μm, and most preferably 0.5 to 3.0 μm. In the invention, the average projected area equivalent diameter of the silver halide grains is preferably in the range of 0.1 to 5 μm and more preferably in the range of 0.3 to 3 μm. The size distribution of the tabular grains in the invention is preferably mono-dispersion. The variation coefficient of projected area equivalent diameters of the grains is preferably 25% or less and more preferably 20% or less. The projected area equivalent diameter herein means the diameter of a circle having the same area as the area of a silver halide grain. The sphere equivalent diameter herein means the diameter of a sphere having the same volume as the volume of a silver halide grain. The projected area equivalent diameter and the sphere equivalent diameter can be obtained by observing a grain with an electron microscope, measuring the projected area and the thickness of the grain, obtaining therefrom the projected area and the volume of the grain, and calculating the diameter of a sphere having the same volume as the grain volume and the diameter of a circle having the same area as the projected area.

The silver halide grains in the invention are preferably tabular grains. Examples of the tabular grains include tabular octahedron grains, tabular tetradecahedron grains and tabular icosahedron grains which are classified according to side face structures. The tabular octahedron grains and tabular tetradecahedron grains are preferable. The tabular octahedron grains herein mean grains having {001}, {100} and {001} planes, or grains having {001}, {120} and {1(−1)0} planes. The tabular tetradecahedron grains mean grains having {001}, {100}, {010}, {101} and {011} planes, grains having {001}, {120}, {1(−1)0}, {121} and {1(−1)1)}planes, grains having {001)}, {101}, {011}, {10(−1)} and {01(−1)} planes, or grains having {001}, {121}, {1(−1)1}, {12(−1)} and {1(−1) (−1)} planes. The tabular icosahedron grains mean grains having {001}, {100}, {010}, {101}, {011}, {10(−1)} and {01(−1)} planes, or grains having {001}, {120}, {1(−1)0}, {121}, {1(−1)0}, {12(−1)} and {1(−1)(−1)} planes. Here, indications such as {001} represent crystal planes having plane indices equivalent to the plane index of (001) plane. In addition, tabular grains with other shapes are also preferably used.

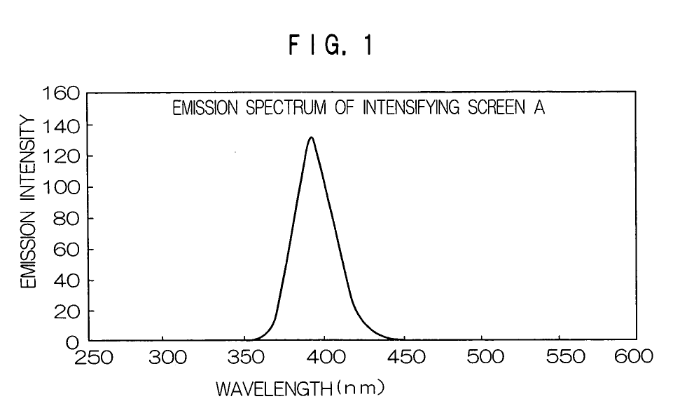

Silver halides with a high silver iodide content may have a complex form. The silver halide is preferably junction particles shown in, for example, FIG. 1 of R. L. Jenkins et al., J of Phot. Sci. Vol. 28 (1980) P 164. The tabular grains shown in FIG. 1 of the Journal can also be preferably used. Silver halide grains having rounded corners are also preferably used. There is no particular restriction on the plane index of the outer surface (Miller index) of the photosensitive silver halide grain. However, it is preferable that the rate of [100] plane, which has a high spectral sensitization effect when the photosensitive silver halide adsorbs a spectral sensitizing dye, is high. The rate is preferably 50% or more, more preferably 65% or more, and still more preferably 80% or more. The Miller index and the rate of [100] plane can be obtained according to a method using adsorption dependency of [111] plane and [100] plane in adsorption of a sensitizing dye, the method being described in T. Tani; J. Imaging Sci., 29,165 (1985).

Plane indices of main planes of the outer surface can be obtained by subjecting the surface to epitaxial junction of a structure with known crystal orientation, for example, silver bromide grains.

Terms “epitaxy” and “epitaxial” herein have meanings accepted in the art in order to indicate that a silver salt has a crystal form with an orientation which can be controlled by a host tabular grain.

In order to form a sensitization site on host tabular grains, a silver salt deposited by epitaxial growth can be utilized. By controlling a deposition site through epitaxial growth, selectively localized sensitization of the host tabular grains can be conducted. Accordingly, the sensitization site can be disposed at one or more regular sites. Term “regular” means that the sensitization sites have an expectable orderly relation between themselves and the principal crystal plane of the tabular grain. Is is preferable that the sensitization sites and the principal crystal plane mutually have such a relation. Control of epitaxial deposition with respect to the principal crystal plane of the tabular grain allows the number and the distance in the horizontal direction of the sensitization sites to be controlled.

In particular, it is preferable to substantially exclude epitaxial deposition at at least a part of the principal crystal plane of the host tabular grain by controlling silver salt exitaxy. In the host tabular grains, epitaxial deposition of the silver salt tends to occur at edges and/or corners of the grains.

Limitation of epitaxial deposition to a selected site or sites of the tabular grains provides more improved sensitivity than random deposition of the silver salt on the principal plane of the tabular grains due to epitaxial growth. At least a part of the principal crystal plane is substantially forbidden to be subjected to epitaxial deposition of the silver salt, and the silver salt is allowed to deposit on a selected site or sites in a limited range. The deposition range can be broadly changed without deviating from the invention. Generally, the smaller the covering amount of epitaxial on the principal crystal plane, the larger the sensitivity. The silver salt is preferably deposited by epitaxial growth on less than half of the area of the principal crystal planes of the tabular grains, and more preferably on less than 25% of the area. When the silver salt is deposited by epitaxial growth on the corners of the tabular silver halide grains, the are of sites having epitaxial deposition is preferably less than 10%, and more preferably less than 5% of the area of the principal crystal planes of the tabular grains. In some embodiments, it is observed that epitaxial deposition starts at the edge surfaces of the tabular grains. Accordingly, depending on conditions, epitaxy is limited to selected edge sites to effectively exclude epitaxy on the principal crystal plane.

Complete development of grains including a latent image center makes it impossible to determine the position and the number of the latent image centers. However, when development before extension of a developed area from a position close to the latent image center is inhibited and the partially developed gains are magnified and the magnified grains are observed, the partially developed sites can be clearly seen. These sites generally correspond to the latent image centers, and the latent image centers generally correspond to the sensitization sites.

A silver salt to be deposited by epitaxy can be selected from any of silver salts conventionally generally known for their capability of epitaxially growing on silver halide grains and effectiveness in photography. In particular, the silver salt is preferably selected from those conventionally known for their effectiveness for formation of the shell of a core-shell silver halide emulsion. In addition to all the known and photographically useful silver halides, other silver salts known for their capability of depositing on the silver halide grains as a silver salt, such as silver cyanide, silver carbonate, silver ferricyanide, silver arsenate or silver arsenite, and silver chromate can be used. Further, mixtures thereof may be usable. Among them, silver chloride, silver bromide and silver thiocyanate, and mixtures thereof are preferable. The silver salt particularly preferably includes at least silver bromide.

By allowing a modifying compound to exist together with the tabular silver halide grains, the silver salt can be effectively deposited in accordance with a selected silver salt and intended application. Iodide may migrate from the host grains into silver salt epitaxy. The host grains may contain anions other than iodide ions up to solubility limit to silver iodide.

The silver halide in the invention preferably has at least one dislocation line. The silver halide more preferably has 5 dislocation lines or more, and particularly preferably has 10 dislocation lines or more. It is preferable that at least a part of the tabular grains, the entire projected area of which part corresponds to 50% or more of the entire projected area of all the tabular grains, include one dislocation line or more. It is more preferable that at least a part of the tabular grains, the entire projected area of which part corresponds to 80% or more of the entire projected area of all the tabular grains, include one dislocation line or more. It is particularly preferable that at least a part of the tabular grains, the entire projected area of which part corresponds to 80% or more of the entire projected area of all the tabular grains, include ten dislocation lines or more.

Dislocation of silver halide crystal is described in, for example, the following documents.
1) C. R Berry, J. APPl. Phys., 27, 636 (1956),
2) C. R Berry, D. C. Skilman, J. APPl. Phys., 35, 2165 (1964),
3) J. F. Hamilton, Phot. Sci. Eng., 11, 57 (1967),
4) T. Shiozawa, J. Soc. Phot. Sci. JAP., 34, 16 (1971), and
5) T. Shiozawa, J. Soc. Phot. Sci. JAP., 35, 213 (1972).

They describe that observation of dislocation in a crystal is possible by an X-ray diffraction method or transmission electron microscopic method at a low temperature, and that various dislocations occur in a crystal by giving strain to the crystal.

On the other hand, influence of dislocation on photographic properties is described in, for example, G. C. Fame 11, R. B. Flint and J. B. Chanter, J. Phot. Sci., 13, 25 (1965). It shows that, in tabular silver bromide grains with a large size and a high aspect ratio, affinity exists between places where latent image nucleuses are formed and defects in the grains.

JP-A Nos. 63-220238 and 1-201649 disclose tabular silver halide grains to which dislocation has been intentionally introduced. The tabular grains to which dislocation has been introduced have better photographic properties such as sensitivity, and reciprocity law than tabular grains without dislocation. The application also shows that use of the tabular grains with dislocation for photosensitive material results in excellent sharpness and graininess.

However, dislocation lines are irregularly introduced to the edges of these tabular grains and every grain has the different number of dislocations.

3) Coating Amount

The coating amount of silver halide can be arbitrarily selected in accordance with application and object.

In the case of general silver halide photosensitive materials for wet development system, there is no particular restriction on the amount of the silver to be applied. When a high image density is required, the silver halide is usually used in a silver amount of 1 g/m² to 10 g/m². When a not so high image density is required, the silver halide is usually used in a silver amount of 0.1 g/m² to 5 g/m².

Generally, in the case of photothermographic material, in which silver halide remains as it stands even after thermal development, an increased coated amount of silver halide results in reduction of transparency of the film, which is undesirable for image quality. Therefore, contrary to a demand for a higher sensitivity, the coated amount has been restricted to a low value. However, in the invention, since haze of the film caused by silver halide can be decreased by thermal development, a larger amount of silver halide can be applied. In the invention, the amount of the silver halide to be applied is preferably from 0.5 mol % to 100 mol %, and more preferably from 5 mol % to 50 mol % per mol of silver of a non-photosensitive organic silver salt described later.

4) Grain Formation Method

A method for forming photosensitive silver halide is well known in the art, and the silver halide can be prepared according to a conventionally known method. In particular, the silver halide employed in a photothermographic material is prepared by, for example, methods described in Research Disclosure, No. 17029, June 1978 and U.S. Pat. No. 3,700,458. Specifically, a method is employed in which photosensitive silver halide is prepared by adding a silver-donating compound and a halogen-donating compound to a solution including gelatin or other polymer followed by blending the resultant with an organic silver salt. In addition, a method described in JP-A No. 11-119374, paragraphs [0217] to [0224] and methods described in JP-A Nos. 11-352627 and 2000-347335 are also preferable.

As for a method for preparing silver iodide tabular grains, methods described in aforementioned JP-A Nos. 59-119350 and 59-119344 are preferably used.

Preparation of the tabular grains in the invention may be conducted by any of grain formation methods including three steps of nucleus formation, aging and growing, those including two steps of nucleus formation and growing, and those including one step in which nucleus formation and growing are conducted.

In the nucleus formation step, nucleus formation can be preferably conducted in a short period of time at low pI. pI is a logarithm of the inverse of iodide ion concentration in a system. In the invention, an aqueous solution of silver nitrate and an aqueous halogen solution are particularly preferably added to the system at a temperature within the range of 20° C. to 80° C. in the presence of gelatin while the system is being stirred. At this time, pI of the system is preferably 3 or less and pH of the system is preferably 7 or less. The concentration of the aqueous solution of silver nitrate is preferably 1.5 mol/L or less.

The aging step is preferably conducted at a temperature within the range of 50° C. to 80° C. Further, an additional amount of gelatin is preferably added within a period from a time just after the nucleus formation to completion of aging.

The growing step in the invention may be conducted either by adding a halogen ion-containing solution including iodide and a solution containing AgNO₃, or by adding silver iodide fine grain emulsion. The silver halide fine grain emulsion may be added alone, or the aqueous solution of silver nitrate, the halogen-containing aqueous solution containing the iodide and the silver iodide fine grain emulsion can be simultaneously added.

In the invention, a growing step at least including the addition of the silver iodide fine grain emulsion is preferred. The silver iodide fine grain emulsion means an emulsion which includes grains having a size smaller than the average thickness of the tabular grains. Further, the addition of the silver iodide fine grain emulsion is preferably at least 10 mol % with respect to the entire amount of silver during growing.

The silver iodide fine particle emulsion in the invention may be substantially made of silver iodide and may also contain silver bromide and/or silver chloride so long as mixed crystals can be formed. The emulsion is preferably made of 100% silver iodide.

The silver iodide can have the following crystal structures: beta phase, gamma phase, and alpha phase or a structure similar to the alpha phase as describe in U.S. Pat. No. 4,672,026. The crystal structure is not limited in the invention, however a mixture of the beta phase and the gamma phase is preferably used and the beta phase is more preferably used.

The silver iodide fine grain emulsion may be formed just before addition as described, for example, in U.S. Pat. No. 5,004,679, or may undergo an ordinary water washing step. In the invention, those which have undergone the ordinary water washing step are preferably used.

The silver iodide fine grain emulsion can be easily formed by a method described in, for example, U.S. Pat. No. 4,672,026. A double jet addition method in which an aqueous silver salt solution and an aqueous iodide salt solution are added to a system in grain formation while keeping the pI value constant during the grain formation is preferred. There are no particular restrictions on temperature, pI, pH, the kind and the concentration of a protective colloid agent such as gelatin, absence or presence, the kind and the concentration of a solvent for silver halide. However, it is advantageous in the invention that the grain size is from 0.0005 μm to 0.1 μm, preferably from 0.0005 μm to 0.07 μm, more preferably from 0.0005 μm to 0.04 μm and particularly preferably from 0.0005 μm to 0.025 μm. It is also advantageous that the variation coefficient of the grain size distribution is 18% or less. Since the silver halide grains are fine, the grain shapes cannot be completely defined. However, the variation coefficient of the grain size distribution is preferably 25% or less.

The effect of the invention is particularly remarkable when the variation coefficient is 20% or less. After silver iodide fine grains grains contained in the silver iodide fine grain emulsion are placed on a mesh for electron microscopic observation, the size and the size distribution thereof are obtained not by a carbon replica method but directly by observation using a transmission method.

This is because the grain size is small and therefore measuring error increases under the observation by the carbon replica method. The grain size is defined as the diameter of a circle having the same area as the projected area of the observed grain. The grain size distribution is also determined by using such diameters.

In principle, growing occurs by Ostwald ageing so long as the size of each of the added fine grains in the emulsion is smaller than the average thickness of the tabular grains. For the tabular grains with the average silver iodide content of 40 mol % or more, it is desirable that the size is smaller and that the variation coefficient of the grain size distribution is smaller.

The method used most preferably in the growing step of the invention is similar to a method described in JP-A No. 2-188741. In the method, an emulsion including fine grains of silver iodide, silver bromide, or silver chloride which have been prepared just before addition is continuously added to a system during growing of tabular grains to dissolve the ultrafine grains contained in the emulsion and grow the tabular grains. An external mixer for preparing the fine grain emulsion has an intense stirring power and an aqueous solution of silver nitrate, an aqueous halogen solution and gelatin are placed in the mixer. The gelatin can be added as a mixture of the gelatin and at least one of the aqueous solution of silver nitrate and the aqueous halogen solution which mixture has been prepared previously or immediately before addition, or an aqueous gelatin solution can be added alone. The gelatin preferably has a molecular weight smaller than that of ordinary gelatin, and particularly preferably has a molecular weight of 10,000 to 50,000. The gelatin is preferably at least one selected from gelatin in which 90% or more of amino groups have been phthalized, succinated or trimellitated, and oxidized gelatin with a lowered methionine content. Gelatin which has undergone phthalizing modification is particularly preferable.

5) Heavy Metal

The photosensitive silver halide grains in the invention can contain a metal which belongs to any of 6 to 13 groups (preferably 6 to 10 groups or 8 to 10 groups) of the periodic table including 1 to 18 groups, or a metal complex thereof. The metal or the central metal of the metal complex is preferably rhodium, ruthenium, iridium or iron. A single kind of metal complex may be used alone, or two or more kinds of metal complexes including the same kind of metal or different kinds of metals may be used as a mixture. The content thereof is preferably in the range of 1×10⁻⁹ mol to 1×10⁻³ mol per mol of silver. The heavy metals, the metal complexes and addition methods thereof are described in JP-A Nos. 7-225449, 11-65021, paragraphs [0018] to [0024], and 11-119374, paragraphs [0227] to [0240].

In the invention, silver halide grains in which a hexacyano-metal complex is allowed to exist on the uppermost surface of the grains are preferable. Examples of the hexacyano-metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, a hexacyano-iron complex is preferable.

Since the hexacyano-metal complex exists in the form of ions in an aqueous solution, its counter cation is not important. However, use of an alkali metal ion such as a sodium ion, a potassium ion, a rubidium ion, a cesium ion or a lithium ion, an ammonium ion, or an alkilammonium ion (e.g., a tetramethylammonium ion, a tetraethylammonium ion, a tetrapropylammonium ion or a tetra(n-butyl)ammonium ion), which is easily miscible with water and suitable for precipitation operation of the silver halide emulsion, is preferable as the counter cation.

The hexacyano-metal complex can be added in the form of mixture of the complex and a solvent such as water, a mixed solvent of water and a suitable organic solvent miscible with water such as an alcohol, an ether, a glycol, a ketone, an ester, or an amide, or gelatin.

The addition amount of the hexacyano-metal complex preferably ranges from 1×10⁻⁵ mol to 1×10⁻² mol, and more preferably from 1×10⁻⁴ mol to 1×10⁻³ mol per mol of silver.

In order to allow the hexacyano-metal complex to exist on the outermost surface of the silver halide grains, the hexacyano-metal complex is directly added to a system after completion of adding an aqueous solution of silver nitrate used in grain formation, and before completion of feeding process (i.e., before chemical sensitization process performing chalcogen sensitization such as sulfur sensitization; selenium sensitization or tellurium sensitization or noble metal sensitization such as gold sensitization), during water washing process, during dispersion process or before chemical sensitization process. In order not to allow silver halide fine grains to grow, it is preferable that addition of the hexacyano-metal complex after grain formation is rapidly conducted. The hexacyano-metal complex is preferably added before completion of feeding process.

The addition of the hexacyano-metal complex may be started after the addition of silver nitrate used in the grain formation has proceeded by 96 mass %, preferably after the addition has proceeded by 98 mass %, and more preferably after the addition has proceeded by 99 mass %.

Addition of the hexacyano-metal complex after adding an aqueous solution of silver nitrate to be added just before completion of the grain formation allows the silver halide grains to adsorb the complex on the outermost surface thereof, and most of the complex forms a hardly soluble salt with silver ions on the surfaces of the grains. The silver salt of hexa-iron (II) is more hardly soluble than AgI, and therefore re-dissolution caused by that the grains are fine can be prevented. Thus, production of silver halide fine grains with a small grain size has become possible.

Further, a metal atom (e.g., [Fe(CN)₆ ⁴⁻) that can be incorporated in the silver halide grains used in the invention, a desalting method and a chemical sensitization method of the silver halide emulsion are described in JP-A Nos. 11-84574, paragraphs [0046] to [0050], 11-65021, paragraphs [0025] to [0031] and 11-119374, paragraphs [0242] to [0250].

6) Gelatin

The photosensitive silver halide emulsion used in the invention may include any gelatin, but phthalated gelatin is preferable. In order to keep the dispersion state of the gelatin good in a coating liquid including the photosensitive silver halide emulsion and an organic silver salt, use of gelatin having a low molecular weight ranging from 500 to 60,000 is preferable. Such low molecular weight gelatin may be used during grain formation, or during dispersion which is conducted after desalting process, and use thereof during dispersion conducted after desalting process is preferable.

7) Chemical Sensitization

The photosensitive silver halide used in the invention may not be subjected to chemical sensitization, but is preferably subjected to chemical sensitization by at least one of a chalcogen sensitization method, a gold sensitization method and a reduction sensitization method. The silver halide may be sensitized by a gold-chalcogen sensitization method. Examples of the chalcogen sensitization method include a sulfur sensitization method, a selenium sensitization method and a tellurium sensitization method.

In the sulfur sensitization, a labile sulfur compound is used. As the labile sulfur compound, those described in P. Grafkides, Chimie et Physique Photographique, 5th Ed., Paul Momtel (1987), and Research Disclosure, vol. 307, No. 307150 can be utilized.

Specifically, a known sulfur compound such as thiosulfates (e.g., hypo), thioureas (e.g., diphenylthiourea, triethylthiourea, N-ethyl-N′(4-methyl-2-thiazolyl) thiourea, or carboxymethyltrimethylthiourea), thioamides (e.g., thioacetamide), rhodanines (e.g., diethylrhodanine, or 5-benzylidene-N-ethylrhodanine), phosphine sulfides (e.g., trimethylphosphine sulfide), thiohydantoins, 4-oxo-oxazolidine-2-thions, di- or poly-sulfides (e.g., dimorpholine disulfide, cysteine, or lenthionine), polythionates, or elemental sulfur, active gelatin may be used. Thiosulfates, thioureas and rhodanines are particularly preferable.

In the selenium sensitization, a labile selenium compound is used. As the labile selenium compound, those described in Japanese Patent Application Publication (JP-B) Nos. 43-13489 and 44-15748, JP-A Nos. 4-25832, 4-109340, 4-271341, 5-40324, 5-11385, 6-51415, 6-175258, 6-180478, 6-208186, 6-208184, 6-317867, 7-92599, 7-98483 and 7-140579 can be used.

Specifically, examples thereof include colloidal metal selenium, selenoureas (e.g., N,N-dimethylselenourea, trifluoromethylcarbonyl-trimethylselenourea, and acetyltrimethylselenourea), selenoamides (e.g., selenoamide, and N,N-diethylphenylselenoamide), phosphine selenides (e.g., triphenylphosphineselenide, and pentafluorophenyl-triphenylphosphineselenide), selenophosphates (e.g., tri-p-tolylselenophosphate, and tri-n-butylselenophosphate), selenoketones (e.g., selenobenzophenone), isoselenocyanates, selenocarboxylic acids, selenoesters and diacyl selenides. In addition, non-labile selenium compounds (those described in JP-B Nos. 46-4553 and 52-34492) such as selenious acid, selenocyanates, selenazoles and selenides may also be used. In particular, phosphine selenides, selenoureas and selenocyanates are preferable.

In the tellurium sensitization, a labile tellurium compound is used and labile tellurium compounds described in JP-A Nos. 4-224595, 4-271341, 4-333043, 5-303157, 6-27573, 6-175258, 6-180478, 6-208186, 6-208184, 6-317867, 7-140579, 7-301879 and 7-301880 can be used.

Specifically, examples thereof include phosphine tellurides (e.g., butyl-diisopropylphosphine telluride, tributylphosphine telluride, tributoxyphosphine telluride, and ethoxydiphenylphophine telluride), diacyl (di)tellurides (e.g., bis(diphenylcarbamoyl) ditelluride, bis(N-phenyl-N-methylcarbamoyl) ditelluride, bis(N-phenyl-N-methylcarbamoyl) telluride, bis(N-phenyl-N-benzylcarbamoyl) telluride, and bis(ethoxycarbonyl) telluride), telluroureas (e.g., N,N′-dimethylethylenetellurourea, and N,N′-diphenylethylenetellurourea), telluroamides and telluroesters. In particular, diacyl (di)tellurides and phosphine tellurides are preferable and compounds described in documents described in JP-A No. 11-65021, paragraph [0030] and compounds represented by formula (II), (III) or (IV) in JP-A No. 5-313284 are more preferable.

In particular, the chalcogen sensitization in the invention is preferably selenium sensitization or tellurium sensitization and more preferably tellurium sensitization.

In the gold sensitization, a gold sensitizer described in P. Grafkides, Chimie et Physique Photographique, 5th Ed., Paul Momtel (1987) and Research Disclosure, vol. 307, No. 307105 may be used. Specific examples thereof include chloroauric acid, potassium chloroaurate, potassium aurithiocyanate, gold sulfide, gold selenide, and gold 5,049,485, 5,169,751 and 5,252,455 and Belgian Patent No. 691,857. A salt of a noble metal other than gold such as plutinum, paradium or iridium which salt is described in P. Grafkides, Chimie et Physique Photographique, 5th Ed., Paul Momtel (1987) and Research Disclosure, vol. 307, No. 307105 may be also used.

The gold sensitization may be conducted alone, however a combined use of the gold sensitization and the chalcogen sensitization is preferable. Specific examples of the combination include gold-sulfur sensitization, gold-selenium sensitization, gold-tellurium sensitization, gold-sulfur-selenium sensitization, gold-sulfur-tellurium sensitization, gold-selenium-tellurium sensitization and gold-sulfur-selenium-tellurium sensitization. The combination of gold sensitization and at least sulfur sensitization is preferable.

The amount of the chalcogen sensitizer used in the invention depends on the silver halide grains to be used or chemical ageing conditions, however, may be about from 10⁻⁸ to 10⁻¹ mol, and is preferably about from 10⁻⁷ to 10⁻² mol per mol of silver halide.

Similarly, the amount of the gold sensitizer for use in the invention depends on various conditions, however may be from 10⁻⁷ to 10⁻² mol for measure, and is preferably from 10⁻⁶ to 5×10⁻³ mol per mol of silver halide. Any condition may be selected as environmental conditions for chemical sensitization of the emulsion. However, pAg is 8 or less, preferably 7.0 or less, more preferably 6.5 or less and particularly 6.0 or less, however pAg is 1.5 or more, preferably 2.0 or more, more preferably 2.5 or more, still more preferably 3 or more and particularly preferably 4.0 or more. pH is from 3 to 10, and preferably from 4 to 9. Temperature is from 20° C. to 95° C., and preferably from 25° C. to 80° C.

It is preferable to use a water-soluble thiocyanate such as potassium thiocyanate, sodium thiocyanate or ammonium thiocyanate at the time of chemical sensitization, particularly at the time of chalcogen sensitization or gold-chalcogen sensitization. The amount of the thiocyanate is 1×10⁻³ mol or more, preferably from 2×10⁻³ mol to 8×10⁻¹ mol, more preferably from 3×10⁻³ mol to 2×10⁻⁰² mol, and particularly preferably 5×10⁻³ mol to 1×10⁻¹ mol per mol of silver of silver halide.

In the invention, reduction sensitization may be further conducted in combination with the chalcogen sensitization and gold sensitization. In particular, a combination of the reduction sensitization and the chalcogen sensitization is preferable.

As a specific compound for use in the reduction sensitization method, ascorbic acid, thiourea dioxide and dimethylamineborane are preferable. In addition, stannous chloride, aminoiminomethanesulfinic acid, a hydrazine derivative, a borane compound, a silane compound or a polyamine compound is preferably used. A reduction sensitizer may be added to a system at any step in manufacturing process of the photosensitive emulsion from crystal growth to a preparation process just before coating. The reduction sensitization is preferably conducted by respectively maintaining pH and pAg of the emulsion at 8 or higher and 4 or lower to age the emulsion. Further, the reduction sensitization is also preferably carried out by introducing a single addition portion of silver ions into a system at the time of grain formation.

The reduction sensitization may be conducted alone or in arbitrary combination with the chalcogen sensitization or gold-chalcogen sensitization. However, when combined with the gold-chalcogen sensitization, these sensitizations are preferably carried out with respect to the interiors of the silver halide grains.

The amount of the reduction sensitizer to be added depends on various conditions, and is from 10⁻⁷ mol to 10⁻¹ mol for measure, and more preferably from 10⁻⁶ mol to 5×10⁻² mol per mol of silver halide.

In the invention, the chemical sensitization can be conducted at any time during grain formation, or at any time after grain formation and before coating, and is particularly preferably carried out after and during grain formation. Further, the sensitization may be conducted at any time after desalting, before, during, or after spectral sensitization, or just before coating.

The silver halide emulsion for use in the invention may contain a thiosulfonic acid compound and the addition method is described in EP-A No. 293,917.

The photosensitive silver halide grains in the invention may be preferably subjected to chemical sensitization by at least one method of the gold sensitization and the chalcogen sensitization from the viewpoint of design of a photothermographic material with high sensitivity.

8) Compound Capable of Undergoing One-electron Oxidation to Form One-electron Oxidant Capable of Releasing One or More Electrons

The photothermographic material of the invention preferably contains a compound capable of undergoing one-electron oxidation to form a one-electron oxidant capable of releasing one or more electrons. The compound may be used alone or in combination with any of the aforementioned chemical sensitizers to improve sensitivity of the silver halide.

The compound capable of undergoing one-electron oxidation to form a one-electron oxidant capable of releasing one or more electrons contained in the photosensitive material of the invention is preferably a compound selected from following types 1 and 2.
(Type 1): A compound capable of undergoing one-electron oxidation to form a one-electron oxidant thereof which is capable of releasing further one or more electrons through a subsequent bond cleavage reaction; and
(Type 2): A compound capable of undergoing one-electron oxidation to form a one-electron oxidant thereof which is capable of releasing further one or more electrons after going through a subsequent bond formation reaction

First, Type 1 compound will be explained.

Examples of Type 1 compound, which is capable of undergoing one-electron oxidation to form a one-electron oxidant thereof which is capable of releasing further one electron through a subsequent bond cleavage reaction, include those referred to as “a one-photon-two-electron sensitizer” or “a deprotonation electron donating sensitizer” described in JP-A Nos. 9-211769 (specific examples: compounds PMT-1 to S-37 listed in Tables E and F on pages 28 to 32), 9-211774 and 11-95355 (specific examples: compounds INV 1 to 36), 2001-500996 (specific examples: compounds 1 to 74, 80 to 87 and 92 to 122), U.S. Pat. Nos. 5,747,235 and 5,747,236, EP-A No. 786,692 (specific examples: compounds INV 1 to 35), and EP-A No. 893,732 and U.S. Pat. Nos. 6,054,260 and 5,994,051. Preferable range of these compounds is the same as that described in the above patent specifications.

In addition, examples of Type 1 compound, which is capable of undergoing one-electron oxidation to form a one-electron oxidant thereof which is capable of releasing further one or more electrons through a subsequent bond cleavage reaction, include those represented by formula (1) (equivalent to formula (1) described in JP-A No. 2003-114487), formula (2) (equivalent to formula (2) described in JP-A No. 2003-114487), formula (3) (equivalent to formula (1) described in JP-A No. 2003-114488), formula (4) (equivalent to formula (2) described in JP-A No. 2003-114488), formula (5) (equivalent to formula (3) described in JP-A No. 2003-114488), formula (6) (equivalent to formula (1) described in JP-A No. 2003-75950), formula (7) (equivalent to formula (2) described in JP-A No. 2003-75950), or formula (8) (equivalent to formula (1) described in Japanese Patent Application No. 2003-25886), and compounds represented by formula (9) (equivalent to formula (3) described in Japanese Patent Application No. 2003-33446) among those capable of causing a reaction of reaction formula (1) (equivalent to reaction formula (1) described in Japanese Patent Application No. 2003-33446). Preferable range of these compounds is the same as that described in the above patent specifications.

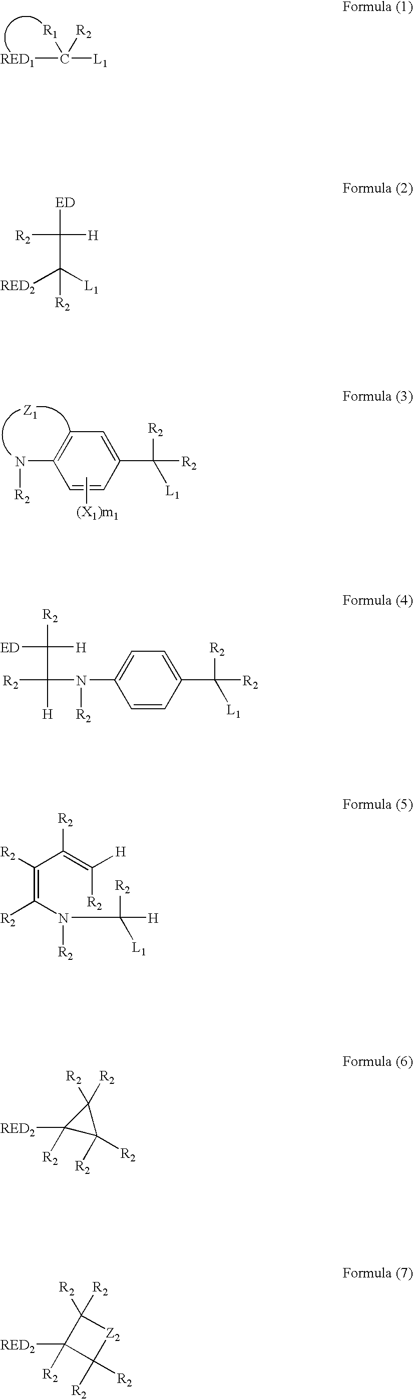

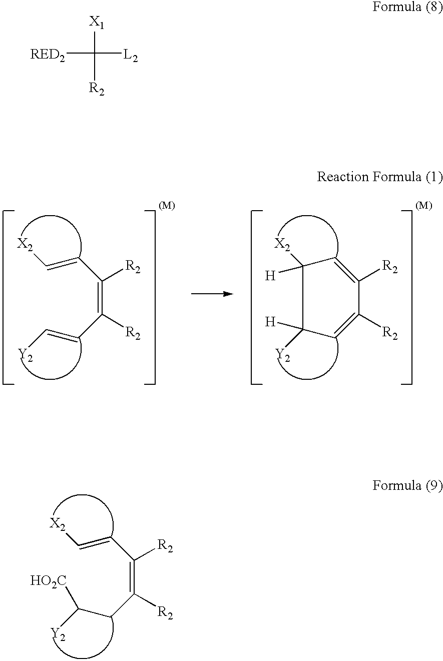

In the formulae, RED₁ and RED₂ represent reducing groups. R₁ represents a nonmetallic atomic group capable of forming a ring structure corresponding to a tetrahydro or octahydro derivative of a 5- or 6-membered aromatic ring (including an aromatic heterocycle) together with a carbon atom (C) and RED₁. R₂ represents a hydrogen atom or a substituent. In the case where plural R₂s exist in one molecule, they may be identical to or different from each other. L₁ represents a leaving group. ED represents an electron-donating group. Z₁ represents an atomic group capable of forming a 6-membered ring together with a nitrogen atom and two carbon atoms of a benzene ring. X₁ represents a substituent. m₁ represents an integer of 0 to 3. Z₂ represents —CR₁₁R₁₂—, —NR₁₃— or —O—. R₁₁ and R₁₂ independently represent a hydrogen atom or a substituent. R₁₃ represents a hydrogen atom, an alkyl group, an aryl group or a heterocyclic group. X₁ represents an alkoxy group, an aryloxy group, a heterocyclic oxy group, an alkylthio group, an arylthio group, a heterocyclic thio group, an alkylamino group, an arylamino group, or a hetercyclic amino group. L₂ represents a carboxyl group or a salt thereof, or a hydrogen atom. X₂ represents a group forming a 5-membered heterocycle together with C═C. Y₂ represents a group forming a 5- or 6-membered aryl group or heterocyclic group together with C═C. M represents a radical, a radical cation, or a cation.

Next, Type 2 compound will be explained.

Examples of Type 2 compound, which is capable of undergoing one-electron oxidation to form a one-electron oxidant thereof which is capable of releasing further one or more electrons after going through a subsequent bond formation reaction, include compounds represented by formula (10) (equivalent to formula (1) described in JP-A No. 2003-140287) and compounds formula (11) (equivalent to formula (2) described in Japanese Patent Application No. 2003-33446) among those capable of causing a reaction represented by reaction formula (1) (equivalent to reaction formula (1) described in Japanese Patent Application 2003-33446). Preferable range of these compounds is identical to that described in the above patent specifications.
X—L₂—Y Formula (10)

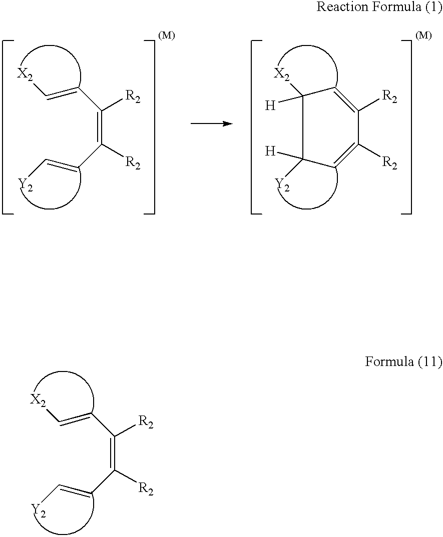

In the above formulas, X represents a reducing group to be subjected to one-electron oxidation. Y represents a reactive group containing a carbon-carbon double bond site, a carbon-carbon triple bond site, an aromatic group site or a non-aromatic heterocycle site of benzo condensation group capable of reacting with a one-electron oxidant generated by one-electron oxidation of X to from a new bond. L₂ represents a liking group liking X and Y. R₂ represents a hydrogen atom or a substituent. In the case where plural R₂s exist in one molecule, they may be identical to or different from each other. X₂ represents a group forming a 5-membered heterocyclic group together with C═C. Y₂ represents a group forming a 5- or 6-membered aryl group or a heterocyclic group together with C═C. M represents a radical, a radical cation, or a cation.

Among compounds of Type 1 or Type 2, “those having an adsorptive group to silver halide in the molecule thereof” or “those having the partial structure of a spectral sensitizing dye in the molecule thereof” are preferable. As for the adsorptive group to silver halide, typical ones are described in JP-A No. 2003-156823, page 16, line 1 of right column to page 17, line 12 of right column. The partial structure of a spectral sensitizing dye is a structure described on page 17, line 34 of right column to page 18, line 6 of left column of the same patent specification.

Type 1 and Type 2 compounds are more preferably “those having at least one adsorptive group to silver halide in the molecule thereof.” Still more preferable compounds of Types 1 and 2 are “those having 2 or more adsorptive groups to silver halide in the molecule thereof.” When 2 or more adsorptive groups to silver halide exist in one molecule, these groups may be identical to or different from each other.

Preferable examples of the adsorptive group include mercapto-substituted nitrogen-containing heterocyclic groups (e.g., a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzthiazole group, and a 1,5-dimethyl-1,2,4-triazolium-3-thiolate group) and nitrogen-containing heterocyclic groups having, as a partial structure of the heterocycle, —NH-group capable of forming imino silver (>NAg) (such as a benzotriazole group, a benzoimidazole group and an indazole group). A 5-mercaptotetrazole group, a 3-mercapto-1,2,4-triazole group and a benzotriazole group are particularly preferable, and a 3-mercapto-1,2,4-triazole group and a 5-mercaptotetrazole group are the most preferable.

Compounds having, as the adsorptive groups and as partial structures thereof, 2 or more mercapto groups in one molecule are also particularly preferable. Here, the mercapto group (—SH) may tautomerize, if possible, to form a thion group. Preferable examples of the adsorptive group having 2 or more mercapto groups as partial structures (such as a dimercapto-substituted nitrogen-containing heterocyclic group) include a 2,4-dimercapto pyrimidine group, a 2,4-dimercapto triazine group and a 3,5-dimercapto-1,2,4-triazole group.

In addition, quaternary salt structure of nitrogen or phosphorous is also preferably used as the adsorptive group. Specific examples of the structure of a quaternary salt of nitrogen include ammonio groups (such as a trialkylammonio group, a dialkylaryl-(or heteroaryl-)ammonio group, and an alkyldiaryl-(or heteroaryl-)ammonio group) and groups containing a nitrogen-containing heterocyclic group including a quaternary nitrogen atom. Examples of the structure of a quaternary salt of phosphorous include phosphonio groups (such as a trialkylphosphonio group, a dialkylaryl-(or heteroaryl-) phosphonio group, an alkyldiaryl-(or heteroaryl-)phosphonio group, a triaryl-(or heteroaryl-)phosphonio group). The structure of the quaternary salt of nitrogen is more preferably used, and a 5-membered or 6-membered nitrogen-containing aromatic heterocyclic group containing a quaternary nitrogen atom is still more preferably used. Particularly preferably, a pyridinio group, a quinolinio group or an isoquinolinio group is used. These nitrogen-containing heterocyclic groups including a quaternary nitrogen atom may have any substituent.

Examples of the counter anion of the quaternary salt include halogen ions, carboxylate ions, sulfonate ions, a sulfate ion, a perchlorate ion, a carbonate ion, a nitrate ion, BF₄⁻, PF₆⁻ and Ph₄B⁻. When a group with a minus charge such as carboxylate groups exists in the molecule, an intramolecular salt including the group may be formed. As a counter-anion not existing in the molecule, a chloride ion, a bromide ion or a methanesulfonate ion is particularly preferable.

Preferable structures of compounds of Type 1 and Type 2 having, as the adsorptive group, the quaternary salt structure of nitrogen or phosphorous is represented by formula (X)
(P-Q₁-)ᵢ—R(-Q₂-S)ⱼ Formula (X)

In formula (X), P and R independently represent a quaternary salt structure of nitrogen or phosphorous which quaternary salt is not the partial structure of a sensitizing dye. Q₁ and Q₂ independently represent a linking group, and specifically represent a single bond, an alkylene group, an arylene group, a heterocyclic group, —O—, —S—, —NR_{N}—, —C(═O)—, —SO₂—, —SO— and —P(═O)—, or groups having a combination of these groups. R_{N} represents a hydrogen atom, an alkyl group, an aryl group or a heterocyclic group. S is a residue formed by removing one atom from a compound of Type 1 or Type 2. Both i and j are integers of 1 or more. They are selected such that the sum of i and j is 2 to 6. Preferably, i is 1 to 3 and j is 1 or 2. More preferably, i is 1 or 2 and j is 1. Particularly preferably, i is 1 and j is 1. The compound represented by formula (X) preferably has 10 to 100 carbon atoms in total, more preferably 10 to 70 carbon atoms, and still more preferably 11 to 60 carbon atoms, and particularly preferably 12 to 50 carbon atoms.

The compounds of Type 1 and Type 2 in the invention may be used at any time during preparation of the photosensitive silver halide emulsion or in photothermographic material manufacturing steps, for example, during photosensitive silver halide grain formation, at the time of a desalting step, at the time of chemical sensitization or before coating. Further, separate portions of the compound may be added two or more times in these steps. The addition is preferably conducted within a period from completion of photosensitive silver halide grain formation to before the desalting step, during the chemical sensitization (immediately before initiation of chemical sensitization to immediately after completion thereof), or before coating. The addition timing is more preferably conducted within a period from the chemical sensitization to formation of a mixture of the emulsion and a non-photosensitive organic silver salt.

The compound of Type 1 or Type 2 in the invention is preferably added as a solution in which the compound is dissolved in water, a water-soluble solvent such as methanol or ethanol, or a mixed solvent thereof. For the compound which is soluble in water and whose solubility increases by increasing or decreasing pH of the resultant solution, a solution in which the compound is dissolved in water and whose pH is adjusted to be high or low may be added.

The compound of Type 1 or Type 2 in the invention is preferably used in an emulsion layer containing a photosensitive silver halide and a non-photosensitive organic silver salt. Further, it may be added to not only the emulsion layer containing the photosensitive silver halide and the non-photosensitive organic silver salt but also a protective layer and/or an intermediate layer so as to allow the compound to diffuse at the time of coating. Regardless of addition timing of a sensitizing dye, the compound of the invention may be added to a silver halide emulsion layer. The content thereof is preferably 1×10⁻⁹ to 5×10⁻¹ mol, and more preferably 1×10⁻⁸ to 5×10⁻² mol per mol of silver halide.

Hereinafter, specific examples of Type 1 and Type 2 compounds will be shown. However, the invention is not limited to them. 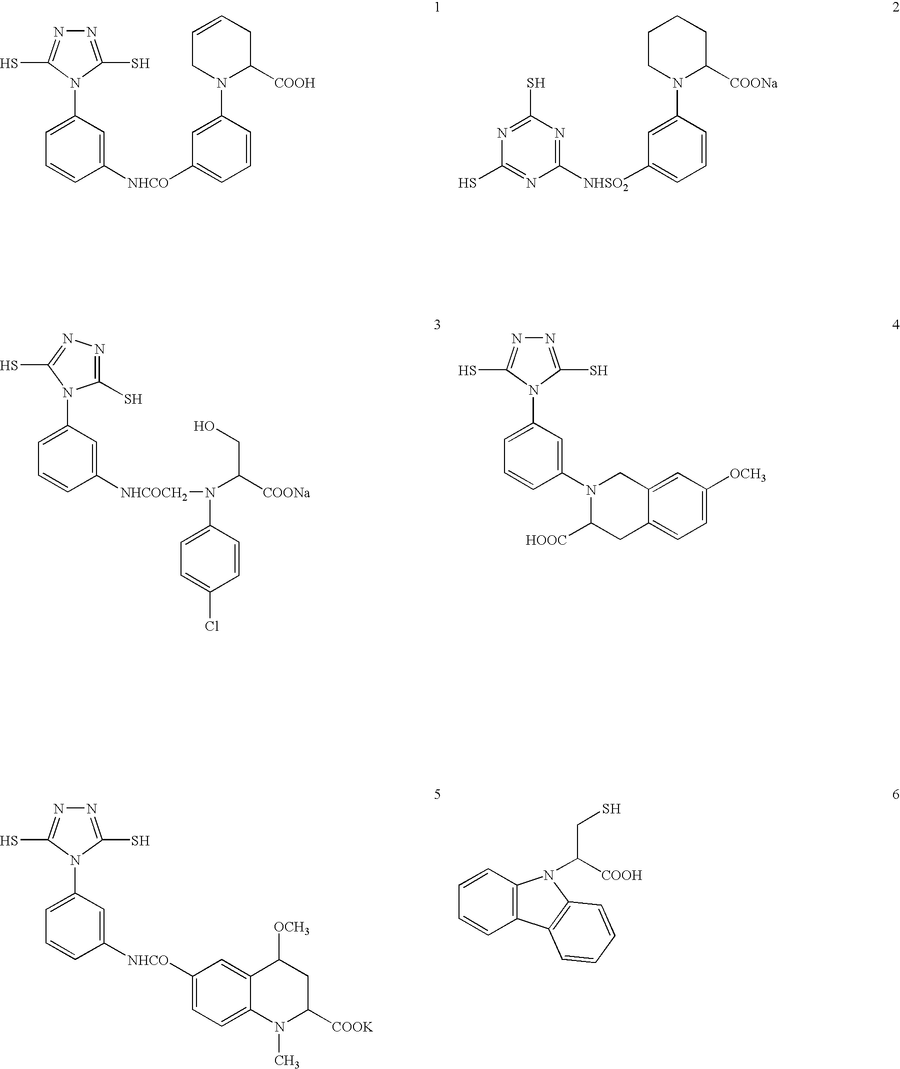 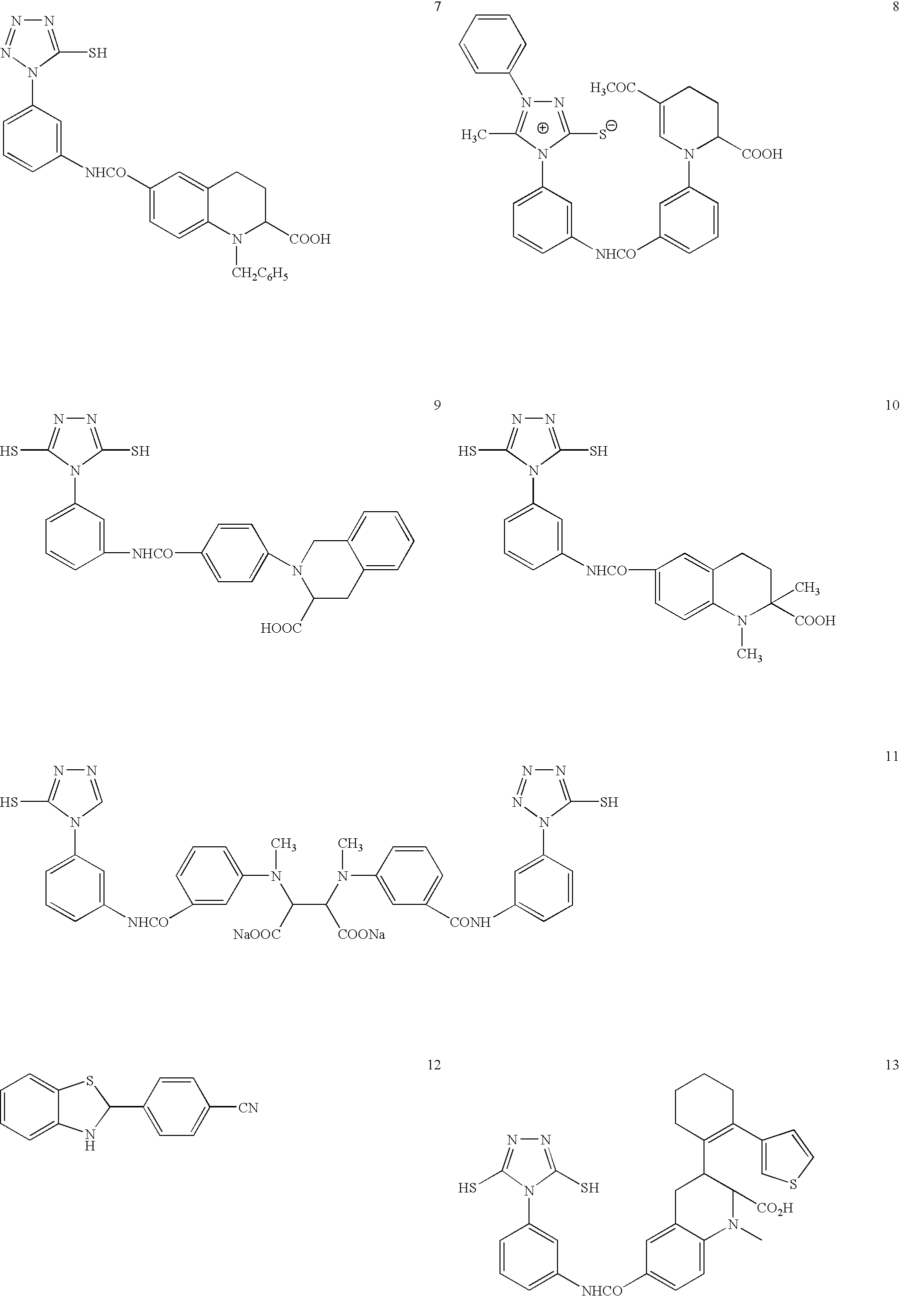 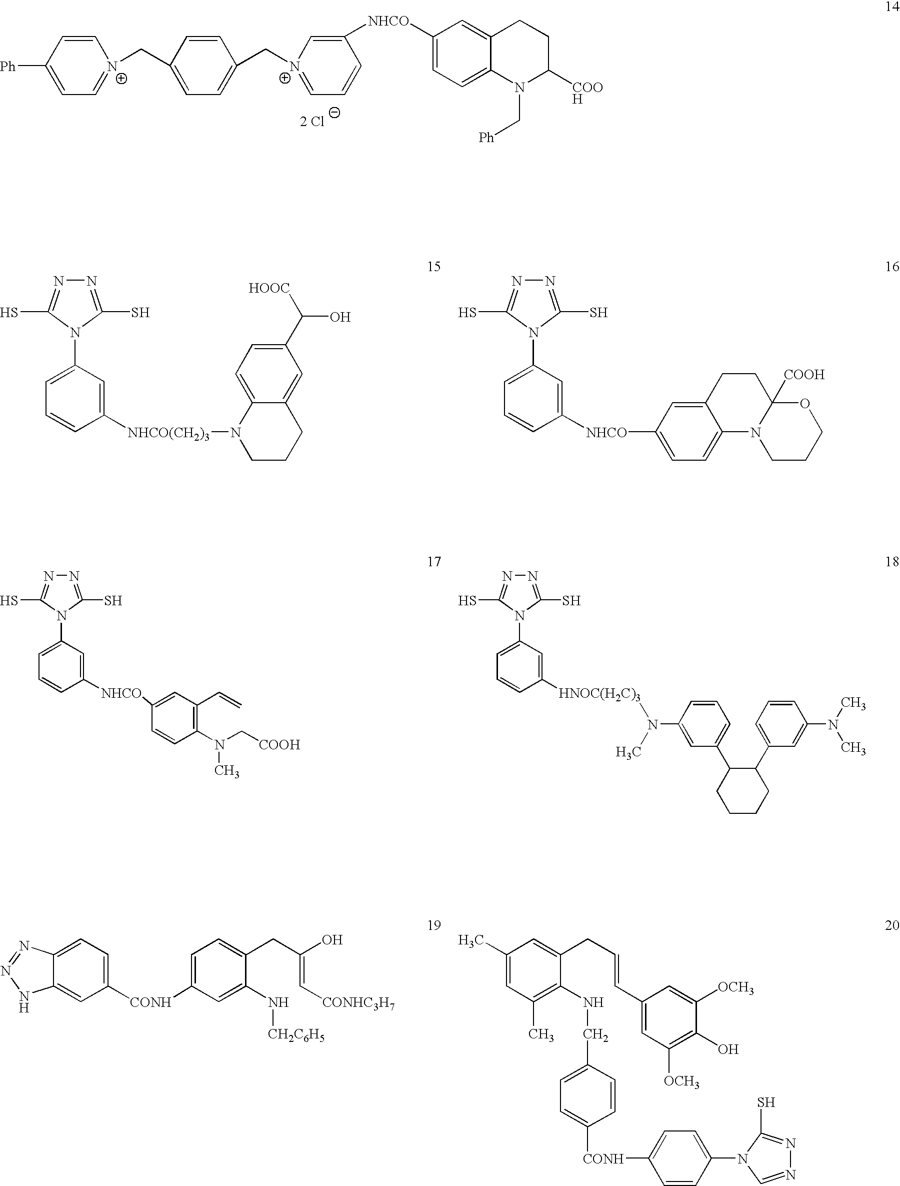 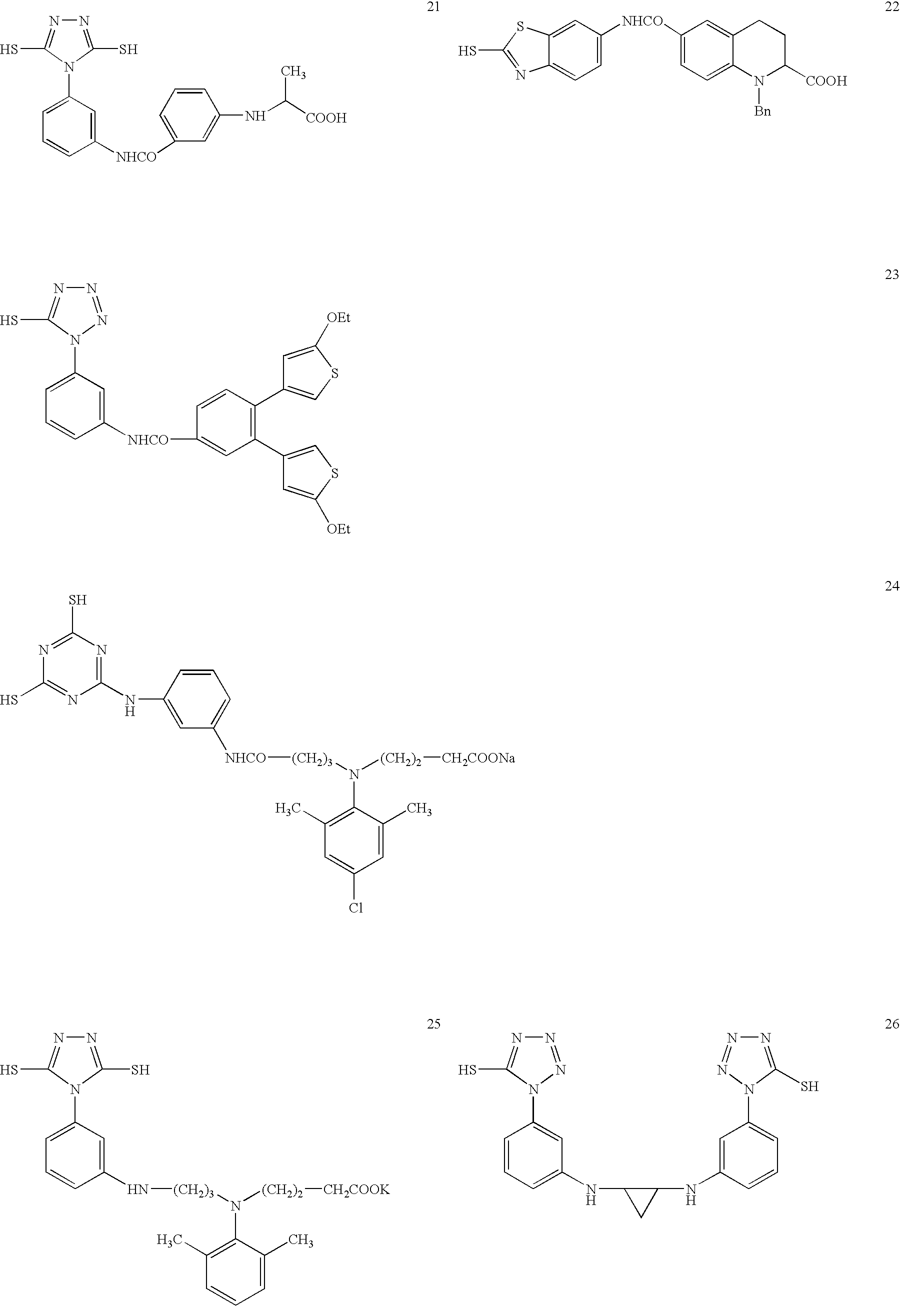 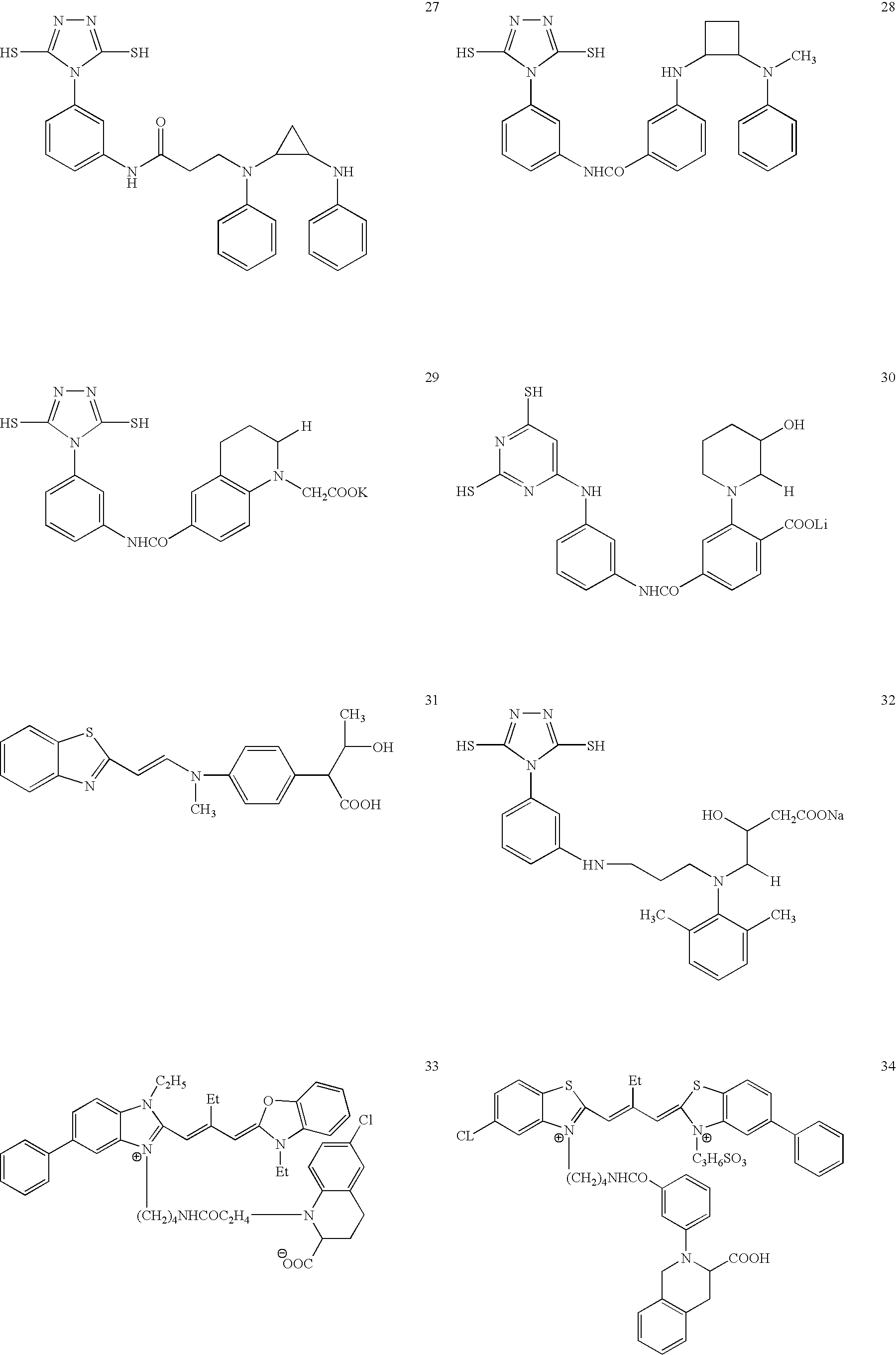 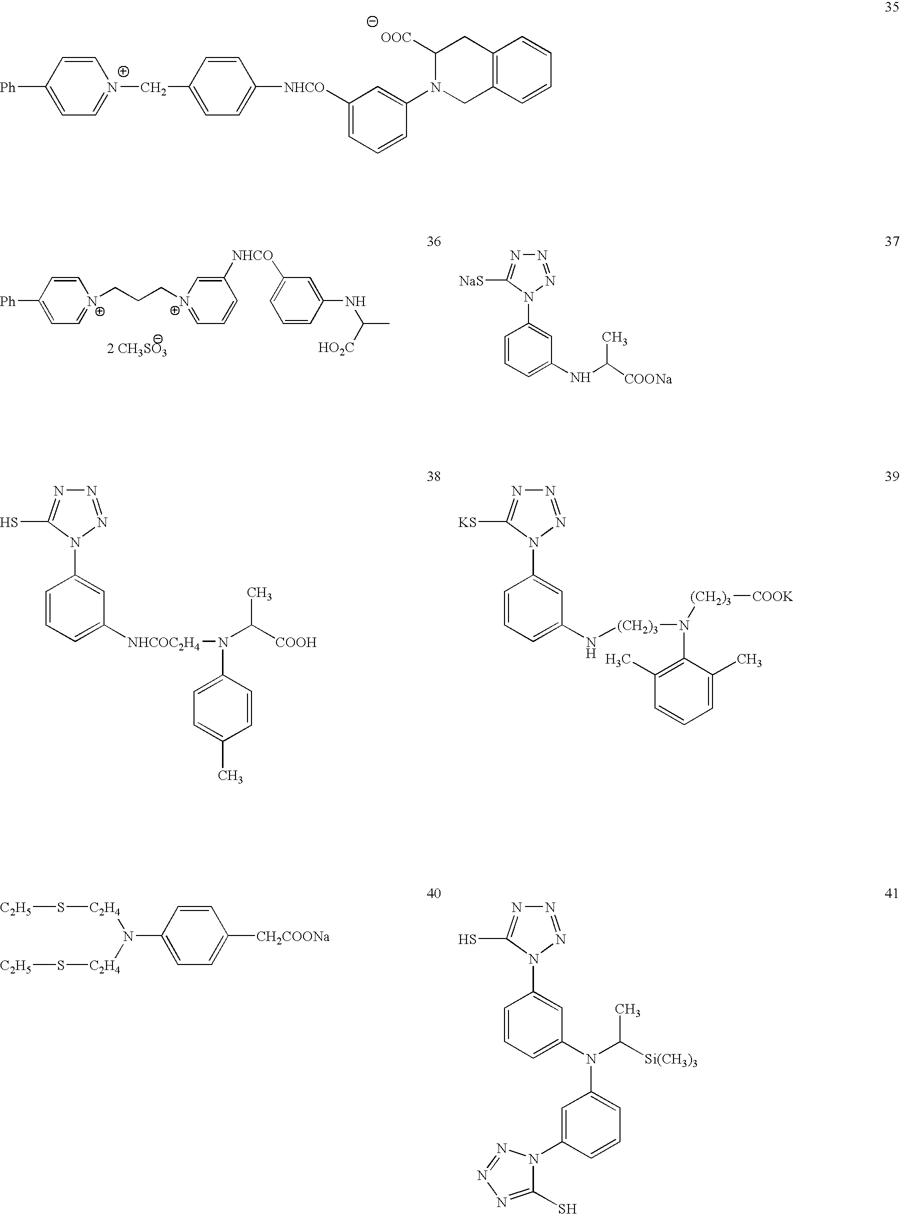 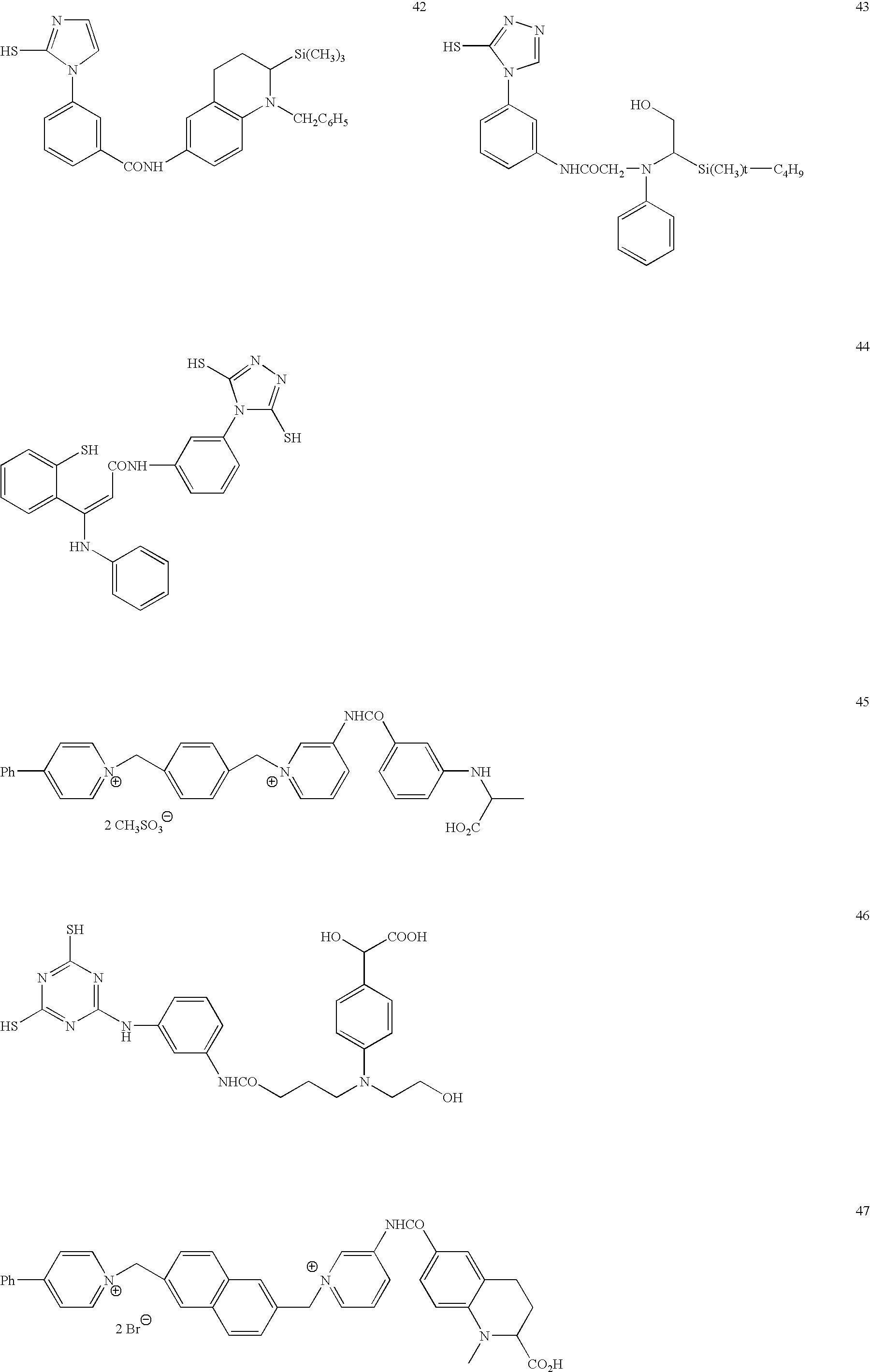
9) Adsorptive Redox Compound having Adsorptive Group and Reducing Group

In the invention, incorporation of an adsorptive redox compound having an adsorptive group to silver halide and reducing group in the molecule thereof is preferable. The adsorptive redox compound is preferably a compound represented by formula (I).
A−(W)ₙ−B Formula (I)

In formula (I), A represents a group capable of being adsorbed by silver halide (hereinafter, referred to as an adsorptive group), W represents a divalent linking group, n represents 0 or 1, and B represents a reducing group.

In formula (I), the adsorptive group represented by A means a group which is directly adsorptive to a silver halide, or a group which promotes such adsorption to the silver halide. Specific examples thereof include a mercapto group (or a salt thereof), a thion group (—C(═S)—), a heterocyclic group containing at least one atom selected from a nitrogen atom, a sulfur atom, a selenium atom and a tellurium atom, a sulfide group, a disulfide group, a cationic group and an ethynyl group.

The “mercapto group (or the salt thereof)” serving as the adsorptive group means not only a mercapto group (or a salt thereof) but also a heterocyclic, aryl or alkyl group preferably substituted by at least one mercapto group (or salt thereof). Herein, the heterocyclic group at least refers to a 5- to 7-membered, monocyclic or condensed-cyclic, aromatic or non-aromatic heterocyclic group. Examples of such a heterocyclic group include an imidazole ring group, a thiazole ring group, an oxazole ring group, a benzoimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group and a triazine ring group. A heterocyclic group containing a quaternary nitrogen atom may be usable, in which a mercapto substituent can dissociate to form a meso ion. When the mercapto group forms a salt, the counter ion can be, for example, the cation of an alkali metal, an alkaline earth metal or a heavy metal (e.g., Li⁺, Na⁺, K⁺, Mg²⁺, Ag⁺, or Zn²⁺), an ammonium ion, a heterocyclic group containing a quaternary nitrogen atom, or a phosphonium ion.

The mercapto group serving as the adsorptive group may tautomerize to a form thion group.

Examples of the thion group serving as the adsorptive group include a linear or cyclic thioamide group, a thioureido group, a thiourethan group and a dithiocarbamic acid ester group.

The heterocyclic group containing at least one atom selected from a nitrogen atom, a sulfur atom, a selenium atom and a tellurium atom serving as the adsorptive group means a nitrogen-containing heterocyclic group having an —NH— group capable of forming an imino silver (>NAg) as a partial structure of the heterocycle, or a heterocyclic group having as a partial structure of the heterocycle a “—S—” group or a “—Se—” group or a “—Te—” group or a “═N—” group capable of coordinating with a silver ion by a coordinate bond. The former heterocyclic group can be, for example, a benzotriazole group, a triazole group, an indazole group, a pyrazole group, a tetrazole group, a benzimidazole group, an imidazole group or a purine group. The latter heterocyclic group can be, for example, a thiophene group, a thiazole group, an oxazole group, a benzothiophene group, a benzothiazole group, a benzoxazole group, a thiadiazole group, an oxadiazole group, a triazine group, a selenoazole group, a benzoselenoazole group, a tellurazole group or a benzotellurazole group.

Examples of the sulfido group and the disulfido group serving as the adsorptive group include all the groups having a partial structure of “—S—” or “—S—S—.”

The cationic group serving as the adsorptive group means a group containing a quaternary nitrogen atom. An specific example thereof is a group containing a nitrogen-containing heterocyclic group containing an ammonio group or a quaternary nitrogen atom. The nitrogen-containing heterocyclic group containing a quaternary nitrogen atom can be, for example, a pyridinio group, a quinolinio group, an isoquinolinio group or an imidazolio group.

The ethynyl group serving as the adsorptive group means a —C≡CH group, whose hydrogen atom may be replaced by a substituent.

The adsorptive group may have any substituent.

Furthermore, specific examples of the adsorptive group include those listed in JP-A No. 11-95355, pages 4 to 7.

In formula (I), preferable examples of the adsorptive group represented by A include mercapto-substituted heterocyclic groups (e.g., a 2-mercaptothiadiazole group, a 2-mercapto-5-aminothiadiazole group, a 3-mercapto-1,2,4 -triazole group, a 5-mercaptotetrazole group, a 2-mercapto-1,3,4-oxadiazole group, a 2-mercaptobenzimidazole group, a 1,5-dimethyl-1,2,4-triazolium-3-thiolate group, a 2,4-dimercaptopyrimidine group, a 2,4-dimercaptotriazine group, a 3,5-dimercapto-1,2,4-triazole group, and a 2,5-dimercapto-1,3-thiazole group), and nitrogen-containing heterocyclic groups having an —NH— group capable of forming an iminosilver (>NAg) as a partial structure of the heterocycle (e.g., a benzotriazole group, a benzimidazole group and an indazole group). More preferably, the adsorptive group is a 2-mercaptobenzimidazole group or a 3,5-dimercapto-1,2,4-triazole group.

In formula (I), W represents a divalent linking group. Any linking group may be usable except as long as it does not give an adverse affect to photographic properties. For example, a divalent linking group constituted by a carbon atom, a hydrogen atom, an oxygen atom, a nitrogen atom and/or a sulfur atom can be utilized. Examples of such a linking group include an alkylene group having from 1 to 20 carbon atoms (for example, a methylene group, an ethylene group, a trimethylene group, a tetramethylene group, and a hexamethylene group), an alkenylene group having from 2 to 20 carbon atoms, an alkynylene group having from 2 to 20 carbon atoms, an arylene group having from 6 to 20 carbon atoms (for example, a phenylene group, and a naphthylene group), a —CO— group, an —SO₂— group, an —O— group, an —S— group, an —NR₁— group and combinations thereof, in which R₁ represents a hydrogen atom, an alkyl group, a heterocyclic group, or an aryl group.

The linking group represented by W may have any substituent.

In formula (I), the reducing group represented by B is a group capable of reducing silver ions. Examples thereof include a formyl group, an amino group, a group with a triple bond such as an acetylene group and a propargyl group, a mercapto group, hydroxylamines, hydroxamic acids, hydroxyureaes, hydroxyurethans, hydroxysemicarbazides, reductones (including reductone derivatives), anilines, phenols (including chroman-6-ols, 2,3-dihydrobenzofuran-5-ols, aminophenols, sulfonamidophenols, and polyphenols such as hydroquinones, catechols, resorcinols, benzentriols, and bisphenols), or a residue formed by removing one hydrogen atom from acylhydrazines, carbamoylhydrazines, 3-pyrazolidones and the like. They may have, of course, any substituent.

In formula (I), oxidation potential of the reducing group represented by B can be measured by a measuring method described in Akira Fujishima “DENKIKAGAKU SOKUTEIHOU (Electrochemical Measuring method)” (pp. 150-208, GIHODO SHUPPAN Co. Ltd.) and “JIKKEN KAGAKU KOUZA (Experimental Chemical Course)” 4th Edition, edited and written by Chemical Society of Japan (Vol. 9, pp 282 to 344, published by Maruzen Co., Ltd.). For example, it can be measured by a rotary disc voltammetry technique. Specifically, in the method, a sample is dissolved in a solution of methanol (pH 6.5) and Britton-Robinson buffer at a mixed ratio of 10 vol %:90 vol %, and a nitrogen gas is introduced into a container including the resultant solution for 10 minutes, and then voltammogram of the solution can be obtained at 25° C. at 1000 rotation per minute at a sweep speed of 20 mV/s by using a rotary disc electrode (RDE) made of glassy carbon as a working electrode, a platinum wire as a counter electrode, and a saturated calomel electrode as a reference electrode. A half-wave potential (E½) can be obtained based on the obtained voltammogram.

The reducing group represented by B in the invention preferably has an oxidation potential, when measured by the above method, in the range of about −0.3 V to about 1.0 V, more preferably about −0.1 V to about 0.8 V, and particularly preferably about 0 to about 0.7 V.

In formula (I), the reducing group represented by B is preferably hydroxylamines, hydroxamic acids, hydroxyureas, hydroxysemicarbazides, reductones, phenoles, acylhydrazines, carbamoilhydrazines, or residues formed by removing one hydrogen atom from 3-pyrazolidons.

The compound represented by formula (I) in the invention may be one into which a ballasting group or a polymer chain customarily employed in immobile photographic additives such as couplers is introduced. The polymer can be, for example, any of those described in JP-A No. 1-100530.

The compound of formula (I) in the invention may be a bis- or tris-body. The compound of formula (I) in the invention preferably has molecular weight in the range of 100 and 10000, more preferably in the range of 120 and 1000, and particularly preferably in the range of 150 and 500.

Hereinafter, examples of the compound of formula (I) in the invention are shown, however the invention is not restricted to them.

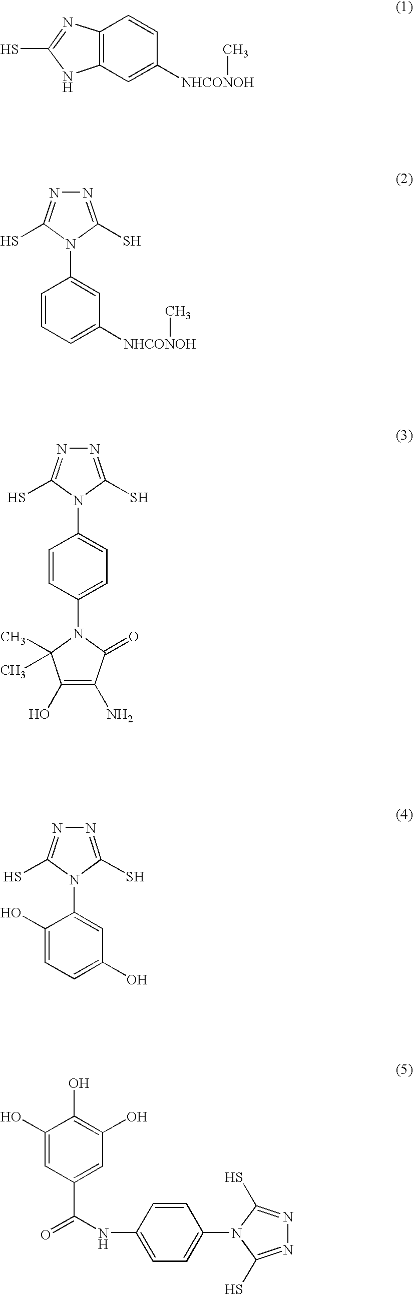

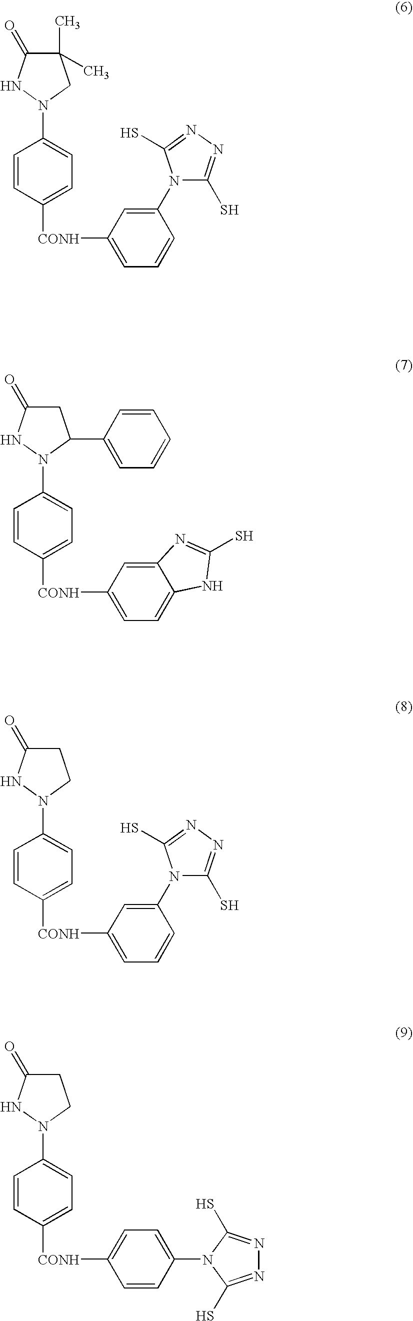

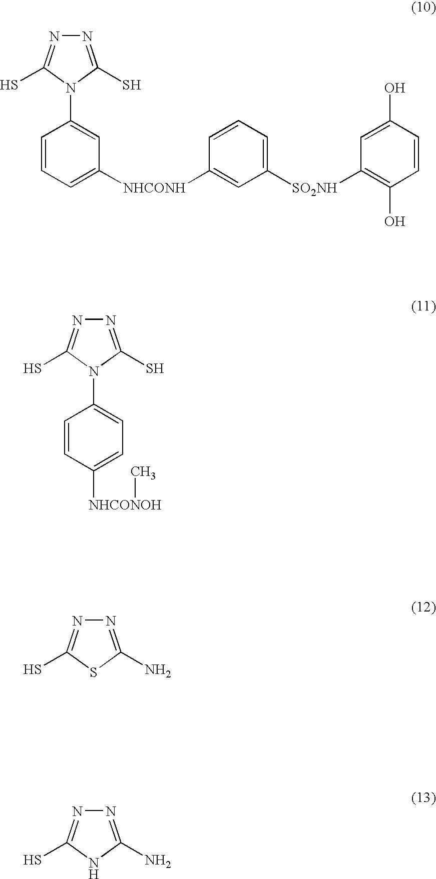

In addition, specific compounds 1 to 30 and 1″-1 to 1″-77 described in EP-A No. 1,308,776A2, pages 73 to 87, can also be preferably used as the compound having the adsorptive group and the reducing group in the invention.

The compound in the invention can be easily synthesized according to a known method.

The compound of formula (I) in the invention may be used alone or two kinds or more of the compounds are also preferably used. When two kinds or more of the compounds are used, they may be added to the same layer or to different layers. In this case, adding methods can be different from each other.

The compound of formula (I) in the invention is preferably contained in a silver halide emulsion layer and more preferably, it is added to a system during preparation of the emulsion. When it is added during preparation of the emulsion, it is possible to add it at any stage of the process. The compound can be added, for example, during silver halide grain formation step, before initiation of desalting step, during the desalting step, before initiation of chemical ageing step, during the chemical ageing step or before preparation of completed emulsion. Further, separate portions of the compound may be added two or more times during these steps. Use of the compound in the emulsion layer is preferable, but it may be added to not only the emulsion layer but also a protective layer or an intermediate layer adjacent to the emulsion layer to allow the compound to diffuse during coating.

Preferable addition amount of the compound greatly depends on the adding methods and the kind of the compound to be added, but generally is in the range of 1×10⁻⁶ to 1 mol, preferably 1×10⁻⁵ to 5×10⁻¹ mol, and more preferably 1×10⁻⁴ to 1×10⁻¹ mol per mol of photosensitive silver halide.

The compound of formula (I) in the invention may be added as a solution in which the compound is dissolved in water, a water-soluble solvent such as methanol or ethanol, or a mixed solvent thereof. At this time, it is possible to suitably adjust pH of the solution by an acid or a base, and the solution may also contain a surfactant. Further, the compound may be dissolved as an emulsion dispersion in an organic solvent with a high boiling point ane added, or may be added as a solid dispersion.

10) Sensitizing Dye

As a sensitizing dye applicable to the invention, a sensitizing dye, which, when adsorbed by silver halide grains, can spectrally sensitize the silver halide grains in a desired wavelength range and has spectral sensitivity suitable for spectral properties of an exposure source, can be advantageously selected. The silver halide photosensitive material and the photothermographic material of the invention are preferably subjected to spectral sensitization so as to have a peak of spectral sensitivity particularly in the range of 600 nm to 900 nm, or in the range of 300 nm to 500 nm. Examples of the sensitizing dye and the adding method include compounds described in JP-A No. 11-65021, paragraphs [0103] to [0109] and those represented by formula (II) of JP-A No. 10-186572, dyes represented by formula (I) and described in paragraph [0106] of JP-A No. 11-119374, dyes described in U.S. Pat. No. 5,510,236 and example 5 of U.S. Pat. No. 3,871,887, dyes disclosed in JP-A Nos. 2-96131 and 59-48753, and those described in line 38 of page 19 to line 35 of page 20 of EP-A No. 0,803,764, and JP-A Nos. 2001-272747, 2001-290238 and 2002-23306. One of these sensitizing dyes may be used alone or two or more of thereof may be used.

The addition amount of the sensitizing dye in the invention can be a desired one in accordance with properties such as sensitivity and fogging, but is preferably in the range of 10⁻⁶ to 1 mol, and more preferably 10⁻⁴ to 10⁻¹ mol per mol of silver halide in the photosensitive layer.

In the invention, a super-sensitizer may be employed in order to improve spectral sensitizing efficiency. As the super-sensitizer to be used in the invention, compounds described in EP-A No. 587,338, U.S. Pat. Nos. 3,877,943 and 4,873,184, and JP-A Nos. 5-341432, 11-109547 and 10-111543 can be used.

11) Combined Use of Silver Halides

As the photosensitive silver halide emulsion in the silver halide photosensitive material and the photothermographic material of the invention, only one kind thereof may be employed, or two or more kinds thereof (e.g., those having different average grain sizes, different halogen compositions, different crystal habits, or different chemical sensitization conditions) may be employed. Use of plural kinds of photosensitive silver halides having different sensitivities makes it possible to adjust gradation. The techniques in relation thereto are described in JP-A Nos. 57-119341, 53-106125, 47-3929, 48-55730, 46-5187, 50-73627 and 57-150841. Respective emulsions preferably have different sensitivities such that the difference in sensitivity is 0.2 log E or more.

2. Silver Halide Photosensitive Material and Photothermographic Material

The silver halide photosensitive material of the invention includes a photosensitive layer containing the photosensitive silver halide on at least one side of a support. On the other hand, the photothermographic material of the invention includes an image-forming layer containing the photosensitive silver halide, a non-photosensitive organic silver salt, a reducing agent and a binder on at least one side of a support. Further, each of them may preferably include a surface protective layer on the photosensitive layer or the image-forming layer, or a back layer or back protective layer on the other side of the support.

Configuration of each of these layers and preferable components thereof will be described in detail.

2-1. Photosensitive Silver Halide

The above-described photosensitive silver halide is employed.

2-2. Organic Silver Salt

The non-photosensitive organic silver salt employed in the invention is a silver salt that is relatively stable with respect to light, but which forms a silver image when heated to 80° C. or higher in the presence of exposed photosensitive silver halide and a reducing agent. The organic silver salt may be any organic material containing a source capable of reducing silver ions. Such non-photosensitive organic silver salts are described in JP-A No. 10-62899, paragraphs [0048] to [0049], EP-A No. 0803764A1 page 18, line 24 to page 19, line 37, EP-A No. 0962812, JP-A Nos. 11-349591, 2000-7683 and 2000-72711. Silver salts of organic acids, particularly silver salts of long-chain aliphatic carboxylic acids (having 10 to 30 carbon atoms, preferably having 15 to 28 carbon atoms) are preferable. Preferable examples of the organic silver salt include silver behenate, silver arachidate, silver stearate, silver oleate, silver laurate, silver caproate, silver myristate, silver palmitate and mixtures thereof. In the invention, among these organic silver salts, use of an organic acid silver salt containing 50 mol % to 100 mol % of silver behenate is preferable. In particular, the content of silver behenate is preferably 75 mol % to 98 mol %.

The form of the organic silver salt that can be used in the invention is not particularly limited. Preferable examples of the form are needle-like, bar-shaped, tabular and flaky forms.

The organic silver salt having a flaky form is preferable in the invention. In the specification, the flaky organic silver salt is defined as follows. The organic silver salt is observed by an electron microscope, the form of a organic silver salt grain is regarded as a rectangular parallelopiped. Then, given that the length of the shortest edge of the rectangular parallelopiped, the length of the next shortest edge and the length of the longest edge are respectively defined as “a, b and c” (c may be equal to b), x is calculated according to the following expression by using lengths a and b.
x=b/a

In this manner, the values x of around 200 grains are obtained and the average of the obtained values is defined as x (average). Grains satisfying the following relation: 1.5≧x (average) are determined as flaky grains. Preferably, flaky grains satisfying the following relation: 1.5≧x (average)≧30 are preferable and flaky grains satisfying the following relation: 1.5≧x (average)≧15 are more preferable. In this connection, needle-like grains satisfy the following relation: 1≦x (average)<1.5.

In the flaky grains, “a” can be regarded as the thickness of tabular grains having, as the principal plane, a plane with edges b and C. The average of “a” is preferably in the range of 0.01 μm to 0.3 μm, and more preferably 0.1 μm to 0.23 μm. The average of (c/b) s is preferably in the range of 1 to 6, more preferably in the range of 1 to 4, still more preferably in the range of 1 to 3, and particularly preferably in the range of 1 to 2.

The size distribution of the organic silver salt grains is preferably monodispersion. The term “monodispersion” as used herein is intended to mean that the percentage of a value obtained by dividing the standard deviation of the length of the short axis or the long axis by the length of the short axis or long axis, respectively, is preferably 100% or less, more preferably 80% or less, and still more preferably 50% or less. As for a measuring method of the form of the organic silver salt, the form can be obtained from a transmission electron microscopic image of an organic silver salt dispersion. Another method for determining the monodispesibility is a method involving obtaining the standard deviation of a volume weight average diameter of the organic silver salt. The percentage (coefficient of variation) of the value obtained by dividing the standard deviation by the volume weight average diameter is preferably 100% or less, more preferably 80% or less, and still more preferably 50% or less. As for a measurement method, for example, laser light is irradiated on the organic silver salt dispersed in a liquid to allow the light to be scattered and, then, an autocorrelation function of fluctuation of the resultant scattered light against time is obtained to measure a grain size (volume weight average diameter) and, thereafter, the monodispesibility can be obtained from the thus-measured grain size.

As a method for manufacturing and dispersing the organic silver salt for use in the invention, a known method may be applied. For example, JP-A No. 10-62899, EP-A Nos. 0803763A1 and 0962812A1, JP-A Nos. 11-349591, 2000-7683, 2000-72711, 2001-163827, 2001-163889, 2001-163890, 11-203413, 2001-188313, 2001-83652, 2002-6442, and 2002-31870, Japanese Patent Application No. 2000-214155 and JP-A2000-191226 can be referred to.

2-3. Blending of Silver Halide with Organic Silver Salt

It is particularly preferable that the photosensitive silver halide grains in the invention are formed in the absence of the non-photosensitive organic silver salt and chemically sensitized. This is because sufficient sensitivity may not be obtained by a method for forming silver halide in which a halogenating agent is added to the organic silver salt.

As a method for blending the silver halide and the organic silver salt, there are a method in which the photosensitive silver halide and the organic silver salt which have been separately prepared are blended by, for example, a high-speed stirrer, a ball mill, a sand mill, a colloid mill, a vibration mill or a homogenizer, a method in which the photosensitive silver halide which has been previously prepared is mixed at an appropriate timing in the process of preparing the organic silver salt to prepare the organic silver salt. Any of these methods can favorably obtain an effect of the invention.

In the invention, it is possible to manufacture a photosensitive material by blending the aqueous dispersion of the organic silver salt and the aqueous dispersion of the photosensitive silver salt. Blending of two kinds or more of the aqueous dispersions of the organic silver salts and two kinds or more of the aqueous dispersions of the photosensitive silver salts is preferably used for the purpose of controlling photographic properties.

Blending of Silver Halide to Coating Liquid

The silver halide in the invention is added to a coating liquid of an image-forming layer during a period starting from 180 minutes before coating and ending immediately before coating, preferably during a period starting from 60 minutes to 10 seconds before coating. A blending method and blending conditions are not particularly limited as far as the effect of the invention sufficiently arises. Specific examples of the blending method include a method of blending in a tank such that an average residence period, calculated from an adding flow rate and a supplying flow rate to a coater, is allowed to be within a predetermined duration, and a method using a static mixer described, for example, in N. Harnby, M. F. Edwards & A. W. Nienow, (translated by Koji Takahashi), “Liquid Mixing Technology” Chap. 8, The Nikkan Kogyo Shimbun, Ltd. (1989).

The organic silver salt in the invention can be used in any amount, but the amount is preferably in the range of 0.1 g/m² to 5 g/m², more preferably 1 g/m² to 3 g/m², and particularly preferably 1.2 g/m² to 2.5 g/m² in terms of silver amount.

2-4. Compound which Substantially Decreases Visible Light Absorption Derived from Photosensitive Silver Halide after Thermal Development

In the invention, the photosensitive material and the thermographic material preferably contains a compound that substantially decreases visible light absorption derived from the photosensitive silver halide after thermal development compared with visible light absorption before thermal development. As the compound which substantially decreases visible light absorption derived from the photosensitive silver halide after thermal development, a silver iodide complex-forming agent is particularly preferably used.

Silver Iodide Complex-Forming Agent

The silver iodide complex-forming agent in the invention can contribute to Lewis acid-base reaction in which at least one of a nitrogen atom and a sulfur atom in the compound donates an electron to silver ions as a coordinating atom (electron donor: Lewis base). Stability of the complex is defined by a sequential stability constant or an entire stability constant. The stability depends on a combination of three members, i.e., a silver ion, an iodide ion and the silver complex-forming agent. As a general guide, it is possible to obtain a large stability constant by means such as a chelating effect due to formation of an intramolecular chelate ring or increase of an acid-base dissociation constant of a ligand.

Ultraviolet-visible absorption spectrum of the photosensitive silver halide can be measured by a transmission method or a reflection method. In the case where an absorption originated from other compound added to the photothermographic material overlaps the absorption of the photosensitive silver halide, the ultraviolet-visible absorption spectrum of the photosensitive silver halide can be observed by employing a means such as differential spectrum, or removal of the other compound by a solvent, or the combination thereof.

As the silver iodide complex-forming agent in the invention, a 5- to 7-membered heterocyclic compound containing at least one nitrogen atom is preferable. When the compound does not have a mercapto group, a sulfide group or a thion group as a substituent, the nitrogen-containing 5- to 7-membered heterocycle may be either saturated or unsaturated, and have another Substituent. Further, substituents of the heterocycle may bond to each other to form a ring.

Typical examples of a 5- to 7-membered heterocyclic compound include pyrrole, pyridine, oxazole, isooxazole, thiazole, isothiazole, imidazole, pyrazole, pyrazine, pyrimidine, pyridazine, indole, isoindole, indolizine, quinoline, isoquinoline, benzoimidazole, 1H-imidazole, quinoxaline, quinazoline, cinnoline, phthalazine, naphthylizine, purine, pteridine, carbazole, acridine, phenanthridine, phenanthroline, phenazine, phenoxazine, phenothiazine, benzothiazole, benzooxazole, benzoimidazole, 1,2,4-triazine, 1,3,5-triazine, pyrrolidine, imidazolidine, pyrazolidine, piperidine, piperazine, morpholine, indoline and isoindoline. Pyridine, imidazole, pyrazole, pyrazine, pyrimidine, pyridazine, indole, isoindole, indolizine, quinoline, isoquinoline, benzoimidazole, 1H-imidazole, quinoxaline, quinazoline, cinnoline, phthalazine, 1,8-naphthylizine, 1,10-phenanthroline, benzoimidazole, benzotriazole, 1,2,4-triazine and 1,3,5-triazine are more preferable. Pyridine, imidazole, pyrazine, pyrimidine, pyridazine, phthalazine, triazine, 1,8-naphthylizine and 1,10-phenanthroline are still more preferable.

These rings may have a substituent. Any substituent may be used as far as it does not give an adverse affect to photographic properties. Preferable examples include a halogen atom (a fluorine atom, a chlorine atom, a bromine atom or an iodine atom), an alkyl group (a linear-, branched-, cyclic-alkyl group containing a bicycloalkyl group or an active methine group), an alkenyl group, an alkynyl group, an aryl group, a heterocyclic group (no restriction on a substituting site), an acyl group, an alkoxycarbonyl group, an aryloxycarbonyl group, a heterocyclicoxycarbonyl group, a carbamoyl group, a N-acylcarbamoyl group, a N-sulfonylcarbamoyl group, a N-carbamoylcarbamoyl group, a N-sulfamoylcarbamoyl group, a carbazoyl group, a carboxyl group and salts thereof, an oxalyl group, an oxamoyl group, a cyano group, a carbonimidoyl group, a formyl group, a hydroxyl group, an alkoxy group (including a group repeatedly containing an ethyleneoxe group unit or a propyleneoxy group unit), an aryloxy group, a heterocyclicoxy group, an acyloxy group, a (alkoxy- or aryloxy-)carbonyloxy group, a carbamoyloxy group, a sulfonyloxy group, an amino group, an (alkyl-, aryl- or heterocyclic-) amino group, an acylamino group, a sulfonamido group, an ureide group, a tioureide group, an imido group, a (alkoxy- or aryloxy-)carbonylamino group, a sulfamoylamino group, a semicarbazidegroup, an ammonio group, an oxamoylamino group, a N-(alkyl- or aryl-)sulfonylureido group, a N-acylureide group, a N-acylsulfamoylamino group, a nitro group, a heterocyclic group containing a quaternary nitrogen atom (e.g., a pyridinio group, an imidazolio group, a quinolinio group, and an isoquinolinio group), an isocyano group, an imino group, a (alkyl- or aryl-)sulfonyl group, a (alkyl- or aryl-) sulfinyl group, a sulfo group and salts thereof, a sulfamoyl group, a N-acylsulfamoyl group, a N-sulfonylsulfamoyl group and salts thereof, a phosphino group, a phosphinyl group, a phosphinyloxy group, a phosphinylamino group and a silyl group. Here, the active methine group means a methine group having, as substituents, two electron-attractive groups. The electron-attractive group means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group or a carbonimidoyl group. The two electron-attractive groups may bond to each other to form a ring structure. The salt means the cation of an alkali metal, an alkali earth metal or a heavy metal, or an organic cation such as an ammonium ion or a phosphonium ion. These substituents may further have any of these substituents.

Any of these heterocycles and other ring may form a condensed ring. When the substituent is an anion group (e.g., —CO₂⁻ group, —SO₃⁻— group, —S⁻— group), the nitrogen-containing heterocycle of the invention may have a cation (e.g., pyridinium, or 1,2,4-triazolium) to form an intramolecular salt.

When the heterocyclic compound is a derivative of pyridine, pyrazine, pyrimidine, pyridazine, phthalazine, triazine, naphthylizine or phenanthroline, it is more preferable that an acid dissociation constant (pKa) of the conjugate acid of the nitrogen-containing heterocycle moiety in acid dissociation equilibrium of the compound is 3 to 8 in a mixed solution of tetrahydrofuran/water (3/2) at 25° C. Furthermore preferably, pKa is 4 to 7.

As such a heterocyclic compound, a derivative of pyridine, pyridazine or phthalazine is preferable, and a derivative of pyridine or phthalazine is more preferable.

When the heterocyclic compound includes a mercapto group, a sulfide group or a thion group as a substituent, the compound is preferably a derivative of pyridine, thiazole, isothiazole, oxazole, isooxazole, imidazole, pyrazole, pyrazine, pyrimidine, pyridazine, triazine, triazole, thiazole or oxadiazole, particularly preferably a derivative of thiazole, imidazole, pyrazole, pyrazine, pyrimidine, pyridazine, triazine or triazole.

For example, a compound represented by the following formula (1) or (2) may be utilized as the silver iodide complex-forming agent.

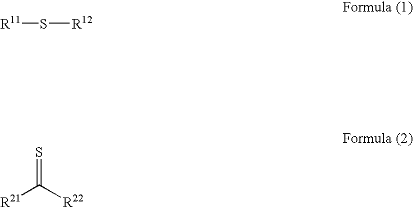

In formula (1), each of R¹¹ and R¹² represents a hydrogen atom or a substituent. In formula (2), each of R²¹ and R²² represents a hydrogen atom or a substituent. However, both of R¹¹ and R¹², or both of R²¹ and R²² cannot be hydrogen atoms at the same time. Examples of the substituent include those explained as the substituent of the nitrogen-containing 5- to 7-membered heterocycle type silver iodide complex-forming agent.

Further, a compound represented by the following formula (3) is also preferably utilized.

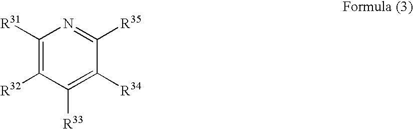

In formula (3), R³¹ to R³⁵ independently represent a hydrogen atom or a substituent. Examples of the substituent represented by R³¹ to R³⁵ include those explained as the substituent of the nitrogen-containing 5- to 7-membered heterocycle type silver iodide complex-forming agent. When the compound represented by formula (3) has at least one substituent, the compound preferably has the at least one substituent at at least one site of R³², R³³ and R³⁴. R³¹ to R³⁵ may bond to each other to form a saturated or unsaturated ring. Preferably, each of R³¹ to R³⁵ is a halogen atom, an alkyl group, an aryl group, a carbamoyl group, a hydroxyl group, an alkoxy group, an aryloxy group, a carbamoyloxy group, an amino group, an acylamino group, an ureido group, or a (alkoxy- or aryloxy-) carbonylamino group.

For the compound represented by formula (3), an acid dissociation constant (pKa) of the conjugate acid of the pyridine ring moiety is preferably 3 to 8, and more preferably 4 to 7 in a mixed solution of tetrahydrofuran/water (3/2) at 25° C.

Further, a compound represented by the following formula (4) is also preferable.

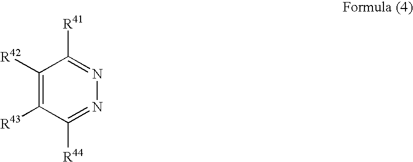

In formula (4), R⁴¹ to R⁴⁴ independently represent a hydrogen atom or a substituent. At least two of R⁴¹ to R⁴⁴ may bond to each other to form a saturated or unsaturated ring. Examples of the substituent represented by R⁴¹ to R⁴⁴ include those explained as the substituent of the nitrogen-containing 5- to 7-membered heterocycle type silver iodide complex-forming agent. These groups preferably represent an alkyl group, an alkenyl group, an alkynyl group, an aryl group, a hydroxyl group, an alkoxy group, an aryloxy group or a heterocyclicoxy group, and may form a phthalazine ring due to a benzo-condensed ring. When a carbon atom adjacent to a nitrogen atom of the compound represented by formula (4) has a hydroxyl group, equilibrium exists between the compound and pyridazinon.

Preferably, the compound represented by formula (4) forms a phthalazine ring represented by the following formula (5). Preferably, the phthalazine ring further has at least one substituent. Examples of R⁵¹ to R⁵⁶ in formula (5) include those explained as the substituent of the nitrogen-containing 5- to 7-membered heterocycle type silver iodide complex-forming agent. As the preferable substituent, an alkyl group, an alkenyl group, an alkynyl group, an aryl group, a hydroxyl group, an alkoxy group or an aryloxy group can be used. The substituent is preferably an alkyl group, an alkenyl group, an aryl group, an alkoxy group or an aryloxy group, and more preferably an alkyl group, an alkoxy group or an aryloxy group.

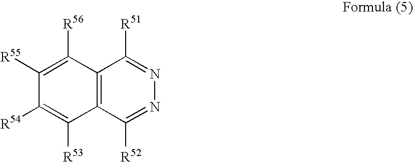

Further, a compound represented by the following formula (6) is also preferable.

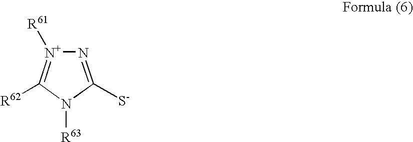

In formula (6), R⁶¹ to R⁶³ independently represent a hydrogen atom or a substituent. Examples of the substituent represented by R⁶² include those explained as the substituent of the nitrogen-containing 5- to 7-membered heterocycle type silver iodide complex-forming agent.

A compound represented by the following formula (7) is preferably used.
R⁷¹—S—(L)ₙ—S—R⁷² Formula (7)

In formula (7), R⁷¹ and R⁷² independently represent a hydrogen atom or a substituent. L represents a bivalent linking group. n represents 0 or 1. Examples of the substituents represented by R⁷¹ and R⁷² include an alkyl group (including a cycloalkyl group), an alkenyl group (including a cycloalkenyl group), an alkynyl group, an aryl group, a heterocyclic group, an acyl group, an aryloxycarbonyl group, an alkoxycarbonyl group, a carbamoyl group, an imido group and a composite substituent containing some of these groups. The bivalent linking group represented by L is preferably a linking group having 1 to 6 atoms, and more preferably 1 to 3 atoms. The bivalent linking group may have a substituent.

Further, a compound represented by the following formula (8) is also preferably used.

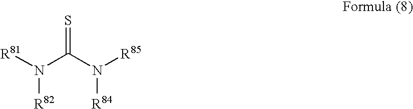

In formula (8), R⁸¹ to R⁸⁴ independently represent a hydrogen atom or a substituent. Examples of the substituents represented by R⁸¹ to R⁸⁴ include an alkyl group (including a cycloalkyl group), an alkenyl group (including a cycloalkenyl group), an alkynyl group, an aryl group, a heterocyclic group, an acyl group, an aryloxycarbonyl group, an alkoxycarbonyl group, a carbamoyl group and an imido group.

The silver iodide complex-forming agents is more preferably a compound represented by formula (3), (4), (5), (6) or (7), and still more preferably a compound represented by formula (3) or (5).

Hereinafter, preferable examples of the silver iodide complex-forming agent in the invention are shown. However, the invention is not restricted to them.

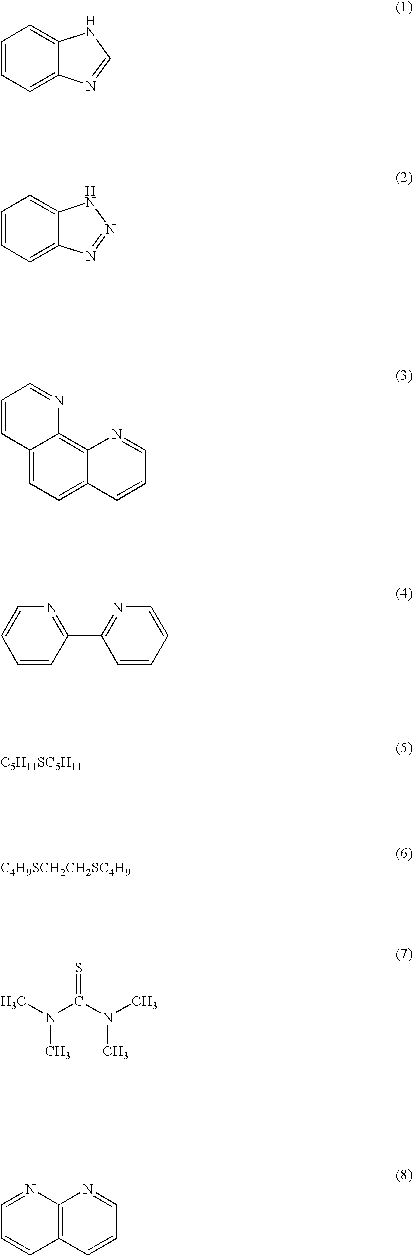

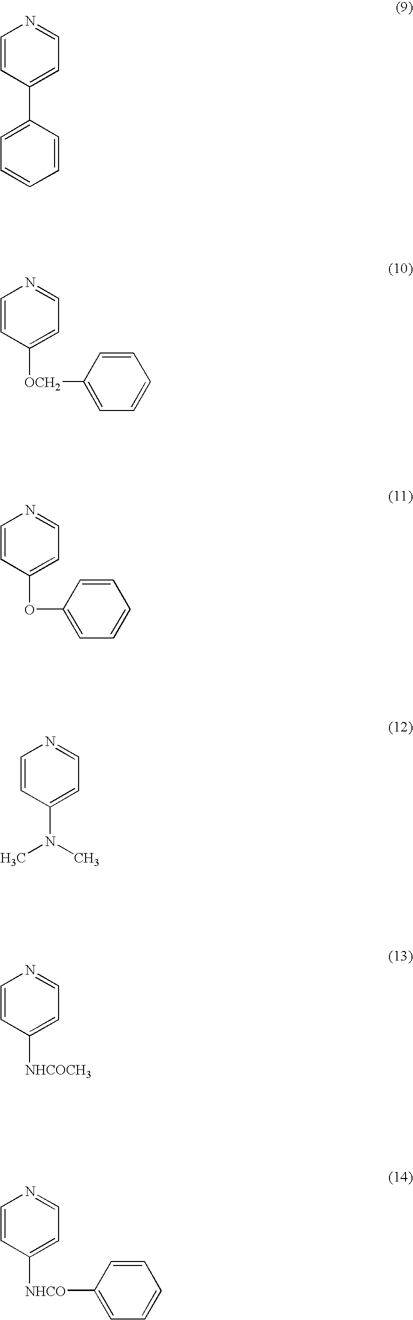

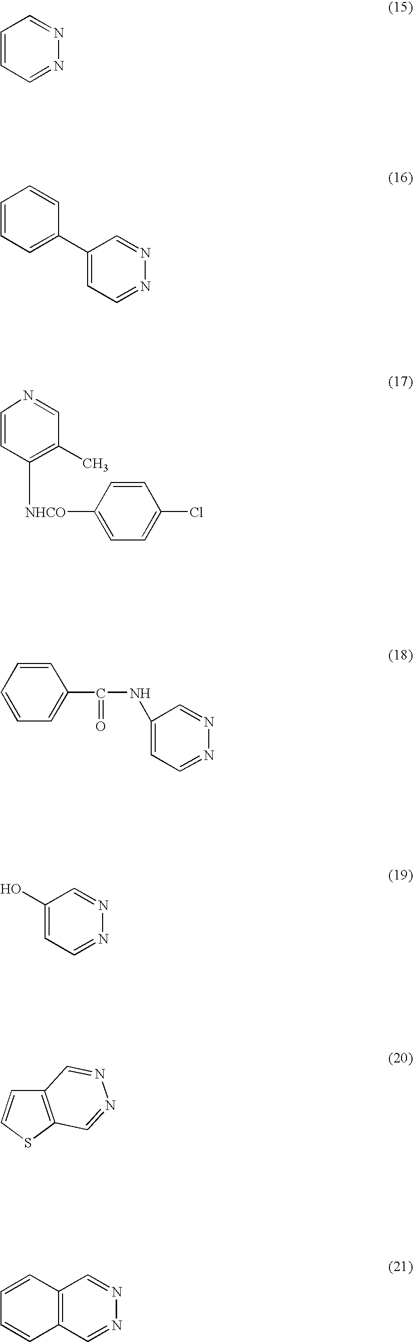

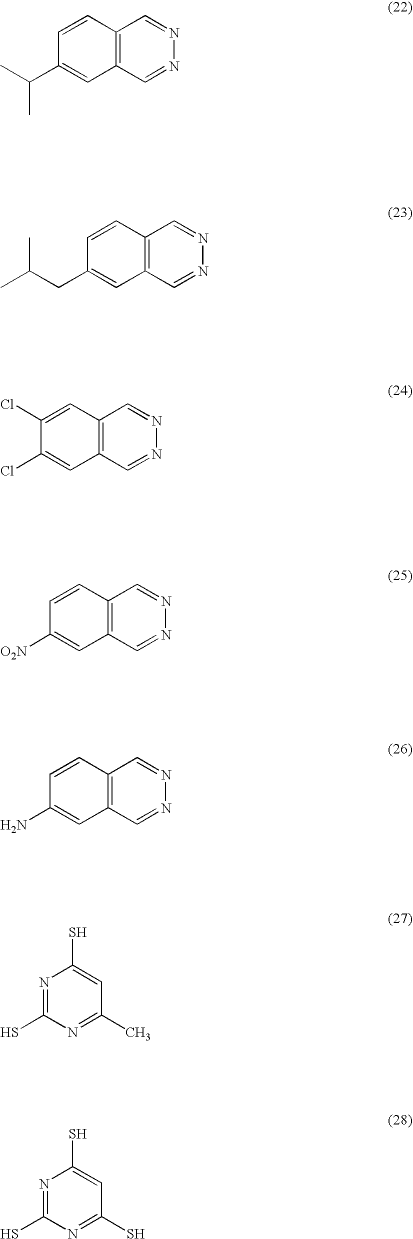

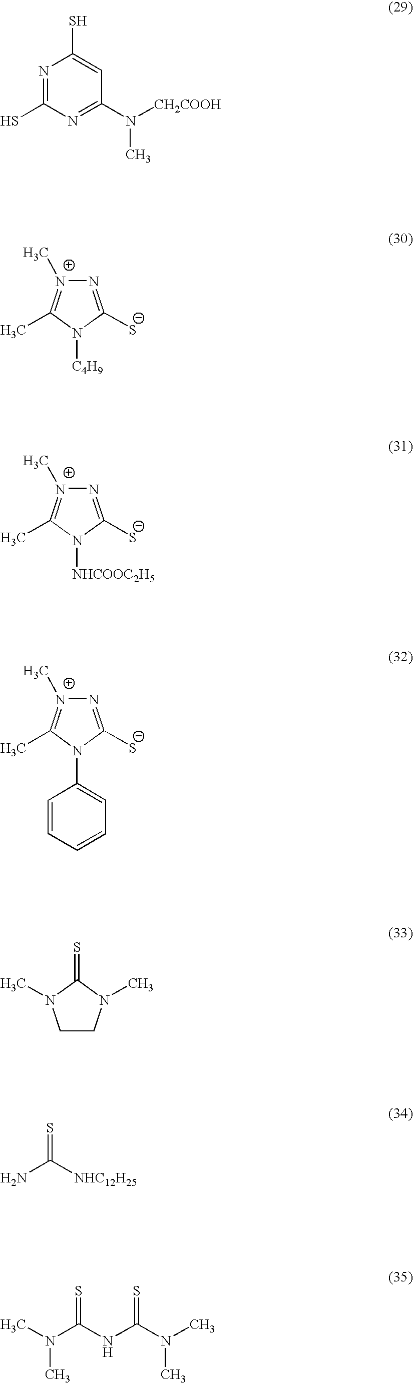

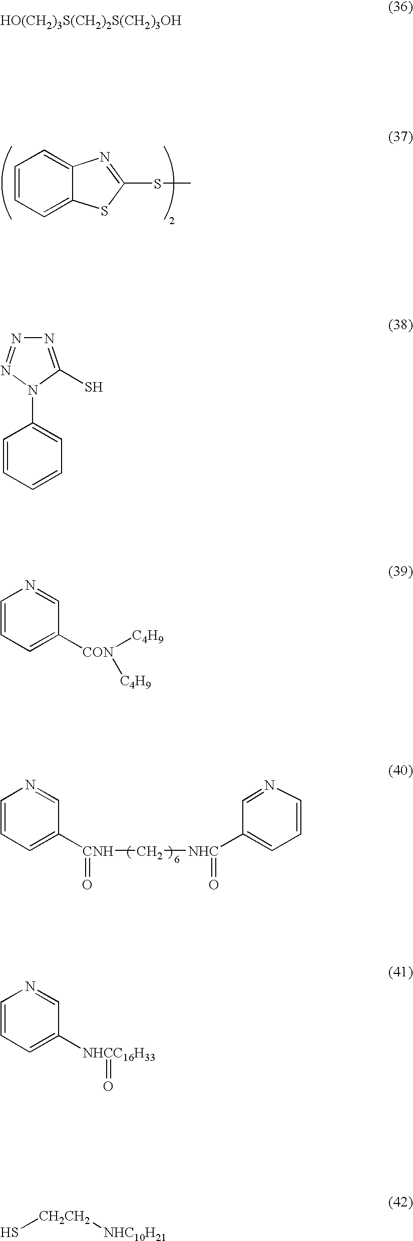

When the silver iodide complex-forming agent in the invention functions as a conventionally known color-toning agent, it can serve the color-toning agent. The silver iodide complex-forming agent in the invention can be used in combination with a color-toning agent. Further, two or more kinds of the silver iodide complex-forming agents may be used.

The silver iodide complex-forming agent in the invention preferably exists in the film such that the agent separates from the photosensitive silver halide. Such is realized, for example, by allowing the agent to exist in the form of solid. It is also preferable that the agent is contained in a layer adjacent to a layer including the photosensitive silver halide. The melting point of the agent is preferably adjusted to a value within a suitable range so that the silver iodide complex-forming agent in the invention melts when heated to a thermal development temperature.

In the invention, the ratio of the absorption intensity of the ultraviolet-visible absorption spectrum of the photosensitive silver halide after thermal development to that before thermal development is preferably 80% or less, more preferably 40% or less, and still more preferably 10% or less.

The silver iodide complex-forming agent in the invention may be incorporated in a coating liquid and in turn the photosensitive material in any form such as a solution, an emulsified dispersion or a solid fine grain dispersion.

An example of s a well known method for emulsion dispersion can be a method in which a material is dissolved in an oil such as dibutyl phthalate, tricresyl phosphate, glyceryl triacetate or diethyl phtalate or an auxiliary solvent such as ethyl acetate or cyclohexanone to mechanically produce an emulsified dispersion.

An example of a method for dispersing solid microparticles can be a method in which powder of the silver iodide complex-forming agent in the invention is dispersed in a suitable solvent such as water by using a ball mill, a colloid mill, a vibrational ball mill, a sand mill, a jet mill, a roller mill or an ultrasonic wave to produce a solid dispersion. In this method, a protective colloid (such as polyvinyl alcohol) and/or a surfactant (anionic surfactant such as sodium triisopropylnaphthalenesulfonate (mixture of the sulfonates having three isopropyl groups at different sites)) may be employed. In the above-mentioned mill, beads made of zirconia are commonly used as a dispersion medium, and therefore Zr derived from these beads sometimes contaminates the dispersion. The amount of the contaminant depends on dispersion conditions, but is usually in the range of 1 ppm to 1000 ppm. When the amount of Zr in the photosensitive material is 0.5 mg or less per g of silver, the photosensitive material is not problematic in practical use.

An aqueous dispersion preferably contains an antiseptic agent (e.g., benzoisothiazolinon sodium salt).

The silver iodide complex-forming agent in the invention is preferably used as a solid dispersion.

The silver iodide complex-forming agent in the invention is preferably used in the range of 1 mol % to 5000 mol %, more preferably in the range of 10 mol % to 1000 mol %, and still more preferably in the range of 50 mol % to 300 mol % with respect to photosensitive silver halide.

2-5. Reducing Agent

The photothermographic material of the invention includes a reducing agent for the organic silver salt. The reducing agent may be any material (preferably an organic material) capable of reducing silver ions to metal silver. Examples of the reducing agent are described in JP-A No. 11-65021, paragraphs [0043] to [0045] and EP-B No. 0803764, page 7, line 34 to page 18, line 12.

The reducing agent for use in the invention is preferably a so-called hindered phenol reducing agent having a substituent at the ortho position with respect to a phenolic hydroxyl group or a bisphenol reducing agent. In particular, a compound represented by the following formula (R) is preferable.

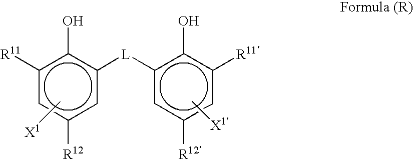

In formula (R), R¹¹ and R^{11′} independently represent an alkyl group having 1 to 20 carbon atoms. R¹² and R^{12′} Independently represent a hydrogen atom or a substituent capable of bonding to a benzene ring. L represents —S— group or —CHR¹³— group. R¹³ represents a hydrogen atom or an alkyl group having 1 to 20 carbon atoms. X¹ and X^{1′} independently represent a hydrogen atom or a group capable of bonding to a benzene ring.

Each substituent will be described in detail.

1) R¹¹ and R^{11′}

R¹¹ and R^{11′} independently represent a substituted or unsubstituted alkyl group having 1 to 20 carbon atoms. The substituent of the substituted alkyl group is not particularly limited. For example, typical examples thereof include an aryl group, a hydroxyl group, an alkoxy group, an aryloxy group, an alkylthio group, an arylthio group, an acylamino group, a sulfonamido group, a sulfonyl group, a phosphoryl group, an acyl group, a carbamoyl group, an ester group and a halogen atom.

2) R¹² and R^{12′} and X¹ and X^{1′}

R¹² and R¹²′ independently represent a hydrogen atom or a group capable of bonding to a benzene ring.

X¹ and X^{1′} independently represent a hydrogen atom or a group capable of bonding to a benzene ring. Typical examples of the group capable of bonding to a benzene ring include an alkyl group, an aryl group, a halogen atom, an alkoxy group and an acylamino group.

3) L

L represents —S— group or —CHR¹³ group. R¹³ represents a hydrogen atom or a substituted or unsubstituted alkyl group having 1 to 20 carbon atoms.

Specific examples of the unsubstituted alkyl group represented by R¹³ include a methyl group, an ethyl group, a propyl group, a butyl group, a heptyl group, an undecyl group, an isopropyl group, a 1-ethylpentyl group and a 2,4,4-trimethylpentyl group.

Examples of the substituent of the substituted alkyl group are similar to those described in the explanations of R¹¹, and include a halogen atom, an alkoxy group, an alkylthio group, an aryloxy group, an arylthio group, an acylamino group, a sulfonamido group, a sulfonyl group, a phosphoryl group, an oxycarbonyl group, a carbamoyl group and a sulfamoil group.

4) Typical Substituents

Typical examples of R¹¹ and R^{11′} are secondary or tertiary alkyl groups having 3 to 15 carbon atoms. Specific examples thereof include an isopropyl group, an isobutyl group, a t-butyl group, a t-amyl, a t-octyl group, a cyclohexyl group, a cyclopentyl group, a 1-methylcyclohexyl group and a 1-methylcyclopropyl group. R¹¹ and R^{11′} more independently preferably represent a tertiary alkyl group having 4 to 12 carbon atoms, still more preferably represent a t-butyl group, a t-amyl group or a 1-methylcyclohexyl group, and most preferably represent a t-butyl group.

Typical examples of R¹² and R^{12′} are alkyl groups having 1 to 20 carbon atoms. Specific examples thereof include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group and a methoxyethyl group. R¹² and R^{12′} independently more preferably represent a methyl group, an ethyl group, a propyl group, an isopropyl group or a t-butyl group.

Each of X¹ and X^{1′} is preferably a hydrogen atom, a halogen atom or an alkyl group, and more preferably a hydrogen atom.

L is preferably a —CHR¹³— group.

R¹³ is preferably a hydrogen atom or an alkyl group having 1 to 15 carbon atoms. The alkyl group is preferably a methyl group, an ethyl group, a propyl group, an isopropyl group or a 2,4,4-trimethylpentyl group, and particularly preferably a hydrogen atom, a methyl group, a propyl group or an isopropyl group.

When R¹³ is a hydrogen atom, each of R¹² and R^{12′} is preferably an alkyl group having 2 to 5 carbon atoms, more preferably an ethyl group or a propyl group, and most preferably an ethyl group.

When R¹³ is a primary or secondary alkyl group having 1 to 8 carbon atoms, preferably R¹² and R^{12′} are methyl groups. The primary or secondary alkyl group having 1 to 8 carbon atoms represented by R¹³ is more preferably a methyl group, an ethyl group, a propyl group or an isopropyl group, and still more preferably a methyl group, an ethyl group or propyl group.

When each of R¹¹, R^{11′}, R¹² and R^{12′} is a methyl group, R¹³ is preferably a secondary alkyl group. In this case, the secondary alkyl group represented by R¹³ is preferably an isopropyl group, an isobutyl group or a 1-ethylpentyl group, and more preferably an isopropyl group.

The reducing agent differs in various thermal development properties according to combinations of R¹¹ and R^{11′}, and R¹² and R^{12′}, and R¹³. These thermal development properties can be adjusted by using two or more kinds of the reducing agents in various mixing ratios. Therefore, use of two or more kinds of reducing agents is preferable for some purposes.

Specific examples of the compound represented by formula (R) in the invention. However, the invention is not restricted to them.

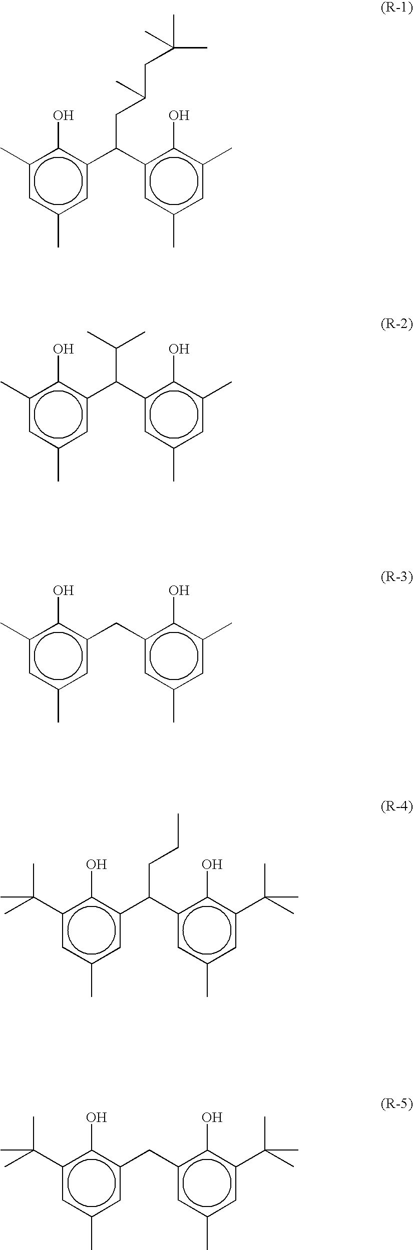

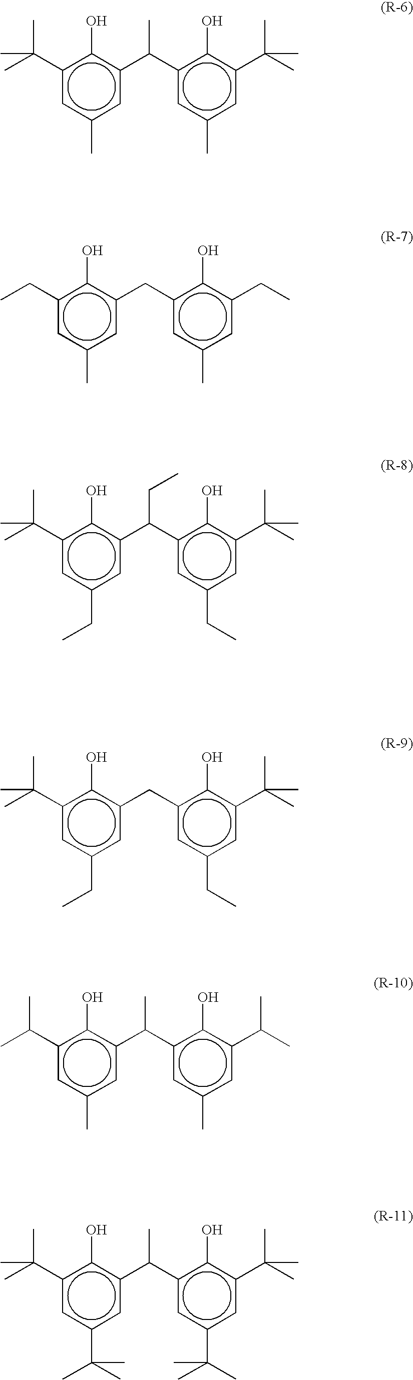

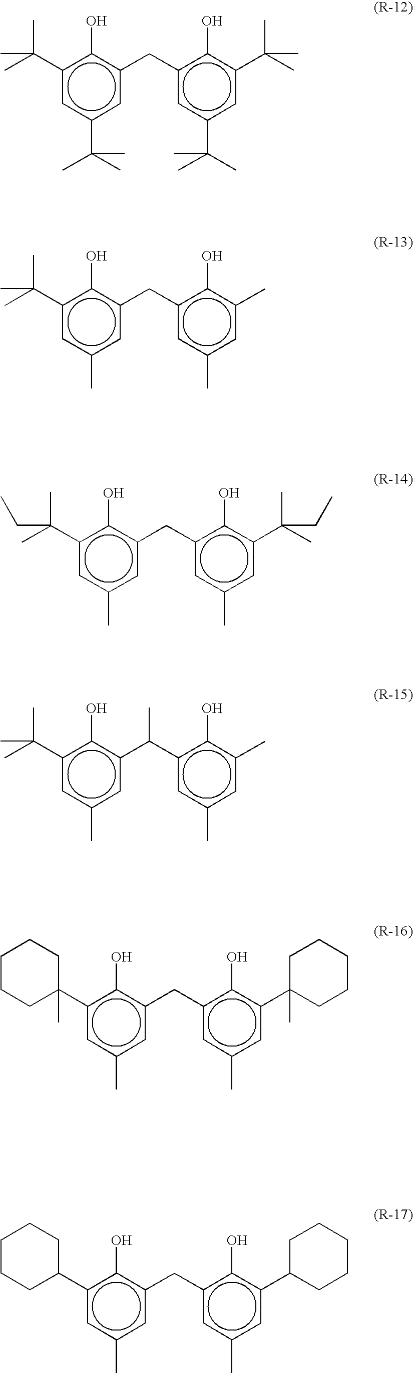

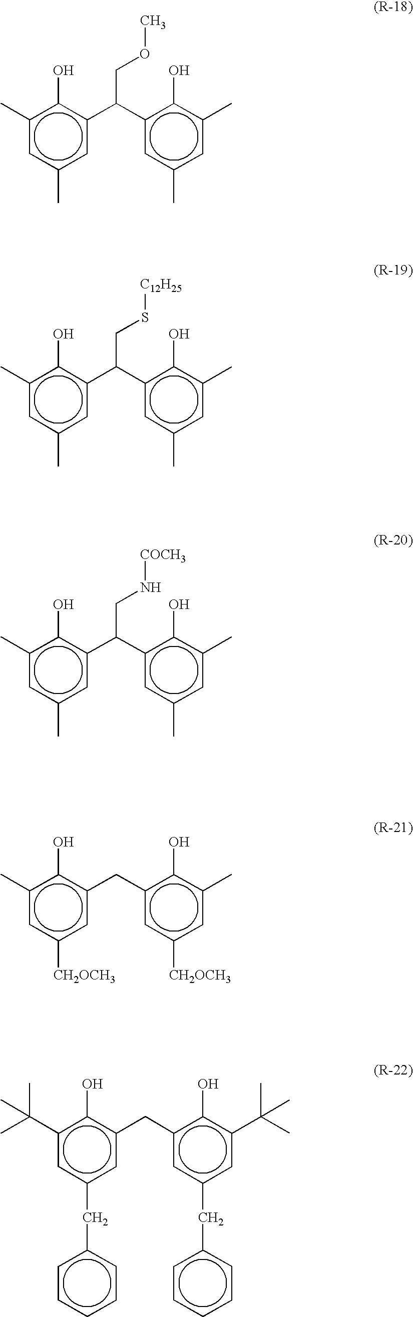

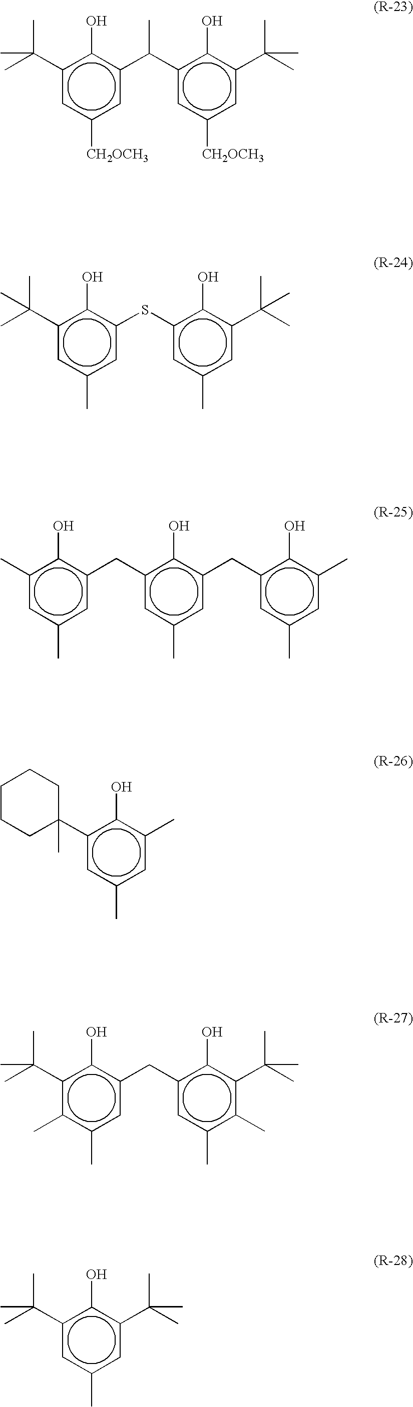

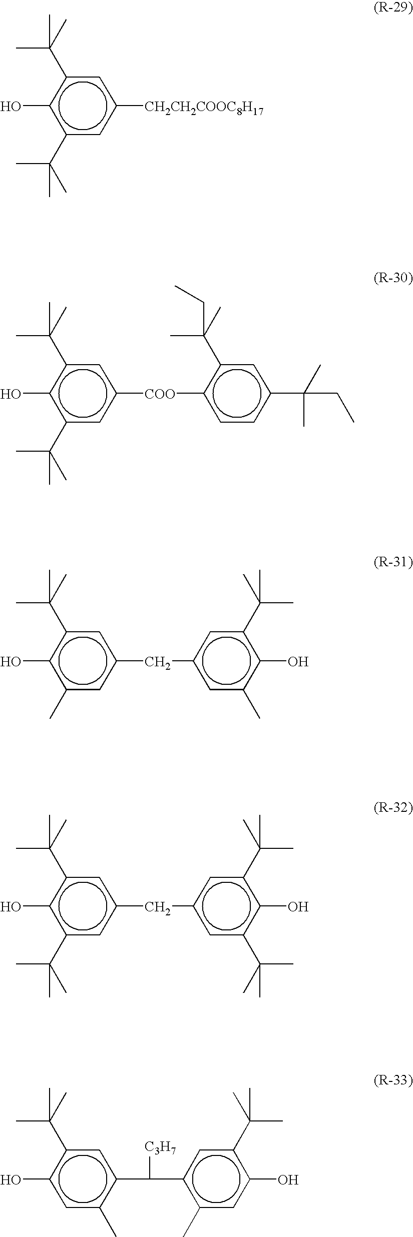

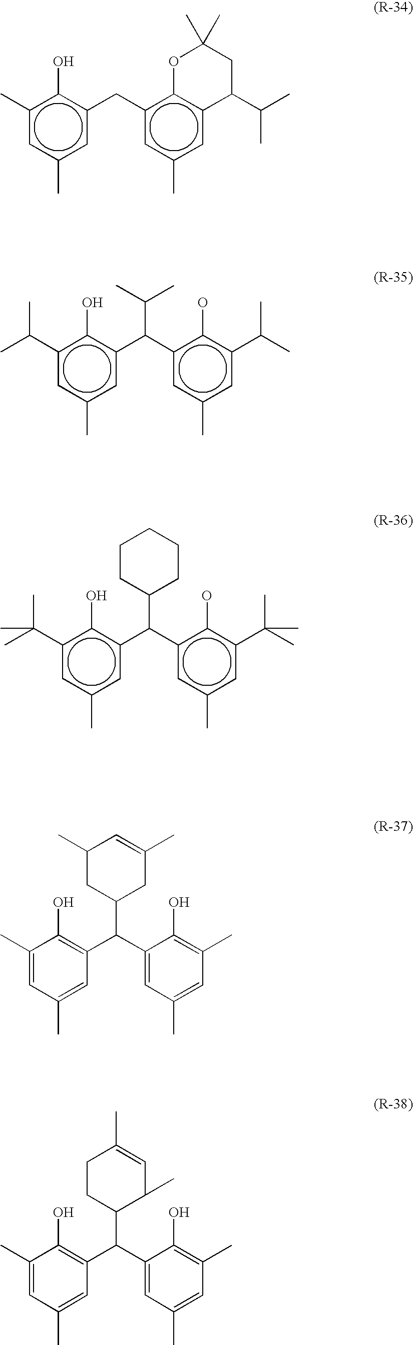

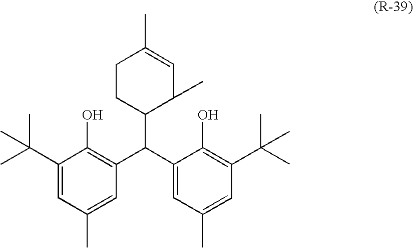

The reducing agent is particularly preferably any of compounds represented by (R-1) to (R-20).

The amount of the reducing agent added in the invention is preferably 0.01 g/m² to 5.0 g/m², and more preferably 0.1 g/m² to 3.0 g/m². Further, the content of the reducing agent contained in a layer or layers on one surface of the support on which surface the image-forming layer is formed is preferably 5 mol % to 50 mol %, and more preferably 10 mol % to 40 mol % per mol of silver.

The reducing agent in the invention can be contained in the image-forming layer containing the organic silver salt and the photosensitive silver halide and a layer adjacent to the image-forming layer, but is more preferably incorporated in the image-forming layer.

The reducing agent in the invention may be incorporated in a coating liquid and in turn the photosensitive material as any form such as a solution, an emulsified dispersion and a solid microparticle dispersion.

An example of a well known emulsion dispersion method is a method in which the reducing agent is dissolved in an oil such as dibutyl phthalate, tricresyl phosphate, glyceryl triacetate or diethyl phtalate, or an auxiliary solvent such as ethyl acetate or cyclohexanone, and then mechanically emulsion-dispersed.

An example of a solid microparticle dispersion method is a method in which the reducing agent is dispersed in a suitable solvent such as water by using a ball mill, a colloid mill, a vibrational ball mill, a sand mill, a jet mill, a roller mill or an ultrasonic wave to produce a solid dispersion. It is preferable that the sand mill is used in the method. In this method, a protective colloid (such as polyvinyl alcohol) or a surfactant (anionic surfactant such as sodium triisopropylnaphthalenesulfonate (mixture of the sulfonates having three isopropyl groups at different sites)) may be employed. An aqueous dispersion may contain an antiseptic agent (e.g., benzoisothiazolinon sodium salt).

The solid particle dispersion method of the reducing agent is particularly preferable. The reducing agent is preferably used as a solid dispersion including microparticles which has an average particle size in the range of 0.01 μm to 10 μm, preferably in the range of 0.05 μm to 5 μm, and more preferably in the range of 0.1 μm to 1 μm and added to a system. In the invention, it is preferable that other solid dispersions include particles having a size within the above range.

2-6. Development Accelerator

The photothermographic material of the invention preferably contains a development accelerator such as sulfonamidophenol compounds represented by formula (A) described in JP-A Nos. 2000-267222 and 2000-330234, hindered phenol compounds represented by formula (II) described in JP-A No. 2001-92075, compounds represented by formula (I) described in JP-A No. 10-32895 and 11-15116, hydrazine compounds represented by formula (I) described in JP-A No. 2002-278017, and phenol and naphthol compounds represented by formula (2) described in JP-A No. 2001-264929. The content of the development accelerator is 0.1 mol % to 20 mol %, preferably 0.5 mol % to 10 mol %, and more preferably 1 mol % to 5 mol % with respect to the reducing agent. The development accelerator can be introduced into the photothermographic material in the same manner as introduction of the reducing agent, and is preferably contained as a solid dispersion or an emulsified dispersion. When the development accelerator is used as an emulsified dispersion, the development accelerator is preferably used as an emulsified dispersion octained including the development accelerator, a high-boiling solvent which is solid at ordinary temperature, and a low-boiling auxiliary solvent, or as a so-called oilless emulsified dispersion without a high-boiling solvent.

In the invention, the development accelerator is particularly preferably a hydrazine compound represented by formula (1) described in JP-A No. 2002-278017 and a phenol or naphthol compound represented by formula (2) described in JP-A No. 2001-264929.

Typical examples of the development accelerator in the invention are shown below. However, the invention is not restricted to them. 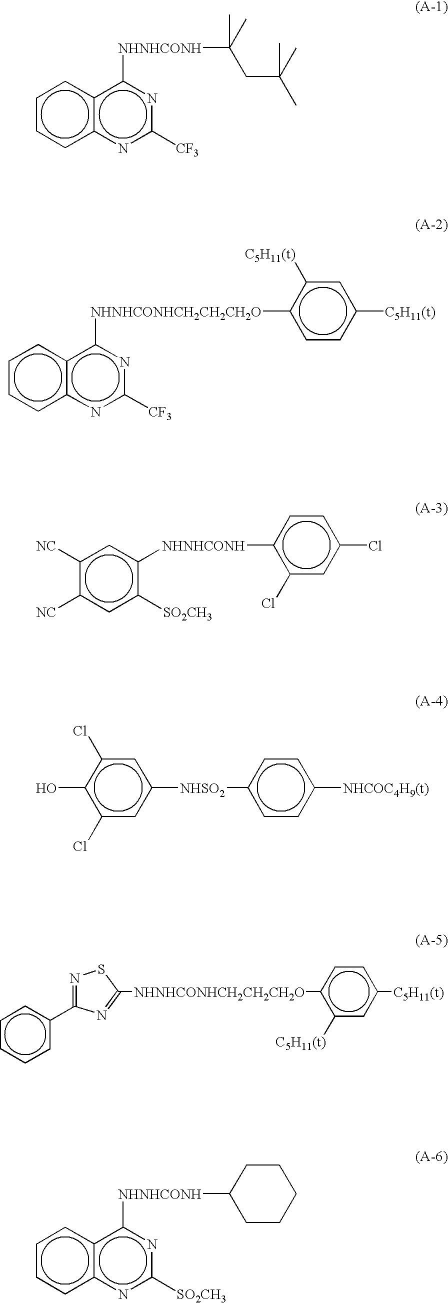 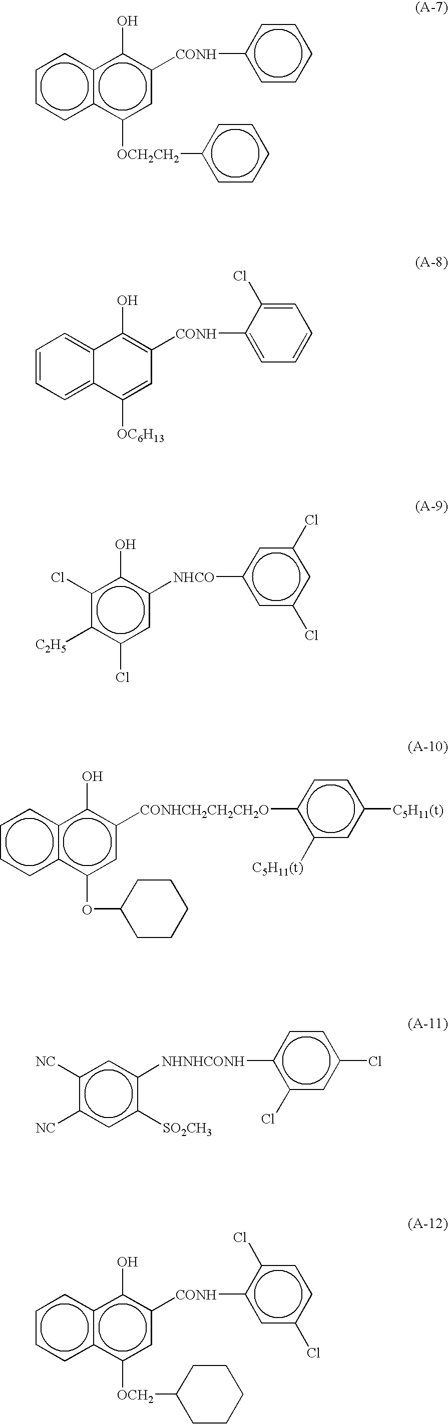 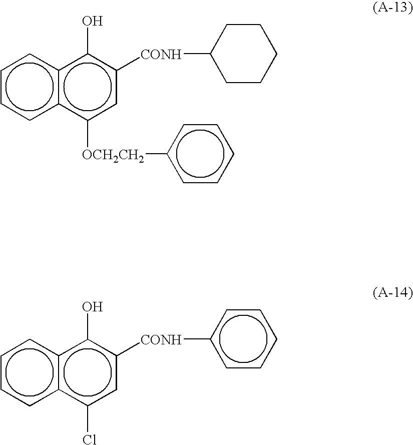
2-7. Hydrogen Bonding Compound

In the invention, the photosensitive material and the thermographic material preferably contain a non-reducing compound having a group capable of forming a hydrogen bond with the aromatic hydroxyl group (—OH) of the reducing agent, or, when the reducing agent also has an amino group, the amino group.

The group capable of forming a hydrogen bond can be a phosphoryl group, a sulfoxide group, a sulfonyl group, a carbonyl group, an amide group, an ester group, an urethane group, an ureido group, a tertiary amino group, or a nitrogen-containing aromatic group. Compounds having a phosphoryl group, a sulfoxide group, an amide group (having no >N—H group and blocked, for example, such that the nitrogen atom forms a >N—Ra group (Ra is a substituent other than hydrogen)), an urethane group (having no >N—H group and blocked, for example, such that the nitrogen atom forms a >N—Ra group (Ra is a substituent other than hydrogen)) or an ureido group (having no >N—H group and blocked, for example, such that the nitrogen atom forms a >N—Ra group (Ra is a substituent other than hydrogen)) are preferable.

In the invention, the hydrogen bonding compound is particularly preferably a compound represented by the following formula (D).

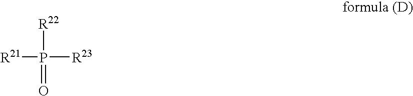

In formula (D), R²¹ to R²³ independently represent an alkyl group, an aryl group, an alkoxy group, an aryloxy group, an amino group or a heterocyclic group. These groups may be unsubstituted or substituted.

Examples of a substituent when R²¹, R²² or R²³ has the substituent include a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group or a phosphoryl group. The substituent is preferably an alkyl group or an aryl group, such as a methyl group, an ethyl group, an isopropyl group, a t-butyl group, a t-octyl group, a phenyl group, a 4-alkoxyphenyl group or a 4-acyloxyphenyl group.

Specific examples of the alkyl group represented by R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group and a 2-phenoxypropyl group.

Examples of the aryl group include a phenyl group, a cresyl group, a xylyl group, a naphthyl group, a 4-t-butylphenyl group, a 4-t-octylphenyl group, a 4-anisidyl group and a 3,5-dichlorophenyl group.

Examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group and a benzyloxy group.

Examples of the aryloxy group include a phenoxy group, a cresyloxy group, an isopropylphenoxy group, a 4-t-butylphenoxy group, a naphthoxy group and a biphenyloxy group.

Examples of the amino group include a dimethylamino group, a diethylaminoamino group, a dibutylamino group, a dioctylamino group, a N-methyl-N-hexylamino group, a dicyclohexylamino group, a diphenylamino group and a N-methyl-N-phenylamino group.

R²¹ to R²³ independently preferably represent an alkyl group, an aryl group, an alkoxy group or an aryloxy group. From the viewpoint of the effect of the invention, it is preferable that at least one of R²¹ to R²³ is an alkyl group or an aryl group. It is more preferable that at least two of them independently represent an alkyl group or an aryl group. Further, it is preferable that R²¹ to R²³ are the same group, since such a compound is inexpensively available.

Hereinafter, specific examples of the hydrogen bonding compound in the invention including the compound represented by formula (D) are shown. However, the invention is not limited to them.

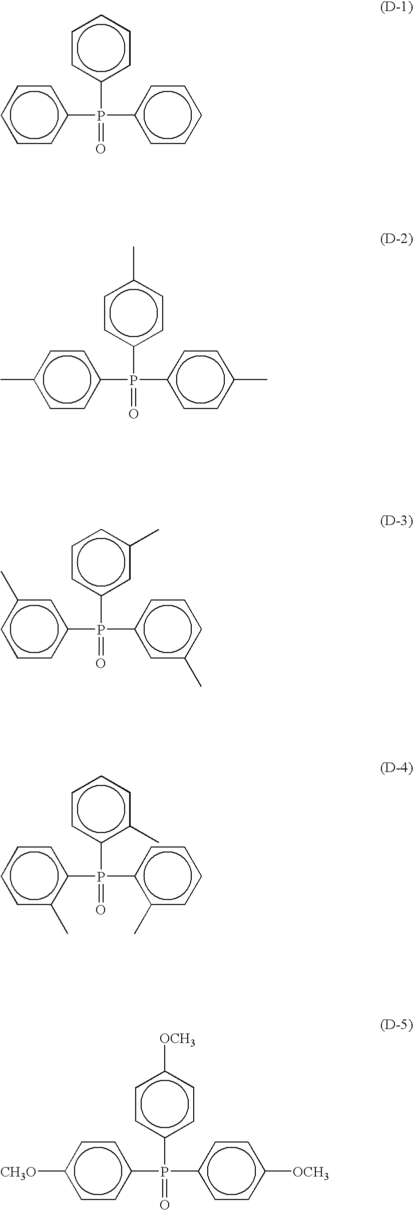

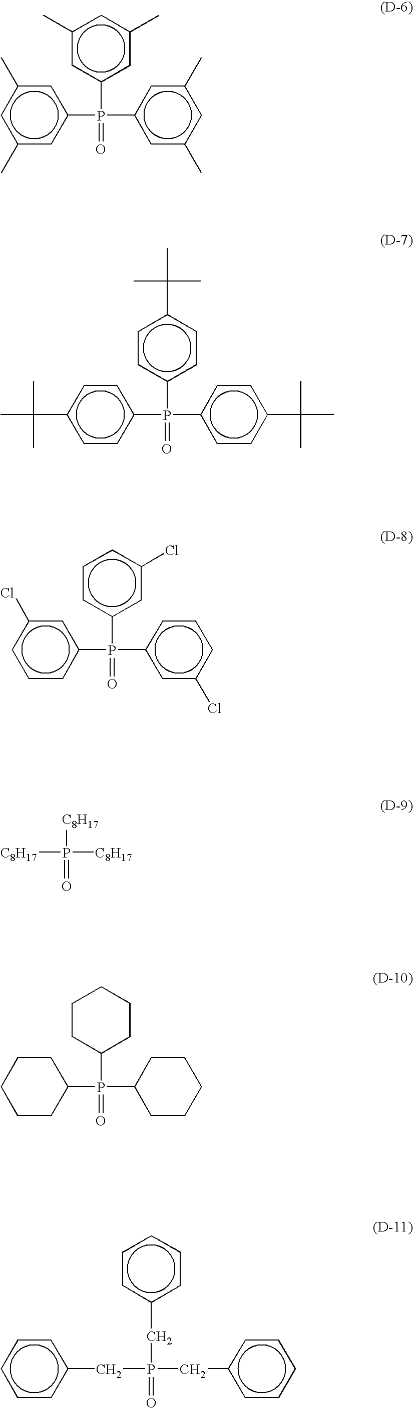

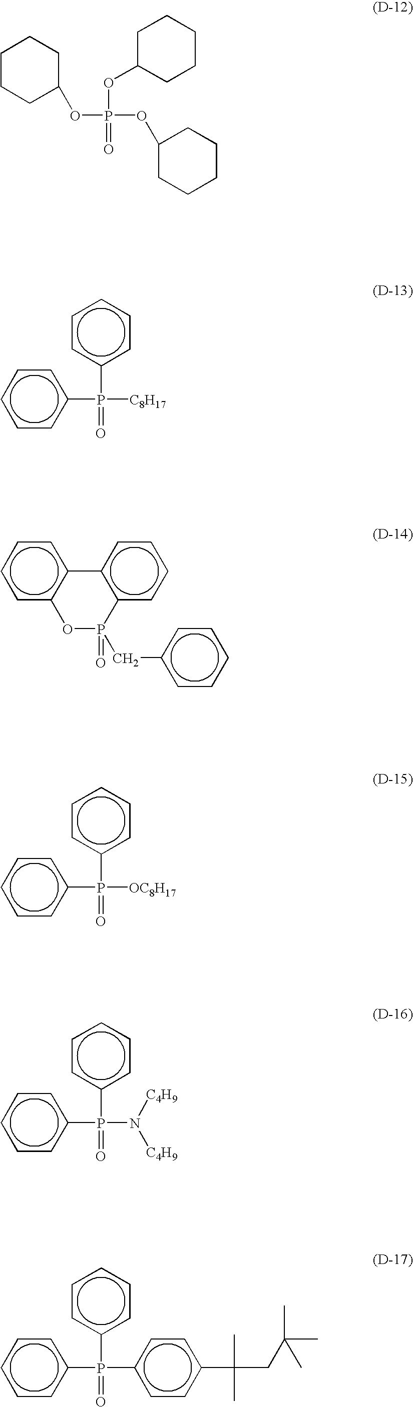

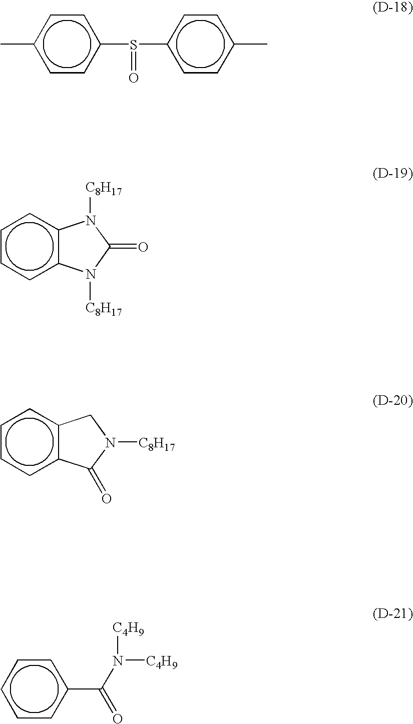

Specific examples of the hydrogen bonding compound include not only the above-mentioned compounds but also those described in Japanese Patent Application Nos. 2000-192191 and 2000-194811.

As in the reducing agent, the hydrogen bonding compound of the invention can be incorporated in a coating liquid and in turn the photosensitive material as a solution, an emulsified dispersion or a solid-dispersed fine particle dispersion. The hydrogen bonding compound in the invention forms a complex with a compound having a phenolic hydroxyl group through a hydrogen bond in a solution. Therefore, the complex can be isolated as crystalline in some combinations of the reducing agent and the compound represented by formula (A) in the invention.

The crystal powder thus isolated is particularly preferably used as a solid-dispersed fine particle dispersion in order to obtain stable performance. In addition, a method can also be preferably conducted in which powder of the reducing agent is mixed with powder the hydrogen bonding compound in the invention, and in which the resultant mixture is dispersed with a suitable dispersant by a sand grinder mill to form a complex.

The content of the hydrogen bonding compound in the invention can be preferably in the range of 1 mol % to 200 mol %, more preferably in the range of 10 mol % to 150 mol %, and still more preferably in the range of 30 mol % to 100 mol % with respect to the reducing agent.

2-8. Binder

Any kind of polymer may be used as the binder of a layer containing the organic silver salt in the invention. The binder is preferably transparent or translucent and generally colorless. Examples thereof include natural resins, polymers and copolymers; synthetic resins, polymers and copolymers; and film forming media. Specific examples thereof include gelatins, rubbers, polyvinyl alcohols, hydroxyethylcelluloses, cellulose acetates, cellulose acetate butylates, polyvinylpyrrolidones, casein, starch, polyacrylic acids, polymethyl methacrylates, polyvinyl chlorides, polymethacrylic acids, styrene-maleic anhydride copolymers, styrene-acrylonitrile copolymers, styrene-butadiene copolymers, polyvinylacetals (e.g., polyvinylformal and polyvinylbutylar), polyesters, polyurethanes, phenoxy resins, polyvinylidene chlorides, polyepoxides, polycarbonates, polyvinyl acetates, polyolefins, cellulose esters and polyamides. The binder may be used as a solution in which it is dissolved in water or an organic solvent, or an emulsion in which the polymer is emulsified in a suitable solvent to form a film.

In the invention, the glass transition temperature of the binder of the layer containing the organic silver salt is preferably from 10° C. to 80° C., more preferably from 20° C. to 70° C., and still more preferably from 23° C. to 65° C.

In this specification, Tg is calculated by using the following expression.
1/Tg=Σ(Xi/Tgi)

Here, it is assumed that the polymer is formed by copolymerization of n monomer components from i=1 to i=n. Xi is the weight rate of i-th monomer (ΣXi=1), and Tgi is the glass transition temperature (absolute temperature) of a homopolymer made of the i-th monomer alone. Σ is the sum of Xi/Tgis from i=1 to n.

The values (Tgi) of the glass transition temperatures of homopolymers made of each monomer alone which values are used herein are those described in Polymer Handbook (3rd Edition) (J. Brandrup, E. H. Immergut (Wiley-Interscience, 1989)).

The polymer serving as the binder may be used alone or, if necessary, two polymers can be used together. A polymer having a glass transition temperatures of 20° C. or higher and a polymer having a glass transition temperature of less than 20° C. may be used together. When a blend of two or more kinds of polymers having different glass transition temperatures is used, it is preferable that weight average Tg of the blend is within the above-described range.

In the invention, performance is improved when the organic silver salt-containing layer is formed by coating a coating liquid whose solvent(s) contains 30 mass % or more of water and drying the resultant film. Performance is more improved when the binder of the layer containing the organic silver salt is soluble or dispersible in a water-based solvent (aqueous solvent). Performance is still more improved when the coating liquid contains a latex of a polymer whose equilibrium moisture content is 2 mass % or lower at 25° C. and relative humidity of 60%.

The polymer is most preferably prepared such that the polymer has an ion conductivity of 2.5 mS/cm or lower. As the preparation method thereof, a method in which a synthesized polymer is purified with a separation function membrane can be used.

The water-based solvent herein in which the polymer is soluble or dispersible is water or a mixture of water and a 70 mass % or less of a water-miscible organic solvent.

Examples of the water-miscible organic solvent include an alcohol solvent such as methyl alcohol, ethyl alcohol and propyl alcohol, a cellosolve solvent such as methylcellosolve, ethylcellosolve and bytylcellosolve, ethyl acetate and dimethylformamide.

The “equilibrium moisture content at 25° C. and relative humidity of 60%” is represented by the following expression, given that weight of the polymer in a moisture equilibrium state under an atmosphere of 25° C. and relative humidity of 60% is W1 and weight of the polymer in an absolute dry state at 25° C. is W0.

Equilibrium moisture content at 25° C. and relative humidity of 60%={(W1-W0)/W0}×100 (mass %)

With respect to the definition of the moisture content and the method of measuring the same, for example, Kobunshi Kogaku Koza 14 and Kobunshi Zairyo Shikenho (Polymer Engineering Course 14, Method of testing polymer material; compiled by Kobunshi Gakkai (the Society of Polymer Science, Japan) and published by Chijin Shokan) can be referred to.

The equilibrium moisture content of the binder polymer in the invention at 25° C. and relative humidity of 60% is preferably 2 mass % or less, more preferably from 0.01 mass % to 1.5 mass %, and still more preferably from 0.02 mass % to 1 mass %.

In the invention, a polymer dispersible in the aqueous solvent is particularly preferable. Examples of the dispersed state include latex in which fine particles of a water-insoluble hydrophobic polymer are dispersed, and a state in which polymer molecules are dispersed in a molecular state or form micelles and are dispersed. Both cases are preferable. The average particle diameter of the dispersion particles is preferably 1 nm to 50000 nm, and more preferably 5 nm to 1000 nm. Particle size distribution of the dispersion particles is not particularly limited. The dispersion particles can have a wide particle size distribution or a monodisperse particle size distribution.

In the invention, typical examples of the polymer dispersible in the aqueous solvent include hydrophobic polymers such as acrylic polymers, polyesters, rubbers (e.g., an SBR resin), polyurethanes, polyvinyl chlorides, polyvinyl acetates, polyvinylidene chlorides and polyolefins. The polymer may be linear, branched or crosslinked. The polymer can be a so-called homopolymer obtained by polymerizing one kind of monomer alone or a copolymer obtained by polymerizing two or more kinds of monomers. In the case of a copolymer, a random copolymer and a block copolymer are usable.

The number average molecular weight of the polymer is 5000 to 1000000, preferably 10000 to 200000. When the molecular weight of the polymer is too small, the image-forming layer has insufficient mechanical strength. When the molecular weight of the polymer is too larger, the polymer has a poor film forming property.

Typical examples of the polymer latex are shown below. In the following list, the polymer latex is shown by starting monomers, the unit of the parenthesized value is mass %, and the molecular weight is a number average molecular weight. When a polymer is made of at least one monomer including a polyfunctional monomer, the concept of molecular weight cannot be applied to the polymer. This is because the polymer has a crosslinked structure. Thus, in the case of such a polymer, the term “crosslinked” is shown, and description of the molecular weight is omitted. Tg indicates the glass transition temperature of the polymer.
P-1: a polymer latex made of MMA (70), EA (27) and MAA (3) and having a molecular weight of 37000 and Tg of 61° C.
P-2: a polymer latex made of MMA (70), 2EHA (20), St (5), and AA (5) and having a molecular weight of 40000 and Tg of 59° C.
P-3: a crosslinked polymer latex made of St (50), Bu (47) and MAA (3) having Tg of 17° C.
P-4: a crosslinked polymer latex made of St (68), Bu (29) and AA (3) having Tg of 17° C.
P-5: a crosslinked polymer latex made of St (71), Bu (26) and AA (3) and having Tg of 24° C.
P-6: a crosslinked polymer latex made of St (70), Bu (27) and IA (3)
P-7: a crosslinked polymer latex made of St (75), Bu (24) and AA (1) and having Tg of 29° C.
P-8: a crosslinked polymer latex made of St (60), Bu (35), DVB (3) and MAA (2)
P-9: a crosslinked polymer latex made of St (70), Bu (25), DVB (2) and AA (3)
P-10: a polymer latex made of VC (50), MMA (20), EA (20), AN (5) and AA (5) and having a molecular weight of 80000
P-11: a polymer latex made of VDC (85), MMA (5), EA (5) and MAA (5) and having a molecular weight of 67000
P-12: a polymer latex made of Et (90) and MAA (10) and having a molecular weight of 12000
P-13: a polymer latex made of St (70), 2EHA (27) and AA (3) and having a molecular weight of 130000 and Tg of 43° C.
P-14: a polymer latex made of MMA (63), EA (35) and AA (2) and having a molecular weight of 33000 and Tg of 47° C.
P-15: a crosslinked polymer latex made of St (70.5), Bu (26.5) and AA (3) and having Tg of 23° C.
P-16: a crosslinked polymer latex made of St (69.5), Bu (27.5) and AA (3) and having Tg of 20.5° C.

Abbreviations in the above structures indicate the following monomers.
MMA: methyl methacrylate
EA: ethyl acrylate
MAA: methacrylic acid
2EHA: 2-ethylhexyl acrylate
St: styrene
Bu: butadiene
AA: acrylic acid
DVB: divinylbenzene
VC: vinyl chloride
AN: acrylonitrile
VDC: vinylidene chloride
Et: ethylene
IA: itaconic acid.

The polymer latexes listed above are commercially available, and the following polymers can be utilized. Examples of the acrylic polymer include SEVIAN A-4635, 4718 and 4601 (all manufactured by Daicel Chemical Industries, Ltd.), and NIPOL Lx 811, 814, 821, 820 and 857 (all manufactured by Nippon Zeon Co., Ltd.). Examples of the polyester include FINETEX ES 650, 611, 675 and 850 (all manufactured by Dainippon Ink and Chemicals, Inc.), and WD-size and WMS (both manufactured by Eastman Chemical). Examples of the polyurethane include HYDRAN AP 10, 20, 30 and 40 (all manufactured by Dainippon Ink and Chemicals, Inc.). Examples of the rubber include LACSTAR 7310K, 3307B, 4700H and 7132C (all manufactured by Dainippon Ink and Chemicals, Inc.), and NIPOL Lx 416, 410, 438C and 2507 (all manufactured by Nippon Zeon Co., Ltd.). Examples of the polyvinyl chloride include G351 and G576 (both manufactured by Nippon Zeon Co., Ltd.). Examples of the polyvinylidene chloride include L502 and L513 (both manufactured by Asahi Chemical Industry Co., Ltd.). Examples of the polyolefin include CHEMIPEARL S120 and SA100 (both manufactured by Mitsui Petrochemical Industries, Ltd.).

One of these polymer latexes may be used alone or, if necessary, two or more thereof can be used together.

The polymer latex used in the invention is particularly preferably a styrene-butadiene copolymer latex. The weight ratio of styrene monomer units and butadiene monomer units in the styrene-butadiene copolymer is preferably from 40:60 to 95:5. The ratio of the sum of the styrene monomer units and the butadiene monomer units to all the monomers of the copolymer is preferably 60 to 99 mass %. The preferable range of molecular weight is the same as above.

The styrene-butadiene copolymer latex is preferably a polymer P-3 to P-8, P-14, or P-15, or any of commercial products LACSTAR-3307B, LACSTAR-7132C and NIPOL Lx 416.

The organic silver salt-containing layer of the photosensitive material in the invention may contain a hydrophilic polymer such as gelatin, polyvinyl alcohol, methyl cellulose, hydroxypropyl cellulose or carboxymethyl cellulose, if necessary.

The amount of the hydrophilic polymer is preferably 30 mass % or less, and more preferably 20 mass % or less based on the total amount of the binder(s) of the organic silver salt-containing layer.

The organic silver salt-containing layer (the image-forming layer) in the invention preferably contains the polymer latex as the binder. As for the amount of the binder in the organic silver salt-containing layer, the weight ratio of all the binders to the organic silver salt is from 1/10 to 10/1, and preferably 1/5 to 4/1.

This organic silver salt-containing layer is usually the photosensitive layer (image-forming layer) containing the photosensitive silver halide which is a photosensitive silver salt. In this case, the weight ratio of all the binders to the silver halide is preferably in the range of 400 to 5, and more preferably 200 to 10.

The total amount of the binder in the image-forming layer in the invention is preferably from 0.2 g/m² to 30 g/m², and more preferably from 1 g/m² to 15 g/m². The image-forming layer in the invention may contain a crosslinking agent for crosslinking and a surfactant to improve a coating property.

A solvent (for simplicity, a solvent and a dispersion medium are in common referred to as “a solvent”) of the coating liquid for the organic silver salt-containing layer coating liquid of the photosensitive material in the invention may be an aqueous solvent containing 30 mass % or more of water. As a component other than water, any water-miscible organic solvent may be used. Examples thereof include methyl alcohol, ethyl alcohol, isopropyl alcohol, methylcellosolve, ethylcellosolve, dimethylformamide and ethyl acetate. The content of water in the aqueous solvent is preferably 50 mass % or more, and more preferably 70 mass % or more.

Solvents having the following compositions are preferable: water; a mixture of water and methyl alcohol at a mass ratio of 90/10, a mixture of water and methyl alcohol at a mass ratio of 70/30, a mixture of water, methyl alcohol and dimethylformamide at a mass ratio of 80/15/5, a mixture of water, methyl alcohol and ethylcellosolve at a mass ratio of 85/10/5 and a mixture of water, methyl alcohol and isopropyl alcohol at a mass ratio of 85/10/5.

2-9. Antifogging Agent

1) Organic Polyhalogenated Compound

The photosensitive material and the thermographic material of the invention preferably include a compound represented by the following formula (H) as an antifoggant.
Q-(Y)ₙ—C(Z₁) (Z₂)X Formula (H)

In formula (H), Q represents an alkyl group, an aryl group or a heterocyclic group. Y represents a divalent linking group. n represents 0 or 1. Each of Z₁ and Z₂ represents a halogen atom, and X represents a hydrogen atom or an electron-attractive group.

In formula (H), when Q is an aryl group, Q is preferably a phenyl group having, as a substituent, an electron-attractive group whose Hammett's substituent constant σp is a positive value. With respect to Hammett's substituent constant, Journal of Medicinal Chemistry, 1973, vol. 16, No. 11, pp. 1207-1216 can be referred to.

Examples of the electron-attractive group include halogen atoms, alkyl groups having as a substituent an electron-attractive group, aryl groups having as a substituent an electron-attractive group, heterocyclic groups, alkyl- or aryl-sulfonyl groups, acyl groups, alkoxycarbonyl groups, carbomoyl groups and sulfamoyl groups.

Specific examples thereof include halogen atoms (e.g., a fluorine atom (σp: 0.06), a chlorine atom (σp: 0.23), a bromine atom (σp: 0.23) and an iodine atom (σp: 0.18)), trihalomethyl groups (a tribromomethyl group (σp: 0.29), a trichloromethyl group (σp: 0.33) and a trifluoromethyl group (σp: 0.54)), a cyano group (σp: 0.66), a nitro group (σp: 0.78), aliphatic, aryl or heterocyclic sulfonyl groups (e.g., a methanesulfonyl group (σp: 0.72)), an aliphatic, aryl or heterocyclic acyl group (e.g., an acetyl group (σp: 0.50) and a benzoyl group (σp: 0.43)), alkynyl groups (e.g., a C≡CH group (σp: 0.23)), aliphatic, aryl or heterocyclic oxycarbonyl groups (e.g., a methoxycarbonyl group (σp: 0.45) and a phenoxycarbonyl group (σp: 0.44)), a carbamoyl group (σp: 0.36), a sulfamoyl group (σp: 0.57), a sulfoxide group, a heterocyclic group and a phosphoryl group.

σp is preferably from 0.2 to 2.0, and more preferably from 0.4 to 1.0.

The electron-attractive group is preferably a halogen atom, a carbamoyl group, an alkoxycarbonyl group, an alkylsulfonyl group, an alkyphosphoryl group, a carboxyl group, an alkyl- or aryl-carbonyl group or an arylsulfonyl group, more preferably a halogen atom, a carbamoyl group or an arylsulfonyl group, or a carbamoyl group, an alkoxycarbonyl group, an alkylsulfonyl group or an alkylphosphoryl, and most preferably a carbamoyl group.

X is preferably an electron-attractive group. The electron-attractive group is preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group or a sulfamoyl group, more preferably a halogen atom or a carbamoyl group, and most preferably a halogen atom.

Among the halogen atoms, a chlorine atom, a bromine atom and an iodine atom are preferable. A chlorine atom and a bromine atom are more preferable. A bromine atom is most preferable.

Each of Z₁ and Z₂ is preferably a bromine atom or an iodine atom, and more preferably a bromine atom.

Y represents preferably —C(═O)—, —SO—, —SO₂—, —C(═O)N(R)— or —SO₂N(R)—, more preferably —C(═O)—, —SO—, —SO₂— or —C(═O)N(R)—, and still more preferably —C(═O)—, —SO₂— or —C(═O)N(R)—; or —C(═O)—, —SO— or —SO₂—, still more preferably —SO₂— or —C(═O)N(R)— or —C(═O)— or —SO₂—, and most preferably —SO₂—. R represents a hydrogen atom, an aryl group or an alkyl group, more preferably a hydrogen atom or an alkyl group, and most preferably a hydrogen atom.

n is 0 or 1, and preferably 1.

Specific examples of the compound of formula (H) in the invention are shown below. However, the invention is not limited to them.

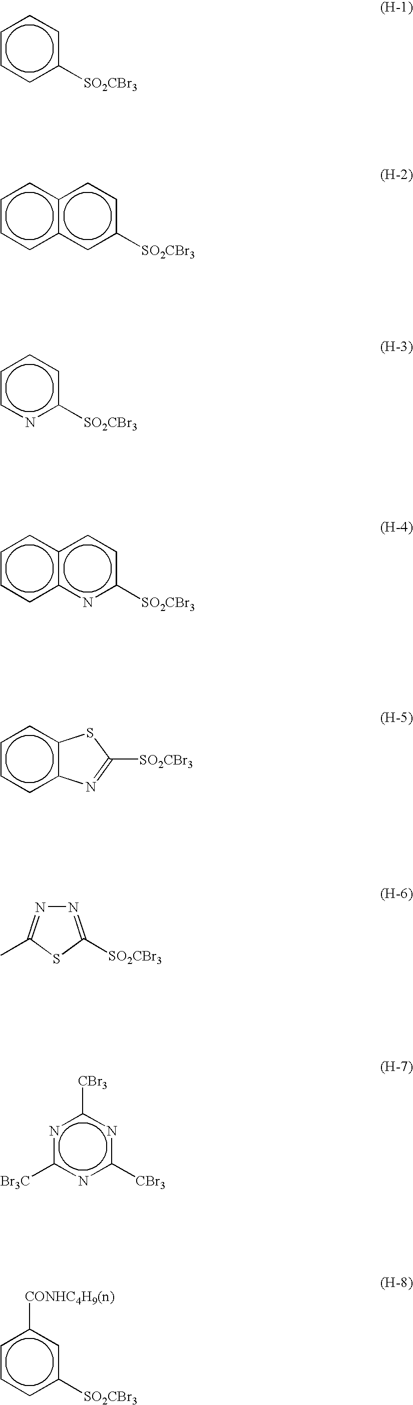

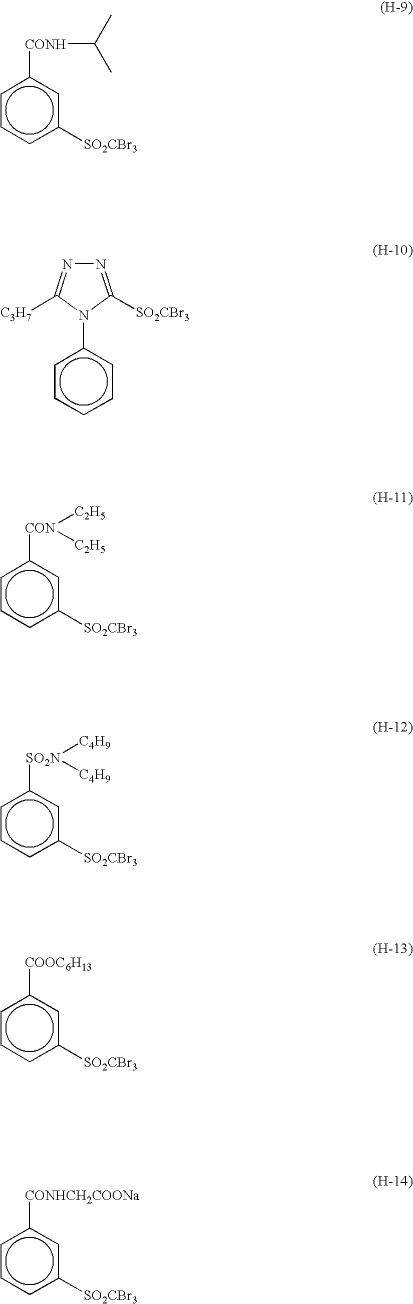

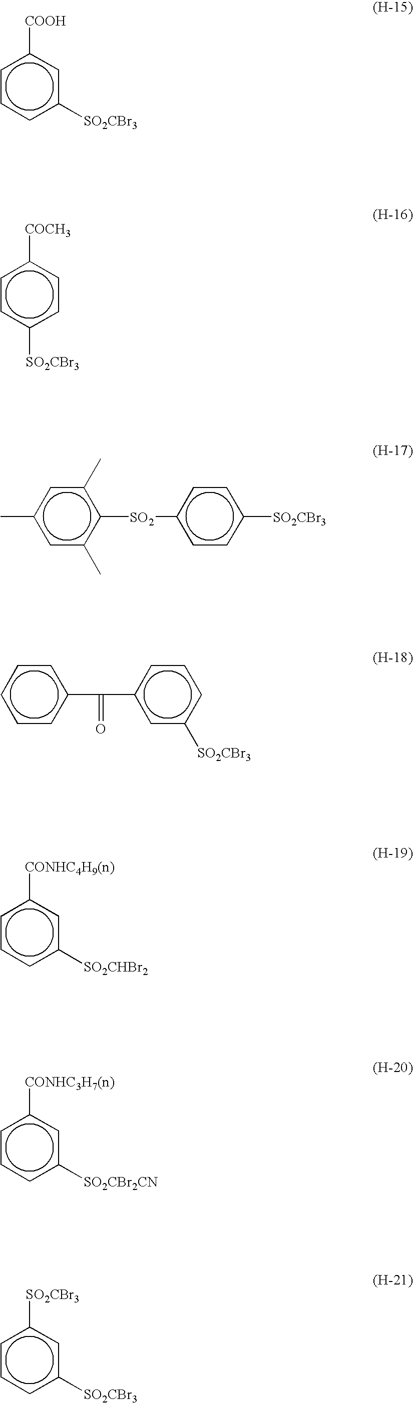

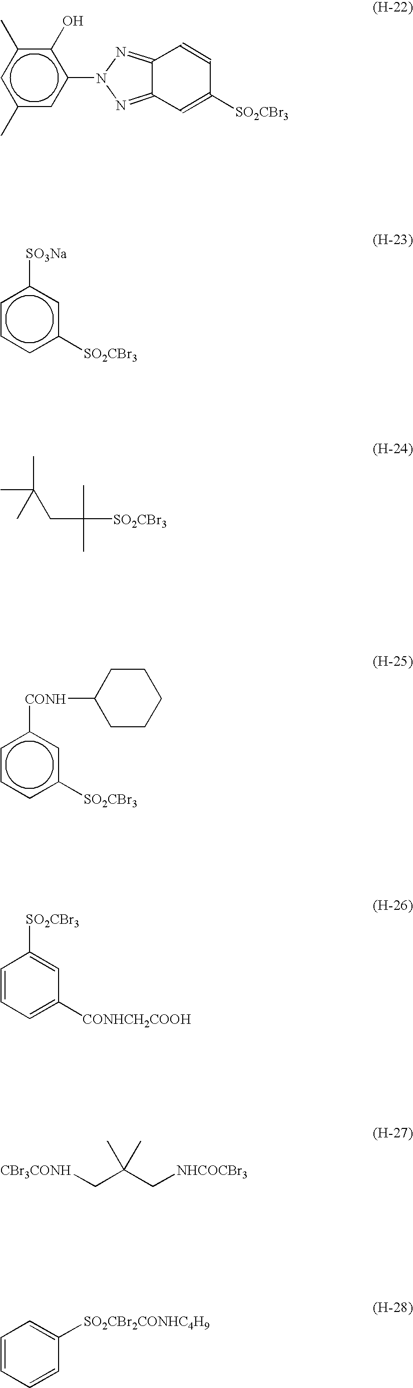

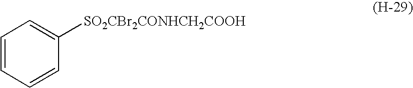

The compound represented by formula (H) in the invention is preferably used in an amount of 10⁻⁴ to 0.8 mol, more preferably in an amount of 10⁻³ to 0.1 mol, and still more preferably in an amount of 5×10⁻³ to 0.05 mol per mol of the non-photosensitive silver salt of the image-forming layer.

In particularly, when the silver halide with a high content of silver iodide according to the invention is used, the addition amount of the compound of formula (H) is important to obtain a sufficient fogging preventing effect. Most preferably, the compound is used in an amount of 5×10⁻³ to 0.03 mol.

In the invention, the compound represented by formula (H) can be incorporated in the photosensitive material in the same manner as incorporation of the reducing agent.

The melting point of the compound represented by formula (H) is preferably 200° C. or less, and more preferably 170° C. or less.

As other organic polyhalogenated compound for use in the invention, those disclosed in official gazettes described in JP-A No. 11-65021, paragraphs [0111] to [0112] can be used. In particular, an organic halogenated compound represented by formula (P) of JP-A NO. 2000-284399, an organic polyhalogenated compound represented by formula (II) of JP-A No. 10-339934 and an organic polyhalogenated compound described in JP-A No. 2001-33911 are preferable.

Other Antifoggant

Examples of other antifoggants include mercury (II) salts in JP-A No. 11-65021, paragraph [0113], benzoic acids in the same document, paragraph [0114], salicylic acid derivatives in JP-A No. 2000-206642, formalin scavenger compounds represented by formula (S) in JP-A No. 2000-221634, triazine compounds in claim 9 of JP-A No. 11-352624, compounds represented by formula (III) in JP-A No. 6-11791 and 4-hydroxy-6-methyl-1,3,3a,7-tetrazaindene.

Moreover, other antifogging agent, a stabilizer and a stabilizer precursor that can be used in the invention can also be any of those disclosed in official gazettes described in JP-A No. 10-62899, paragraph [0070] and EP-A No. 0803764A1, page 20, line 57 to page 21, line 7, and compounds described in JP-A Nos. 9-281637 and 9-329864.

The photothermographic material in the invention may contain azolium salt for the purpose of fogging prevention. Examples of the azolium salt include compounds represented by formula (XI) described in JP-A No. 59-193447, compounds described in JP-B No. 55-12581, compounds represented by formula (II) described in JP-A No. 60-153039. The azolium salt may be contained in any portion of the photosensitive material. However, the azolium salt is preferably contained in a layer on a side of a support which side has the photosensitive layer, and more preferably the organic silver salt-containing layer.

The azolium salt may be added at any step of preparation of a coating liquid. When it is added to the organic silver salt-containing layer, it may be added at any step from preparation of the organic silver salt to preparation of the coating liquid, however preferably within a period from completion of preparation of the organic silver salt to a time just before coating. The azolium salt may be added in any form such as powder, a solution or a fine particle dispersion. Further, it may be added to a solution including any other additive such as a sensitizing dye, the reducing agent or a color-toning agent.

The amount of the azolium salt in the invention is preferably from 1×10⁻⁶ mol to 2 mol, and more preferably from 1×10⁻³ mol to 0.5 mol per mol of silver, but may be out of the above range.

2-10. Other Additives

1) Mercapto, Disulfide and Thions

The photosensitive material and the thermographic material of the invention may include a mercapto compound, a disulfide compound and/or a thion compound may in order to inhibit, accelerate or control development, to improve a spectral sensitization effect, or to improve storability before and after development. Examples thereof include compounds described in JP-A No. 10-62899, paragraphs [0067] to [0069], compounds represented by formula (I) of JP-A No. 10-186572 including specific compounds described in paragraphs [0033] to [0052], compounds described in EP-A1 No. 0803764, page 20, lines 36 to 56, and compounds described in JP-A No. 2001-100358. Among them, a mercapto-substituted heteroaromatic compound is preferable.

2) Color-Toning Agent

The photothermographic material of the invention preferably contains a color-toning agent. The Color-toning agent is described in JP-A No. 10-62899, paragraphs [0054] to [0055], EP-A No. 0803764A1, page 21, lines 23 to 48, JP-A No. 2000-356317 and Japanese Patent Application No. 2000-187298. In particular, phthalazinones (phthalazinone, phthalazinone derivatives and metal salts thereof, such as 4-(1-naphthyl) phthalazinone, 6-chlorophthalazinone, 5,7-dimethoxyphthalazinone and 2,3-dihydro-1,4-phthalazinedione); combinations of phthalazinones and phthalic acids (e.g., phthalic acid, 4-methylphthalic acid, 4-nitrophthalic acid, diammonium phthalate, sodium phthalate, potassium phthalate and tetrachlorophthalic anhydride); phthalazines (phthalazine, phthalazine derivatives and metal salts thereof, such as 4-(1-naphthyl)phthalazine, 6-isopropylphthalazine, 6-t-butylphthalazine, 6-chlorophthalazine, 5,7-dimethoxyphthalazine and 2,3-dihydrophthalazine) are preferable. In particular, when the color-toning agent is used together with silver halide having a high silver iodide content, combined used of phthalazines and phthalic acids is preferable.

The amount of phthalazines is preferably 0.01 to 0.3 mol, more preferably 0.02 to 0.2 mol, and most preferably 0.02 to 0.1 mol per mol of the organic silver salt. The amount is an important factor for accelerated development, which is a subject for the silver halide emulsion of the invention having a high silver iodide content, and appropriate selection of the amount can make a sufficient development property and low fogging compatible.

3) Plasticizer and Lubricant

The photosensitive material and the thermographic material can contain a plasticizer, and/or a lubricant in the photosensitive layer (image-forming layer). The plasticizer and the lubricant are described in JP-A No. 11-65021, paragraph [0117]. The material may also contain a slipping agent, which is described in JP-A No. 11-84573, paragraphs [0061] to [0064] and Japanese Patent Application No. 11-106881, paragraphs [0049] to [0062].

4) Dye and Pigment

The photosensitive layer in the invention may contain any dye and/or any pigment (e.g., C.I. Pigment Blue 60, C.I. Pigment Blue 64 or C.I. Pigment Blue 15:6) so as to improve color tone, inhibit generation of interference fringe at the time of laser exposure, or inhibit irradiation. They are described in detail in WO98/36322, JP-A Nos. 10-268465 and 11-338098.

5) Ultrahigh Contrasting Agent and Nucleus Forming Agent

In order to form an ultrahigh contrast image suitable for use in making of printing plates, the photosensitive material and the thermographic material of the invention preferably contains an ultrahigh contrasting agent in the image-forming layer. Examples of the ultrahigh contrasting agent include compounds described in JP-A Nos. 11-65021, paragraph [0118] and 11-223898, paragraphs [0136] to [0193], compounds represented by formulas (H), (1) to (3), (A) and (B) of Japanese Patent Application No. 11-87297, and compounds represented by formulas (III) to (V) of Japanese Patent Application No. 11-91652 (specific compounds: [Formula 21] to [Formula 24]). An addition method and the amount of the ultrahigh contrasting agent are also described in the above applications. A high contrast accelerator is described in JP-A No. 11-65021, paragraph [0102] and JP-A No. 11-223898 paragraphs [0194] to [0195].

Next, the nucleus forming agent which can be used in the invention will be described. The nucleus forming agent in the invention is a compound capable of decreasing the amount of silver which amount is necessary to obtain a predetermined silver image density. While there are some mechanisms of action for decreasing function, a compound improving the covering power of developed silver is preferable in the invention. The covering power of the developed silver means an optical density of silver per unit amount.

Typical examples of the nucleus forming agent include a hydrazine derivative compound represented by the following formula (H), a vinyl compound represented by the following formula (G), a quaternary onium compound represented by the following formula (P) and cyclic olefin compounds represented by formulae (A), (B) and (C).

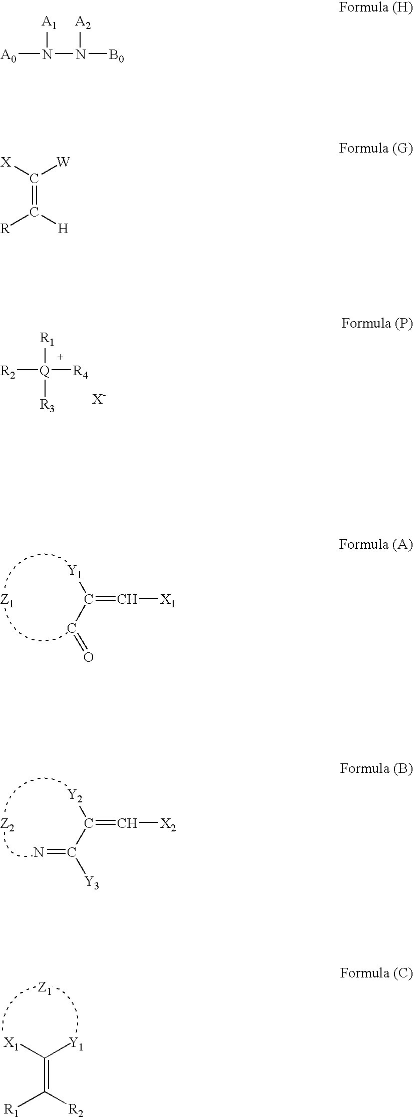

In formula [H], A₀ represents an aliphatic group, an aromatic group, a heterocyclic group or a -G₀-D₀ group which may have a substituent, and B₀ represents a blocking group. Both of A₁ and A₂ are hydrogen atoms. Alternatively, one A₁ and A₂ is a hydrogen atom and the other is an acyl group, a sulfonyl group or an oxalyl group. G₀ represents —CO— group, —COCO— group, —CS— group, —C(═NG₁D₁)— group, —SO— group, —SO₂— group or —P(O) (G₁D₁)— group. G₁ represents a single bond, —O— group, —S— group or —N(D₁)— group. D₁ represents an aliphatic group, an aromatic group, a heterocyclic group or a hydrogen atom. When a plurality of D₁s are contained in one molecule, they may be identical to or different from each other. D₀ represents a hydrogen atom, an aliphatic group, an aromatic group, a heterocyclic group, an amino group, an alkoxy group, an aryloxy group, an alkylthio group or an arylthio group. D₀ is preferably a hydrogen atom, an alkyl group, an alkoxy group, or an amino group.

In formula (H), the aliphatic group represented by A₀ is preferably one having from 1 to 30 carbon atoms, and more preferably a linear, branched or cyclic alkyl group having from 1 to 20 carbon atoms including a methyl group, an ethyl group, a t-butyl group, an octyl group, a cyclohexyl group and a benzyl group. These exemplified groups may have an appropriate substituent (for example, an aryl group, an alkoxy group, an aryloxy group, an alkylthio group, an arylthio group, a sulfoxy group, a sulfonamide group, a sulfamoyl group, an acylamino group, or a ureido group).

In formula (H), the aromatic group represented by A₀ is preferably a monocyclic or condensed cyclic aryl group including a benzene ring and naphthalene ring. The heterocyclic ring represented by A₀ is preferably a monocyclic or condensed hetero cyclic ring containing at least one hetero atom selected from nitrogen, sulfur, and oxygen atoms. Examples thereof include a pyrrolidine ring, an imidazole ring, a tetrahydrofuran ring, a morpholine ring, a pyridine ring, a pyrimidine ring, a quinoline ring, a thiazole ring, a benzothiazole ring, a thiophene ring and a furan ring. The aromatic group, the heterocyclic ring and the -G₀-D₀ group represented by A₀ may have a substituent. A₀ is more preferably an aryl group or -G₀-D₀ group.

Further, in formula (H), A₀ preferably contains at least one diffusion resistant group or a group adsorptive to silver halide. The diffusion resistant group is preferably a ballast group ordinarily used in an immobile photographic additive such as a coupler. Examples of the ballast group include a photographically inactive alkyl group, alkenyl group, alkynyl group, alkoxy group, phenyl group, phenoxy group, and alkyl phenoxy group, and the number of carbon atoms in the substituent moiety is preferably 8 or more in total.

In formula (H), examples of the group adsorptive to silver halide include thiourea, a thiourethane group, a mercapto group, a thioether group, a thione group, a heterocyclic ring group, a thioamide heterocyclic group, a mercapto heterocyclic group, and an absorptive group described in JP-A No. 64-90439.

In formula (H), B₀ represents a blocking group, preferably -G₀-D₀ group. G₀ represents —CO— group, —COCO— group, —CS— group, —C(═NG₁D₁)—group, —SO— group, —SO₂— group or —P═(O) (G₁D₁)— group. G₀ is preferably —CO— group and —COCO— group. G₁ represents a single bond, —O— group, —S— group, or —N(D₁)— group. D₁ represents an aliphatic group, an aromatic group, a heterocyclic group or a hydrogen atom. When a plurality of D₁s are present in one molecule, they may be identical with or different from each other. D₀ represents a hydrogen atom, an aliphatic group, an aromatic group, a heterocyclic group, an amino group, an alkoxy group, an aryloxy group, an alkylthio group, or an arylthio group. D₀ is preferably a hydrogen atom, an alkyl group, an alkoxyl group, or an amino group. A₁ and A₂ are hydrogen atoms, or one of them is a hydrogen atom and the other represents an acyl group (e.g., an acetyl group, a trifluoroacetyl group, or a benzoyl group), a sulfonyl group (e.g., a methanesulfonyl group, or a toluenesulfonyl group) or an oxalyl group (e.g., an ethoxalyl group).

Specific examples of the compound represented by formula (H) include, but are not limited to, compounds H-1 to H-35 in formula Nos. 12 to 18 and compounds H-1-1 to H-4-5 in formula Nos. 20 to No. 26 of JP-A No. 2002-131864.

The compound represented by formulae (H-1) to (H-4) of the invention can be easily synthesized by a known method. The compound can be synthesized with reference to, for example, U.S. Pat. Nos. 5,464,738 and 5,496,695.

Other examples of the hydrazine derivatives to be preferably used include compounds H-1 to H-29 described in columns 11 to 20 of U.S. Pat. No. 5,545,505 and compounds 1 to 12 described in columns 9 to 11 of U.S. Pat. No. 5,464,738.

Next, formula (G) will be explained. In formula (G), X and R has a cis-form, but compounds in which X and R has a trans-form are also included in formula (G). It is also applicable to expressions of the structure of specific compounds.

In formula (G), X represents an electron-attractive group, and W represents a hydrogen-atom, an alkyl group, an alkenyl group, an alkynyl group, an aryl group, a heterocyclic group, a halogen atom, an acyl group, a thioacyl group, an oxalyl group, an oxyoxalyl group, a thiooxalyl group, an oxamoyl group, an oxycarbonyl group, a thiocarbonyl group, a carbamoyl group, a thiocarbamoyl group, a sulfonyl group, a sulfinyl group, an oxysulfinyl group, a thiosulfinyl group, a sulfamoyl group, an oxysulfamoyl group, a thiosulfamoyl group, a sulfinamoyl group, a phosphoryl group, a nitro group, an imino group, an N-carbonylimino group, an N-sulfonylimino group, a dicyanoethylene group, an ammonium group, a sulfonium group, a phosphonium group, a pyrylium group, or an immonium group.

R represents a halogen atom, a hydroxyl group, an alkoxy group, an aryloxy group, a hetero cyclic oxy group, an alkenyloxy group, an acyloxy group, an alkoxycarbonyloxy group, an aminocarbonyloxy group, a mercapto group, an alkylthio group, an arylthio group, a hetero cyclic thio group, an alkenylthio group, an acylthio group, an alkoxycarbonylthio group, an aminocarbonylthio group, an organic or inorganic salt (for example, a sodium salt, a potassium salt, and a silver salt) of the hydroxyl group or the mercapto group, an amino group, an alkylamino group, a cyclic amino group (for example, a pyrolidino group), an acylamino group, an oxycarbonylamino group, a hetero cyclic group, (a five or six-membered nitrogen-containing hetero ring, for example, a benzotriazolyl group, an imidazolyl group, a triazolyl group, and a tetrazolyl group), an ureido group and a sulfonamide group. X and W, and/or X and R may respectively join to each other to form a cyclic structure. Examples of the ring formed by X and W include pyrazolone, pyrazolidinone, cyclopentanedione, β-ketolactone, and β-ketolactam.

In formula (G), the electron-attractive group represented by X is a substituent which can have a substituent constant σp of a positive value. Specific examples thereof include a substituted alkyl group (e.g., a halogen-substituted alkyl group), a substituted alkenyl group (e.g., a cyanovinyl group), a substituted or unsubstituted alkynyl group (e.g., a trifluoromethylacetylenyl group, and a cyanoacetylenyl group) a substituted aryl group (e.g., an cyanophenyl group), a substituted or unsubstituted hetero cyclic group (e.g., a pyridyl group, a triazynyl group, and a benzooxazolyl group), a halogen atom, a cyano group, an acyl group (e.g., an acetyl group, a trifluoroacetyl group, a formyl group), a thioacetyl group (e.g., a thioacetyl group, and a thioformyl group), an oxalyl group (e.g., a methyloxalyl group), an oxyoxalyl group (e.g., an ethoxalyl group), a thiooxalyl group (e.g., an ethylthiooxalyl group), an oxamoyl group (e.g., a methyloxamoyl group), an oxycarbonyl group (e.g., an ethoxycarbonyl group), a carboxyl group, a thiocarbonyl group (e.g., an ethylthiocarbonyl group), a carbamoyl group, a thiocarbamoyl group, a sulfonyl group, a sulfinyl group, an oxysulfonyl group (e.g., an ethoxysulfonyl group), a thiosulfonyl group (e.g., an ethylthiosulfonyl group), a sulfamoyl group, an oxysulfinyl group (e.g., a methoxysulfiny group), a thiosulfinyl group (e.g., a methylthiosulfinyl group), a sulfinamoyl group, a phosphoryl group, a nitro group, an imino group, an N-carbonylimino group (e.g., an N-acetylimino group), an N-sulfonylimino group (e.g., an N-methanesulfonylimino group), a dicyanoethylene group, an ammonium group, a sulfonium group, a phosphonium group, a pyrylium group, and an immonium group. A heterocycle in which any combination of an ammonium group, a sulfonium group, a phosphonium group and an immonium group forms a ring are also included in X. Substituents having a σp value of 0.30 or more are particularly preferable.

Examples of the alkyl group represented by W include methyl, ethyl, and trifluoromethyl groups. Examples of the alkenyl group include vinyl, halogen-substituted vinyl, and cyanovinyl groups. Examples of the alkynyl group include acetylenyl and cyanoacetylenyl groups. Examples of the aryl group include nitrophenyl, cyanophenyl, and pentafluorophenyl groups. Examples of the hetero cyclic group include pyridyl, pyrimidyl, triazinyl, succinimide, tetrazolyl, triazolyl, imidazolyl, and benzooxazolyl groups. W is preferably an electron-attractive group having a positive σp value, and more preferably an electron-attractive group having a value σp of 0.30 or more.

R is preferably a hydroxyl group, a mercapto group, an alkoxy group, an alkylthio group, a halogen atom, an organic or inorganic salt of the hydroxyl group or the mercapto group, or a hetero cyclic group, more preferably a hydroxyl group, an alkoxy group, an organic or inorganic salt of the hydroxyl group or the mercapto group, or a hetero cyclic group, and still more preferably a hydroxyl group, or an organic or inorganic salt of the hydroxyl group or the mercapto group.

Further, among the substituents represented by X and W, those having therein a thioether bond are preferable.

Specific examples of the compound represented by formula (G) include, but are not limited to, Compounds 1-1 to 92-7 of formulae 27 to 50 disclosed in JP-A No. 2002-131864.

In formula (P), Q represents a nitrogen atom or a phosphor atom, and R₁, R₂, R₃ and R₄ each represent a hydrogen atom or a substituent, and X⁻ represents an anion. Further, R₁ to R₄ may join to each other to form a ring.

Examples of the substituents represented by R₁ to R₄ include alkyl groups (e.g., a methyl group, an ethyl group, a propyl group, a butyl group, a hexyl group, and a cyclohexyl group), alkenyl groups (e.g., an allyl group, and a butenyl group), alkynyl groups (e.g., a propargyl group, and a butynyl group), aryl groups (e.g., a phenyl group, and a naphthyl group), heterocyclic groups (e.g., a piperidinyl group, a peperazinyl group, a morphorinyl group, a pyridyl group, a furyl group, a thienyl group, a tetrahydrofuryl group, a tetrahydrothienyl group, and a sulfolanyl group), and an amino group.

Examples of the ring which R₁ to R₄ join with each other to form include a piperidine ring, a morpholine ring, a piperazine ring, a quinacridine ring, a pyridine ring, a pyrrol ring, an imidazol ring, a triazole ring, and a tetrazole ring.

The group represented by R₁ to R₄ may have a substituent such as a hydroxyl group, an alkoxy group, an aryloxy group, a carboxyl group, a sulfo group, an alkyl group, or an aryl group. Each of R₁, R₂, R₃ and R₄ is preferably a hydrogen atom or an alkyl group.

Examples of the anion represented by X include inorganic and organic anions such as halogen ions, a sulfate ion, a nitrate ion, an acetate ion and a p-toluene sulfonate ion.

As the structure of formula P, a structure described in the columns Nos. 0153 to 0163 of JP-A No. 2002-131864 is preferable.

Specific examples of the compound of formula (P) include, but are not limited to, Compounds P-1 to P-52 and T-1 to T-18 represented by formulas 53 to 62 described in JP-A No. 2002-131864.

The quaternary onium compound can be synthesized according to a known method. For example, the tetrazolium compound can be synthesized on the basis of a method described in Chemical Reviews, vol. 55, page 335 to 483.

Next, compounds represented by (A) and (B) will be explained in detail. In formula (A), Z₁ represents a non-metal atomic group capable of forming a 5- to 7-membered ring structure together with —Y₁—C(═CH—X₁)—C(═O)—. Z₁ preferably represents an atomic group including atoms selected from a carbon atom, an oxygen atom, a sulfur atom, a nitrogen atom and a hydrogen atom. Several atoms selected from them bond to each other via a single bond or a double bond to form a 5- to 7-membered ring structure together with —Y₁—C(═CH—X₁)—C(═O)—.

Z₁ may have a substituent, and Z₁ per se may be a part of an aromatic or non-aromatic carbocyclic ring or an aromatic or non-aromatic heterocyclic ring. In this case, the 5- to 7-membered ring structure formed by Z₁ and —Y₁—C(═CH—X₁)—C(═O)— forms a condensed ring structure.

In formula (B), Z₂ represents a non-metal atomic group capable of forming a 5- to 7-membered ring structure together with —Y₂—C(═CH—X₂)—C (Y₃)N—.

Z₂ preferably represents an atomic group including atoms selected from a carbon atom, an oxygen atom, a sulfur atom, a nitrogen atom and a hydrogen atom, and several atoms selected from them bond to each other via a single bond or a double bond to form a 5- to 7-membered ring structure together with —Y₂—C (═CH—X₂)—C (Y₃)N—.

Z₂ may have a substituent, or Z₂ itself may be a part of an aromatic or non-aromatic carbocyclic ring, or an aromatic or non-aromatic heterocyclic ring. In this case, the 5- to 7-membered ring structure formed by Z₂ and —Y₂—C(═CH—X₂)—C(Y₃)N-forms a condensed ring structure.

In the case where Z₁ and Z₂ have a substituent, typical examples of the substituent include a halogen atom (e.g., a fluorine atom, a chlorine atom, a bromine atom and an iodine atom), an alkyl group (including an aralkyl group, a cycloalkyl group, and an active methine group), an alkenyl group, an alkynyl group, an aryl group, a heterocyclic group, a quaternary nitrogen-containing heterocyclic group (for example, a pyridinio group), an acyl group, an alkoxycarbonyl group, an aryloxycarbonyl group, a carbamoyl group, a carboxy group and a salt thereof, a sulfonylcarbamoyl group, an acylcarbamoyl group, a sulfamoylcarbamoyl group, a carbazoyl group, an oxalyl group, an oxamoyl group, a cyano group, a thiocarbamoyl group, a hydroxyl group, an alkoxy group (including groups repeatedly containing an ethyleneoxy group unit or a propyleneoxy group unit), an aryloxy group, a heterocyclic oxy group, acyloxy group, a (alkoxy- or aryloxy-) carbonyloxy group, a carbamoyloxy group, a sulfonyloxy group, an amino group, an (alkyl-, aryl- or heterocyclic-)amino group, an N-substituted nitrogen-containing heterocyclic group, an acylamino group, a sulfonamide group, an ureido group, a thioureido group, an imido group, a (alkoxy- or aryloxy-) carbonylamino group, a sulfamoylamino group, a semicarbazide group, a thiosemicarbazide group, a hydrazino group, a quaternary ammonio group, an oxamoylamino group, a (alkyl- or aryl-) sulfonylureido group, an acylureido group, an acylsulfamoylamino group, a nitro group, a mercapto group, a (alkyl-, aryl- or heterocyclic-) thio group, a (alkyl- or aryl-) sulfonyl group, a (alkyl- or aryl) sulfinyl group, a sulfo group and a salt thereof, a sulfamoyl group, an acylsulfamoyl group, a sulfonylsulfamoyl group and a salt thereof, a group containing a phosphoric acid amide or a phosphate structure, a silyl group and a stannyl group. Those substituents may further have any of those substituents.

Next, Y₃ will be explained. In formula (B), Y₃ represents a hydrogen atom or a substituent. When Y₃ represents a substituent, examples thereof include an alkyl group, an aryl group, a heterocyclic group, a cyano group, an acyl group, an alkoxycabonyl group, an aryloxycarbonyl group, a carbamoyl group, an amino group, a (alkyl-, aryl- or heterocyclic-)amino group, an acylamino group, a sulfonamide group, an ureido group, a thioureido group, an imide group, an alkoxy group, an aryloxy group, and a (alkyl-, aryl- or heterocyclic-) thio group.

Those substituents may have any substituent, and examples thereof include those of the substituent which Z₁ and/or Z₂ may have.

In formulae (A) and (B), X₁ and X₂ each represent a hydroxy group (or a salt thereof), an alkoxy group (for example, a methoxy group, an ethoxy group, a propoxy group, an isopropoxy group, an octyloxy group, a dodecyloxy group, a cetyloxy group, or a t-butoxy group), an aryloxy group (for example, a phenoxy group, a p-t-pentylphenoxy group, or a p-t-octylphenoxy group), a heterocyclic oxy group (for example, a benzotriazolyl-5 -oxy group, or a pyridinyl-3-oxy group), a mercapto group (or a salt thereof), an alkylthio group (for example, a methylthio group, an ethylthio group, a butylthio group, or a dodecylthio group), an arylthio group (for example, a phenylthio group, or ap-dodecylphenylthio group), a heterocyclic thio group (for example, a 1-phenyltetrazoyl-5-thio group, a 2-methyl-1-phenyltriazolyl-5-thio group, or a mercaptothidiazolylthio group), an amino group, an alkylamino group (for example, a methylamino group, a propylamino group, an octylamino group, or a dimethylamino group), an arylamino group (for example, an anilino group, a naphthylamino group, or an o-methoxyanilino group), a heterocyclic amino group (for example, a pyridylamino group, or a benzotriazole-5-ylamino group), an acylamino group (for example, an acetoamide group, an octanoylamino group, or a benzoylamino group), a sulfonamide group (for example, a methanesulfonamide group, a benzene sulfonamide group, or a dodecylsulfonamide group) or a heterocyclic group.

The heterocyclic group is an aromatic or non-aromatic, saturated or unsaturated, monocyclic or condensed, substituted or unsubstituted heterocyclic group, including an N-methylhydantoyl group, an N-phenylhydantoyl group, a succinimide group, a phthalic imide group, an N,N′-dimethylurazolyl group, an imidazolyl group, a benzotriazolyl group, an indazolyl group, a morpholino group, and a 4,4-dimethyl-2,5-dioxo-oxazolyl group.

Further, examples of the salt include salts of alkali metals (e.g., sodium, potassium and lithium) and alkaline earth metals (e.g., magnesium and calcium), silver salts, quaternary ammonium salts (e.g., a tetraethyl ammonium salt, and a dimethyl cetyl benzyl ammonium salt) and quaternary phosphonium salts. In formulas (A) and (B), Y₁ and Y₂ each represent —C(═O)— or —SO₂—.

The preferred range of the compounds represented by formulas (A) and (B) is described in the columns 0027 to 0043 of JP-A No. 11-231459. Specific examples of the compounds represented by formulas (A) and (B) include, but are not limited to, Compounds 1 to 110 in Tables 1 to 8 of JP-A No. 11-231459.

Next, the compound represented by formula (C) in the invention will be explained in detail. In formula (C), X₁ represents an oxygen atom, a sulfur atom or a nitrogen atom. When X₁ represents a nitrogen atom, the bond between X₁ and Z₁ may be a single bond or a double bond. When the bond is a single bond, the nitrogen atom may bond to a hydrogen atom or any substituent.

Examples of the substituent include an alkyl group (including an aralkyl group, a cycloalkyl group, and an active methine group), an alkenyl group, an alkynyl group, an aryl group, a heterocyclic group, an acyl group, an alkoxycarbonyl group, an aryloxycarbonyl group, a carbamoyl group, and a (alkyl-, aryl- or heterocyclic-) sulfonyl group.

Y₁ represents —C(═O)—, —C(═S)—, —SO—, —SO₂—, —C (═NR₃)—, or —(R₄)C═N—.

Z₁ represents a non-metallic atomic group which can form a 5- to 7-membered ring containing X₁ and Y₁. The atomic group which forms the ring is an atomic group including two to four atoms other than metal atoms which two to four atoms may bond to each other via a single bond or a double bond and which may have a hydrogen atom or any substituent (for example, an alkyl group, an aryl group, a heterocyclic group, an alkoxy group, an alkylthio group, an acyl group, an amino group, or an alkenyl group).

When Z₁ forms a 5- to 7-membered ring containing X₁ and Y₁, the ring is a saturated or unsaturated heterocycle, and may be a monocycle or a condensed ring. When Y₁ is C (═NR₃) group or (R₄)C═N group, the condensed ring may have a ring in which R₃ or R₄ bonds to a substituent which Z₁ has.

In formula (C), R₁, R₂, R₃ and R₄ each represent a hydrogen atom or a substituent. However, R₁ and R₂ never bond to each other to form a cyclic structure.

When R₁ and R₂ each represent a monovalent group, examples thereof include a halogen atom (e.g., a fluorine atom, a chlorine atom, a bromine atom and an iodine atom), an alkyl group (including an aralkyl group, a cycloalkyl group, and an active methine group), an alkenyl group, an alkynyl group, an aryl group, a heterocyclic group, a quaternary nitrogen-containing heterocyclic group (such as a pyridinio group), an acyl group, an alkoxycarbonyl group, an aryloxycarbonyl group, a carbamoyl group, a carboxy group and a salt thereof, a sulfonylcarbamoyl group, an acylcarbamoyl group, a sulfamoylcarbamoyl group, a carbazoyl group, an oxalyl group, an oxamoyl group, a cyano group, a thiocarbamoyl group, a hydroxyl group and a salt thereof, an alkoxy group (including groups repeatedly containing an ethyleneoxy group unit or a propyleneoxy group unit), an aryloxy group, a heterocyclic oxy group, an acyloxy group, a (alkoxy- or aryloxy-) carbonyloxy group, a carbamoyloxy group, a sulfonyloxy group, an amino group, an (alkyl-, aryl- or heterocyclic-)amino group, an N-substituted nitrogen-containing heterocyclic group, an acylamino group, a sulfonamide group, an ureido group, a thioureido group, an imide group, a (alkoxy- or aryloxy-) carbonylamino group, a sulfamoylamino group, a semicarbazide group, a thiosemicarbazide group, a hydrazino group, a quaternary ammonio group, an oxamoylamino group, a (alkyl- or aryl-) sulfonylureido group, an acylureido group, an acylsulfamoylamino group, a nitro group, a mercapto group and a salt thereof, a (alkyl-, aryl- or heterocyclic-) thio group, a (alkyl- or aryl-) sulfonyl group, a (alkyl- or aryl-) sulfinyl group, a sulfo group and a salt thereof, a sulfamoyl group, an acylsulfamoyl group, a sulfonylsulfamoyl group and a salt thereof, a phosphoryl group, a group containing a phosphoric amide or phosphoric acid ester structure, a silyl group and a stannyl group. The substituents may further have such a monovalent substituent.

When R₃ and R₄ each represent a substituent, examples thereof include those of the substituent which R₁ and R₂ may have, but exclude halogen atoms. R₃ and R₄ may bond to Z₁ to form a condensed ring.

Preferred examples of the compound by formula (C) are as follows. In formula (C), Z₁ preferably forms a 5- to 7-membered ring together with X₁ and Y₁, and is preferably an atomic group including two to four atoms selected from a carbon atom, a nitrogen atom, a sulfur atom and an oxygen atom. The hetero ring which Z₁ forms together with X₁ and Y₁ is preferably a hetero ring preferably having from 3 to 40 carbon atoms, more preferably from 3 to 25 carbon atoms and most preferably from 3 to 20 carbon atoms in total. Z₁ preferably contains at least one carbon atom.

In formula (C), Y₁ is preferably —C(═O)—, —C(═S)—, —SO₂—, or —(R₄)C═N—, more preferably —C(═O)—, —C(═S)—, or —SO₂— and most preferably —C(═O)—.

In formula (C), when R₁ and R₂ each represent a monovalent group, the monovalent groups represented by R₁ and R₂ is preferably the following groups having from 0 to 25 carbon atoms in total: an alkyl group, an aryl group, a heterocyclic group, an alkoxy group, an aryloxy group, a heterocyclicoxy group, an alkylthio group, an arylthio group, a heterocyclic thio group, an amino group, an alkylamino group, an arylamino group, a heterocyclic amino group, an ureido group, an imide group, an acylamino group, a hydroxy group, or a salt thereof, a mercapto group or a salt thereof, or an electron-attractive substituent. The electron-attractive substituent is a substituent which can have a Hammet's substituent constant σp of a positive value and specific examples thereof include a cyano group, a sulfamoyl group, an alkylsulfonyl group, an arylsulfonyl group, a sulfonamide group, an imino group, a nitro group, a halogen atom, an acyl group, a formyl group, a phosphoryl group, a carboxyl group (or a salt thereof), a sulfo group (or a salt thereof), a saturated or unsaturated heterocyclic group, an alkenyl group, an alkynyl group, an acyloxy group, an acylthio group, a sulfonyloxy group, or an aryl group having any of these electron-attractive groups. These groups may have any substituent.

In formula (C), when R₁ and R₂ each represent a monovalent substituent, each of R₁ and R₂ is preferably an alkoxy group, an aryloxy group, a heterocyclic oxy group, an alkylthio group, an aryl thio group, a heterocyclic thio group, an amino group, an alkylamino group, an arylamino group, a heterocyclic amino group, an ureido group, an imide group, an acylamino group, a sulfonamide group, a heterocyclic group, a hydroxyl group or a salt thereof or a mercapto group or a salt thereof.

In formula (C), R₁ and R₂ is more preferably a hydrogen atom, an alkoxy group, an aryloxy group, an alkylthio group, an arylthio group, a heterocyclic group, a hydroxy group or a salt thereof, or a mercapto group or a salt thereof.

In formula (C), most preferably, one of R₁ and R₂ is a hydrogen atom, and the other is an alkoxy group, an aryloxy group, an alkylthio group, an arylthio group, a heterocyclic group, a hydroxy group or a salt thereof, or a mercapto group or a salt thereof.

In formula (C), when R₃ represents a substituent, the substituent is preferably an alkyl group having from 1 to 25 carbon atoms in total (including an aralkyl group, a cycloalkyl group, and an active methine group), an alkenyl group, an aryl group, a heterocyclic group, a quaternary nitrogen-containing heterocyclic group (for example, a pyridinio group), an acyl group, an alkoxycarbonyl group, an aryloxycarbonyl group, a carbamoyl group, a (alkyl- or aryl) sulfonyl group, a (alkyl- or aryl-) sulfinyl group, a sulfosulfamoyl group, an alkoxy group, an aryloxy group, a heterocyclic oxy group, an alkylthio group, an arylthio group, a heterocyclic thio group or an amino group. The substituent is more preferably an alkyl group or an aryl group.

In formula (C), when R₄ represents a substituent, the substituent is preferably an alkyl group having from 1 to 25 carbon atoms in total (including an aralkyl group, a cycloalkyl group, and an active methine group), an aryl group, a heterocyclic group, a quaternary nitrogen-containing heterocyclic group (for example, a pyridinio group), an acyl group, an alkoxycarbonyl group, an aryloxycarbonyl group, a carbamoyl group, a (alkyl- or aryl-) sulfonyl group, a (alkyl- or aryl-) sulfinyl group, a sulfosulfamoyl group, an alkoxy group, an aryloxy group, a heterocyclic oxy group, an alkylthio group, an arylthio group, or a heterocyclic thio group. The substituent is preferably an alkyl group, an aryl group, an alkoxy group, an aryloxy group, a heterocyclic oxy group, an alkylthio group, an arylthio group or a heterocyclic thio group. When Y₁ represents C(R₄)═N, a carbon atom in Y₁ bonds to the carbon atom to which X₁ and Y₁ Bond.

Specific examples of the compound of formula (C) include, but are not limited to, Compounds A-1 to A-230 of formulae No. 6 to 18 described in JP-A No. 11-133546.

The amount of the nucleus forming agent is in the range of 10⁻⁵ to 1 mol, and preferably in the range of 10⁻⁴ to 5×10⁻¹ mol based on mol of the organic silver salt.

The nucleus forming agent may be contained in a coating liquid and in turn the photothermographic material in any form such as an emulsified dispersion, or a fine solid particle dispersion.

An example of a well known emulsion dispersion method is a method in which the nucleus forming agent is dissolved in an oil such as dibutyl phthalate, tricresyl phosphate, dioctyl cebacate or tri(2-ethylhexyl) phosphate or an auxiliary solvent such as ethyl acetate or cyclohexanone, and adding a surfactant such as sodium dodecylbenzenesulfonate, sodium oleoyl-N-methyl taurinate, or sodium di(2-ethylhexyl) sulfosuccinate to the resultant solution, and mechanically forming an emulsified dispersion from the resultant.

In this case, it is also preferable to add a polymer such as α-methylstyrene oligomer or poly(t-butylacrylamide) to control the viscosity and the refractive index of oil droplets.

Further, an examples of a fine solid particle dispersion method is a method of dispersing powder of the nucleus forming agent in an appropriate solvent such as water by a ball mill, a colloid mill, a vibration ball mill, a sand mill, a jet mill, a roller mill or supersonic waves to prepare a solid dispersion. In this case, a protective colloid (for example, polyvinyl alcohol), a surfactant (for example, anionic surfactant such as sodium triisopropylnaphthalenesulfonate (mixture of those having different substitution positions of three isopropyl groups)) may also be used.

In the above-described mills, beads, for example, zirconia beads, are generally used as a dispersion medium, and Zr or the like leaching from the beads may sometimes be introduced into the dispersion. Depending on the dispersion condition, the amount thereof is usually within the range of 1 ppm to 1000 ppm. If the content of Zr in the photosensitive material is 0.5 mg or less per 1 g of silver, Zr causes no practical problem.

The aqueous dispersion preferably contains an antiseptic (for example, sodium salt of benzoisothiazolinone).

The solid particle dispersion method is most preferable for the nucleus forming agent and the agent is desirably added as fine particles with an average grain size of 0.01 μm to 10 μm, preferably from 0.05 μm to 5 μm and more preferably from 0.1 μm to 2 μm. In the present application, other solid dispersions preferably include particles having a particle size within the range described above.

The photothermographic material processed by rapid development with a developing time of 20 sec or less preferably contains the compound represented by formula (H) or (P), and more preferably the compound represented by formula (H) among the nucleus forming agents described above.

The photothermographic material which is required to have a low fogging property preferably contains the compound represented by formula (G), (A), (B), or (C) and more preferably contains the compound represented by formula (A) or (B). Further, the photothermographic material which less changes photographic performance to environmental conditions even when used under various environmental conditions (e.g., temperature, and humidity) preferably contains the compound represented by formula (C).

Specific examples of the nucleus forming agent are shown below, but the invention is not limited to these examples.

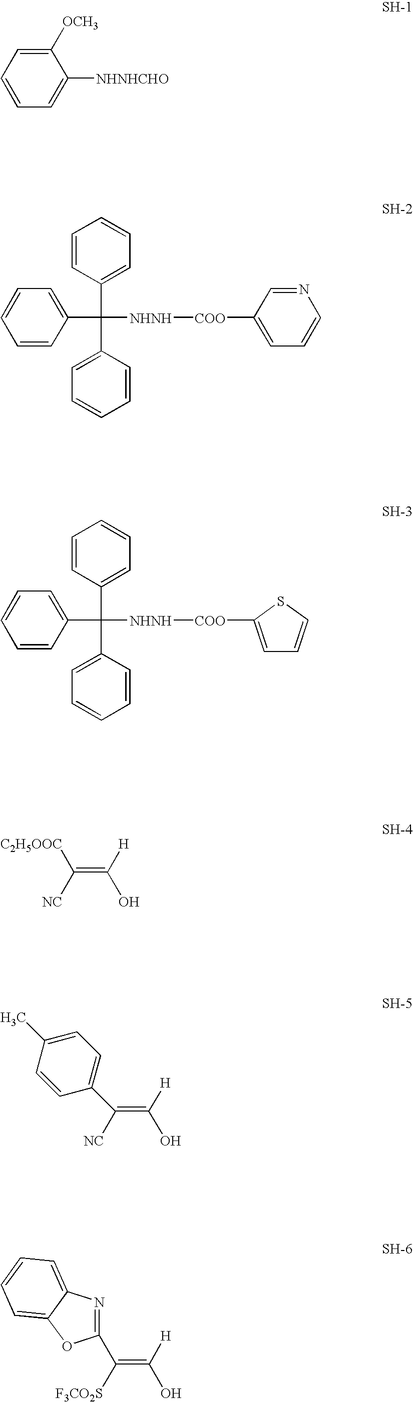

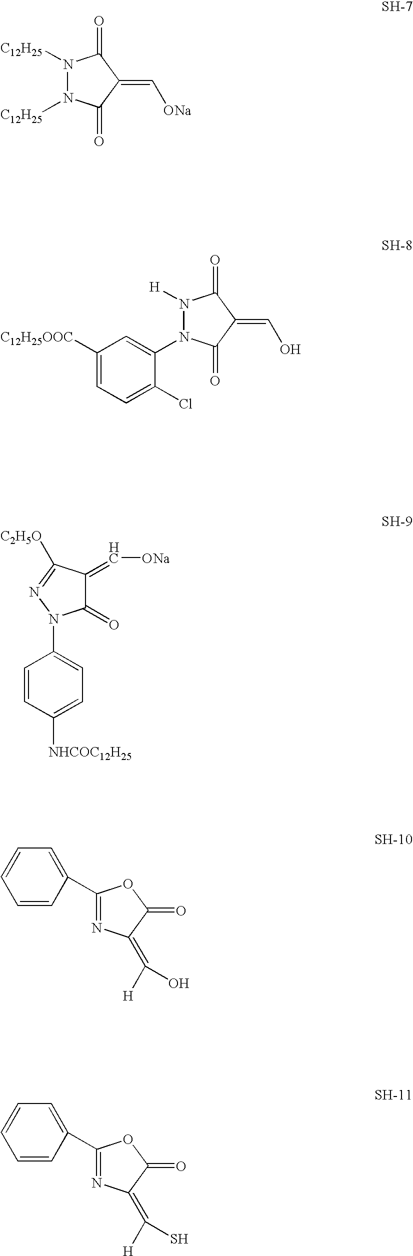

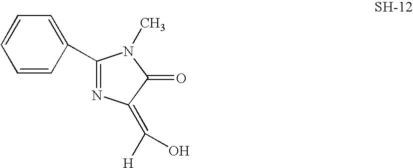

In order to use formic acid or formate as a strong fogging material, it is preferable to incorporate it in a layer on a side of a support having the image-forming layer containing the photosensitive silver halide in an amount of 5 mmol or less, and preferably in an amount of 1 mmol or less per mol of silver.

When an ultrahigh contrasting agent is employed in the photothermographic material of the invention, a combined use of an acid formed by hydration of diphosphorous pentoxide or a salt thereof is preferable as such. Examples of the acid formed by hydration of diphosphorous pentoxide or the salt thereof include metaphosphoric acid (salts thereof), pyrophoric acid (salts thereof), orthophosphoric acid (salts thereof), triphosphoric acid (salts thereof), tetraphosphoric acid (salts thereof) and hexamethylphosphoric acid (salts thereof). Among them, orthophosphoric acid (salts thereof) and hexamethylphosphoric acid (salts thereof) are preferable. Specific salts include sodium orthophosphate, sodium dihydrogen orthophosphate, sodium hexamethaphosphate and ammonium hexamethaphosphate.

The amount of the acid formed by hydration of diphosphorous pentoxide or the salt thereof (coating amount per m² of the photosensitive material) may be a desired amount in accordance with properties such as sensitivity and fogging, but is preferably 0.1 mg/m² to 500 mg/m², and more preferably 0.5 mg/m² to 100 mg/m².

2-11. Preparation of Coating Liquid and Coating

The Preparation temperature of the coating liquid for the image-forming layer in the invention is preferably 30° C. to 65° C., more preferably 35° C. to 60° C., and still more preferably 35° C. to 55° C. In addition, it is preferable that the temperature of the coating liquid for the image-forming layer just after addition of the polymer latex is kept in the range of 30° C. to 65° C.

3. Layer Configuration and Other Components

The silver halide photosensitive material and the photothermographic material of the invention can have a non-photosensitive layer in addition to the photosensitive layer or the image-forming layer. The non-photosensitive layer can be classified, according to arrangement thereof, into (a) a surface protective layer disposed on the image-forming layer (side far from a support), (b) an intermediate layer disposed between the image-forming layers or between the image-forming layer and the protective layer, (C) an undercoat layer disposed between the image-forming layer and the support, and (d) a back layer disposed on a side of the support which side is opposite to the side having the image-forming layer.

In addition, the photosensitive material and the photothermographic material may also have a layer which acts as an optical filter, and the layer is provided as the layer (a) or (b). The photosensitive material and the photothermographic material may also have an antihalation layer, and the antihalation layer is provided as the layer (c) or (d).

1) Surface Protective Layer

The silver halide photosensitive material and the photothermographic material in the invention may have a surface protective layer to inhibit adhesion of the image-forming layer. The surface protective layer may be a single layer or plural layers. The detail of the surface protective layer is described in JP-A Nos. 11-65021, paragraphs [0119] to [0120] and 2001-348546.

The surface protective layer in the invention includes a binder, and the binder is preferably gelatin, but may be polyvinyl alcohol (PVA). A combination of polyvinyl alcohol and gelatin is also preferable. As the gelatin, an inert gelatin (e.g., Nitta gelatin 750™) or a phthalated gelatin (e.g., Nitta gelatin 801™) can be used.

PVA can be any of those described in JP-A No. 2000-171936, paragraphs [0009] to [0020], and a completely saponified product, PVA-105, partially saponified products, PVA-205 and PVA-335, and modified polyvinyl alcohol, MP-203 (all are trade names of KURARAY Co., LTD.) are preferably used.

The coating amount (per m² of the support) of polyvinyl alcohol in the protective layer (per layer) is preferably 0.3 g/m² to 4.0 g/m², and more preferably 0.3 g/m² to 2.0 g/m².

The total coating amount (per m² of the support) of all the binders (including a water-soluble polymer and a latex polymer) in the surface protective layer (per layer) is preferably 0.3 g/m² to 5.0 g/m², and more preferably 0.3 g/m² to 2.0 g/m².

2) Antihalation Layer

The silver halide photosensitive material and the photothermographic material of the invention may have an antihalation layer on a side far from an exposure light source with respect to the photosensitive layer. The antihalation layer is described in JP-A Nos. 11-65021, paragraphs [0123] to [0124], 11-223898, 9-230531, 10-36695, 10-104779, 11-231457, 11-352625 and 11-352626.

The antihalation layer contains an antihalation dye having absorption at an exposure wavelength. When the exposure wavelength is in the wavelength range of infrared light, an infrared ray-absorbing dye may be used as the antihalation dye. In this case, the dye preferably has no absorption in the visible light region.

When a dye having absorption in visible light region is used to prevent halation, it is preferable that the color of the dye does not substantially remain in the material after image formation. For this purpose, a means for causing decolorization by heat of thermal development is preferably used. In particular, it is preferable that a thermally decolorizable dye and a base precursor are contained in the non-photosensitive layer to allow the layer to function as the antihalation layer. Such a technique is described in JP-A No. 11-231457.

The amount of the decolorizable dye is determined according to application of the dye. Generally, the amount is such that an optical density (absorbance) measured at an objective desired wavelength is more than 0.1. The optical density is preferably 0.2 to 2. The amount of the dye to obtain such an optical density is generally about 0.001 g/m² to about 1 g/m².

The optical density after thermal development can be decreased to be 0.1 or lower by decolorizing the dye. Two or more kinds of decolorizable dyes may be used together in a thermally decolorizable recording material or the photothermographic material. Similarly, two or more kinds of base precursors may be used together.

In such a heat decolorization using these decolorizable dye and base precursor, it is preferable to use a material which can decrease a melting point by 3° C. or more when used together with the base precursor and which is described in, for example, JP-A No. 11-352626, such as diphenylsulfone, or 4-chlorophenyl(phenyl)sulfone from the viewpoint of thermal decolorizability.

3) Back Layer

The back layer applicable to the invention is described in JP-A No. 11-65021, paragraphs [0128] to [0130].

The photosensitive material and the photothermographic material of the invention may contain a colorant having an absorption maximum in the range of 300 nm to 450 nm in order to improve silver tone and reduce change of image over time. Such a colorant is described in JP-A Nos. 62-210458, 63-104046, 63-103235, 63-208846, 63-306436, 63-314535 and 1-61745, and Japanese Patent Application No. 11-276751. Such a colorant is usually contained in an amount of 0.1 mg/m² to 1 g/m², and is preferably contained in the back layer disposed on the side of the support which side is opposite the side having the photosensitive layer.

4) Matting Agent

The photosensitive material and the photothermographic material of the invention preferably contains a matting agent in the surface protective layer and the back layer in order to improve the conveying property of the material. The matting agent is described in JP-A No. 11-65021, paragraphs [0126] and [0127].

The coating amount of the matting agent is preferably from 1 mg to 400 mg, and more preferably from 5 mg to 300 mg per m² of the photosensitive material.

The matted degree of the image-forming layer surface may be any value as far as so-called “star defects”, which are missing portions formed in an image area and which cause leak of light, do not occur. However, Bekk smoothness of the surface is preferably from 30 seconds to 2000 seconds, and more preferably from 40 seconds to 1500 seconds. The Bekk smoothness can be easily determined by “Method for testing smoothness of paper and paperboard by Bekk tester” defined in JIS P8119, or TAPPI standard method T479, which are incorporated by reference herein.

In the invention, as for the matted degree of the back layer, the Bekk smoothness of the back layer is preferably from 10 seconds to 1200 seconds, more preferably from 20 seconds to 800 seconds, and even more preferably from 40 seconds to 500 seconds.

In the invention, the matting agent is preferably incorporated in an outermost layer, a layer which acts as the outermost layer, a layer close to the outer surface of the photosensitive material, or a layer which acts as a so-called protective layer.

5) Polymer Latex

A polymer latex may be incorporated in the surface protective layer or the back layer in the invention.

The polymer latex is described in “Gosei Jushi Emulsion (Synthetic Resin Emulsion)”, compiled by Taira Okuda and Hiroshi Inagaki, published by Kobunshi Kanko Kai (1978); “Gosei Latex no Oyo (Application of Synthetic Latex)”, compiled by Takaaki Sugimura, Yasuo Kataoka, Souichi Suzuki and Keishi Kasahara, published by Kobunshi Kanko Kai (1993); and Soichi Muroi, “Gosei Latex no Kagaku (Chemistry of Synthetic Latex)”, published by Kobunshi Kanko Kai (1970). Specific examples thereof include a methyl methacrylate (33.5 mass %)/ethyl acrylate (50 mass %)/methacrylic acid (16.5 mass %) copolymer latex, a methyl methacrylate (47.5 mass %)/butadien (47.5 mass %)/itaconic acid (5 mass %) copolymer latex, an ethyl acrylate/methacrylic acid copolymer latex, a methyl methacrylate (58.9 mass %)/2-ethylhexyl acrylate (25.4 mass %)/styrene (8.6 mass %)/2-hydroxyethyl methacrylate (5.1 mass %)/acrylic acid (2.0 mass %) copolymer latex, methyl methacrylate (64.0 mass %)/styrene (9.0 mass %)/butyl acrylate (20.0 mass %)/2-hydroxyethyl methacrylate (5.0 mass %)/acrylic acid (2.0 mass %) copolymer latex.

The content of the polymer latex is preferably 10 mass % to 90 mass %, and more preferably 20 mass % to 80 mass % on the basis of the total amount of all the binders (including a water-soluble polymer and latex polymer) of the surface protective layer or the back layer.

6) Film Surface pH

The photothermographic material of the invention preferably has a film surface pH of 7.0 or less, more preferably 6.6 or less before thermal development. Although the lower limit thereof is not particularly limited, it is generally around 3. The pH is most preferably in the range or 4 to 6.2.

An organic acid such as phthalic acid derivatives, a nonvolatile acid such as sulfuric acid, or a volatile base such as ammonia is preferably used to control the film surface pH from the viewpoint of lowering of the film surface pH. In particular, ammonia is preferably used to achieve a low film surface pH, because it evaporates easily and therefore it can be removed before coating or thermal development.

In addition, a combined use of a nonvolatile base such as sodium hydroxide, potassium hydroxide or lithium hydroxide and ammonia is also preferable. A method for measuring the film surface pH is described in JP-A No. 2000-284399, paragraph [0123].

7) Hardening Agent

A hardening agent may be contained in each of the photosensitive layer, the protective layer and the back layer in the invention. The hardening agent is described in T. H. James “THE THEORY OF THE PHOTOGRAPHIC PROCESS FOURTH EDITION” Macmillan Publishing Co., Inc. 1977) pp. 77-87. The hardening agent is preferably chrome alum, 2,4-dichloro-6-hydroxy-s-triazine sodium salt, N,N-ethylenebis(vinylsulfonacetamide), N,N-propylenebis(vinylsulfonacetamide), polyvalent metal ions shown on page 78 of the above document, a polyisocyanate described in U.S. Pat. No. 4,281,060 and JP-A No. 6-208193, an epoxy compound described in JP-A No. 62-89048.

The hardening agent is added as a solution to a coating liquid. When the hardening agent is added to a protecting layer coating liquid, it is added during a period starting from 180 minutes before coating and ending immediately before coating, and preferably during a period starting from 60 minutes to 10 seconds before coating. A mixing method and mixing conditions are not particularly limited so long as the effects of the invention satisfactorily show.

Specific examples of the mixing method include a method of mixing in a tank such that an average residence period, calculated from an adding flow rate and a supplying flow rate to a coater, is allowed to be within a predetermined duration, and a method using a static mixer described, for example, in N. Harnby, M. F. Edwards & A. W. Nienow, (translated by Koji Takahashi), “Liquid Mixing Technology” Chap. 8, The Nikkan Kogyo Shimbun, Ltd. (1989).

8) Surfactant

A surfactant to be usable in the invention is described in JP-A 11-65021, paragraph [0132].

In the invention, a fluorine-containing surfactant is preferably used. Typical examples of the fluorine-containing surfactant include compounds described in JP-A Nos. 10-197985, 2000-19680 and 2000-214554. Further, a polymeric fluorine-containing surfactant described in JP-A No. 9-281636 is also preferably used. In the invention, use of the fluorine-containing surfactant described in Japanese Patent Application No. 2000-206560 is particularly preferable.

9) Antistatic Agent

The photosensitive material and the photothermographic material of the invention may have an antistatic layer including any known metal oxide or an electroconductive polymer. The antistatic layer may also serve as the undercoat layer, the back layer or the surface protective layer, or may be disposed separately from these layers. Techniques described in JP-A Nos. 11-65021, paragraph [0135], 56-143430, 56-143431, 58-62646, 56-120519 and 11-84573, paragraphs [0040] to [0051], U.S. Pat. No. 5,575,957 and JP-A 11-223898, paragraphs [0078] to [0084] may be applied to the antistatic layer.

10) Support

A transparent support which can be used in the invention is preferably a polyester film which has been heated at a temperature in the range of 130 to 185° C. in order to relax internal strain remaining in the film during biaxial orientation and thereby eliminate heat shrinkage distortion that may occur during thermal development, particularly a polyethylene terephthalate film.

The support of the photothermographic material to be used together with an ultraviolet-luminescent screen is preferably PEN. However, the support is not restricted to the same. PEN is preferably polyethylene-2,6-naphthalate. Polyethylene-2,6-naphthalate in the invention may be any one in which a repeating structural unit is substantially reconstructed by an ethylene-2,6-naphthalenedicarboxylate unit, and includes not only non-copolymerized polyethylene-2,6-naphthalenedicarboxylate but also copolymers in which 10% or less, preferably 5% or less of the number of the repeating structural units are modified by other components, and mixtures and compositions including polyethylene-2,6-naphthalate and any other polymer.

Polyethylene 2,6-naphthalate is synthesized by bonding naphthalene-2,6-dicarboxylic acid or its functional derivative, and ethylene glycol or its functional derivative in the presence of a catalyst under suitable reaction conditions. Polyethylene 2,6-naphthalate as referred to herein may be a copolymer or a mixed polyester obtained by adding at least one kind of a suitable third component (modifier) to a reaction system before completion of polymerization of polyethylene 2,6-naphthalate. The suitable third component is a compound having a divalent ester-forming functional group, for example, dicarboxylic acids such as oxalic acid, adipic acid, phthalic acid, isophthalic acid, terephthalic acid, naphthalene-2,7-dicarboxylic acid, succinic acid or diphenyl ether dicarboxylic acid, or their lower alkyl esters, or oxycarboxylic acids such as p-oxybenzoic acid or p-oxyethoxybenzoic acid, or their lower alkyl esters, or dihydric alcohols, such as propylene glycol or trimethylene glycol. Polyethylene 2,6-naphthalate or its modified polymer may be a polymer whose terminal hydroxyl group(s) and/or carboxyl group(s) is blocked with a monofunctional compound such as benzoic acid, benzoylbenzoic acid or benzyloxybenzoic acid, methoxypolyalkylene glycol, or may be a polymer which is modified with an extremely small amount of a trifunctional or tetrafunctional ester-forming compound, such as glycerin or pentaerythritol such that the resultant copolymer is substantially linear.

In the case of a photothermographic material for medical use, the transparent substrate may be colored with a blue dye (e.g., dye-1 described in Examples of JP-A No. 8-240877] or may be colorless.

Specific examples of the substrate are described in JP-A No. 11-65021, paragraph [0134].

An undercoat including a water-soluble polyester described in JP-A No. 11-84574, a styrene-butadiene copolymer described in JP-A No. 10-186565 or a vinylidene chloride copolymer described in JP-A No. 2000-39684 and Japanese Patent Application No. 11-106881, paragraphs [0063] to [0080] is preferably disposed on the substrate.

11) Other Additives

The silver halide photosensitive material and the photothermographic material may further contain an antioxidant, a stabilizer, a plasticizer, an ultraviolet ray absorbent and/or a coating aid. One or more kinds of solvents described in JP-A No. 11-65021, paragraph [0133] may be added to these additives. Various kinds of additives are contained in at least one of the photosensitive layer and the non-photosensitive layer. For these, WO98/36322, EP-A No. 803764A1, JP-A Nos. 10-186567 and 10-186568 can be referred to.

12) Coating Method

The silver halide photosensitive material and the photothermographic material in the invention may be prepared by any coating method. Specific examples these include extrusion coating, slide coating, curtain coating, dip coating, knife coating, flow coating, and extrusion coating using a hopper as described in U.S. Pat. No. 2,681,294. The extrusion coating or slide coating as described by Stephen F. Kistler, Petert M. Schweizer, “LIQUID FILM COATING” (CHAPMAN & HALL, 1997), pp. 399 to 536 is preferably conducted, and the slide coating is more preferably conducted.

An example of the form of a slide coater used in the slide coating is illustrated in FIG. 11b.1 on page 427 of the same document. Further, at least two layers can be simultaneously formed in accordance with any of coating methods described in British Patent No. 837,095, if necessary.

The organic silver salt-containing layer coating liquid in the invention is preferably a so-called thixotropic fluid. With regard to the technique, JP-A No. 11-52509 can be referred to.

The viscosity of the organic silver salt-containing layer coating liquid in the invention at a shear rate of 0.1 s⁻¹ is preferably from 400 mPa·s to 100,000 mPa·s, and more preferably from 500 mPa·s to 20,000 mPa·s.

Further, the viscosity thereof at a shear rate of 1000 s¹ is preferably from 1 mPa·s to 200 mPa·s, and more preferably from 5 mPa·s to 80 mPa·s.

13) Packaging Material

It is preferable that the photosensitive material and the photothermographic material of the invention are hermetically packed by a packaging material having at least one of a low oxygen permeability and a low moisture permeability in order to prevent photographic properties thereof from being deteriorated at the time of storage before being used, or, when the photosensitive material and the photothermographic material are in roll form, prevent the material from being curled or curly deformed. The oxygen permeability is preferably 50 mL/atm/m²·day or less, more preferably 10 mL/atm/m²·day or less, and still more preferably 1.0 mL/atm/m²·day or less at 25° C. The moisture permeability is preferably 10 g/atm/m²·day or less, more preferably 5 g/atm/m²·day or less, and still more preferably 1 g/atm/m²·day or less. Specific examples of the packing material having the low oxygen permeability and/or the moisture permeability include those described in JP-A Nos. 8-254793 and 2000-206653.

14) Other Techniques which can be Used

Techniques which can be used in the photothermographic material of the invention are described in, for example, EP-A Nos. 803764A1 and 883022A1, WO98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, and 11-343420, Japanese Patent Application No. 2000-187298, JP-A Nos. 2001-200414, 2001-234635, 2002-20699, 2001-275471, 2001-275461, 2000-313204, 2001-292844, 2000-324888, 2001-293864, and 2001-348546.

15) Color Image Formation

The multicolor photothermographic material may contain a combination of these two layers for each color, or may contain all components in a single layer as described in U.S. Pat. No. 4,708,928.

In the case of multicolor photothermographic materials, a functional or non-functional barrier layer is generally disposed between the respective photosensitive layers (emulsion layers), as described in USP. No. 4,460,681.

4. Image Forming Method

4-1. Exposure

The photothermographic material of the invention may be a single-sided material having an image-forming layer only on one side of the support, or a double-sided material having the image-forming layer on each side of the support.

Double-sided Photothermographic Material

The photothermographic material of the invention can be preferably used for an image forming method in which an X-ray image is recorded by using X-ray intensifying screens.

The image forming method using the photothermographic material include the following steps of:
(a) disposing the photothermographic material between a pair of X-ray intensifying screens to obtain an assembly for image formation;
(b) arranging a subject between the assembly and an X-ray source;
(c) irradiating the subject with X-rays having an energy level in the range of 25 kVp to 125 kVp;
(d) removing the photothermographic material from the assembly; and
(e) heating the removed photothermographic material at a temperature in the range of 90° C. to 180° C.

The photothermographic material for use in the assembly according to the invention is preferably such that an image obtained by stepwise exposing the photothermographic material with X-rays followed by thermal development thereof has a characteristic curve that is drawn on a rectangular coordinate in which the coordinate axis unit lengths of optical density (D) and light exposure logarithm (log E) are equal to each other, and in which characteristic curve an average gamma (γ) formed by a point, whose density is the sum of a minimum density (Dmin) and 0.1, and a point, whose density is the sum of the minimum density (Dmin) and 0.5, is from 0.5 to 0.9, and an average gamma (γ) formed by a point, whose density is the sum of the minimum density (Dmin) and 1.2, and a point, whose density is the sum of the minimum density (Dmin) and 1.6 is from 3.2 to 4.0. When the photothermographic material with the characteristic curve is used in an X-ray photographing system in the invention, an X-ray image having excellent photographic properties such as a remarkably extended leg and high gamma at a medium density area can be obtained. Thanks to the photographic properties, depiction becomes good in a low density region in which an X-ray transmission amount is small such as a mediastinum region or heart shadow, and images of the lung field region, where an X-ray transmission amount is large, have a density which can be easily seen, and contrast becomes good.

The photothermographic material having the above-described preferable characteristic curve can be easily produced by, for example, a method in which each of the image-forming layers on both sides is constructed by two or more layers of silver halide emulsion layers having different sensitivities. In particular, it is preferable to form the image-forming layers by using an emulsion having a high sensitivity in an upper layer and an emulsion having a low sensitivity and contrasty photographic characteristics in a lower layer. When the image-forming layer including such two layers is employed, the ratio of the sensitivity (sensitivity difference) of the silver halide emulsion of the upper layer to that of the lower layer is from 1.5 to 20, and preferably from 2 to 15. The ratio of the amount of the emulsion contained in the upper layer to that in the lower layer differs in accordance with sensitivity difference and covering power of emulsions to be used. Generally, the larger the sensitivity difference, the smaller the percentage of the amount of the emulsion having a high sensitivity. For example, when the sensitivity difference is two and the covering powers of the two emulsions are approximately the same, the ratio of the amount of the emulsion having a high sensitivity to that of the emulsion having a low sensitivity is preferably in the range of 1:20 to 1:50 in terms of silver amount.

For crossover cut (double-sided photosensitive material) and antihalation (single-sided photosensitive material), a dye, or a combination of a dye and a mordant described in JP-A No. 2-68539, page 13, left lower column, line 1 to page 14, left lower column, line 9, may be employed.

Next, a fluorescent intensifying screen (radiation intensifying screen) in the invention will be described. The basic structure of the radiation intensifying screen has a support and a fluorescent substance layer disposed on one side of the support. In the fluorescent substance layer, a fluorescent substance is dispersed in a binder. A transparent protective coat is provided on the surface of the fluorescent substance layer opposite to the support (the surface not facing the support) to protect the fluorescent substance layer from chemical degeneration or mechanical shock.

In the invention, typical examples of the fluorescent substance include tungstate fluorescent substance (e.g., CaWO₄, MgWO₄, and CaWO₄:Pb), terbium-activated rare earth oxysulfide fluorescent substance (e.g., Y₂O₂S:Tb, Gd₂O₂S:Tb, La₂O₂S:Tb, (Y,Gd)₂O₂S:Tb, and (Y,Gd)O₂S:Tb, Tm), terbium-activated rare earth phosphate fluorescent substance (e.g., YPO₄:Tb, GdPO₄:Tb, and LaPO₄:Tb), terbium-activated rare earth oxyhalide fluorescent substance (e.g., LaOBr:Tb, LaOBr:Tb,Tm, LaOCl:Tb, LaOCl:Tb,Tm, LaOBr:Tb, GdOBr:Tb, and GdOCl:Tb), thulium-activated rare earth oxyhalide fluorescent substance (e.g., LaOBr:Tm, and LaOCl:Tm), barium sulfate fluorescent substance (e.g., BaSO₄:Pb, BaSO₄:Eu²⁺, and (Ba,Sr)SO₄:Eu²⁺), bivalent europium-activated alkaline earth metal phosphate fluorescent substance (e.g., (Ba₂PO₄)₂:Eu²⁺, and (Ba₂PO₄)₂:Eu²⁺), bivalent europium-activated alkaline earth metal fluorohalide fluorescent substance (e.g., BaFCl:Eu²⁺, BaFBr:Eu²⁺, BaFCl:Eu²⁺, Tb, BaFBr:Eu²⁺, Tb, BaF₂·BaCl·KCl:Eu²⁺, and (Ba,Mg)F₂·BaCl·KCl:Eu²⁺), iodide fluorescent substance (e.g., CsI:Na, CsI:Tl, NaI, and KI:Tl), sulfide fluorescent substance (e.g., ZnS:Ag(Zn,Cd)S:Ag, (Zn,Cd)S:Cu, and (Zn,Cd)S:Cu,Al), hafnium phosphate fluorescent substance (e.g., HfP₂O₇:Cu), YTaO₄, and YTaO₄ into which any activator is incorporated as an emission center. However, the fluorescent substance for use in the invention is not restricted to them, and any fluorescent substance which can emit light in the visible or near ultraviolet region due to irradiation of radiation may be employed.

In the X-ray fluorescence intensifying screen preferably used in the invention, 50% or more of emission light has a wavelength in the range of 350 nm to 420 nm. In particular, the fluorescent substance is preferably a bivalent Eu-activated fluorescent substance and more preferably a bivalent Eu-activated barium halide fluorescent substance. The emission wavelength region is preferably from 360 nm to 420 nm, and more preferably 370 nm to 420 nm. Further, the fluorescent screen has more preferably 70% or more, and more preferably 85% or more of emission light in the region described above.

The rate of the emission light is calculated by the following method. That is, the emission spectrum is measured given that emission wavelength is shown by antilogarithm disposed at a reggular interval on the abscissa and the number of emitted photons is shown by the ordinate. The value obtained by dividing the area on the chart in which area wavelength is from 350 nm to 420 nm by the area of the entire emission spectrum on the chart is defined as the rate of emission in the wavelength range of 350 nm to 420 nm. When the photothermographic material of the invention is combined with a fluorescent intensifying screen having emission light in such a wavelength region, high sensitivity can be attained.

In order that most of emission light of the fluorescent substance exists in the wavelength region described above, the fluorescent substance preferably has a narrow half breadth of the emission light. The half breadth is preferably 1 nm to 70 nm, more preferably 5 nm to 50 nm and still more preferably 10 nm to 40 nm.

There is no particular restriction on the fluorescent substance to be used so long as the light emission described above is obtained. For improved sensitivity which is an object of the invention, the fluorescent substance is preferably an Eu-activated fluorescent substance having bivalent Eu as an emission center.

However, the invention is not limited thereto.

Examples of such a fluorescent substance include BaFCl:Eu, BaFBr:Eu, BaFI:Eu and those in which the halogen compositions of the above materials are modified, BaSO₄:Eu, SrFBr:Eu, SrFCl:Eu, SrFI:Eu, (Sr, Ba)Al₂Si₂O₈:Eu, SrB₄O₇F:Eu, SrMgP₂O₇:Eu, Sr₃(PO₄)₂:Eu, and Sr₂P₂O₇:Eu.

The fluorescent substance is more preferably a bivalent Eu activated barium halide fluorescent substance represented by formula: MX₁X₂:Eu. M includes Ba as the main ingredient thereof and can preferably contain a small amount of any other compound such as Mg, Ca or Sr. X₁ and X₂ each represent a halogen atom which can be selected arbitrarily from F, Cl, Br and I. X₁ is preferably fluorine. X₂ can be selected from Cl, Br and I, and a composition including some of the halogen compounds in admixture can also be preferably used.

More preferably, X is Br. Eu is europium. Eu serving as the emission center is preferably contained in a ratio of 10⁻⁷ to 0.1, and more preferably 10⁻⁴ to 0.05 with respect to Ba. A small amount of other compound may also be preferably mixed. The fluorescent substance is most preferably BaFCl:Eu, BaFBr:Eu, or BaFBr_{1-X}Iₓ:Eu.

The fluorescence intensifying screen preferably has a support, and an undercoat layer, a fluorescent substance layer, and a surface protective layer which are disposed on the support.

The fluorescent substance layer can be formed by dispersing particles of the fluorescent substance in a solution containing an organic solvent and a binder resin to prepare a liquid dispersion, directly applying the liquid dispersion to a support (or to an undercoat layer in the case where the undercoat layer such as a light reflection layer is formed on the support), and drying the resultant coating. Alternatively, the liquid dispersion may be applied to a separately prepared provisional support, and the resultant coating is dried to prepare a fluorescent substance sheet, and then the fluorescent substance sheet may be peeled from the provisional support and bonded to a support by using an adhesive.

The grain size of the fluorescent substance particles has no particular restriction and is usually within the range of about 1 μm to 15 μm and preferably within the range of about 2 μm to 10 μm. The volumetric filling rate of the fluorescent substance particles in the fluorescent substance layer is preferably high. It is usually within the range of 60 to 85%, preferably within the range of 65 to 80% and more preferably within the range of 68 to 75% (the mass rate of the fluorescent substance particles in the fluorescent substance layer is usually 80 mass % or more, preferably 90 mass % or more and more preferably 95 mass % or more). The binder resin, the organic solvent, and various kinds of optional additives used in formation of the fluorescent substance layer are described in various known literatures. The thickness of the fluorescent substance layer can be set in accordance with an aimed sensitivity. The thickness of the screen for the front side is preferably within the range of 70 μm to 150 μm, and the thickness of the screen for the back side is prefearbly within the range of 80 μm to 400 μm. The X-ray absorptivity of the fluorescent substance layer depends on the coating amount of the fluorescent substance particles.

The fluorescent substance layer may be a single layer or may have two or more layers. The fluorescent substance layer preferably has one to three layers and more preferably one or two layers. For example, layers including the fluorescent substance particles of different grain sizes with a relatively narrow grain size distribution may be stacked. In this case, the grain size of the fluorescent substance particles contained in a layer nearer to the support may be smaller. It is particularly preferable to apply fluorescent substance particles of a large grain size to a layer on a surface protective layer side and to apply fluorescent substance particles of a small grain size to a layer on the support side. The small grain size is preferably within the range of 0.5 μm to 2.0 μm and the large grain size is within the range of 10 μm to 30 μm.

Further, the fluorescent substance layer may be formed by mixing fluorescent substance particles of different grain sizes. Alternatively, as described in JP-B No. 55-33560, page 3, left column, line 3 to page 4, left column, line 39, the fluorescent substance layer may have a structure in which the grain size distribution of the fluorescent substance particles has a gradient. Usually, the fluctuation coefficient of the grain size distribution of the fluorescent substance particles is within the range of 30 to 50% but mono-dispersed fluorescent substance particles with a fluctuation coefficient of 30% or less may also be preferably used.

It has been attempted to provide a preferred sharpness by dyeing the fluorescent substance layer with respect to the emission wavelength. However, the layer is preferably designed such that dyeing level thereof is as low as possible. The absorption length of the fluorescent substance layer is preferably 100 μm or more and more preferably 1000 μm or more.

The scattering length of the layer is preferably designed to be 0.1 μm to 100 μm and more preferably 1 μm to 100 μm. The scattering length and the absorption length can be calculated according to the formula based on the Kubelka-Munk's theory.

The support can be appropriately selected from various kinds of supports used in known radiation intensifying screens according to the purpose. For example, a polymer film containing a white pigment such as titanium dioxide or a polymer film containing a black pigment such as carbon black can be preferably used. An undercoat layer such as a light reflection layer containing a light reflection material may also be disposed on the surface of the support (surface on which the fluorescent substance layer is formed). A light reflection layer as described in JP-A No. 2001-124898 can also be preferably used. In particular, a light reflection layer including yttrium oxide as described in Example 1 of the above-mentioned patent application or a light reflection layer as described in Example 4 of the patent application is preferably used. As for the another preferred light reflection layer, JP-A No. 2001-124898, from page 3, right column, line 15 to page 4, right column, line 23 can be referred to.

A surface protective layer is preferably provided on the surface of the fluorescent substance layer. The light scattering length measured at the main emission wavelength of the fluorescent substance is preferably within the range of 5 μm to 80 μm, more preferably within the range of 10 μm to 70 μm, and more preferably within the range of 10 μm to 60 μm. The light scattering length represents an average distance for which light advances within a period starting just after scattering and ending just before next scattering. The shorter the scattering length, the higher the light scattering property.

Further, The light absorption length expressing an average free distance till light is absorbed is any value. However, it is preferable that the surface protective layer has no adsorption, since such a surface protective layer less reduces screen sensitivity. Alternatively, in order to compensate insufficient scattering, the surface protective layer may have a slight absorptivity. The absorption length is preferably 800 μm or more, and more preferably 1200 μm or more. The light scattering length and the light absorption length can be calculated according to the formula based on the Kubelka-Munk's theory by using values measured by the following method.

At first, three or more film specimens having different thicknesses and the same composition as that of the surface protective layer to be measured are prepared. Then, the thickness (μm) and the diffuse transmittance (%) of each of the film specimens are measured. The diffuse transmittance can be measured by a device in which an integrating sphere is attached to an ordinary spectrophotometer. In measurement in the invention, an autographic spectrophotometer (Model U-3210, manufactured by Hitachi Ltd.) provided with a 150 φ integrating sphere (150-0901) is used. It is necessary that the measuring wavelength coincides with the peak wavelength of the main emission of the fluorescent substance in the objective fluorescent substance layer to which the surface protective layer is attached. Then, the measured values of the thickness (μm) and the diffuse transmittance (%) of the film are introduced into the following formula (A) derived from the Kubelka-Munk's theoretical formula. The formula (A) can be introduced simply, for example, from the formulae in 5.1.12 to 5.1.15, page 403, in “Fluorescent substance Handbook” (edited by Fluorescent substance Dogakukai, published from Ohm Co. in 1987) under the boundary condition for the diffuse transmittance factor T (%).
T/100=4β[(1+β)²·exp (αd)−(1−β)²·exp (−αd)] formula (A)

In the formula, T represents a diffuse transmittance (%), d represents a film thickness (μm), and α and β are defined by the following formulae:
α=[K·(K+2S)]^{1/2}
β=[K/(K+2S)]^{1/2}

T (diffuse transmittance: %) and d (film thickness: μm) measured of the three or more films are respectively introduced into formula (A) to calculate K and S that satisfy formula (A). The scattering length (μm) is defined as 1/S and the absorption wavelength (μm) is defined as 1/K.

It is preferable that the surface protective layer has a structure in which light scattering particles are dispersed and contained in the resin material. The optical refractive index of the light scattering particles is usually 1.6 or more and preferably 1.9 or more. Further, the grain size of the light scattering particles is usually within the range of 0.1 μm to 1.0 μm. Examples of the light scattering particles include fine particles of aluminum oxide, magnesium oxide, zinc oxide, zinc sulfide, titanium oxide, niobium oxide, barium sulfate, lead carbonate, silicon oxide, polymethyl methacrylate, polystyrene, and melamine.

The resin material of the surface protective layer has no particular restriction, and is preferably polyethylene terephthalate, polyethylene naphthalate, polyamide, alamide, a fluoro resin or polyester. The surface protective layer can be formed by dispersing the light scattering particles in a solution containing an organic solvent and the resin material (binder resin) to prepare a liquid dispersion, directly applying the liquid dispersion to the fluorescent substance layer (or to an optional auxiliary layer), and drying the resultant coating. Alternatively, a sheet for the protective layer formed separately may be bonded to the fluorescent substance layer by using an adhesive. The thickness of the surface protective layer is usually within the range of 2 μm to 12 μm, and preferably within the range of 3.5 μm to 10 μm.

Further, preferred manufacturing methods and of radiation-intensifying screens and materials used in the methods are described in detail, for example, in JP-A No. 9-21899, page 6, left column, line 47 to page 8, left column, line 5, JP-A No. 6-347598, page 2, right column, line 17 to page 3, left column, line 33, and page 3, left column, line 42 to page 4, left column, line 22, and these descriptions can be referred to.

Single-Sided Photothermographic Material

The single-sided photothermographic material in the invention is particularly preferably used as an X-ray sensitive material for mammography.

It is important to design a single-sided photothermographic material used for this purpose such that contrast of an image to be obtained is within a suitable range.

As preferable configuration requirements for the X-ray sensitive material for mammography, JP-A Nos. 5-45807, 10-62881, 10-54900 and 11-109564 can be referred to.

Combination of Photothermographic Material and Ultraviolet Fluorescent Screen

As a method for forming an image on the photothermographic material of the invention, a method in which an image is formed by combining the same with a fluorescent substance having a principal peak at 400 nm or less can be preferably employed. A method in which an image is formed by combining the same with a fluorescent substance having a principal peak at 380 nm or less is more preferable. Either the double-sided photosensitive material or the single-sided photosensitive material may be used as an assembly. As the screen having a principal fluorescent peak at 400 nm or less, screens described in JP-A No. 6-11804 and WO93/01521 are used, however the invention is not restricted to them. As techniques of crossover cut (double-sided photosensitive material) and antihalaton (single-sided photosensitive material), those described in JP-A No. 8-76307 can be used. As an ultraviolet absorbing dye, dyes described in Japanese Patent Application No. 2000-320809 are particularly preferable.

4-2. Thermal Development

The photothermographic material of the invention may be developed by any method, and usually the photothermographic material imagewise exposed is heated and developed. The development temperature is preferably from 90° C. to 180° C., and more preferably from 100° C. to 140° C.

The development time is preferably from 1 sec to 60 sec, more preferably from 5 sec to 30 sec, and still more preferably from 5 sec to 20 sec.

A thermal development method is preferably a method using a plate heater. The thermal development method using the plate heater system is preferably a method described in JP-A No. 11-133572, in which a visible image is obtained by bring a photothermographic material having thereon a latent image into contact with a heating unit at the thermal development zone of a thermal developing apparatus. In the thermal developing apparatus, the heating unit has a plate heater and plural press rollers disposed along one surface of the plate heater, and thermal development is conducted by allowing the photothermographic material to pass through a nip portion formed between the press rollers and the plate heater. It is preferable that the plate heater is divided into 2 to 6 portions and the temperature of the top portion is set to be lower than that of the other portions by around 1° C. to 10° C.

Such method is also described in JP-A No. 54-30032, by which it becomes possible to remove moisture and an organic solvent contained in the photothermographic material out of the system and inhibit change in the shape of the support caused by rapid heating of the photothermographic material.

4-3. System

An example of a medical laser imager having a light exposure portion and a heat development portion is Fuji Medical Dry Imager FM-DPL. The imager is described in Fuji Medical Review, No. 8, pages 39-55, and techniques described therein can be utilized in the invention. Further, the photothermographic material can be used as a photothermographic material for laser imagers in “AD network”, which has been proposed by Fuji Medical System as a network system that conforms to the DICOM standard.

5. Applications of the Invention

The silver halide photosensitive material and photothermographic material including the photographic emulsion having a high silver iodide content of the invention form a black and white image based on a silver image and is preferably used as a photosensitive material for general purposes, a wet-type or photothermographic material for medical diagnosis, or a wet-type or photothermographic material for industrial purposes, a wet-type or photothermographic material for printing, or a wet-type or photothermographic material for COM.

### EXAMPLES

Hereinafter, the present invention will be described in detail while referring Examples, however the invention is not restricted to them.

### Example 1

1. Preparation of PET Support and Undercoat

1-1. Film Formation

PET was made of terephthalic acid and ethylene glycol in an ordinary manner and had an intrinsic viscosity IV of 0.66 (measured in a mixture of phenol and tetrachloroethane at a weight ratio of 6/4 at 25° C.). This was pelletized, and the resultant was dried at 130° C. for 4 hours. This pellet was colored with a blue dye, 1,4-bis(2,6,-diethylanilinoanthraquinone) and the resultant was extruded out from a T-die, and rapidly cooled. Thus, a non-oriented film was prepared.

The film was longitudinally oriented by rolls rotating at different circumferencial speeds at 110° C. so that the longitudinal length thereof after the orientation was 3.3 times as long as the original longitudinal length thereof. Next, the film was laterally oriented by a tenter at 130° C. so that the lateral length thereof after the orientation was 4.5 times as long as the original lateral length thereof. Next, the oriented film was thermally fixed at 240° C. for 20 seconds, and then laterally relaxed by 4% at the same temperature. Next, the chuck portion of the tenter was slitted, and the both edges of the film were knurled, and the film was rolled up at 4 kg/cm². The rolled film having a thickness of 175 μm was obtained.

1-2. Corona Processing of Surface

Both surfaces of this support were processed at a rate of 20 m/minute at room temperature by using a solid state corona processing machine (6 KVA model manufactured by Pillar Company) From values of current and voltage read at this time, it was found that the support had been processed at 0.375 kV.A.min/m². At this time, the processing frequency was 9.6 kHz, and a gap clearance between an electrode and a dielectric roll was 1.6 mm.

1-3. Preparation of Undercoated Support

(1) Preparation of Coating Liquid for Undercoat Layer

Formulation (a) (for undercoat layer on photosensitive layer side)

| Formulation (a) for the undercoat layer | | |
|---|---|---|
| on the photosensitive layer side | | |
| Pesresin A-520 | 46.8 | g |
| (manufactured by Takamatsu Oil and Fats Co., Ltd.; | | |
| 30 mass % solution) | | |
| Vylonal MD-1200 | 10.4 | g |
| (manufactured by Toyobo Co., Ltd.) | | |
| Polyethylene glycol monononyl phenyl ether | 11.0 | g |
| (average ethylene oxide number = 8.5, 1 mass % | | |
| solution) | | |
| MP-1000 | 0.91 | g |
| (manufactured by Soken chemical & Engineering Co., | | |
| Ltd.; fine particles of PMMA polymer, | | |
| average particle size: 0.4 μm) | | |
| Distilled water | 931 | mL |

Each surface of the biaxially-oriented polyethylene terephthalate support having a thickness of 175 μm which had been subjected to the above-described corona discharge treatment was coated with the coating liquid for the under coat having formulation (a) with a wire bar such that a wet coating amount became 6.6 ml/m² (per one side). Each of the resultant coating was dried at 180° C. for 5 min. Thus, an undercoated support was prepared.

2. Formation of Coated Sample

2-1. Preparation of Coating Materials

1) Silver Halide Emulsion

Preparation of Silver Halide Emulsion 1

4.3 mL of a 1 mass % potassium iodide solution, 3.5 mL of 0.5 mol/L sulfuric acid, 36.5 g of phthalated gelatin and 160 mL of a 5 mass % methanol solution of 2,2′-(ethylenedithio)diethanol were added to 1421 mL of distilled water. The resulting solution was kept at 75° C. in a stainless steel reaction pot while it was being stirred. Solution A was prepared by diluting 22.22 g of silver nitrate with distilled water such that the total volume of the resultant mixture was 218 mL. Solution B was prepared by diluting 36.6 g of potassium iodide with distilled water such that the total volume of the resultant mixture was 366 mL. These solutions A and B were added to the content in the reaction pot by a controlled double jet method. At this time, the whole of solution A was added at a constant flow rate over 16 minutes. Moreover, solution B was added while pAg of the system was kept at 10.2. Then, 10 mL of a 3.5 mass % aqueous solution of hydrogen peroxide, and 10.8 mL of a 10 mass % aqueous solution of benzimidazole were added to the system. Solution C was prepared by diluting 51.86 g of silver nitrate with distilled water such that the total volume of the resultant mixture was 508.2 mL. Moreover, Solution D was prepared by diluting 63.9 g of potassium iodide with distilled water such that the total volume of the resultant mixture was 639 mL. These solutions C and D were added to the system by the controlled double jet method. At this time, the whole of Solution C was added at a constant flow rate over 80 minutes. Moreover, Solution D was added while pAg of the system was kept at 10.2. When ten minutes had lapsed since staring of addition of Solutions C and D, potassium hexachloroiridate (III) was added to the system in an amount of 1×10⁻⁴ mol per mol of silver. Further, when five seconds had lapsed since completion of addition of Solution C, an aqueous solution of potassium hexacyanoiron (II) was added to the system in an amount of 3×10⁻⁴ mol per mol of silver. 0.5 mol/L sulfuric acid was added to the system so as to adjust pH of the system at 3.8. Then stirring was stopped, and precipitating/desalting/washing steps were carried out. One mol/L sodium hydroxide was added to the system so as to adjust pH of the system at 5.9 and then a silver halide dispersion having pAg of 11.0 was prepared.

Silver halide grains in the obtained silver halide dispersion were made of pure silver iodide, and included tabular grains having an average projected area diameter of 0.93 μm, a coefficient of variation of the average projected area diameter of 17.7%, an average thickness of 0.057 μm, and an average aspect ratio of 16.3. The entire projected area of the tabular grains corresponded to 80% or more of the entire projected area of all the silver halide grains. The sphere equivalent diameter thereof was 0.42 μm. A result of X-ray powder diffraction analysis showed that 90% or more of the silver iodide had gamma phase. pAg was 10.2 when measured at 38° C.

Preparation of Silver Halide Emulsion 2

A silver halide emulsion dispersion 2 was prepared in the same manner as preparation of the silver halide emulsion 1 except that the addition amount of the 5 mass % methanol solution of 2,2′- (ethylenedithio)diethanol was changed to 240 mL, the whole of Solution A was added over 12 minutes, the whole of Solution C was added over 64 minutes and other conditions were also suitably changed. The obtained silver halide emulsion grains were made of pure silver iodide, and included tabular grains having an average projected area diameter of 1.369 μm, a coefficient of variation of the average projected area diameter of 19.7%, an average thickness of 0.130 μm, and an average aspect ratio of 10.5. The entire projected area of the tabular grains corresponded to 80% or more of the entire projected area of all the silver halide grains. The sphere equivalent diameter thereof was 0.71 μm. A result of X-ray powder diffraction analysis showed that 83% or more of the silver iodide had gamma phase.

Preparation Silver Halide Emulsions 3 and 4

Preparation of Emulsions having Different Thickness, Aspect Ratio and/or Sphere Equivalent Diameter

Silver halide emulsions 3 and 4 were prepared in the same manner as preparation of the silver halide emulsion 1 (or 2) except that the addition amount of the 5 mass % methanol solution of 2,2′-(ethylenedithio)diethanol, temperature, pAg during formation of silver halide, and the addition rates of the silver nitrate solution and potassium iodide solution were suitably changed. Properties of the obtained silver halide dispersion were as follows. The silver halide emulsion 3 a pure silver iodide emulsion having an average projected area of 1.43 μm, a coefficient of variation of the average projected area diameter of 20.1%, an average thickness of 0.24 μm, an average aspect ratio of 5.95 and a sphere equivalent diameter of 0.90 μm. A result of X-ray powder diffraction analysis showed that 88% or more of the silver iodide had gamma phase. The silver halide emulsion 4 was a pure silver iodide emulsion having an average projected area of 1.422 μm, a coefficient of variation of the average projected area diameter of 20.1%, an average thickness of 0.48 μm, an average aspect ratio of 2.96 and a sphere equivalent diameter of 1.13 μm. A result of X-ray powder diffraction analysis showed that 90% or more of the silver iodide had gamma phase.

Preparation of Silver Halide Emulsions 5 to 8

Preparation of Silver Bromide-Epitaxially Joined Grains

The silver halide emulsion 1 was placed in a reaction vessel in an amount which corresponded to one mole of the AgI emulsion. A 0.5 mol/L KBr solution and 0.5 mol/L AgNO₃ solution were added to the emulsion by the double jet method over 20 minutes at 10 mL/minute to allow substantially 10 mol % of silver bromide to epitaxially deposit on the AgI host grains. During this operation, pAg of the reaction system was kept at 10.2. Further, 0.5 mol/L sulfuric acid was added to the system so as to adjust pH of the system at 3.8. Then stirring was stopped, and precipitating/desalting/washing steps were carried out. One mol/L sodium hydroxide was added to the system so as to adjust pH of the system at 5.9 and then a silver halide dispersion having pAg of 11.0 was prepared.

5 mL of a 0.34 mass % methanol solution of 1,2-benzoisothiazoline-3-one was added to the silver halide dispersion which was kept at 38° C. and was being stirred. Forty minutes later, the temperature of the system was raised to 47° C. When 20 minutes lapsed since increase of temperature, a methanol solution of sodium benzenethiosulfonate was added to the system in an amount of 7.6×10⁻⁵ mol per mol of silver. Additional 5 minutes later, a methanol solution of tellurium-including sensitizer C was added to the system in an amount of 2.9×10⁻⁵ mol per mol of silver and then the system was aged for 91 minutes. Subsequently, 1.3 mL of a 0.8 mass % methanol solution of N,N′-dihydroxy-N″,N″-diethylmelamine was added to the system. Additional 4 minutes later, a methanol solution of 5-methyl-2-mercaptobenzoimidazole was added to the system in an amount of 4.8×10⁻³ mol per mol of silver, and a methanol solution of 1-phenyl-2-heptyl-5-mercapto-1,3,4-triazole was also added in an amount of 5.4×10⁻³ mol per mol of silver, and an aqueous solution of 1-(3-metylureidophenyl)-5-mercaptotetrazole was also add in an amount of 8.5×10⁻³ mol per mol of silver to prepare a silver halide emulsion 5.

Silver halide dispersions 6 to 8 were prepared in the same manner as preparation of the silver halide dispersion 5, except that the emulsion to be added to the reaction vessel was replaced with silver halide emulsions 2 to 4, respectively.

Preparation of Silver Halide Emulsions 9 and 10

Preparation of Emulsions for Comparison

A silver halide emulsion 9 was prepared in the same manner as preparation of the silver halide emulsion 1 except that the temperature was changed to 45° C., pAg at the time of addition by the controlled double jet method was set to 9.3, and other conditions were suitably changed. The obtained silver halide emulsion grains were made of pure silver iodide, and included tabular grains having an average projected area diameter of 1.39 μm, a coefficient of variation of the average projected area diameter of 20.2%, an average thickness of 0.52 μm, and an average aspect ratio of 2.67. The entire projected area of the tabular grains corresponded to 80% or more of the entire projected area of all the silver halide grains. The sphere equivalent diameter thereof was 1.15 μm. A result of X-ray powder diffraction analysis showed that 73% or more of the silver iodide had gamma phase.

A silver halide emulsion 10 was prepared in the same manner as preparation of the silver halide dispersion 5, except that the emulsion to be added to the reaction vessel was replaced with the silver halide emulsion 9.

Preparation of Silver Halide Emulsions 1 to 10 for Coating Liquid

A 1 mass % aqueous solution of benzothiazolium iodide was added to each of the silver halide emulsions 1 to 10 in an amount of 7×10⁻³ mol per mol of silver.

Further, each of compounds 1, 2 and 3 capable of undergoing one-electron oxidation to form a one-electron oxidant that can release one or more electrons was added to each emulsion in an amount of 2×10⁻³ mol per mol of silver of silver halide.

In addition, each of compounds 1, 2 and 3 having an adsorptive group and a reducing group was added to each emulsion in an amount of 8×10⁻³ mol per mol of silver halide.

Furthermore, water was added to each emulsion to prepare a silver halide emulsion for coating liquid so that the amount of silver of silver halide became 15.6 g per L of the silver halide emulsion for coating liquid.

2) Preparation of Dispersion of Silver Salt of Fatty Acid

Preparation of Recrystallized Behenic Acid

100 kg of behenic acid manufactured by Henkel Co. (trade name of product: Edenor C22-85R) was dissolved in 1200 kg of isopropyl alcohol at 50° C., and the resultant solution was filtered through a filter having a pore size of 10 μm and then cooled to 30° C. to recrystallize behenic acid. The cooling rate in the recrystallization was controlled to 3° C./hour. The solution was centrifugally filtered to collect recrystallized crystals, and the crystals were washed with 100 kg of isopropyl alcohol and then dried. The obtained crystals were esterified and the resultant was measured by GC-FID. The resultant had a behenic acid content of 96 mol % and, in addition, included 2 mol % of lignoceric acid, 2 mol % of archidic acid and 0.001 mol % of erucic acid.

Preparation of Dispersion of Silver Salt of Fatty Acid

88 kg of recrystallized behenic acid, 422 L of distilled water, 49.2 L of a 5 mol/L aqueous NAOH solution and 120 L of t-butyl alcohol were mixed and reacted at 75° C. for one hour while the resultant system was being stirred. Thus, a sodium behenate solution B was obtained. Separately, 206.2 L of an aqueous solution (pH 4.0) containing 40.4 kg of silver nitrate was prepared and kept at 10° C. A reaction vessel containing 635 L of distilled water and 30 L of t-butyl alcohol was kept at 30° C. The entire amount of the sodium behenate solution and the entire amount of the aqueous solution of silver nitrate were added to the content of the vessel at constant flow rates over 93 minutes and 15 seconds and over 90 minutes, respectively, while the content in the vessel was being sufficiently stirred. At this time, only the aqueous solution of silver nitrate was added for 11 minutes after starting the addition of the aqueous solution of silver nitrate, addition of sodium behenate solution was started subsequently, and only the sodium behenate solution was added for 14 minutes and 15 seconds after completion of the addition of the aqueous solution of silver nitrate. At this time, the internal temperature of the reaction vessel was kept at 30° C. The external temperature was controlled such that the liquid temperature was constant. The pipe line for the sodium behenate solution was a double-walled pipe and thermally insulated by circulating hot water through the interspace of the double-walled pipe, and the temperature of the solution at the outlet of the nozzle tip was adjusted at 75° C. The pipe line for the aqueous silver nitrate solution was also a double-walled pipe and thermally insulated by circulating cold water through the interspace of the double-walled pipe. The position at which the sodium behenate solution was added to the reaction system and that at which the aqueous silver nitrate solution was added thereto were disposed symmetrically relative to the shaft of the stirrer disposed in the reactor, and the nozzle tips of the pipes were spaced apart from the reaction solution level in the reactor.

After adding the sodium behenate solution was finished, the reaction system was stirred for 20 minutes at that temperature, and then heated to 35° C. over 30 minutes. Thereafter, the system was aged for 210 minutes. Immediately after completion of the ageing, the system was centrifugally filtered to collect a solid component, which was washed with water until the conductivity of the washing waste reached 30 μS/cm. The solid thus obtained was a silver salt of a fatty acid and was stored as wet cake without drying it.

The shapes of the silver behenate particles obtained herein were analyzed on the basis of their images taken through electronmicroscopic photography. Average values of a, b, and c were 0.21 μm, 0.4 μm and 0.4 μm, respectively (a, b and c are defined hereinabove). An average aspect ratio was 2.1. A coefficient of variation of sphere equivalent diameters of the particles was 11%.

19.3 kg of polyvinyl alcohol (trade name, PVA-217) and water were added to the wet cake whose amount corresponded to 260 kg of the dry weight thereof so that the total amount of the resultant became 1000 kg. The resultant was formed into slurry with a dissolver wing, and then pre-dispersed with a pipe-line mixer (Model PM-10 available from Mizuho Industry Co.).

Next, the pre-dispersed stock slurry was processed three times in a disperser (MICROFLUIDIZER M-610 obtained from Microfluidex International Corporation, and equipped with a Z-type interaction chamber) at a controlled pressure of 1150 kg/cm². A silver behenate dispersion was thus prepared. To cool it, corrugated tube type heat exchangers were disposed before and behind the interaction chamber. The temperature of the coolant in these heat exchangers was so controlled that the system could be processed at a dispersion temperature of 18° C.

3) Preparation of Reducing Agent Dispersion

Preparation of of Reducing Agent-1 Dispersion

10 kg of a reducing agent-1 (2,2′-methylenebis-(4-ethyl-6-tert-butylphenol)), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) including zirconia beads which had a mean diameter of 0.5 mm, and dispersed therewith for 3 hours. Then, 0.2 g of sodium salt of benzoisothiazolinone and water were added thereto to adjust the reducing agent concentration of the resultant at 25% by mass. The dispersion was heated at 60° C. for 5 hours. A reducing agent-1 dispersion was thus prepared. The reducing agent particles in the dispersion had a median diameter of 0.40 μm, and a maximum particles size of at most 1.4 μm. The reducing agent dispersion was filtered through a polypropylene filter having a pore size of 3.0 μm to remove foreign objects such as dirt from it, and then stored.

Preparation of Reducing Agent-2 Dispersion

10 kg of a reducing agent-2 (6,6′-di-t-butyl-4,4′-dimethyl-2,2′-butylidenediphenol), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) including zirconia beads which had a mean diameter of 0.5 mm, and dispersed therewith for 3 hours and 30 minutes. Then, 0.2 g of sodium salt of benzoisothiazolinone and water were added thereto to adjust the reducing agent concentration of the resultant at 25% by mass. The dispersion was then heated at 40° C. for 1 hour, and then at 80° C. for 1 hour. A reducing agent-2 dispersion was thus prepared. The reducing agent particles in the dispersion had a median diameter of 0.50 μm, and a maximum particle size of at most 1.6 μm. The reducing agent dispersion was filtered through a polypropylene filter having a pore size of 3.0 μm to remove foreign objects such as dirt from it, and then stored.

4) Preparation of Hydrogen Bonding Compound Dispersion

Preparation of Hydrogen Bonding Compound-1 Dispersion

10 kg of a hydrogen bonding compound-1 (tri(4-t-butylphenyl)phosphine oxide), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) containing zirconia beads which had a mean diameter of 0.5 mm, and dispersed therewith for 4 hours. Then, 0.2 g of sodium salt of benzoisothiazolinone and water were added thereto to adjust the hydrogen bonding compound concentration of the resultant at 25% by mass. The dispersion was heated at 40° C. for 1 hour and then at 80° C. for 1 hour. A hydrogen bonding compound-1 dispersion was thus prepared. The hydrogen bonding compound particles in the dispersion had a median diameter of 0.45 μm, and a maximum particle size of at most 1.3 μm. The hydrogen bonding compound dispersion was filtered through a polypropylene filter having a pore size of 3.0 μm to remove foreign objects such as dirt from it, and then stored.

5) Preparation of Development Accelerator Dispersion and Color-Toning Agent Dispersion

Preparation of Development Accelerator-1 Dispersion

10 kg of a development accelerator-1, 20 kg of a 10 mass % solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) containing zirconia beads which had a mean diameter of 0.5 mm, and dispersed therewith for 3 hours and 30 minutes. Then, 0.2 g of sodium salt of benzoisothiazolinone and water were added thereto to prepare a development accelerator-1 dispersion having a development accelerator concentration of 20% by mass. The development accelerator particles in the dispersion had a median diameter of 0.48 μm, and a maximum particle size of at most 1.4 μm. The development accelerator dispersion was filtered through a polypropylene filter having a pore size of 3.0 μm to remove foreign objects such as dirt from it, and then stored.

Development accelerator-2 and color toning agent-1 solid dispersions respectively having concentrations of 20 mass % and 15 mass % were prepared in the same manner as the preparation of the development accelerator-1 dispersion.

6) Preparation of Polyhalogenated Compound Dispersion

Preparation of Organic Polyhalogenated Compound-1 Dispersion

10 kg of an organic polyhalogen compound-1 (tribromomethanesulfonylbenzene), 10 kg of a 20 mass % aqueous solution of modified polyvinyl alcohol (POVAL MP203 available from Kuraray Co., Ltd.), 0.4 kg of a 20 mass % aqueous solution of sodium triisopropylnaphthalenesulfonate, and 14 kg of water were sufficiently mixed to prepare slurry. The slurry was fed by a diaphragm pump into a horizontal sand mill (UVM-2 available from Imex Corporation) including zirconia beads which had a mean diameter of 0.5 mm, and dispersed therewith for 5 hours. Then, 0.2 g of sodium salt of benzoisothiazolinone and water were added thereto to prepare an organic polyhalogen compound-1 dispersion having an organic polyhalogen compound content of 30 mass %. The organic polyhalogen compound particles in the dispersion had a median diameter of 0.41 μm, and a maximum particle size of at most 2.0 μm. The organic polyhalogen compound dispersion was filtered through a polypropylene filter having a pore size of 10.0 μm to remove foreign objects such as dirt from it, and then stored.

Preparation of Organic Polyhalogenated Compound-2 Dispersion

10 kg of an organic polyhalogen compound-2 (N-butyl-3-tribromomethanesulfonylbenzamide), 20 kg of a 10 mass % aqueous solution of modified polyvinyl alcohol (POVAL MP203 available from Kuraray Co., Ltd.), and 0.4 kg of a 20 mass % aqueous solution of sodium triisopropylnaphthalenesulfonate were sufficiently mixed to prepare slurry. The slurry was fed by a diaphragm pump into a horizontal sand mill (UVM-2 available from Imex Corporation) including zirconia beads which had a mean diameter of 0.5 mm, and dispersed therewith for 5 hours. Then, 0.2 g of sodium salt of benzoisothiazolinone and water were added thereto to adjust the organic polyhalogen compound content of the resultant at 30 mass %. The dispersion was heated at 40° C. for 5 hours. An organic polyhalogen compound-2 dispersion was thus obtained. The organic polyhalogen compound particles in the dispersion had a median diameter of 0.40 μm, and a maximum particle size of at most 1.3 μm. The organic polyhalogen compound dispersion was filtered through a polypropylene filter having a pore size of 3.0 μm to remove foreign objects such as dirt from it, and then stored.

7) Preparation of Silver Iodide Complex-Forming Agent

8 kg of modified polyvinyl alcohol MP203 was dissolved in 174.57 kg of water, and 3.15 kg of a 20 mass % aqueous solution of sodium triisopropylnaphthalenesulfonate and 14.28 kg of a 70 mass % aqueous solution of 6-isopropylphthalazine were added to the resultant solution so as to prepare a 5 mass % solution of a silver iodide complex-forming compound.

8) Preparation of Mercapto Compound

Preparation of Aqueous Solution of Mercapto Compound-1

7 g of a mercapto compound-1 (sodium salt of 1-(3-sulfophenyl)-5-mercaptotetrazole) was dissolved in 993 g of water to form a 0.7 mass % aqueous solution.

Preparation of Aqueous Solution of Mercapto Compound-2

20 g of a mercapto compound-2 (1-(3-methylureidophenyl)-5-mercaptotetrazole) was dissolved in 980 g of water to form a 2.0 mass % aqueous solution.

9) Preparation of SBR Latex Liquid

An SBR latex was prepared as follows.

287 g of distilled water, 7.73 g of a surfactant (PIONIN A-43-S produced by Takemoto Yushi Corporation and having a solid content of 48.5 mass %), 14.06 ml of 1 mol/liter NaOH, 0.15 g of tetrasodium ethylenediaminetetraacetate, 255 g of styrene, 11.25 g of acrylic acid, and 3.0 g of tert-dodecylmercaptan were put into the polymerization reactor of a gas monomer reaction apparatus (TAS-2J Model available from Taiatsu Techno Corporation). The reactor was sealed off, and the content therein was stirred at 200 rpm. The internal air was exhausted via a vacuum pump, and replaced a few times repeatedly with nitrogen. Then, 108.75 g of 1,3-butadiene was introduced into the reactor under pressure, and the internal temperature of the reactor was raised to 60° C. A solution in which 1.875 g of ammonium persulfate was dissolved in 50 ml of water was added to the system, and the system was stirred for 5 hour. It was further heated to 90° C. and stirred for 3 hours. After the reaction was completed, the internal temperature was lowered to room temperature. Then, NaOH and NH₄OH (both 1 mol/liter) were added to the system at a molar ratio of Na⁺ and NH₄⁺ of 1/5.3 so as to adjust the pH of the system at 8.4. Next, the system was filtered through a polypropylene filter having a pore size of 1.0 μm to remove foreign objects such as dirt from it, and then stored. 774.7 g of SBR latex was thus obtained. Its halide ion content was measured through ion chromatography, and the chloride ion concentration of the latex was 3 ppm. The chelating agent concentration thereof was measured through high-performance liquid chromatography, and was 145 ppm.

The mean particle size of the latex was 90 nm, Tg thereof was 17° C., the solid content thereof was 44% by mass, the equilibrium moisture content thereof at 25° C. and 60% RH was 0.6 mass %, and the ion conductivity thereof was 4.80 mS/cm. To measure the ion conductivity, a conductivity meter CM-30S manufactured by To a Denpa Kogyo K. K. was used. In the device, the 44 mass % latex was measured at 250° C. Its pH was 8.4.

2-2. Preparation of Coating Liquid

1) Preparation of Coating Liquid-1 to −10 for Image-Forming Layer

The organic polyhalogen compound-2 dispersion, the organic polyhalogen compound-2 dispersion, the SBR latex (Tg: 17° C.) liquid, the reducing agent-1 dispersion, the reducing agent-2 dispersion, the hydrogen bonding compound-1 dispersion, the development accelerator-1 dispersion, the development accelerator-2 dispersion, the color toning agent-1 dispersion, the aqueous solution of mercapto compound-1, and the aqueous solution of mercapto compound-2 were successively added to 1,000 g of the dispersion of the silver salt of the fatty acid obtained above and 276 ml of water. Then, the silver iodide complex-forming agent was added to the resultant. Just before coating, each of the silver halide emulsion-1 to -10 for coating liquid was added to and sufficiently mixed with the above mixture so that the amount of silver of the emulsion became 0.22 mol per mol of silver salt of fatty acid. Coating liquids-1 to -10 for the image-forming layer was thus prepared and each of them was fed as it is to a coating die.

2) Preparation of Coating Liquid for Intermediate Layer 27 ml of a 5 mass % aqueous solution of AEROSOL OT (available from American Cyanamid Company), 135 ml of a 20 mass % aqueous solution of diammonium phthalate and water were added to 1000 g of polyvinyl alcohol (PVA-205 available from Kuraray Co., Ltd.), and 4200 ml of a 19 mass % latex of a methyl methacrylate/styrene/butyl acrylate/hydroxyethyl methacrylate/acrylic acid copolymer (copolymerization weight ratio: 64/9/20/5/2) so that the total amount of the resultant mixture became 10000 g. The pH of the mixture was adjusted at 7.5 by adding NaOH to the mixture. A coating liquid for intermediate layer was thus obtained. This was fed into a coating die so that the amount of the coating liquid was 9.1 ml/m².

The viscosity of the coating liquid was 58 mPa·S when measured with a B-type viscometer (rotor No. 1, 60 rpm) at 40° C.

3) Preparation of Coating Liquid for First Surface Protective Layer

64 g of inert gelatin was dissolved in water, and 112 g of a 19.0 mass % latex of a methyl methacrylate/styrene/butyl acrylate/hydroxyethyl methacrylate/acrylic acid copolymer (copolymerization weight ratio: 64/9/20/5/2), 30 ml of a 15 mass % methanol solution of phthalic acid, 23 ml of a 10 mass % aqueous solution of 4-methylphthalic acid, 28 ml of 0.5 mol/L sulfuric acid, 5 ml of a 5 mass % aqueous solution of AEROSOL OT (available from American Cyanamid Company), 0.5 g of phenoxyethanol, 0.1 g of benzoisothiazolinone, and water were added to the resultant solution so that the total amount of the resultant mixture became 750 g. Just before application thereof, 26 ml of 4 mass % chromium alum was mixed with the mixture by using a static mixer. The resultant coating liquid was fed into a coating die so that the amount of the resultant coating was 18.6 ml/m².

The viscosity of the coating liquid was 20 mPa·S when measured with a B-type viscometer (rotor No. 1, 60 rpm) at 40° C.

4) Preparation of Coating Liquid for Second Surface Protective Layer

80 g of inert gelatin was dissolved in water, and 102 g of a 27.5 mass % latex of a methyl methacrylate/styrene/butyl acrylate/hydroxyethyl methacrylate/acrylic acid copolymer (copolymerization weight ratio: 64/9/20/5/2), 5.4 ml of a 2 mass % solution of a fluorine-containing surfactant (F-1), 5.4 ml of a 2 mass % aqueous solution of a fluorine-containing surfactant (F-2), 23 ml of a 5 mass % solution of AEROSOL OT (available from American Cyanamid Company), 4 g of fine polymethyl methacrylate particles (mean particle size thereof was 0.7 μm and distribution of volume-weighted average was 30%), 21 g of fine polymethyl methacrylate particles (mean particle size thereof was 3.6 μm and distribution of volume-weighted average was 60%), 1.6 g of 4-methylphthalic acid, 4.8 g of phthalic acid, 44 ml of 0.5 mol/L sulfuric acid, 10 mg of benzoisothiazolinone, and water were added to the resultant solution so that the total amount of the resultant mixture became 650 g. Just before application thereof, 445 ml of an aqueous solution containing 4 mass % of chromium alum and 0.67 mass % of phthalic acid was mixed with the mixture by using a static mixer. A coating liquid for the surface protective layer was thus obtained. The coating liquid was fed into a coating die, with its flow rate so controlled that its coating amount was 8.3 ml/m².

The viscosity of the coating liquid was 19 mPa·S when measured with a B-type viscometer (rotor No. 1, 60 rpm) at 40° C.

2-3. Preparation of Photothermographic Material-1 to −10

The coating liquid for image forming layer, the coating liquid for intermediate layer, the coating liquid for first surface-protective layer, and the coating liquid for second surface-protective layer were coated simultaneously by a slide bead coating method on the undercoat layer disposed on the support in that order to prepare specimens of heat-developable photosensitive materials. The temperatures of the coating liquid for image forming layer and the coating liquid for intermediate layer were controlled at 31° C., and the temperature of the coating liquid for first surface-protective layer was controlled at 36° C., and the temperature of the coating liquid for second surface-protective layer was controlled at 37° C. The coating amount of silver, which was the sum of the coating amount of silver of silver salt of fatty acid and that of silver of silver halide, in one image-forming layer was 0.821 g/m². Both sides of the support were coated according to the same formulation to form photothermographic materials-1 to -10. The photothermographic materials-1 to -10 corresponded to the coating liquids-1 to -10 for image-forming layer.

The coating amount (g/m²) of each compound in one image-forming layer was as follows.

| | |
|---|---|
| Silver behenate | 2.80 |
| Polyhalogenated compound-1 | 0.028 |
| Polyhalogenated compound-2 | 0.094 |
| Silver iodide complex-forming agent | 0.46 |
| SBR latex | 5.20 |
| Reducing agent-1 | 0.33 |
| Reducing agent-2 | 0.13 |
| Hydrogen bonding compound-1 | 0.15 |
| Development accelerator-1 | 0.005 |
| Development accelerator-2 | 0.035 |
| Color toneing agent-1 | 0.002 |
| Mercapto compound-1 | 0.001 |
| Mercapto compound-2 | 0.003 |
| Silver halide (in terms of Ag amount) | 0.146 |

Coating and drying conditions are shown below.

Before coating, the static electricity of the support was eliminated by blowing an ion blow to the support. The coating speed was 160 m/minute. The coating and drying conditions for each sample were controlled within the range mentioned below so that the coated surface was stabilized to the best.

The distance between the coating die tip and the support was between 0.10 and 0.30 mm. The pressure in the decompression chamber was lower by 196 to 882 Pa than the atmospheric pressure. In the subsequent chilling zone, the coated support was chilled with an air blow (its dry-bulb temperature was 10 to 20° C.). In the next helix type contactless drying zone, the support was dried with a dry air blow (its dry-bulb temperature was 23 to 45° C., and its wet-bulb temperature was 15 to 21° C.). In this zone, the coated support to be dried was kept not in contact with the drier. After the drying, the support was conditioned at 25° C. and 40 to 60% RH, and then heated so that the surface temperature was between 70 and 90° C. After the heating, the support was cooled to have a surface temperature of 25° C.

The degree of matting, in terms of the Bekk's smoothness, of the heat-developable photosensitive material thus prepared was 550 seconds on the image forming layer-coated surface thereof. The pH of the image forming layer-coated surface of the sample was measured and was 6.0.

The chemical structures of the compounds used in this Example are shown below.
Tellurium Sensitizer C 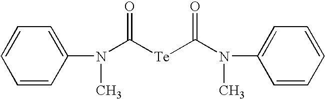
Compound 1 Capable of Undergoing One-Electron Oxidation to Form One-Electron Oxidant that can Release One or More Electrons 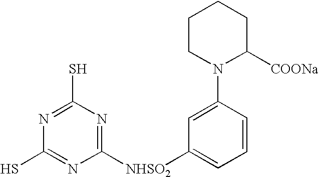
Compound 2 Capable of Undergoing One-Electron Oxidation to Form One-Electron Oxidant that can Release One or More Electrons 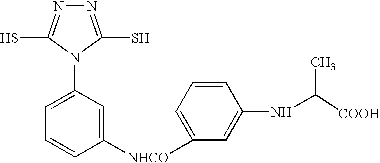
Compound 3 Capable of Undergoing One-Electron Oxidation to Form One-Electron Oxidant that can Release One or More Electrons 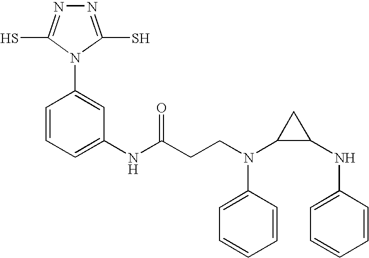
Compound 1 Having Adsorptive Group and Reducing Group 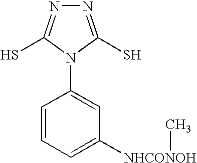
Compound 2 Having Adsorptive Group and Reducing Group

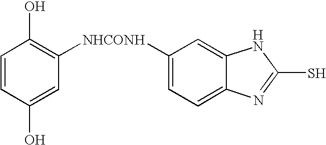

Compound 3 Having Adsorptive Group and Reducing Group 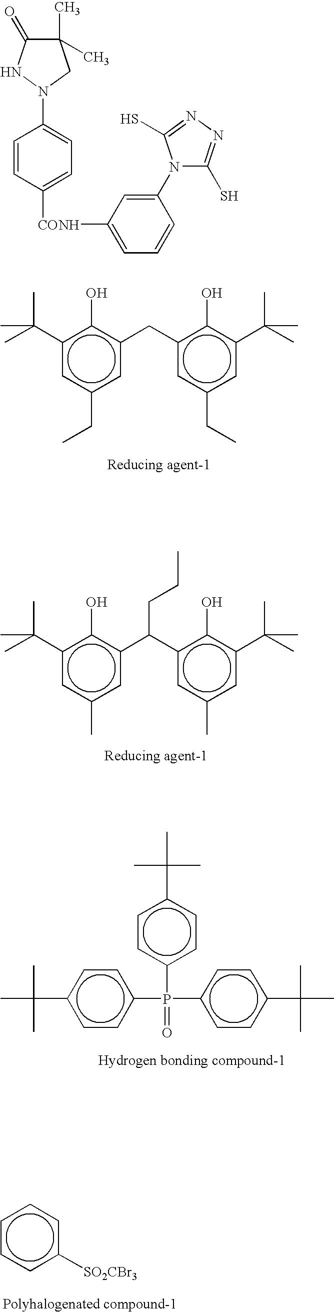 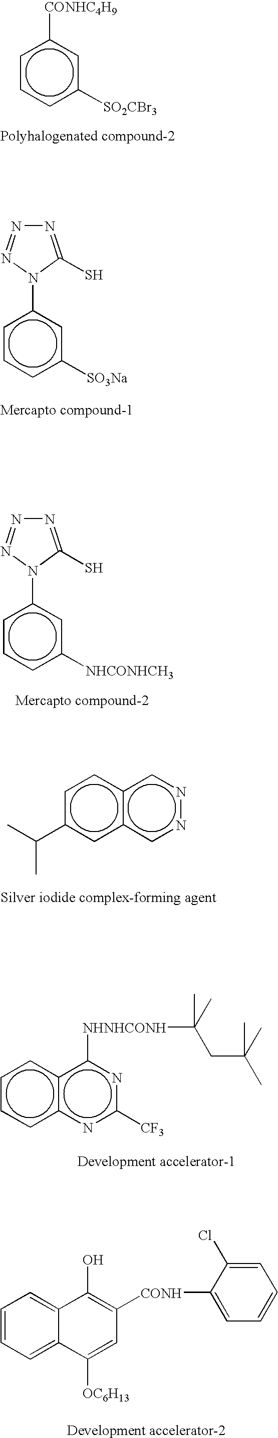 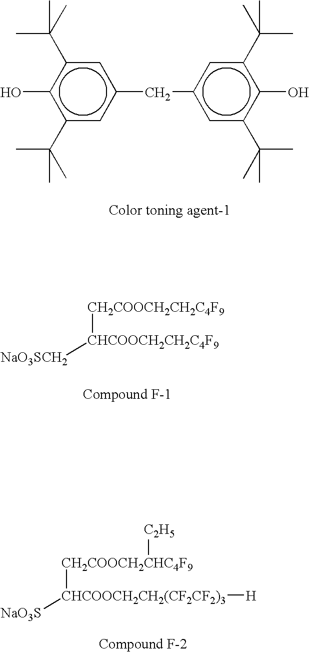
Evaluation of Photographic Performance
1) Preparation

Each specimen thus prepared was cut into pieces of a half-size, packaged with a packaging material mentioned below at 25° C. and 50% RH, stored at ordinary temperature for two weeks, and tested according to a test method mentioned below.

Packaging Material

The packaging material used herein was a film including a PET film having a thickness of 10 μm, a PE film having a thickness of 12 μm, an aluminium foil having a thickness of 9 μm, a nylon film having a thickness of 15 μm, and a 3% carbon-containing polyethylene film having a thickness of 50 μm, and having an oxygen permeability of 0.02 ml/atm·m²·0.25° C.·day and a moisture permeability of 0.10 g/atm·m²·0.25° C.·day.

2) Exposure and Development

The double-side-coated photosensitive material prepared in this manner was evaluated as follows.

The sample was sandwiched between two X-ray regular screens (HI-SCREEN B3 manufactured by Fuji Photo Film Co., Ltd., containing CaWO₄ as a fluorescent substance and having a peak emission wavelength of 425 nm) to form an assembly for image formation. The assembly was exposed to X-rays for 0.05 seconds and subjected to X-ray sensitometry. The X-ray apparatus used was DRX-3724HD (trade name) manufactured by Toshiba Corporation and having a tungsten target. A voltage of 80 KVp was applied to three phases with a pulse generator to generate X-rays and the X-rays were made to pass through a filter of water having a thickness of 7 cm, which filter absorbed X-rays in nearly the same amount as that of X-rays which the human body absorbs, to form an X-ray source. While an X-ray exposure amount was varied by varying the distance between the assembly and the X-ray source, the material was exposed stepwise at an interval of logE=0.15. After exposure, the material was thermally developed under the following thermal development conditions.

The thermal development unit of FUJI MEDICAL DRY LASER IMAGER FM-DPL was remodeled to produce a thermal development apparatus that could heat the material from both sides thereof. Further, the apparatus was also remodeled to enable conveying a film sheet by replacing the conveying roller in the thermal development unit with a heat drum. Temperatures of four panel heaters were set to 112° C., 118° C., 120° C., and 120° C., respectively and that of the heat drum was set to 120° C. In addition, the conveying speed was increased so that the total period of thermal development became 14 seconds.

On the other hand, a wet-developing type regular photosensitive material RX-U (manufactured by Fuji Photo Film Co., Ltd.) was also exposed to X-rays under the same conditions and processed by using an automatic developing apparatus CEPROS-M2 (manufactured by Fuji Photo Film Co., Ltd.) and a processing liquid CE-D1 (manufactured by Fuji Photo Film) for 45 seconds.

3) Evaluation Item

Sensitivity and Fogging

The densities of the obtained images were measured with a densitometer and characteristic curves of density relative to logarithm of the exposure amount were depicted. The optical density of an unexposed area (Dmin area) was defined as fogging level, and the reciprocal number of an exposure amount giving an optical density of 1.5 was defined as sensitivity. Results are represented by relative values given that the sensitivity of the photosensitive material 1 was 100. As for fogging level, a smaller value is preferable.

Image Storability

The printout property of the thermographic material was measured to evaluate image storability. The image formed above on each of the coated samples was stored for 24 hours while it was being exposed to light from a fluorescent lamp having illuminance of 1000 Lux. Increase in fogging density of the Dmin area, ΔDmin, was obtained and evaluated. The smaller the ΔDmin value, the more excellent the image storability (printout property).

Haze Evaluation

The Haze degree of the obtained image was visually and sensorily evaluated on the basis of the following four steps of evaluation standard.

A: No white turbidity was observed.

B: Slight white turbidity was observed.

C: Relatively much white turbidity was observed.

D: Considerably much white turbidity was observed.

4) Result

The obtained results are shown in Table 1.

TABLE 1

| Sample | AgX | Thickness | | | | Image | |
|---|---|---|---|---|---|---|---|
| No | Composition | (μm) | Sensitivity | Fogging | Haze | Storability | Remarks |
| 1 | AgI | 0.057 | 100 | 0.17 | A | 0.01 | Invention |
| 2 | AgI | 0.13 | 124 | 0.18 | A | 0.02 | Invention |
| 3 | AgI | 0.24 | 112 | 0.18 | B | 0.03 | Invention |
| 4 | AgI | 0.48 | 103 | 0.18 | C | 0.03 | Invention |
| 5 | AgI 90, Br 10 | 0.057 | 200 | 0.18 | A | 0.01 | Invention |
| 6 | AgI 90, Br 10 | 0.13 | 242 | 0.19 | A | 0.02 | Invention |
| 7 | AgI 90, Br 10 | 0.24 | 231 | 0.19 | B | 0.02 | Invention |
| 8 | AgI 90, Br 10 | 0.48 | 221 | 0.19 | C | 0.03 | Invention |
| 9 | AgI | 0.52 | 112 | 0.20 | D | 0.04 | Comparative example |
| 10 | AgI 90, Br 10 | 0.52 | 212 | 0.20 | D | 0.05 | Comparative example |
| RX-U | — | — | 256 | 0.26 | A | 0.02 | Comparative example |

From Table 1, it can be understood that the thinner the thickness of each of the specimens of Examples, the better the properties thereof such as fogging, haze and image storability. Accordingly, it is understood that, in the case of photosensitive materials having a high silver iodide content, the photosensitive material preferably has a thickness of no more than 0.5 μm, and more preferably a thickness of no more than 0.2 μm to provide a photosensitive material with low fogging level, low haze level and excellent image storability. In addition, it is also understood that sensitivity is further improved by providing epitaxial join for tabular grains.

### Example 2

Preparation of Fine Particle Emulsion A

4.3 ml of a 1 mass % solution of potassium iodide, 3.5 ml of 0.5 mol/L sulfuric acid and 36.7 g of phthalated gelatin were added to 1420 ml of distilled water. The resultant solution was kept at 25° C. while it was being stirred in a reaction vessel made of stainless steel. The entire amount of solution A obtained by diluting 22.22 g of silver nitrate with distilled water so that the total amount of the resultant became 195.6 ml and the entire amount of solution B obtained by diluting 21.8 g of potassium iodide with distilled water so that the total amount of the resultant became 218 ml were added to the content of the reaction vessel at a constant flow rate over nine minutes. Subsequently, 10 ml of a 3.5 mass % aqueous solution of hydrogen peroxide and 10.8 ml of a 10 mass % aqueous solution of benzimidazole were added to the content of the reaction vessel.

Further, a solution C obtained by adding distilled water to 51.86 g of silver nitrate so that the total amount of the resultant became 317.5 ml and a solution D obtained by diluting 60 g of potassium iodide with distilled water so that the total amount of the resultant became 600 ml were added to the content of the reaction vessel by a controlled double jet method. At this time, the entire amount of the solution C was added at a constant flow rate over 120 minutes. Moreover, the solution D was added while pAg of the reaction system was kept at 8.1.

Then, 0.5 mol/L sulfuric acid was added to the system to adjust pH of the system at 3.8, the stirring was stopped and precipitation/desalting/water washing steps were conducted. One mol/L sodium hydroxide was added to the system to adjust pH of the system at 5.9 and a silver halide emulsion having pAg of 8.0 was thus prepared. The emulsion had an average grain size of 0.021 μm, and a coefficient of variation of grain sizes of 15%. The average grain size was obtained by measuring the size of 1000 grains with a transmission electron microscopy (TEM) and obtaining the average thereof.

Preparation of Silver Halide Emulsion 21

8.0 ml of a 10 mass % solution of potassium iodide, 3.5 ml of 0.5 mol/L sulfuric acid, 9.2 g of phthalated gelatin and 160 ml of a 5 mass % methanol solution of 2,2′-(ethylene dithio) diethanol were added to 1421 ml of distilled water. The resultant solution was kept at 75° C. while is was being stirred in a reaction vessel made of stainless steel. The entire amount of a solution A obtained by diluting 3.2 g of silver nitrate with distilled water so that the total amount of the resultant became 32 ml and the entire amount of a solution B obtained by diluting 3.2 g of potassium iodide with distilled water so that the total amount of the resultant became 32 ml were added to the content of the reaction vessel at a constant flow rate over one minute. Subsequently, 10 ml of a 3.5 mass % aqueous solution of hydrogen peroxide and 10.8 ml of a 10 mass % aqueous solution of benzimidazole were added to the content (reaction system) of the reaction vessel, and the resultant mixture was kept for 16 minutes.

Subsequently, the fine particulate emulsion A, the amount of which corresponded to 0.42 mol of silver, was added to the system at a constant flow rate over 260 minutes. When 100 minutes had lapsed since starting of the addition of the fine particle emulsion A, potassium hexachloroiridate (III) was added to the system in an amount of 1×10⁻⁴ mol per mol of silver. Further, when 5 seconds had lapsed since completion of the addition of the fine particle emulsion A, an aqueous solution of potassium iron (II)hexacyanide (II) was added to the system in an amount of 3×10⁻⁴ per mol of silver. 0.5 mol/L sulfuric acid was added to the system to adjust pH of the system at 3.8, stirring was stopped, and precipitation/desalting/water washing steps were conducted. One mol/L sodium hydroxide was added to the system to adjust pH of the system at 5.9, and a silver halide emulsion 21 having pAg of 11.0 was thus obtained.

The obtained silver halide grains contained in the silver halide emulsion 21 were made of pure silver iodide, and included tabular grains having an average projected area diameter of 2.4 μm, a coefficient of variation of the average projected area diameter of 19.4%, an average thickness of 0.04 μm, and an average aspect ratio of 60.0. The entire projected area of the tabular grains corresponded to 97% or more of the entire projected area of all the silver halide grains. The sphere equivalent diameter thereof was 0.7 μm. A result of X-ray powder diffraction analysis showed that 70% or more of the silver iodide had beta phase. pAg was 10.2 when measured at 38° C.

Preparation of Fine Particle Emulsion B

A fine particle emulsion B was obtained in the same manner as preparation of the fine particle emulsion A except that the temperature during grain formation was kept at 42° C. The emulsion had an average grain size of 0.040 μm and a coefficient of variation of grain sizes of 11%.

Preparation of Silver Halide Emulsion 22

A silver halide emulsion 22 was obtained in the same manner as preparation of the silver halide emulsion 21 except that the fine particle emulsion A was replaced with the fine particle emulsion B. The obtained silver halide grains contained in the silver halide emulsion 22 were made of pure silver iodide, and included tabular grains having an average projected area diameter of 2.16 μm, a coefficient of variation of the average projected area diameter of 18.2%, an average thickness of 0.049 μm, and an average aspect ratio of 44.0. The entire projected area of the tabular grains corresponded to 98% or more of the entire projected area of all the silver halide grains. The sphere equivalent diameter thereof was 0.7 μm. A result of X-ray powder diffraction analysis showed that 60% or more of the silver iodide had beta phase. pAg was 10.2 when measured at 38° C.

Preparation of Silver Halide 23

8.0 ml of a 10 mass % solution of potassium iodide, 3.5 ml of 0.5 mol/L sulfuric acid, 4.2 g of phthalated gelatin and 160 ml of a 5 mass % methanol solution of 2,2′-(ethylene dithio) diethanol were added to 1421 ml of distilled water. The resultant solution was kept at 75° C. while it was being stirred in a reaction vessel made of stainless steel. The entire amount of a solution A obtained by diluting 22.22 g of silver nitrate with distilled water so that the total amount of the resultant became 218 ml and a solution B obtained by diluting 36.6 g of potassium iodide with distilled water so that the total amount of the resultant became 366 ml were added to the system by a controlled double jet method. At this time, the solution A was added at a constant flow rate over 16 minutes. Moreover, the solution B was added while pAg of the system was kept at 10.2. Subsequently, 10 ml of a 3.5 mass % aqueous solution of hydrogen peroxide and 10.8 ml of a 10 mass % aqueous solution of benzimidazole were added to the system.

Further, the entire amount of a solution C obtained by diluting 51.86 g of silver nitrate with distilled water so that the total amount of the resultant became 508.2 ml and the entire amount of a solution D obtained by diluting 63.9 g of potassium iodide with distilled water so that the total amount of the resultant became 639 ml were added to the system by a controlled double jet method. At this time, the solution C was added at a constant flow rate over 80 minutes. Moreover, the solution D was added while pAg of the system was kept at 10.2. When ten minutes had lapsed since the starting of the addition of the solution C and the solution D, potassium hexachloroiridate (III) was added to the system in an amount of 1×10⁻⁴ mol per mol of silver.

Further, when five seconds had lapsed since completion of the addition of the solution C, an aqueous solution of potassium iron (II9 hexacyanide was added to the system in an amount of 3×10⁻⁴ mol per mol of silver. 0.5 mol/L sulfuric acid was added to the system to adjust pH of the system at 3.8, stirring was stopped, and precipitation/desalting/water washing steps were conducted. Then, one mol/L sodium hydroxide was added to the system to adjust pH of the system at 5.9, and a silver halide emulsion 23 having pAg of 11.0 was thus prepared.

The obtained silver halide grains contained in the silver halide emulsion 23 were made of pure silver iodide, and included tabular grains having an average projected area diameter of 1.38 μm, a coefficient of variation of the average projected area diameter of 16.6%, an average thickness of 0.12 μm, and an average aspect ratio of 11.5. The entire projected area of the tabular grains corresponded to 90% or more of the entire projected area of all the silver halide grains. The sphere equivalent diameter thereof was 0.7 μm. A result of X-ray powder diffraction analysis showed that 50% or more of the silver iodide had gamma phase. pAg was 10.2 when measured at 38° C.

Preparation of Silver Halide Emulsion 24

3.5 ml of 0.5 mol/L sulfuric acid, 2.3 g of phthalated gelatin and 20 ml of a 5 mass % methanol solution of 2,2′-(ethylene dithio)diethanol were added to 1421 ml of distilled water. The resultant solution was kept at 75° C. while is was being stirred in a reaction vessel made of stainless steel. The entire amount of a solution A obtained by diluting 22.22 g of silver nitrate with distilled water so that the total amount of the resultant became 218 ml and a solution B obtained by diluting 36.6 g of potassium iodide with distilled water so that the total amount of the resultant became 366 ml were added to the system by a controlled double jet method. At this time, the solution A was added at a constant flow rate over 16 minutes. Moreover, the solution B was added while pAg of the system was kept at 7.2. Subsequently, 10 ml of a 3.5 mass % aqueous solution of hydrogen peroxide and 10.8 ml of a 10 mass % aqueous solution of benzimidazole were added to the system.

Further, the entire amount of a solution C obtained by diluting 51.86 g of silver nitrate with distilled water so that the total amount of the resultant became 508.2 ml and the entire amount of a solution D obtained by diluting 63.9 g of potassium iodide with distilled water so that the total amount of the resultant became 639 ml were added to the system by a controlled double jet method. At this time, the solution C was added at a constant flow rate over 80 minutes. Moreover, the solution D was added while pAg of the system was kept at 7.2.

When ten minutes had lapsed since the starting of the addition of the solution C and the solution D, potassium hexachloroiridate (III) was added to the system in an amount of 1×10⁻⁴ mol per mol of silver. Further, when five seconds had lapsed since completion of the addition of the solution C, an aqueous solution of potassium iron (II)hexacyanide was added to the system in an amount of 3×10⁻⁴ mol per mol of silver. 0.5 mol/L sulfuric acid was added to the system so as to adjust pH of the system at 3.8, stirring was stopped, and precipitation/desalting/water washing steps were conducted. One mol/L sodium hydroxide was added to the system so as to adjust pH of the system at 5.9, and a silver halide emulsion 24 having pAg of 11.0 was thus prepared.

The obtained silver halide grains contained in the silver halide emulsion 24 were made of pure silver iodide, and included tabular grains having an average projected area diameter of 0.67 μm, a coefficient of variation of the average projected area diameter of 23.2%, an average thickness of 0.51 μm, and an average aspect ratio of 1.3. The entire projected area of the tabular grains corresponded to 80% or more of the entire projected area of all the silver halide grains. The sphere equivalent diameter thereof was 0.7 μm. A result of X-ray powder diffraction analysis showed that 70% or more of the silver iodide had gamma phase. pAg was 10.2 when measured at 38° C.

Preparation of Silver Bromochloride-Epitaxially Joined Particles

Silver bromide epitaxial emulsions 25 to 28 were prepared in the same manner as preparation of the silver halide emulsion 5 in Example 1 except that the silver halide emulsions 21 to 24 were respectively used, that the 0.5 mol/L KBr solution was replaced with a solution containing 0.35 mol of KBr and 0.15 mol of NaCl, that pAg of the system was kept at 6.7 during the double jet addition, and that the addition time was changed to 40 minutes to epitaxially precipitate substantially 20 mol % of silver bromochloride on AgI host grains contained in the emulsion.

Photothermographic materials 21 to 28 were manufactured in the same manner as in Example 1 except that the silver halide emulsions 21 to 28 were respectively used. The photographic performance of each of the photothermographic materials was evaluated in the same manner as in Example 1, except that a reducing agent-3 and a nucleus forming agent were used as follows.

The total coating amount (g/m²) of each compound in one image forming layer is as follows.

| | |
|---|---|
| Silver salt of fatty acid | 2.85 |
| Polyhalogen compound-1 | 0.028 |
| Polyhalogen compound-2 | 0.094 |
| Silver iodide complex-forming agent | 0.46 |
| SBR latex | 5.20 |
| Reducing agent-3 | 0.46 |
| Nucleus forming agent-1 | 0.036 |
| Hydrogen bonding compound-1 | 0.15 |
| Development accelerator-1 | 0.005 |
| Development accelerator-2 | 0.035 |
| Color toning agent-1 | 0.002 |
| Mercapto compound-1 | 0.001 |
| Mercapto compound-2 | 0.003 |
| Silver of Silver halide | 0.175 |

Preparation of Dispersion of Nucleus Forming Agent

2.5 g of polyvinyl alcohol (PVA-217 manufactured by Kuraray Co., Ltd.) and 87.5 g of water were added to 10 g of a nucleus forming agent SH-7, and the resultant mixture was sufficiently stirred to form slurry. The slurry was left to stand for three hours. The slurry and 240 g of zirconia beads having a diameter of 0.5 mm were placed in a vessel and the resultant was stirred for 10 hours by a disperser (¼ G sand grinder mill manufactured by Imex Company) to prepare a solid fine particle dispersion of the nucleus forming agent. 80 mass % of the particles had a grain size of 0.1 to 1.0 μm and the average grain size was 0.5 μm.

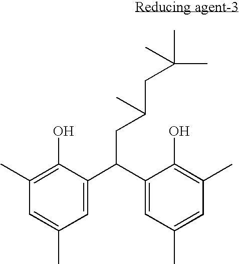

Table 2 shows obtained results. The sensitivity of each sample was expressed as a relative sensitivity given that the sensitivity the specimen 24 was 100.

TABLE 2

| | | Sphere | | | | | | |
|---|---|---|---|---|---|---|---|---|
| | | equiv. | | | | | | |
| Specimen | AgX | diameter | Thickness | | | | Image | |
| No. | Composition | (μm) | (μm) | Sensitivity | Fogging | Haze | storability | Remarks |
| 21 | AgI | 0.70 | 0.04 | 106 | 0.18 | A | 0.02 | Invention |
| 22 | AgI | 0.70 | 0.049 | 121 | 0.18 | A | 0.03 | Invention |
| 23 | AgI | 0.70 | 0.12 | 135 | 0.2 | A | 0.04 | Invention |
| 24 | AgI | 0.70 | 0.51 | 100 | 0.21 | D | 0.06 | Comp. Example |
| 25 | AgI_{9D}Br₁₀ | 0.74 | 0.04 | 403 | 0.19 | A | 0.02 | Invention |
| 26 | AgI_{9D}Br₁₀ | 0.74 | 0.049 | 472 | 0.19 | A | 0.02 | Invention |
| 27 | AgI_{9D}Br₁₀ | 0.74 | 0.12 | 512 | 0.21 | B | 0.03 | Invention |
| 28 | AgI_{9D}Br₁₀ | 0.74 | 0.51 | 265 | 0.23 | D | 0.06 | Comp. Example |

It was found from Table 2 that, as the thickness of the planer particles is reduced, the properties such as sensitivity, fogging, haze and image storability are improved, as in Example 1. Accordingly, it was found that, in the case of photosensitive materials having a high silver iodide content, the photosensitive material preferably has a thickness of no more than 0.5 μm, and more preferably a thickness of no more than 0.2 μm to provide a photosensitive material with low fogging level, low haze level and excellent image storability. In addition, it was also found that sensitivity is further improved by providing epitaxial join for tabular grains.

In particular, it was found that, when the percentage of tabular grains in the emulsion having a high silver iodide content is high (the entire projected area of grains having an aspect ratio of 2 or more corresponds to 80% or more of the entire projected area of all the tabular grains), and when mono-dispersibility of the emulsion is satisfactory (coefficient of variation of 25% or less), sensitivity is especially high.

### Example 3

1. Preparation of Fluorescent Intensifying Screen

1) Preparation of Undercoat Layer

A light reflection layer made of an alumina powder and having a dry thickness of 50 μm was formed on a support made of polyethylene terephthalate and having a thickness of 250 μm in the same manner as in Example 2 of JP-A No. 2001-124898.

2) Preparation of Fluorescent Substance Sheet

250 g of BaFBr:Eu fluorescent substance (average grain size: 3.5 μm), 8 g of a polyurethane binder resin (Pandex T5265M (trade name) manufactured by Dai Nippon Ink and Chemicals Incorporated), 2 g of an epoxy binder resin (Epicoat 1001 (trade name) manufactured by Yuka Shell Epoxy Co.) and 0.5 g of an isocyanate compound (Colonate HX (trade name) manufactured by Nippon Polyurethane Industry Co., Ltd.) were added to methyl ethyl ketone, and the resultant mixture was stirred by a propeller mixer to prepare a coating liquid for forming a fluorescent substance layer having a viscosity of 25 PS at 25° C. The coating solution was coated on a surface of a provisional support (a polyethylene terephthalate sheet previously coated with a silicone releasing agent), and the resultant coating was dried to form a fluorescent substance layer. The fluorescent substance layer was peeled off from the provisional support to form a fluorescent substance sheet.

3) Provision of Fluorescent Substance Sheet on Light Reflection Layer

The fluorescent substance sheet was put on the surface of the light reflection layer disposed on the support and manufactured in step 1), the resultant was pressed by a calendar roll under a pressure of 400 kgw/cm² at 80° C. to dispose the fluorescent substance layer on the light reflection layer. The thickness of the fluorescent substance layer was 125 μm and the volume filling rate of the fluorescent particles was 68%.

4) Formation of Surface Protective Layer

A polyester adhesive was applied to one surface of a polyethylene terephthalate (PET) film having a thickness of 6 μm, and the resultant was bonded to the fluorescent substance layer by a lamination method so as to form a surface protective layer. A fluorescence intensifying screen A having the support, the light reflection layer, the fluorescent substance layer and the surface protection layer was thus obtained.

5) Light Emitting Characteristics

FIG. 1 shows an emission spectrum of an intensifying screen A measured by using X-rays at 40 kVp. The fluorescent intensifying screen A showed emission having a peak at 390 nm and narrow half breadth.

2. Evaluation of Performance

Evaluation was made in the same manner as in Example 2 except that the specimens of Example 2 were used and that the screen used at the time of exposure was replaced with the intensifying screen A. As a result, excellent images were obtained by using the specimen of the invention, as in Example 2.

### Example 4

1. Preparation of Fluorescent Intensifying Screen

Fluorescent intensifying screens C, D and E were manufactured in the same manner as preparation of the fluorescent screen A except that the coating amount of the fluorescent substance coating liquid was changed. Table 3 shows the thickness of the fluorescent substance layer and the volume filling rate of the fluorescent substance in the obtained fluorescent intensifying screen.

TABLE 3

| Fluorescent | | Thickness of | | |
|---|---|---|---|---|
| intensifying | Fluorescent | fluorescent | | Volume filling rate of |
| screen | substance | substance layer | | fluorescent substance |
| A | BaFBr:Eu | 125 | μm | 68% |
| C | BaFBr:Eu | 70 | μm | 70% |
| D | BaFBr:Eu | 160 | μm | 66% |
| E | BaFBr:Eu | 250 | μm | 64% |

2. Evaluation for Performances

Each of the photothermographic materials used in Example 3 was exposed to X-rays in the same manner as in Example 3 except that the fluorescent intensifying screen A was replaced with each combination of screens described below. The front screen herein is a screen disposed nearer to the X-ray source than the photothermographic material, and the back screen is a screen disposed farther from the X-ray source than the photothermographic material.

As in Example 3, preferred results were obtained by using the specimens of the invention.

TABLE 4

| Front screen | Back screen |
|---|---|
| A | A |
| C | C |
| C | A |
| C | D |
| C | E |
| A | E |

### Example 5

1. Preparation of Photosensitive Silver Halide Emulsion

1) Preparation of Silver Halide Emulsion 1′

4.3 mL of a 1 mass % potassium iodide solution, 3.5 mL of 0.5 mol/L sulfuric acid, 36.5 g of phthalated gelatin and 160 mL of a 5 mass % methanol solution of 2,2′-(ethylenedithio)diethanol were added to 1421 mL of distilled water. The resulting solution was kept at 75° C. in a reaction vessel made of stainless steel while it was being stirred. Separately, a solution A was prepared by diluting 22.22 g of silver nitrate with distilled water so that the total amount of the resultant became 218 mL, and a solution B was prepared by diluting 36.6 g of potassium iodide with distilled water so that the total amount of the resultant became 366 mL. The entire amount of the solution A and the entire amount of the solution B were added to the reaction system by a controlled double jet method. At this time, the solution A was added at a constant flow rate over 32 minutes. Moreover, the solution B was added while pAg of the system was kept at 10.2. Then, 10 mL of a 3.5 mass % aqueous solution of hydrogen peroxide, and 10.8 mL of a 10 mass % aqueous solution of benzimidazole were further added to the system. Thereafter, a solution C was prepared by diluting 51.86 g of silver nitrate with distilled water so that the total amount of the resultant became 508.2 mL, and a solution D was prepared by diluting 63.9 g of potassium iodide with distilled water so that the total amount of the resultant became 639 mL. The entire amount of the solution C and the entire amount of the solution D were added to the system by a controlled double jet method. At this time, the solution C was added at a constant flow rate over 160 minutes. Moreover, the solution D was added while pAg of the system was kept at 10.2. When 20 minutes had lapsed since the starting of the addition of the solutions C and D, potassium hexachloroiridate (III) was added to the system in an amount of 1×10⁻⁴ mol per mol of silver. Further, when five seconds had lapsed since completion of the addition of the solution C, an aqueous solution of potassium iron (II)hexacyanide was added to the system in an amount of 3×10⁻⁴ mol per mol of silver. 0.5 mol/L sulfuric acid was added to the system so as to adjust pH of the system at 3.8. Then, stirring was stopped, and precipitating/desalting/washing steps were carried out. One mol/L sodium hydroxide was added to the system so as to adjust pH of the system at 5.9, and a silver halide dispersion having pAg of 11.0 was thus prepared.

Silver halide grains in the obtained silver halide dispersion were made of pure silver iodide, and included tabular grains having an average projected area diameter of 0.86 μm, a coefficient of variation of the average projected area diameter of 17.7%, an average thickness of 0.045 μm, and an average aspect ratio of 19.1. The entire projected area of the tabular grains corresponded to 80% or more of the entire projected area of all the silver halide grains. The sphere equivalent diameter thereof was 0.37 μm. A result of X-ray powder diffraction analysis showed that 90% or more of the silver iodide had gamma phase.

2) Preparation of Silver Halide Emulsions 2′ to 6′

Silver halide emulsions 2′ to 4′ having different average thickness different were prepared in the same manner as preparation of silver halide emulsion 1′ except that temperature in the reaction vessel, pAg at at the time of addition of the solutions C and D, and pH in the reaction vessel were suitably changed. The silver halide grains in each of the resultant silver halide emulsions were made of pure silver iodide. The sizes of the grains in each of the emulsions are shown in Table 5. Further, silver halide emulsions 5′ and 6′ respectively having an average thickness of 0.080 μm and 0.177 μm were prepared in the same manner as preparation of the silver halide emulsion 1′ except that temperature in the reaction vessel, pAg at the time of addition of the solutions C and D, and pH in the reaction vessel were suitably changed. The silver halide grains in each of the resultant silver halide emulsions were made of pure silver iodide. The Sizes of the grains in each of the emulsions are also shown in Table 5.

TABLE 5

| | | Average Projected | Average | | Average Sphere | |
|---|---|---|---|---|---|---|
| Emulsion | Composition | Area Diameter | Thickness | | equivalent Diameter | |
| No | (mole ratio) | (μm) | (μm) | Aspect Ratio | (μm) | Remarks |
| 1′ | AgI 90, Br 10 | 0.86 | 0.045 | 19.1 | 0.37 | The invention |
| 2′ | AgI 90, Br 10 | 0.93 | 0.057 | 16.3 | 0.42 | The invention |
| 3′ | AgI 90, Br 10 | 1.08 | 0.140 | 7.7 | 0.63 | The invention |
| 4′ | AgI 90, Br 10 | 1.11 | 0.155 | 7.1 | 0.66 | The invention |
| 5′ | AgI 90, Br 10 | 1.12 | 0.080 | 14.0 | 0.53 | Comparative |
| | | | | | | example |
| 6′ | AgI 90, Br 10 | 1.15 | 0.177 | 6.5 | 0.71 | Comparative |
| | | | | | | example |

### Example 6

1. Preparation of Support

1) Undercoat

Each surface of a biaxially oriented, blue-colored (1,4-bis(2,6-diethylanilinoanthraquinone)-containing) polyethylene terephthalate support having a thickness of 175 μm was subjected to corona discharge treatment, and coated with respective coating liquids for a first undercoat layer and a second undercoat layer containing following main components in this order by using a wire bar coater.

First Undercoat Layer (Support Side)

The amount of the coating liquid was set at 4.9 mL per m² of each side of the support. The coating amounts of respective materials per m² of each side of the support were as follows.

| | | |
|---|---|---|
| Styrene-butadiene copolymer latex | 0.31 | g |
| (in terms of solid content) | | |
| 2,4-dichloro-6-hydroxy-s-triazine sodium | 8 | mg |

The coated support was dried at 190° C.

Second Undercoat layer

The amount of the coating liquid was set at 7.9 mL per m² of each side of the support. The coating amounts of respective materials per m² of each side of the support were as follows.

| | | |
|---|---|---|
| Gelatin | 80 | mg |
| C₁₂H₂₅O(CH₂CH₂O)₁₀H | 1.8 | mg |
| Antiseptic agent D | 0.27 | mg |
| Matting agent | 2.5 | mg |

(polymethyl methacrylate particles having an average particle size of 2.5 μm)

The coated support was dried at 185° C.

2. Preparation of Coated Sample

1) Preparation of Coating Liquid for Dye Layer

Preparation of Wet Cake of Dye for Crossover Cut

Dye A (solid content 10 g) was added to a mixed solvent containing 150 mL of methanol and 50 mL of water. The resultant mixture was stirred for 2 hours while it was kept at 70° C. A wet cake of the dye was thus prepared. The wet cake of the dye contained 1 mol of methanol and 2 mol of water with respect to mol of the dye. In confirmation of the composition, a part of the wet cake was dried at room temperature. Then, ¹H-NMR measurement was conducted and thereby presence of methanol in the crystal could be confirmed. Moreover, a Karl-Fisher titration method was also conducted and presence of crystallization water could be confirmed. Further, it was also confirmed that, when the crystal was heated at 150° C., methanol and crystallization water in the crystal were released. From these results, solid concentration of the dye in the wet cake was found to be 50 mass %.

Method for Preparing Fine particle Aqueous Dispersion of Wet Cake

The dye in the form of wet cake was treated as a wet cake without being dried and weighed 3.0 g thereof as a solid dye. Water for dispersion was previously mixed with 1.2 g of a 25 mass % solution of a dispersing agent, Demol SNB (manufactured by Kao Corporation), and the weighed dye was added to the resultant solution. Additional water was added to the resulting dispersion so that the total weight of the resultant became 30 g. Then the resultant was sufficiently stirred to form slurry. 120 g of zirconia beads were prepared and the slurry and the beads were put into a vessel. Then, the slurry and the beads were stirred with a sand grinder mill of 1/16 gallon (manufactured by Imex Corporation) at a rotational speed of 1500 rpm while the vessel was cooled with water. The zirconia beads had an average particle diameter of 1 mm and the stirring was performed for 8 hours. After completion of the stirring, water was added to the resultant dispersion so that the solid content of the dye in the dispersion became 5 mass %. Then, a desired dispersion liquid was obtained.

Method for Preparing Coating Liquid for Dye Layer

Compounds were added to a water mother liquor in the following order so as to obtain the following coating amounts. The coating amounts of the respective compounds are those per m² of one side of the support.

| | | |
|---|---|---|
| Gelatin | 0.47 | g |
| Fine particle aqueous dispersion | 8.4 | mg |
| of wet cake (in terms of solid content of dye) | | |
| Sodium polystyrenesulfonate | 10 | mg |
| (average molecular weight: 600000) | | |
| Compound A-1 | 5 | mg |
| Antiseptic agent D | 1 | mg |

At this time, a small amount of acetic acid or sodium hydroxide was added to the resultant coating liquid so as to adjust pH of the coating liquid at 6.0. 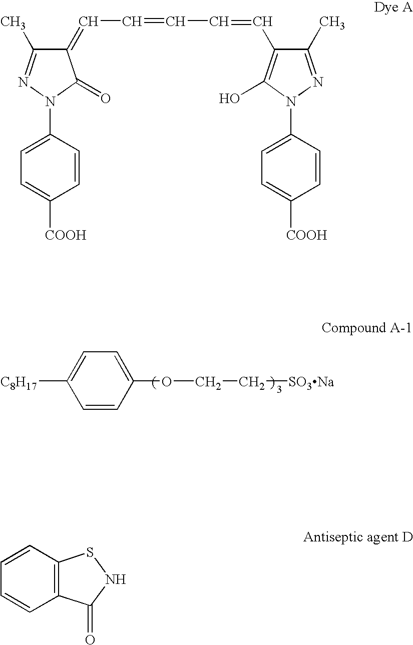
2) Preparation of Silver Halide Photosensitive Layer
Preparation of Photosensitive Silver Halide Emulsion

The silver halide emulsion 1′ of Example 5 was placed in a reaction vessel in an amount of one mole. A 0.5 mol/L KBr solution and 0.5 mol/L AgNO₃ solution were added to the emulsion by the double jet method over 20 minutes at 10 mL/minute to allow substantially 10 mol % of silver bromide to epitaxially deposit on the AgI host grains. During this operation, pAg of the reaction system was kept at 10.2. Further, 0.5 mol/L sulfuric acid was added to the system so as to adjust pH of the system at 3.8. Then stirring was stopped, and precipitating/desalting/washing steps were carried out. One mol/L sodium hydroxide was added to the system so as to adjust pH of the system at 5.9 and then a silver halide dispersion having pAg of 11.0 was prepared.

Five mL of a 0.34 mass % methanol solution of 1,2-benzoisothiazoline-3-one was added to the silver halide dispersion which was kept at 38° C. and was being stirred. Forty minutes later, the temperature of the system was raised to 47° C. When 20 minutes lapsed since increase of temperature, a methanol solution of sodium benzenethiosulfonate was added to the system in an amount of 7.6×10⁻⁵ mol per mol of silver. Additional 5 minutes later, a methanol solution of tellurium-including sensitizer C was added to the system in an amount of 2.9×10⁻⁵ mol per mol of silver and then the system was aged for 91 minutes. Subsequently, 1.3 mL of a 0.8 mass % methanol solution of N,N′-dihydroxy-N″,N″-diethylmelamine was added to the system. Additional 4 minutes later, a methanol solution of 5-methyl-2-mercaptobenzoimidazole was added to the system in an amount of 4.8×10⁻³ mol per mol of silver, and a methanol solution of 1-phenyl-2-heptyl-5-mercapto-1,3,4 -triazole was also added in an amount of 5.4×10⁻³ mol per mol of silver, and an aqueous solution of 1-(3-metylureidophenyl)-5-mercaptotetrazole was also add in an amount of 8.5×10⁻³ mol per mol of silver to prepare a silver halide emulsion 7′.

Silver halide grains in the obtained silver halide dispersion were grains having a high silver iodide content and containing 10 mol % of silver bromide, and included tabular grains having an average projected area diameter of 0.86 μm, a coefficient of variation of the average projected area diameter of 17.7%, an average thickness of 0.045 σm, and an average aspect ratio of 19.1. The entire projected area of the tabular grains corresponded to 80% or more of the entire projected area of all the silver halide grains. The sphere equivalent diameter thereof was 0.37 μm. A result of X-ray powder diffraction analysis showed that 90% or more of the silver iodide had gamma phase.

Preparation of Coating Liquid for Photosensitive Layer

The following components were added to the silver halide emulsion so as to obtain the following coating amounts. The coating amounts are those per m² of one side of the support.

| | |
|---|---|
| Coating amount of silver | 1.8 g |
| Gelatin | 1.7 g |
| Dextran | 428 mg |
| (average molecular weight: 39000) | |
| Sodium polystyrenesulfonate | 40 mg |
| (average molecular weight: 600000) | |
| Compound A-2 | 204 mg |
| Compound A-3 | 2.2 mg |
| Compound A-4 | 0.5 mg |
| Compound A-5 | 2.8 mg |
| 1,2-Bis(vinylsulfonylaceatmide)ethane | 50 mg |

A-2

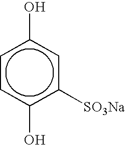

A-3

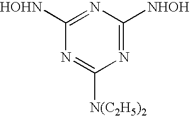

A-4

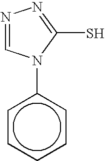

A-5

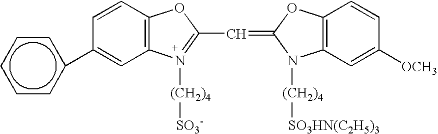

Dye-1

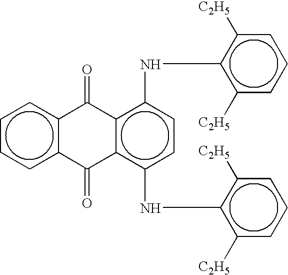

3) Preparation of Coating Liquid for Surface Protective Layer

The following compounds were mixed so as to obtain the following coating amounts.

Coating amounts of compounds per m² of one side of support

| | | |
|---|---|---|
| Gelatin | 0.767 | g |
| Sodium polyacrylate | 80 | mg |
| (average molecular weight: 400000) | | |
| Sodium polystyrenesulfonate | 1.1 | mg |
| (average molecular weight: 600000) | | |
| Matting agent-1 (in terms of solid content) | 70 | mg |
| (average particle size: 3.7 μm) | | |
| Compound A-6 | 18.1 | mg |
| Compound A-7 | 34.5 | mg |
| Compound A-8 | 6.8 | mg |
| Compound A-9 | 3.2 | mg |
| Compound A-10 | 1.4 | mg |
| Compound A-11 | 2.1 | mg |
| Compound A-12 | 1.0 | mg |
| Antiseptic agent D | 0.9 | mg |
| p-Benzoquinone | 0.7 | mg |

At this time, a small amount of sodium hydroxide was added to the coating liquid for surface protective layer so as to adjust pH of the coating liquid at 6.8. 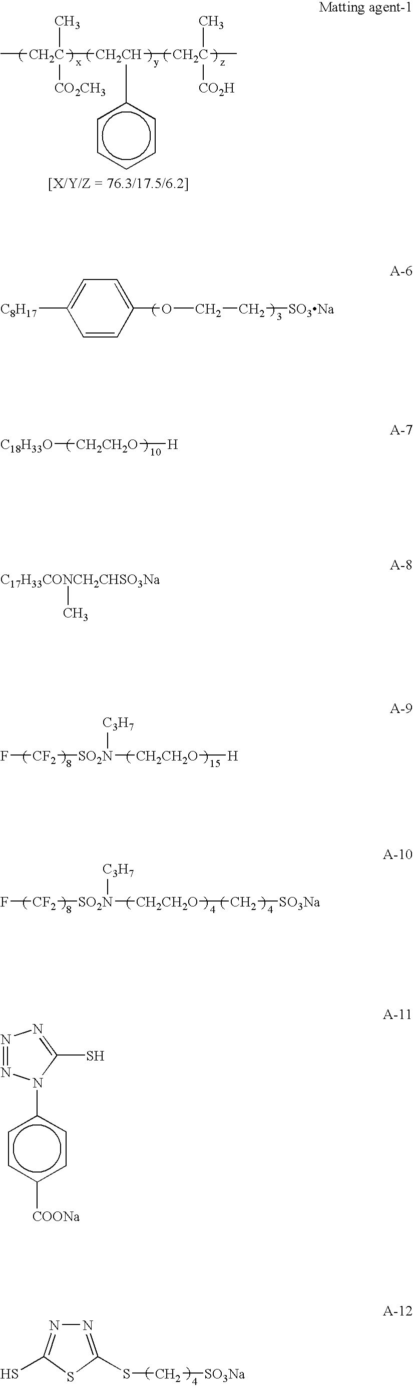
4) Coating of Sample

Both sides of the undercoated support were simultaneously coated with the coating liquid for dye layer, the coating liquid for silver halide photosensitive layer and the coating liquid for surface protective layer by a simultaneous extrusion method in that order, and the resultant coatings were dried. The amounts of the coating liquid for the dye layer, that for the photosensitive layer, and that for the surface protective layer were 12.4 mL, 45.2 mL, and 10.7 mL per m² of one side of the support, respectively.

3. Evaluation

1) Exposure and Development

The double-sided photosensitive material thus prepared was evaluated as follows.

The sample was sandwiched between two X-ray regular screens (HI-SCREEN B3 manufactured by Fuji Photo Film Co., Ltd., containing CaWO₄ as a fluorescent substance and having a peak emission wavelength of 425 nm) to form an assembly for image formation. The assembly was exposed to x-rays for 0.05 seconds and subjected to X-ray sensitometry. The X-ray apparatus used was DRX-3724HD (trade name) manufactured by Toshiba Corporation and having a tungsten target. Voltage of 80 KVp was applied to three phases with a pulse generator to generate X-rays and the X-rays were made to pass through a filter of water having a thickness of 7 cm, which filter absorbed X-rays in nearly the same amount as that of X-rays which the human body absorbs, to form an X-ray source. While an X-ray exposure amount was varied by varying the distance between the assembly and the X-ray source, the material was exposed stepwise at an interval of logE=0.15. After exposure, the material was thermally developed by using an automatic developing apparatus, CEPROS-M2 (manufactured by Fuji Photo Film Co., Ltd.), and a developer solution, CE-D1 (manufactured by Fuji Photo Film), for 5 minutes.

2) Evaluation Item

The densities of the obtained images were measured with a densitometer and characteristic curves of density relative to logarithm of the exposure amount were depicted. The optical density of an unexposed area (Dmin area) was defined as fogging level. As for fogging level, a smaller value is preferable.

Image Storability

The image formed above on each of the coated samples was stored for 24 hours while it was being exposed to light from a fluorescent lamp having illuminance of 1000 Lux. Increase in fogging density of the Dmin area, ΔDmin, was obtained and evaluated. A smaller value means a lower printout level, which stands for more excellent image storability.

Measurement of Sharpness

Contrast transfer function (CTF) was measured to evaluate sharpness.

MRE single-sided photographic material (manufactured by Eastman Kodak Co.) was brought into contact with an intensifying screen to be measured, and a rectangular chart (made of molybdenum, and having a thickness of 80 μm and a spatial frequency of 0 lp/mm to 10 lp/mm) for MTF measurement was photographed. The chart was placed at a position which was 2 m away from an X-ray vessel. The photographic material was sandwiched between two X-ray regular screens (HI-SCREEN B3 manufactured by Fuji Photo Film Co., Ltd., containing CaWO₄ as a fluorescent substance and having a peak emission wavelength of 425 nm), and the resultant assembly was arranged in position. The X-ray vessel was DRX-3724HD (trade name) manufactured by Toshiba Corporation and using a tungsten target. A focal spot size was set at 0.6 mm×0.6 mm. X-rays were generated through 3 mm thick aluminum equivalent material including a diaphragm. A voltage of 80 KV was applied to three phases with a pulse generator to generate X-rays and the X-rays were made to pass through a filter of water having a thickness of 7 cm, which filter absorbed X-rays in nearly the same amount as that of X-rays which the human body absorbs, to form an X-ray source. After exposure, the material was thermally developed by using an automatic developing apparatus, CEPROS-M2 (manufactured by Fuji Photo Film Co., Ltd.), and a developer solution, CE-D1 (manufactured by Fuji Photo Film), for 5 minutes. The exposure amount at the time of X-ray photography was adjusted so that the average of the highest and lowest densities of the developed image would be 1.0.

Subsequently, the sample to be measured was processed with a microdensitometer. At this time, density profile was measured at a sampling interval of 30 μm by using, as an aperture, a slit having a length of 30 μm in the operating direction and a length of 500 μm in a direction perpendicular to the operating direction. This procedure was repeated twenty times and the obtained values were averaged to obtain a density profile on which CTF calculation was based. Thereafter, the peak of the rectangular wave for each frequency in the density profile was detected and density contrast for each frequency was calculated. The measured values with respect to a spatial frequency of 2 lp/mm are shown in Table 6.

3) Evaluation Result

The obtained results are shown in Table 6.

As can be easily recognized from the data shown in Table 6, a photographic material that is exposed to light in a specific range of a spectrum can have improved CTF response when the thickness of the silver halide grains are selected such that light reflection level in the wavelength range becomes minimum. Further, as for absolute properties of the material, it was confirmed that the material has sharpness equal to that of prevailing photosensitive materials.

TABLE 6

| | | Average | Average | | Average Sphere | | | | |
|---|---|---|---|---|---|---|---|---|---|
| Emulsion | Composition | Projected Area | Thickness | Aspect | equivalent Diameter | | Image | Sharpness | |
| No | (mole ratio) | Diameter (μm) | (μm) | Ratio | (μm) | Fogging | Storability | 2 lp/mm | Remarks |
| 1′ | AgI 90, Br 10 | 0.86 | 0.045 | 19.1 | 0.368 | 0.17 | 0.01 | 0.323 | The invention |
| 2′ | AgI 90, Br 10 | 0.93 | 0.057 | 16.3 | 0.420 | 0.17 | 0.01 | 0.291 | The invention |
| 3′ | AgI 90, Br 10 | 1.08 | 0.140 | 7.7 | 0.626 | 0.18 | 0.01 | 0.301 | The invention |
| 4′ | AgI 90, Br 10 | 1.11 | 0.155 | 7.2 | 0.659 | 0.18 | 0.01 | 0.282 | The invention |
| 5′ | AgI 90, Br 10 | 1.12 | 0.080 | 14.0 | 0.532 | 0.18 | 0.01 | 0.203 | Comparative |
| | | | | | | | | | example |
| 6′ | AgI 90, Br 10 | 1.15 | 0.177 | 6.5 | 0.705 | 0.18 | 0.01 | 0.186 | Comparative |
| | | | | | | | | | example |
| RX-U | — | — | — | — | — | 0.17 | 0.01 | 0.289 | Comparative |
| | | | | | | | | | example |

### Example 7

1. Preparation of PET Support and Undercoat

1-1. Film Formation

PET was made of terephthalic acid and ethylene glycol in an ordinary manner and had an intrinsic viscosity IV of 0.66 (measured in a mixture of phenol and tetrachloroethane at a weight ratio of 6/4 at 25° C.). This was pelletized, and the resultant was dried at 130° C. for 4 hours. This pellet was colored with a blue dye, 1,4-bis(2,6,-diethylanilinoanthraquinone) and the resultant was extruded out from a T-die, and rapidly cooled. Thus, a non-oriented film was prepared.

The film was longitudinally oriented by rolls rotating at different circumferencial speeds at 110° C. so that the longitudinal length thereof after the orientation was 3.3 times as long as the original longitudinal length thereof. Next, the film was laterally oriented by a tenter at 130° C. so that the lateral length thereof after the orientation was 4.5 times as long as the original lateral length thereof. Next, the oriented film was thermally fixed at 240° C. for 20 seconds, and then laterally relaxed by 4% at the same temperature. Next, the chuck portion of the tenter was slitted, and the both edges of the film were knurled, and the film was rolled up at 4 kg/cm². The rolled film having a thickness of 175 μm was obtained.

1-2. Corona Processing of Surface

Both surfaces of this support were processed at a rate of 20 m/minute at room temperature by using a solid state corona processing machine (6 KVA model manufactured by Pillar Company). From values of current and voltage read at this time, it was found that the support had been processed at 0.375 kV.A.min/m². At this time, the processing frequency was 9.6 kHz, and a gap clearance between an electrode and a dielectric roll was 1.6 mm.

1-3. Preparation of Undercoated Support

(1) Preparation of Coating Liquid for Undercoat Layer

Formulation (a) (for undercoat layer on photosensitive layer side)

| Formulation (a) (for undercoat layer | | |
|---|---|---|
| on photosensitive layer side) | | |
| Pesresin A-520 | 46.8 | g |
| (manufactured by Takamatsu Oil and Fats Co., Ltd.; | | |
| 30 mass % solution) | | |
| Vylonal MD-1200 | 10.4 | g |
| (manufactured by Toyobo Co., Ltd.) | | |
| Polyethylene glycol monononyl phenyl ether | 11.0 | g |
| (average ethylene oxide number = 8.5 , 1 mass % | | |
| solution) | | |
| MP-1000 | 0.91 | g |
| (manufactured by Soken chemical & Engineering Co., | | |
| Ltd.; fine particles of PMMA polymer, | | |
| average particle size: 0.4 μm) | | |
| Distilled water | 931 | mL |

Each surface of the biaxially-oriented polyethylene terephthalate support having a thickness of 175 μm which had been subjected to the above-described corona discharge treatment was coated with the coating liquid for the under coat having formulation (a) with a wire bar such that a wet coating amount became 6.6 ml/m² (per one side). Each of the resultant coatings was dried at 180° C. for 5 min. Thus, an undercoated support was prepared.

2. Preparation of Materials for Coating

1) Silver Halide Emulsion

Preparation of Silver Halide Emulsions 1′ to 6′ for Coating Liquid

As silver halide emulsions, the silver halide emulsions 1′ to 6′ prepared in Example 6 were used.

2) Preparation of Dispersion of Fatty Acid Silver Salt

Preparation of Recrystallized Behenic Acid

100 kg of behenic acid manufactured by Henkel Co. (trade name of product: Edenor C22-85R) was dissolved in 1200 kg of isopropyl alcohol at 50° C., and the resultant solution was filtered through a filter having a pore size of 10 μm and then cooled to 30° C. to recrystallize behenic acid. The cooling rate in the recrystallization was controlled to 3° C./hour. The solution was centrifugally filtered to collect recrystallized crystals, and the crystals were washed with 100 kg of isopropyl alcohol and then dried. The obtained crystals were esterified and the resultant was measured by GC-FID. The resultant had a behenic acid content of 96 mol % and, in addition, included 2 mol % of lignoceric acid, 2 mol % of archidic acid and 0.001 mol % of erucic acid.

Preparation of Dispersion of Silver Salt of Fatty Acid

88 kg of recrystallized behenic acid, 422 L of distilled water, 49.2 L of a 5 mol/L aqueous NAOH solution and 120 L of t-butyl alcohol were mixed and reacted at 75° C. for one hour while the resultant system was being stirred. Thus, a sodium behenate solution B was obtained. Separately, 206.2 L of an aqueous solution (pH 4.0) containing 40.4 kg of silver nitrate was prepared and kept at 10° C. A reaction vessel containing 635 L of distilled water and 30 L of t-butyl alcohol was kept at 30° C. The entire amount of the sodium behenate solution and the entire amount of the aqueous solution of silver nitrate were added to the content of the vessel at constant flow rates over 93 minutes and 15 seconds and over 90 minutes, respectively, while the content in the vessel was being sufficiently stirred. At this time, only the aqueous solution of silver nitrate was added for 11 minutes after starting the addition of the aqueous solution of silver nitrate, addition of sodium behenate solution was started subsequently, and only the sodium behenate solution was added for 14 minutes and 15 seconds after completion of the addition of the aqueous solution of silver nitrate. At this time, the internal temperature of the reaction vessel was kept at 30° C. The external temperature was controlled such that the liquid temperature was constant. The pipe line for the sodium behenate solution was a double-walled pipe and thermally insulated by circulating hot water through the interspace of the double-walled pipe, and the temperature of the solution at the outlet of the nozzle tip was adjusted at 75° C. The pipe line for the aqueous silver nitrate solution was also a double-walled pipe and thermally insulated by circulating cold water through the interspace of the double-walled pipe. The position at which the sodium behenate solution was added to the reaction system and that at which the aqueous silver nitrate solution was added thereto were disposed symmetrically relative to the shaft of the stirrer disposed in the reactor, and the nozzle tips of the pipes were spaced apart from the reaction solution level in the reactor.

After adding the sodium behenate solution was finished, the reaction system was stirred for 20 minutes at that temperature, and then heated to 35° C. over 30 minutes. Thereafter, the system was aged for 210 minutes. Immediately after completion of the ageing, the system was centrifugally filtered to collect a solid component, which was washed with water until the conductivity of the washing waste reached 30 μS/cm. The solid thus obtained was a silver salt of a fatty acid and was stored as wet cake without drying it.

The shapes of the silver behenate particles obtained herein were analyzed on the basis of their images taken through electronmicroscopic photography. Average values of a, b, and c were 0.21 μm, 0.4 μm and 0.4 μm, respectively (a, b and c are defined hereinabove). An average aspect ratio was 2.1. A coefficient of variation of sphere equivalent diameters of the particles was 11%.

19.3 kg of polyvinyl alcohol (trade name, PVA-217) and water were added to the wet cake whose amount corresponded to 260 kg of the dry weight thereof so that the total amount of the resultant became 1000 kg. The resultant was formed into slurry with a dissolver wing, and then pre-dispersed with a pipe-line mixer (Model PM-10 available from Mizuho Industry Co.).

Next, the pre-dispersed stock slurry was processed three times in a disperser (MICROFLUIDIZER M-610 obtained from Microfluidex International Corporation, and equipped with a Z-type interaction chamber) at a controlled pressure of 1150 kg/cm². A silver behenate dispersion was thus prepared. To cool it, corrugated tube type heat exchangers were disposed before and behind the interaction chamber. The temperature of the coolant in these heat exchangers was so controlled that the system could be processed at a dispersion temperature of 18° C.

3) Preparation of Reducing Agent Dispersion

Preparation of of Reducing Agent-1 Dispersion

10 kg of a reducing agent-1 (2,2′-methylenebis-(4 -ethyl-6-tert-butylphenol)), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) including zirconia beads which had a mean diameter of 0.5 mm, and dispersed therewith for 3 hours. Then, 0.2 g of sodium salt of benzoisothiazolinone and water were added thereto to adjust the reducing agent concentration of the resultant at 25% by mass. The dispersion was heated at 60° C. for 5 hours. A reducing agent-1 dispersion was thus prepared. The reducing agent particles in the dispersion had a median diameter of 0.40 μm, and a maximum particles size of at most 1.4 μm. The reducing agent dispersion was filtered through a polypropylene filter having a pore size of 3.0 μm to remove foreign objects such as dirt from it, and then stored.

Preparation of Reducing Agent-2 Dispersion

10 kg of a reducing agent-2 (6,6′-di-t-butyl-4,4′-dimethyl-2,2′-butylidenediphenol), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) including zirconia beads which had a mean diameter of 0.5 mm, and dispersed therewith for 3 hours and 30 minutes. Then, 0.2 g of sodium salt of benzoisothiazolinone and water were added thereto to adjust the reducing agent concentration of the resultant at 25% by mass. The dispersion was then heated at 40° C. for 1 hour, and then at 80° C. for 1 hour. A reducing agent-2 dispersion was thus prepared. The reducing agent particles in the dispersion had a median diameter of 0.50 μm, and a maximum particle size of at most 1.6 μm. The reducing agent dispersion was filtered through a polypropylene filter having a pore size of 3.0 μm to remove foreign objects such as dirt from it, and then stored.

4) Preparation of Hydrogen Bonding Compound Dispersion

Preparation of Hydrogen Bonding Compound-1 Dispersion

10 kg of a hydrogen bonding compound-1 (tri(4-t-butylphenyl)phosphine oxide), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) containing zirconia beads which had a mean diameter of 0.5 mm, and dispersed therewith for 4 hours. Then, 0.2 g of sodium salt of benzoisothiazolinone and water were added thereto to adjust the hydrogen bonding compound concentration of the resultant at 25% by mass. The dispersion was heated at 40° C. for 1 hour and then at 80° C. for 1 hour. A hydrogen bonding compound-1 dispersion was thus prepared. The hydrogen bonding compound particles in the dispersion had a median diameter of 0.45 μm, and a maximum particle size of at most 1.3 μm. The hydrogen bonding compound dispersion was filtered through a polypropylene filter having a pore size of 3.0 μm to remove foreign objects such as dirt from it, and then stored.

5) Preparation of Development Accelerator Dispersion and Color-Toning Agent Dispersion

Preparation of Development Accelerator-1 Dispersion

10 kg of a development accelerator-1, 20 kg of a 10 mass % solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) containing zirconia beads which had a mean diameter of 0.5 mm, and dispersed therewith for 3 hours and 30 minutes. Then, 0.2 g of sodium salt of benzoisothiazolinone and water were added thereto to prepare a development accelerator-1 dispersion having a development accelerator concentration of 20% by mass. The development accelerator particles in the dispersion had a median diameter of 0.48 μm, and a maximum particle size of at most 1.4 μm. The development accelerator dispersion was filtered through a polypropylene filter having a pore size of 3.0 μm to remove foreign objects such as dirt from it, and then stored.

Preparation of Development Accelerator-2 Dispersion and Color Toning Agent-1 Solid Dispersion

Development accelerator-2 and color toning agent-1 solid dispersions respectively having concentrations of 20 mass % and 15 mass % were prepared in the same manner as the preparation of the development accelerator-1 dispersion.

6) Preparation of Polyhalogenated Compound Dispersion

Preparation of Organic Polyhalogenated Compound-1 Dispersion

10 kg of an organic polyhalogen compound-i (tribromomethanesulfonylbenzene), 10 kg of a 20 mass % aqueous solution of modified polyvinyl alcohol (POVAL MP203 available from Kuraray Co., Ltd.), 0.4 kg of a 20 mass % aqueous solution of sodium triisopropylnaphthalenesulfonate, and 14 kg of water were sufficiently mixed to prepare slurry. The slurry was fed by a diaphragm pump into a horizontal sand mill (UVM-2 available from Imex Corporation) including zirconia beads which had a mean diameter of 0.5 mm, and dispersed therewith for 5 hours. Then, 0.2 g of sodium salt of benzoisothiazolinone and water were added thereto to prepare an organic polyhalogen compound-1 dispersion having an organic polyhalogen compound content of 30 mass %. The organic polyhalogen compound particles in the dispersion had a median diameter of 0.41 μm, and a maximum particle size of at most 2.0 μm. The organic polyhalogen compound dispersion was filtered through a polypropylene filter having a pore size of 10.0 μm to remove foreign objects such as dirt from it, and then stored.

Preparation of Organic Polyhalogenated Compound-2 Dispersion

10 kg of an organic polyhalogen compound-2 (N-butyl-3-tribromomethanesulfonylbenzamide), 20 kg of a 10 mass % aqueous solution of modified polyvinyl alcohol (POVAL MP203 available from Kuraray Co., Ltd.), and 0.4 kg of a 20 mass % aqueous solution of sodium triisopropylnaphthalenesulfonate were sufficiently mixed to prepare slurry. The slurry was fed by a diaphragm pump into a horizontal sand mill (UVM-2 available from Imex Corporation) including zirconia beads which had a mean diameter of 0.5 mm, and dispersed therewith for 5 hours. Then, 0.2 g of sodium salt of benzoisothiazolinone and water were added thereto to adjust the organic polyhalogen compound content of the resultant at 30 mass %. The dispersion was heated at 40° C. for 5 hours. An organic polyhalogen compound-2 dispersion was thus obtained. The organic polyhalogen compound particles in the dispersion had a median diameter of 0.40 μm, and a maximum particle size of at most 1.3 μm. The organic polyhalogen compound dispersion was filtered through a polypropylene filter having a pore size of 3.0 μm to remove foreign objects such as dirt from it, and then stored.

7) Preparation of Silver Iodide Complex-Forming Agent

8 kg of modified polyvinyl alcohol MP203 was dissolved in 174.57 kg of water, and 3.15 kg of a 20 mass % aqueous solution of sodium triisopropylnaphthalenesulfonate and 14.28 kg of a 70 mass % aqueous solution of 6-isopropylphthalazine were added to the resultant solution so as to prepare a 5 mass % solution of a silver iodide complex-forming compound.

8) Preparation of Mercapto Compound

Preparation of Aqueous Solution of Mercapto Compound-1

7 g of a mercapto compound-1 (1-(3-sulfophenyl)-5-mercaptotetrazole sodium salt) was dissolved in 993 g of water to form a 0.7 mass % aqueous solution.

Preparation of Aqueous Solution of Mercapto Compound-2

20 g of a mercapto compound-2 (1-(3-methylureidophenyl)-5-mercaptotetrazole) was dissolved in 980 g of water to form a 2.0 mass % aqueous solution.

9) Preparation of SBR Latex Liquid

An SBR latex was prepared as follows.

287 g of distilled water, 7.73 g of a surfactant (PIONIN A-43-S produced by Takemoto Yushi Corporation and having a solid content of 48.5 mass %), 14.06 ml of 1 mol/liter NaOH, 0.15 g of tetrasodium ethylenediaminetetraacetate, 255 g of styrene, 11.25 g of acrylic acid, and 3.0 g of tert-dodecylmercaptan were put into the polymerization reactor of a gas monomer reaction apparatus (TAS-2J Model available from Taiatsu Techno Corporation). The reactor was sealed off, and the content therein was stirred at 200 rpm. The internal air was exhausted via a vacuum pump, and replaced a few times repeatedly with nitrogen. Then, 108.75 g of 1,3-butadiene was introduced into the reactor under pressure, and the internal temperature of the reactor was raised to 60° C. A solution in which 1.875 g of ammonium persulfate was dissolved in 50 ml of water was added to the system, and the system was stirred for 5 hour. It was further heated to 90° C. and stirred for 3 hours. After the reaction was completed, the internal temperature was lowered to room temperature. Then, NaOH and NH₄OH (both 1 mol/liter) were added to the system at a molar ratio of Na⁺ and NH₄⁺ of 1/5.3 so as to adjust the pH of the system at 8.4. Next, the system was filtered through a polypropylene filter having a pore size of 1.0 μm to remove foreign objects such as dirt from it, and then stored. 774.7 g of SBR latex was thus obtained. Its halide ion content was measured through ion chromatography, and the chloride ion concentration of the latex was 3 ppm. The chelating agent concentration thereof was measured through high-performance liquid chromatography, and was 145 ppm.

The mean particle size of the latex was 90 nm, Tg thereof was 17° C., the solid content thereof was 44% by mass, the equilibrium moisture content thereof at 25° C. and 60% RH was 0.6 mass %, and the ion conductivity thereof was 4.80 mS/cm. To measure the ion conductivity, a conductivity meter CM-30S manufactured by To a Denpa Kogyo K. K. was used. In the device, the 44 mass % latex was measured at 25° C. Its pH was 8.4.

2-2. Preparation of Coating Liquid

1) Preparation of Coating Liquid-1′ to −10′ for Image-Forming Layer

The organic polyhalogen compound-1 dispersion, the organic polyhalogen compound-2 dispersion, the SBR latex (Tg: 17° C.) liquid, the reducing agent-1 dispersion, the reducing agent-2 dispersion, the hydrogen bonding compound-1 dispersion, the development accelerator-1 dispersion, the development accelerator-2 dispersion, the color toning agent-1 dispersion, the aqueous solution of mercapto compound-1, and the aqueous solution of mercapto compound-2 were successively added to 1,000 g of the dispersion of the silver salt of the fatty acid obtained above and 276 ml of water. Then, the silver iodide complex-forming agent was added to the resultant. Just before coating, each of the silver halide emulsion-1′ to −10′ for coating liquid was added to and sufficiently mixed with the above mixture so that the amount of silver of the emulsion became 0.22 mol per mol of silver salt of fatty acid. Coating liquids-1′ to −10′ for the image-forming layer was thus prepared and each of them was fed as it is to a coating die.

2) Preparation of Coating Liquid for Intermediate Layer

27 ml of a 5 mass % aqueous solution of AEROSOL OT (available from American Cyanamid Company), 135 ml of a 20 mass % aqueous solution of diammonium phthalate and water were added to 1000 g of polyvinyl alcohol (PVA-205 available from Kuraray Co., Ltd.), and 4200 ml of a 19 mass % latex of a methyl methacrylate/styrene/butyl acrylate/hydroxyethyl methacrylate/acrylic acid copolymer (copolymerization weight ratio: 64/9/20/5/2) so that the total amount of the resultant mixture became 10000 g. The pH of the mixture was adjusted at 7.5 by adding NaOH to the mixture. A coating liquid for intermediate layer was thus obtained. This was fed into a coating die so that the amount of the coating liquid was 9.1 ml/m².

The viscosity of the coating liquid was 58 mPa·S when measured with a B-type viscometer (rotor No. 1, 60 rpm) at 40° C.

3) Preparation of Coating Liquid for First Surface Protective Layer

64 g of inert gelatin was dissolved in water, and 112 g of a 19.0 mass % latex of a methyl methacrylate/styrene/butyl acrylate/hydroxyethyl methacrylate/acrylic acid copolymer (copolymerization weight ratio: 64/9/20/5/2), 30 ml of a 15 mass % methanol solution of phthalic acid, 23 ml of a 10 mass % aqueous solution of 4-methylphthalic acid, 28 ml of 0.5 mol/L sulfuric acid, 5 ml of a 5 mass % aqueous solution of AEROSOL OT (available from American Cyanamid Company), 0.5 g of phenoxyethanol, 0.1 g of benzoisothiazolinone, and water were added to the resultant solution so that the total amount of the resultant mixture became 750 g. Just before application thereof, 26 ml of 4 mass % chromium alum was mixed with the mixture by using a static mixer. The resultant coating liquid was fed into a coating die so that the amount of the resultant coating was 18.6 ml/m².

The viscosity of the coating liquid was 20 mPa·S when measured with a B-type viscometer (rotor No. 1, 60 rpm) at 40° C.

4) Preparation of Coating Liquid for Second Surface Protective Layer

80 g of inert gelatin was dissolved in water, and 102 g of a 27.5 mass % latex of a methyl methacrylate/styrene/butyl acrylate/hydroxyethyl methacrylate/acrylic acid copolymer (copolymerization weight ratio: 64/9/20/5/2), 5.4 ml of a 2 mass % solution of a fluorine-containing surfactant (F-1), 5.4 ml of a 2 mass % aqueous solution of a fluorine-containing surfactant (F-2), 23 ml of a 5 mass % solution of AEROSOL OT (available from American Cyanamid Company), 4 g of fine polymethyl methacrylate particles (mean particle size thereof was 0.7 μm and distribution of volume-weighted average was 30%), 21 g of fine polymethyl methacrylate particles (mean particle size thereof was 3.6 μm and distribution of volume-weighted average was 60%), 1.6 g of 4-methylphthalic acid, 4.8 g of phthalic acid, 44 ml of 0.5 mol/L sulfuric acid, 10 mg of benzoisothiazolinone, and water were added to the resultant solution so that the total amount of the resultant mixture became 650 g. Just before application thereof, 445 ml of an aqueous solution containing 4 mass % of chromium alum and 0.67 mass % of phthalic acid was mixed with the mixture by using a static mixer. A coating liquid for the surface protective layer was thus obtained. The coating liquid was fed into a coating die, with its flow rate so controlled that its coating amount was 8.3 ml/m².

The viscosity of the coating liquid was 19 mPa·S when measured with a B-type viscometer (rotor No. 1, 60 rpm) at 40° C.

4. Formation of Photothermographic Material-1′ to −10′

The coating liquid for image forming layer, the coating liquid for intermediate layer, the coating liquid for first surface-protective layer, and the coating liquid for second surface-protective layer were coated simultaneously by a slide bead coating method on the undercoat layer disposed on the support in that order to prepare specimens of heat-developable photosensitive materials. The temperatures of the coating liquid for image forming layer and the coating liquid for intermediate layer were controlled at 31° C., and the temperature of the coating liquid for first surface-protective layer was controlled at 36° C., and the temperature of the coating liquid for second surface-protective layer was controlled at 37° C. The coating amount of silver, which was the sum of the coating amount of silver of silver salt of fatty acid and that of silver of silver halide, in one image-forming layer was 0.821 g/m². Both sides of the support were coated according to the same formulation to form photothermographic materials-1′ to −10′. The photothermographic materials-1′ to −10′ corresponded to the coating liquids-1′ to −10′ for image-forming layer.

The coating amount (g/m²) of each compound in one image-forming layer was as follows.

| | |
|---|---|
| Silver behenate | 2.80 |
| Polyhalogenated compound-1 | 0.028 |
| Polyhalogenated compound-2 | 0.094 |
| Silver iodide complex-forming agent | 0.46 |
| SBR latex | 5.20 |
| Reducing agent-1 | 0.33 |
| Reducing agent-2 | 0.13 |
| Hydrogen bonding compound-1 | 0.15 |
| Development accelerator-1 | 0.005 |
| Development accelerator-2 | 0.035 |
| Color toning agent-1 | 0.002 |
| Mercapto compound-1 | 0.001 |
| Mercapto compound-2 | 0.003 |
| Silver halide (in terms of Ag) | 0.146 |

Coating and drying conditions are shown below.

Before coating, the static electricity of the support was eliminated by blowing an ion blow to the support. The coating speed was 160 m/minute. The coating and drying conditions for each sample were controlled within the range mentioned below so that the coated surface was stabilized to the best.

The distance between the coating die tip and the support was between 0.10 and 0.30 mm. The pressure in the decompression chamber was lower by 196 to 882 Pa than the atmospheric pressure. In the subsequent chilling zone, the coated support was chilled with an air blow (its dry-bulb temperature was 10 to 20° C.). In the next helix type contactless drying zone, the support was dried with a dry air blow (its dry-bulb temperature was 23 to 45° C., and its wet-bulb temperature was 15 to 21° C.). In this zone, the coated support to be dried was kept not in contact with the drier.

After the drying, the support was conditioned at 25° C. and 40 to 60% RH, and then heated so that the surface temperature was between 70 and 90° C. After the heating, the support was cooled to have a surface temperature of 25° C.

The degree of matting, in terms of the Bekk's smoothness, of the heat-developable photosensitive material thus prepared was 550 seconds on the image forming layer-coated surface thereof, and 130 seconds on the back layer. The pH of the image forming layer-coated surface of the sample was measured and was 6.0.

The chemical structure of each compound used in this Example is as illustrated previously.

4. Evaluation of Performance

1) Preparation

Each specimen thus prepared was cut into pieces of a half-size, packaged with a packaging material mentioned below at 25° C. and 50% RH, stored at ordinary temperature for two weeks, and tested according to a test method mentioned below.

Packaging Material

The packaging material used herein was a film including a PET film having a thickness of 10 μm, a PE film having a thickness of 12 μm, an aluminium foil having a thickness of 9 μm, a nylon film having a thickness of 15 μm, and a 3% carbon-containing polyethylene film having a thickness of 50 μm, and having an oxygen permeability of 0.02 ml/atm·m²·25° C. day and a moisture permeability of 0.10 g/atm·m²·25° C. day.

2) Exposure and Development

The double-side-coated photosensitive material prepared in this manner was evaluated as follows.

The sample was sandwiched between two X-ray regular screens (HI-SCREEN B3manufactured by Fuji Photo Film Co., Ltd., containing CaWO₄ as a fluorescent substance and having a peak emission wavelength of 425 nm) to form an assembly for image formation. The assembly was exposed to X-rays for 0.05 seconds and subjected to X-ray sensitometry. The X-ray apparatus used was DRX-3724HD (trade name) manufactured by Toshiba Corporation and having a tungsten target. A voltage of 80 KVp was applied to three phases with a pulse generator to generate X-rays and the X-rays were made to pass through a filter of water having a thickness of 7 cm, which filter absorbed X-rays in nearly the same amount as that of X-rays which the human body absorbs, to form an X-ray source. While an X-ray exposure amount was varied by varying the distance between the assembly and the X-ray source, the material was exposed stepwise at an interval of logE=0.15. After exposure, the material was thermally developed under the following thermal development conditions.

The thermal development unit of FUJI MEDICAL DRY LASER IMAGER FM-DPL was remodeled to produce a thermal development apparatus that could heat the material from both sides thereof. Further, the apparatus was also remodeled to enable conveying a film sheet by replacing the conveying roller in the thermal development unit with a heat drum. Temperatures of four panel heaters were set to 112° C., 118° C., 120° C., and 120° C., respectively and that of the heat drum was set to 120° C. In addition, the conveying speed was increased so that the total period of thermal development became 14 seconds.

On the other hand, a wet-developing type regular photosensitive material RX-U (manufactured by Fuji Photo Film Co., Ltd.) was also exposed to X-rays under the same conditions and processed by using an automatic developing apparatus CEPROS-M2 (manufactured by Fuji Photo Film Co., Ltd.) and a processing liquid CE-D1 (manufactured by Fuji Photo Film) for 45 seconds.

3) Evaluation Item

Sensitivity and Fogging

The densities of the obtained images were measured with a densitometer and characteristic curves of density relative to logarithm of the exposure amount were depicted. The optical density of an unexposed area (Dmin area) was defined as fogging level. As for fogging level, a smaller value is preferable.

Image Storability

The image formed above on each of the coated samples was stored for 24 hours while it was being exposed to light from a fluorescent lamp having illuminance of 1000 Lux. Increase in fogging density of the Dmin area, ΔDmin, was obtained and evaluated. A smaller value means a lower printout level, which stands for more excellent image storability.

Measurement of Sharpness

Contrast transfer function (CTF) was measured to evaluate sharpness. MRE single-sided photographic material (manufactured by Eastman Kodak Co.) was brought into contact with an intensifying screen to be measured, and a rectangular chart (made of molybdenum, and having a thickness of 80 μm and a spatial frequency of 0 lp/mm to 10 lp/mm) for MTF measurement was photographed. The chart was placed at a position which was 2 m away from an X-ray vessel. The photographic material was sandwiched between two X-ray regular screens (HI-SCREEN B3 manufactured by Fuji Photo Film Co., Ltd., containing CaWO₄ as a fluorescent substance and having a peak emission wavelength of 425 nm), and the resultant assembly was arranged in position. The X-ray vessel was DRX-3724HD (trade name) manufactured by Toshiba Corporation and using a tungsten target. A focal spot size was set at 0.6 mm×0.6 mm. X-rays were generated through 3 mm thick aluminum equivalent material including a diaphragm. A voltage of 80 KV was applied to three phases with a pulse generator to generate X-rays and the X-rays were made to pass through a filter of water having a thickness of 7 cm, which filter absorbed X-rays in nearly the same amount as that of X-rays which the human body absorbs, to form an X-ray source. After exposure, the material was thermally developed with the above-mentioned developing machine for developing both sides of materials. The exposure amount at the time of X-ray photography was adjusted so that the average of the highest and lowest densities of the developed image would be 1.0.

Subsequently, the sample to be measured was processed with a microdensitometer. At this time, density profile was measured at a sampling interval of 30 μm by using, as an aperture, a slit having a length of 30 μm in the operating direction and a length of 500 μm in a direction perpendicular to the operating direction. This procedure was repeated twenty times and the obtained values were averaged to obtain a density profile on which CTF calculation was based. Thereafter, the peak of the rectangular wave for each frequency in the density profile was detected and density contrast for each frequency was calculated. The measured values with respect to a spatial frequency of 2 lp/mm are shown in Table 7.

3) Evaluation Result

The obtained results are shown in Table 7.

As can be easily recognized from the data shown in Table 7, a photographic material that is exposed to light in a specific range of a spectrum can have improved CTF response when the thickness of the silver halide grains are selected such that light reflection level in the wavelength range becomes minimum. Further, as for absolute properties of the material, it was confirmed that the material has sharpness equal to that of prevailing photosensitive materials.

TABLE 7

| | | Average | Average | | Average Sphere | | | | |
|---|---|---|---|---|---|---|---|---|---|
| Emulsion | Composition | Projected Area | Thickness | Aspect | equivalent Diameter | | Image | Sharpness | |
| No | (mole ratio) | Diameter (μm) | (μm) | Ratio | (μm) | Fogging | Storability | 2 lp/mm | Remarks |
| 1′ | AgI 90, Br 10 | 0.86 | 0.045 | 19.1 | 0.368 | 0.17 | 0.01 | 0.302 | The invention |
| 2′ | AgI 90, Br 10 | 0.93 | 0.057 | 16.3 | 0.420 | 0.17 | 0.01 | 0.284 | The invention |
| 3′ | AgI 90, Br 10 | 1.08 | 0.140 | 7.7 | 0.626 | 0.18 | 0.01 | 0.288 | The invention |
| 4′ | AgI 90, Br 10 | 1.11 | 0.155 | 7.2 | 0.659 | 0.18 | 0.01 | 0.262 | The invention |
| 5′ | AgI 90, Br 10 | 1.12 | 0.080 | 14.0 | 0.532 | 0.18 | 0.01 | 0.172 | Comparative |
| | | | | | | | | | example |
| 6′ | AgI 90, Br 10 | 1.15 | 0.177 | 6.5 | 0.705 | 0.18 | 0.01 | 0.154 | Comparative |
| | | | | | | | | | example |
| RX-U | — | — | — | — | — | 0.17 | 0.01 | 0.289 | Comparative |
| | | | | | | | | | example |

### Example 8

1. Formation of PET Support

1-1. Film Formation

PET was made of terephthalic acid and ethylene glycol in an ordinary manner and had an intrinsic viscosity IV of 0.66 (measured in a mixture of phenol and tetrachloroethane at a weight ratio of 6/4 at 25° C.). This was pelletized, and the resultant was dried at 130° C. for 4 hours. This pellet was melted at 300° C., extruded out from a T-die, and rapidly cooled. Thus, a non-oriented film was prepared.

The film was longitudinally oriented by rolls rotating at different circumferencial speeds at 110° C. so that the longitudinal length thereof after the orientation was 3.3 times as long as the original longitudinal length thereof. Next, the film was laterally oriented by a tenter at 130° C. so that the lateral length thereof after the orientation was 4.5 times as long as the original lateral length thereof. Next, the oriented film was thermally fixed at 240° C. for 20 seconds, and then laterally relaxed by 4% at the same temperature. Next, the chuck portion of the tenter was slitted, and the both edges of the film were knurled, and the film was rolled up at 4 kg/cm². The rolled film having a thickness of 175 μm was obtained.

1-2. Corona Processing of Surface

Both surfaces of this support were processed at a rate of 20 m/minute at room temperature by using a solid state corona processing machine (6 KVA model manufactured by Pillar Company). From values of current and voltage read at this time, it was found that the support had been processed at 0.375 kV.A.min/m². At this time, the processing frequency was 9.6 kHz, and a gap clearance between an electrode and a dielectric roll was 1.6 mm.

Formation of Undercoated Support

1) Preparation of Coating Liquid for Undercoat Layer

| | | |
|---|---|---|
| Pesresin A-520 | 59 | g |
| (manufactured by Takamatsu Oil and Fats | | |
| Co., Ltd.; 30 mass % solution) | | |
| Polyethylene glycol monononyl phenyl ether | 5.4 | g |
| (average ethylene oxide number = | | |
| 8.5, 10 mass % solution) | | |
| MP-1000 | 0.91 | g |
| (manufactured by Soken chemical & | | |
| Engineering Co., Ltd.; fine | | |
| polymer particles having an average | | |
| particle size of 0.4 μm) | | |
| Distilled water | 935 | mL |

2) Undercoat

Each surface of the biaxially-oriented polyethylene terephthalate support having a thickness of 175 μm which had been subjected to the above-described corona discharge treatment was coated with the coating liquid for the under coat with a wire bar such that a wet coating amount became 6.6 ml/m² (per one side). Each of the resultant coatings was dried at 180° C. for 5 min.

2. Preparation of Coating Materials

1) Preparation of Silver Halide Emulsion

Preparation of Silver Halide Emulsion A

2.3 mL of a 10 mass % potassium iodide, 3.5 mL of 0.5 mol/L sulfuric acid, 36.5 g of phthalated gelatin and 160 mL of a 5 mass % methanol solution of 2,2′-(ethylenedithio)diethanol were added to 1421 mL of distilled water. The resulting solution was kept at 78° C. in a stainless steel reaction pot while it was being stirred. Solution A was prepared by diluting 22.22 g of silver nitrate with distilled water such that the total volume of the resultant mixture was 218 mL. Solution B was prepared by diluting 36.6 g of potassium iodide with distilled water such that the total volume of the resultant mixture was 366 mL. These solutions A and B were added to the content in the reaction pot by a controlled double jet method. At this time, the whole of solution A was added at a constant flow rate over 38 minutes. Moreover, solution B was added while pAg of the system was kept at 10.2. Then, 10 mL of a 3.5 mass % aqueous solution of hydrogen peroxide, and 10.8 mL of a 10 mass % aqueous solution of benzimidazole were added to the system. Solution C was prepared by diluting 51.86 g of silver nitrate with distilled water such that the total volume of the resultant mixture was 508.2 mL. Moreover, Solution D was prepared by diluting 63.9 g of potassium iodide with distilled water such that the total volume of the resultant mixture was 639 mL. These solutions C and D were added to the system by the controlled double jet method. At this time, the whole of Solution C was added at a constant flow rate over 60 minutes. Moreover, Solution D was added while pAg of the system was kept at 10.2. When ten minutes had lapsed since staring of addition of Solutions C and D, potassium hexachloroiridate (III) was added to the system in an amount of 1×10⁻⁴ mol per mol of silver. Further, when 40 seconds had lapsed since completion of addition of Solution C, an aqueous solution of potassium hexacyanoiron (II) was added to the system in an amount of 3×10⁻⁴ mol per mol of silver. 0.5 mol/L sulfuric acid was added to the system so as to adjust pH of the system at 3.8. Then stirring was stopped, and precipitating/desalting/washing steps were carried out. One mol/L sodium hydroxide was added to the system so as to adjust pH of the system at 5.9 and then a silver halide dispersion having pAg of 9.0 was prepared.

Silver halide grains in the obtained silver halide dispersion were made of pure silver iodide, and included tabular grains having an average projected area diameter of 1.35 μm, a coefficient of variation of the average projected area diameter of 18.5%, an average thickness of 0.110 μm, and an average aspect ratio of 12.2. The entire projected area of the tabular grains corresponded to 76% or more of the entire projected area of all the silver halide grains. The sphere equivalent diameter thereof was 0.69 μm. A result of X-ray powder diffraction analysis showed that 90% or more of the silver iodide had gamma phase.

Preparation of Silver Halide Emulsion B

One mole of the AgI tabular grain emulsion which was the silver halide emulsion A was placed in a reaction vessel. A 0.5 mol/L KBr solution and 0.5 mol/L AgNO₃ solution were added to the emulsion by the double jet method over 20 minutes at 10 mL/minute at 30° C. to allow substantially 10 mol % of silver bromide to epitaxially deposit on the AgI host grains. During this operation, silver potential was kept at +100 mV. Further, 0.5 mol/L sulfuric acid was added to the system so as to adjust pH of the system at 3.8. Then stirring was stopped, and precipitating/desalting/washing steps were carried out. One mol/L sodium hydroxide was added to the system so as to adjust pH of the system at 5.9. The system was divided in two portions to form silver halide dispersions having pAg of 6.5 and 9.0, respectively.

The silver halide dispersion was divided into small portions. After raising the temperature of each portion to 56° C., chemical sensitizers shown in Table 8 were added to the portions, and the resultant mixtures were aged for 60 minutes to obtain emulsions 101 to 114.

Preparation of Silver Halide Emulsion for Preparing Coating Liquid

One of the silver halide emulsions was molten at 40° C. and 1 mass % aqueous solution of benzothiazolium iodide was added thereto in an amount of 7×10⁻³ mol per mol of silver.

Further, water was added to the emulsion so that the content of silver of silver halide per kg of the resultant mixed emulsion for coating liquid would become 38.2 g. Then, 1-(3-methylureidophenyl)-5-mercaptotetrazole was added to the resultant in an amount of 0.34 g per kg of the mixed emulsion for coating liquid.

Further, compound (19) was added to the resultant mixture as a compound having an adsorptive group and a reducing group in an amount of 2×10⁻⁵ mol per mol of silver halide.

2) Preparation of Dispersion A of Silver Salt of Fatty Acid

Preparation of Recrystallized Behenic Acid

100 kg of behenic acid manufactured by Henkel Co. (trade name of product: Edenor C22-85R) was dissolved in 1200 kg of isopropyl alcohol at 50° C., and the resultant solution was filtered through a filter having a pore size of 10 μm and then cooled to 30° C. to recrystallize behenic acid. The cooling rate in the recrystallization was controlled to 3° C./hour. The solution was centrifugally filtered to collect recrystallized crystals, and the crystals were washed with 100 kg of isopropyl alcohol and then dried. The obtained crystals were esterified and the resultant was measured by GC-FID. The resultant had a behenic acid content of 96 mol % and, in addition, included 2 mol % of lignoceric acid, 2 mol % of archidic acid and 0.001 mol % of erucic acid.

Preparation of Dispersion of Silver Salt of Fatty Acid

88 kg of recrystallized behenic acid, 422 L of distilled water, 49.2 L of a 5 mol/L aqueous NAOH solution and 120 L of t-butyl alcohol were mixed and reacted at 75° C. for one hour while the resultant system was being stirred. Thus, a sodium behenate solution B was obtained. Separately, 206.2 L of an aqueous solution (pH 4.0) containing 40.4 kg of silver nitrate was prepared and kept at 10° C. A reaction vessel containing 635 L of distilled water and 30 L of t-butyl alcohol was kept at 30° C. The entire amount of the sodium behenate solution and the entire amount of the aqueous solution of silver nitrate were added to the content of the vessel at constant flow rates over 93 minutes and 15 seconds and over 90 minutes, respectively, while the content in the vessel was being sufficiently stirred. At this time, only the aqueous solution of silver nitrate was added for 11 minutes after starting the addition of the aqueous solution of silver nitrate, addition of sodium behenate solution was started subsequently, and only the sodium behenate solution was added for 14 minutes and 15 seconds after completion of the addition of the aqueous solution of silver nitrate. At this time, the internal temperature of the reaction vessel was kept at 30° C. The external temperature was controlled such that the liquid temperature was constant. The pipe line for the sodium behenate solution was a double-walled pipe and thermally insulated by circulating hot water through the interspace of the double-walled pipe, and the temperature of the solution at the outlet of the nozzle tip was adjusted at 75° C. The pipe line for the aqueous silver nitrate solution was also a double-walled pipe and thermally insulated by circulating cold water through the interspace of the double-walled pipe. The position at which the sodium behenate solution was added to the reaction system and that at which the aqueous silver nitrate solution was added thereto were disposed symmetrically relative to the shaft of the stirrer disposed in the reactor, and the nozzle tips of the pipes were spaced apart from the reaction solution level in the reactor.

After adding the sodium behenate solution was finished, the reaction system was stirred for 20 minutes at that temperature, and then heated to 35° C. over 30 minutes. Thereafter, the system was aged for 210 minutes. Immediately after completion of the ageing, the system was centrifugally filtered to collect a solid component, which was washed with water until the conductivity of the washing waste reached 30 μS/cm. The solid thus obtained was a silver salt of a fatty acid and was stored as wet cake without drying it.

The shapes of the silver behenate particles obtained herein were analyzed on the basis of their images taken through electronmicroscopic photography. Average values of a, b, and c were 0.21 μm, 0.4 μm and 0.4 μm, respectively (a, b and c are defined hereinabove). An average aspect ratio was 2.1. A coefficient of variation of sphere equivalent diameters of the particles was 11%.

19.3 kg of polyvinyl alcohol (trade name, PVA-217) and water were added to the wet cake whose amount corresponded to 260 kg of the dry weight thereof so that the total amount of the resultant became 1000 kg. The resultant was formed into slurry with a dissolver wing, and then pre-dispersed with a pipe-line mixer (Model PM-10 available from Mizuho Industry Co.).

Next, the pre-dispersed stock slurry was processed three times in a disperser (MICROFLUIDIZER M-610 obtained from Microfluidex International Corporation, and equipped with a Z-type interaction chamber) at a controlled pressure of 1150 kg/cm². A silver behenate dispersion was thus prepared. To cool it, corrugated tube type heat exchangers were disposed before and behind the interaction chamber. The temperature of the coolant in these heat exchangers was so controlled that the system could be processed at a dispersion temperature of 18° C.

3) Preparation of Reducing Agent Dispersion

Preparation of of Reducing Agent-1 Dispersion

10 kg of a reducing agent-1 (2,2′-methylenebis-(4-ethyl-6-tert-butylphenol)), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) including zirconia beads which had a mean diameter of 0.5 mm, and dispersed therewith for 3 hours. Then, 0.2 g of sodium salt of benzoisothiazolinone and water were added thereto to adjust the reducing agent concentration of the resultant at 25% by mass. The dispersion was heated at 60° C. for 5 hours. A reducing agent-1 dispersion was thus prepared. The reducing agent particles in the dispersion had a median diameter of 0.40 μm, and a maximum particles size of at most 1.4 μm. The reducing agent dispersion was filtered through a polypropylene filter having a pore size of 3.0 μm to remove foreign objects such as dirt from it, and then stored.

Preparation of Reducing Agent-2 Dispersion

10 kg of a reducing agent-2 (6,6′-di-t-butyl-4,4′-dimethyl-2,2′-butylidenediphenol), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) including zirconia beads which had a mean diameter of 0.5 mm, and dispersed therewith for 3 hours and 30 minutes. Then, 0.2 g of sodium salt of benzoisothiazolinone and water were added thereto to adjust the reducing agent concentration of the resultant at 25% by mass. The dispersion was then heated at 40° C. for 1 hour, and then at 80° C. for 1 hour. A reducing agent-2 dispersion was thus prepared. The reducing agent particles in the dispersion had a median diameter of 0.50 μm, and a maximum particle size of at most 1.6 μm. The reducing agent dispersion was filtered through a polypropylene filter having a pore size of 3.0 μm to remove foreign objects such as dirt from it, and then stored.

4) Preparation of Hydrogen Bonding Compound Dispersion

Preparation of Hydrogen Bonding Compound-I Dispersion

10 kg of a hydrogen bonding compound-1 (tri(4-t-butylphenyl)phosphine oxide), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) containing zirconia beads which had a mean diameter of 0.5 mm, and dispersed therewith for 4 hours. Then, 0.2 g of sodium salt of benzoisothiazolinone and water were added thereto to adjust the hydrogen bonding compound concentration of the resultant at 25% by mass. The dispersion was heated at 40° C. for 1 hour and then at 80° C. for 1 hour. A hydrogen bonding compound-1 dispersion was thus prepared. The hydrogen bonding compound particles in the dispersion had a median diameter of 0.45 μm, and a maximum particle size of at most 1.3 μm. The hydrogen bonding compound dispersion was filtered through a polypropylene filter having a pore size of 3.0 μm to remove foreign objects such as dirt from it, and then stored.

5) Preparation of Development Accelerator-1 Dispersion

10 kg of a development accelerator-1,20 kg of a 10 mass % solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) containing zirconia beads which had a mean diameter of 0.5 mm, and dispersed therewith for 3 hours and 30 minutes. Then, 0.2 g of sodium salt of benzoisothiazolinone and water were added thereto to prepare a development accelerator-1 dispersion having a development accelerator concentration of 20% by mass. The development accelerator particles in the dispersion had a median diameter of 0.48 μm, and a maximum particle size of at most 1.4 μm. The development accelerator dispersion was filtered through a polypropylene filter having a pore size of 3.0 μm to remove foreign objects such as dirt from it, and then stored.

Development accelerator-2 and color toning agent-1 solid dispersions respectively having concentrations of 20 mass % and 15 mass % were prepared in the same manner as the preparation of the development accelerator-1 dispersion.

6) Preparation of Polyhalogenated Compound Dispersion

Preparation of Organic Polyhalogenated Compound-1 Dispersion

10 kg of an organic polyhalogen compound-1 (tribromomethanesulfonylbenzene), 10 kg of a 20 mass % aqueous solution of modified polyvinyl alcohol (POVAL MP203 available from Kuraray Co., Ltd.), 0.4 kg of a 20 mass % aqueous solution of sodium triisopropylnaphthalenesulfonate, and 14 kg of water were sufficiently mixed to prepare slurry. The slurry was fed by a diaphragm pump into a horizontal sand mill (UVM-2 available from Imex Corporation) including zirconia beads which had a mean diameter of 0.5 mm, and dispersed therewith for 5 hours. Then, 0.2 g of sodium salt of benzoisothiazolinone and water were added thereto to prepare an organic polyhalogen compound-1 dispersion having an organic polyhalogen compound content of 30 mass %. The organic polyhalogen compound particles in the dispersion had a median diameter of 0.41 μm, and a maximum particle size of at most 2.0 μm. The organic polyhalogen compound dispersion was filtered through a polypropylene filter having a pore size of 10.0 μm to remove foreign objects such as dirt from it, and then stored.

Preparation of Organic Polyhalogenated Compound-2 Dispersion

10 kg of an organic polyhalogen compound-2 (N-butyl-3-tribromomethanesulfonylbenzamide), 20 kg of a 10 mass % aqueous solution of modified polyvinyl alcohol (POVAL MP203 available from Kuraray Co., Ltd.), and 0.4 kg of a 20 mass % aqueous solution of sodium triisopropylnaphthalenesulfonate were sufficiently mixed to prepare slurry. The slurry was fed by a diaphragm pump into a horizontal sand mill (UVM-2 available from Imex Corporation) including zirconia beads which had a mean diameter of 0.5 mm, and dispersed therewith for 5 hours. Then, 0.2 g of sodium salt of benzoisothiazolinone and water were added thereto to adjust the organic polyhalogen compound content of the resultant at 30 mass %. The dispersion was heated at 40° C. for 5 hours. An organic polyhalogen compound-2 dispersion was thus obtained. The organic polyhalogen compound particles in the dispersion had a median diameter of 0.40 μm, and a maximum particle size of at most 1.3 μm. The organic polyhalogen compound dispersion was filtered through a polypropylene filter having a pore size of 3.0 μm to remove foreign objects such as dirt from it, and then stored.

7) Preparation of Silver Iodide Complex-Forming Agent (22)

8 kg of modified polyvinyl alcohol MP203 was dissolved in 174.57 kg of water, and 3.15 kg of a 20 mass % aqueous solution of sodium triisopropylnaphthalenesulfonate and 14.28 kg of a 70 mass % aqueous solution of silver iodide complex-forming agent (NO. 22) were added to the resultant solution so as to prepare a 5 mass % solution of the silver iodide complex-forming compound (No. 22).

8) Preparation of SBR Latex Liquid

An SBR latex was prepared as follows.

287 g of distilled water, 7.73 g of a surfactant (PIONIN A-43-S produced by Takemoto Yushi Corporation and having a solid content of 48.5 mass %), 14.06 ml of 1 mol/liter NaOH, 0.15 g of tetrasodium ethylenediaminetetraacetate, 255 g of styrene, 11.25 g of acrylic acid, and 3.0 g of tert-dodecylmercaptan were put into the polymerization reactor of a gas monomer reaction apparatus (TAS-2J Model available from Taiatsu Techno Corporation). The reactor was sealed off, and the content therein was stirred at 200 rpm. The internal air was exhausted via a vacuum pump, and replaced a few times repeatedly with nitrogen. Then, 108.75 g of 1,3-butadiene was introduced into the reactor under pressure, and the internal temperature of the reactor was raised to 60° C. A solution in which 1.875 g of ammonium persulfate was dissolved in 50 ml of water was added to the system, and the system was stirred for 5 hour. It was further heated to 90° C. and stirred for 3 hours. After the reaction was completed, the internal temperature was lowered to room temperature. Then, NaOH and NH₄OH (both 1 mol/liter) were added to the system at a molar ratio of Na⁺ and NH₄⁺, of 1/5.3 so as to adjust the pH of the system at 8.4. Next, the system was filtered through a polypropylene filter having a pore size of 1.0 μm to remove foreign objects such as dirt from it, and then stored. 774.7 g of SBR latex was thus obtained. Its halide ion content was measured through ion chromatography, and the chloride ion concentration of the latex was 3 ppm. The chelating agent concentration thereof was measured through high-performance liquid chromatography, and was 145 ppm.

The mean particle size of the latex was 90 nm, Tg thereof was 17° C., the solid content thereof was 44% by mass, the equilibrium moisture content thereof at 25° C. and 60% RH was 0.6 mass %, and the ion conductivity thereof was 4.80 mS/cm. To measure the ion conductivity, a conductivity meter CM-30S manufactured by To a Denpa Kogyo K. K. was used. In the device, the 44 mass % latex was measured at 25° C. Its pH was 8.4.

9) Preparation of Mercato Compound

Preparation of Aqueous Solution of Mercapto Compound-1

7 g of a mercapto compound-1 (1-(3-sulfophenyl)-5-mercaptotetrazole sodium salt) was dissolved in 993 g of water to form a 0.7 mass % aqueous solution.

Preparation of Aqueous Solution of Mercapto Compound-2

20 g of a mercato compound-2 (1-(3-methylureidophenyl)-5-mercaptotetrazole) was dissolved in 980 g of water to form a 2.0 mass % aqueous solution.

2) Preparation of Pigment-1 Dispersion

250 g of water was added to and sufficiently mixed with 64 g of C.I. Pigment Blue 60 and 6.4 g of Demol N (manufactured by Kao Corporation) to form slurry. 800 g of zirconia beads having an average diameter of 0.5 mm were prepared and the slurry and the zirconia beads were put in a vessel. The resulting mixture was stirred by a dispersion machine (¼ G sand grinder mill manufactured by Imex Co.) for 25 hours. The resultant dispersion was taken out of the vessel and diluted with water to obtain a 5 mass % pigment-1 dispersion. The pigment particles contained in the pigment dispersion thus obtained had an average particle size of 0.21 μm.

3. Preparation of Coating Liquid

Preparation of Coating Liquid for Image-Forming Layer

35 g of the pigment-1 dispersion, 6.3 g of the organic polyhalogen compound-I dispersion, 20.7 g of the organic polyhalogen compound-2 dispersion, 1060 g of the SBR latex (Tg: 17° C.) liquid, 75 g of the reducing agent-1 dispersion, 75 g of the reducing agent-2 dispersion, 106 g of the hydrogen bonding compound-1 dispersion, 4.8 g of the development accelerator-1 dispersion, 3.0 g of the development accelerator-2 dispersion, 2.0 g of the color toning agent-1 dispersion, 9 ml of the aqueous solution of mercapto compound-1, and 27 ml of the aqueous solution of mercapto compound-2 were successively added to 1,000 g of the dispersion A of the silver salt of the fatty acid obtained above and 104 ml of water. Then, the silver iodide complex-forming agent was added to the resultant in an amount of 8 mol % per mol of silver. Just before coating, each of the silver halide emulsion for coating liquid (Table 8) was added to and sufficiently mixed with the above mixture so that the amount of silver of the emulsion became 0.25 mol per mol of silver salt of fatty acid. The resultant Coating liquid for the image-forming layer was fed as it is to a coating die, and applied to the support.

Preparation of Coating Liquid for Intermediate Layer

27 ml of a 5 mass % aqueous solution of AEROSOL OT (available from American Cyanamid Company), 10.5 ml of a 20 mass % aqueous solution of diammonium phthalate and water were added to 772 g of a 10 mass % aqueous solution of polyvinyl alcohol (PVA-205 available from Kuraray Co., Ltd.), 5.3 g of the pigment-1 dispersion and 226 g of a 27.5 mass % latex of a methyl methacrylate/styrene/butyl acrylate/hydroxyethyl methacrylate/acrylic acid copolymer (copolymerization weight ratio: 64/9/20/5/2) so that the total amount of the resultant mixture became 880 g. The pH of the mixture was adjusted at 7.5 by adding NaOH to the mixture. A coating liquid for intermediate layer was thus obtained. This was fed into a coating die so that the amount of the coating liquid was 10 ml/m².

The viscosity of the coating liquid was 65 mPa·S when measured with a B-type viscometer (rotor No. 1, 60 rpm) at 40

Preparation of Coating Liquid for First Surface Protective Layer

64 g of inert gelatin was dissolved in water, and 80 g of a 27.5 mass % latex of a methyl methacrylate/styrene/butyl acrylate/hydroxyethyl methacrylate/acrylic acid copolymer (copolymerization weight ratio: 64/9/20/5/2), 23 ml of a 10 mass % methanol solution of phthalic acid, 23 ml of a 10 mass % aqueous solution of 4-methylphthalic acid, 28 ml of 0.5 mol/L sulfuric acid, 5 ml of a 5 mass % aqueous solution of AEROSOL OT (available from American Cyanamid Company), 0.5 g of phenoxyethanol, 0.1 g of benzoisothiazolinone, and water were added to the resultant solution so that the total amount of the resultant mixture became 750 g. Just before application thereof, 26 ml of 4 mass % chromium alum was mixed with the mixture by using a static mixer. The resultant coating liquid was fed into a coating die so that the amount of the resultant coating was 18.6 ml/m².

The viscosity of the coating liquid was 20 mPa·S when measured with a B-type viscometer (rotor No. 1, 60 rpm) at 40

Preparation of Coating Liquid for Second Surface Protective Layer

80 g of inert gelatin was dissolved in water, and 102 g of a 27.5 mass % latex of a methyl methacrylate/styrene/butyl acrylate/hydroxyethyl methacrylate/acrylic acid copolymer (copolymerization weight ratio: 64/9/20/5/2), 3.2 ml of a 5 mass % solution of a fluorine-containing surfactant (F-1), 32 ml of a 2 mass % aqueous solution of a fluorine-containing surfactant (F-2), 23 ml of a 5 mass % solution of AEROSOL OT (available from American Cyanamid Company), 4 g of fine polymethyl methacrylate particles (mean particle size: 0.7 μm), 21 g of fine polymethyl methacrylate particles (mean particle size: 4.5 μm), 1.6 g of 4-methylphthalic acid, 4.8 g of phthalic acid, 44 ml of 0.5 mol/L sulfuric acid, 10 mg of benzoisothiazolinone, and water were added to the resultant solution so that the total amount of the resultant mixture became 650 g. Just before application thereof, 445 ml of an aqueous solution containing 4 mass % of chromium alum and 0.67 mass % of phthalic acid was mixed with the mixture by using a static mixer. A coating liquid for the surface protective layer was thus obtained. The coating liquid was fed into a coating die, with its flow rate so controlled that its coating amount was 8.3 ml/m².

The viscosity of the coating liquid was 19 mPa·S when measured with a B-type viscometer (rotor No. 1, 60 rpm) at 40° C.

Preparation of Photothermographic Material

1) Preparation of Coated Sample

Each side of the support was simultaneously coated with the coating liquid for image-forming layer which contained one of the silver halide emulsions 101 to 113 and to which sensitizing dyes 1, 2 and 3 were added just before coating, the coating liquid for intermediate layer, the coating liquid for first surface protective layer and the coating liquid for second surface protective layer, and the resultant coatings were dried. Photothermographic materials which had an image-forming layer containing a silver coating amount of 1.65 g/m² on each side of the support and in which the total silver coating amount that was the sum of the silver amount of the silver salt of fatty acid and that of the silver halide was 3.3 g/m² were thus prepared. 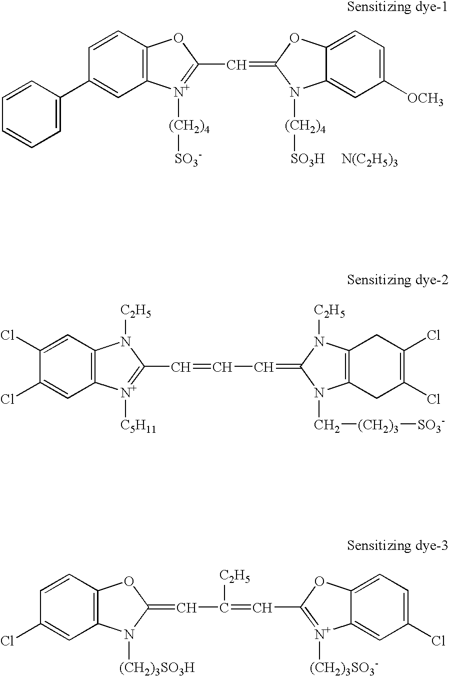
2) Evaluation of Performance

The double-side-coated photosensitive material prepared in this manner was evaluated as follows.

The sample was sandwiched between two X-ray ortho screens (HG-M manufactured by Fuji Photo Film Co., Ltd., containing as a fluorescent substance terbium-activated gadolinium oxysulfide and having a peak emission wavelength of 545 nm) to form an assembly for image formation. The assembly was exposed to X-rays for 0.05 seconds and subjected to X-ray sensitometry. The X-ray apparatus used was DRX-3724HD (trade name) manufactured by Toshiba Corporation and having a tungsten target. A voltage of 80 KVp was applied to three phases with a pulse generator to generate X-rays and the X-rays were made to pass through a filter of water having a thickness of 7 cm, which filter absorbed X-rays in nearly the same amount as that of X-rays which the human body absorbs, to form an X-ray source. While an X-ray exposure amount was varied by varying the distance between the assembly and the X-ray source, the material was exposed stepwise at an interval of logE=0.15. After exposure, the material was thermally developed under the following thermal development conditions. The density of the resultant image was measured with a densitometer.

The thermal development unit of FUJI MEDICAL DRY LASER IMAGER FM-DPL was remodeled to produce a thermal development apparatus that could heat the material from both sides thereof. Further, the apparatus was also remodeled to enable conveying a film sheet by replacing the conveying roller in the thermal development unit with a heat drum. Temperatures of four panel heaters were set to 112° C., 118° C., 120° C., and 120° C., respectively and that of the heat drum was set to 120° C. In addition, the conveying speed was increased so that the total period of thermal development became 14 seconds.

The chemical structures of compounds used in this Example are shown below.

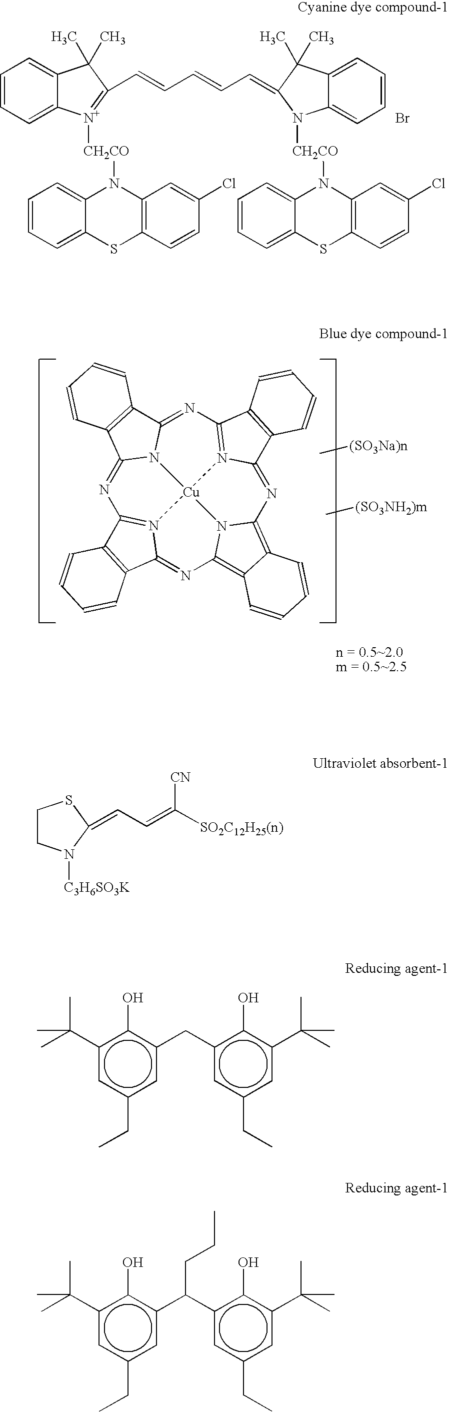

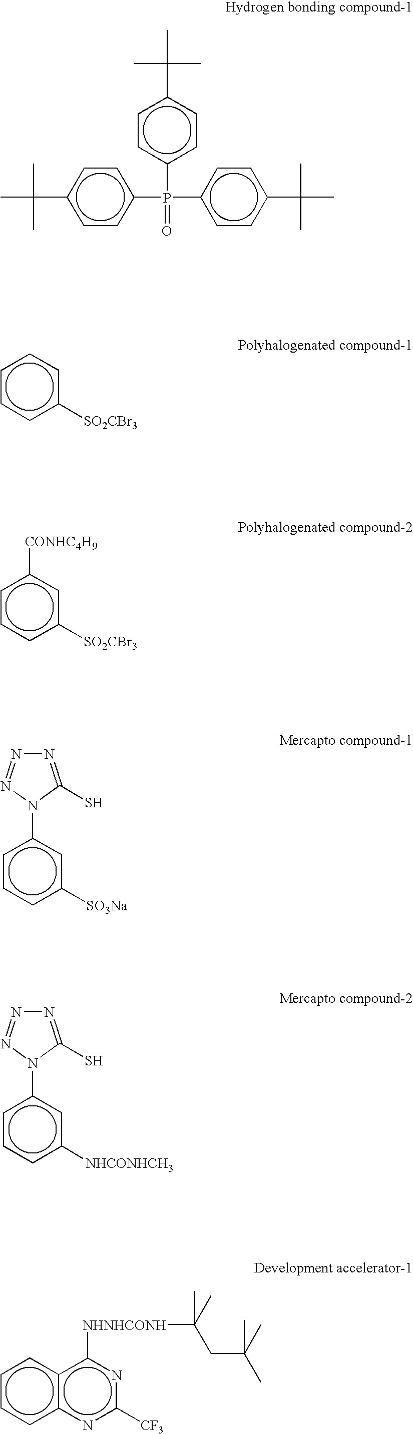

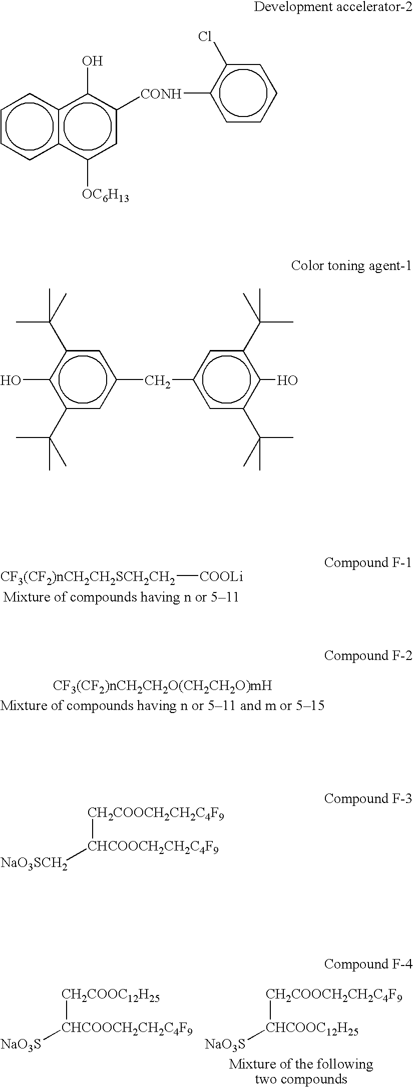

TABLE 8

| | | Chemical Sensitizer | | | | | |
|---|---|---|---|---|---|---|---|
| Sample | | | Addition Amount | | Relative | Image | |
| No | pAg | Compound | (mol/mol AgX) | Fogging | Sensitivity | Storability | Remarks |
| 101 | 6.5 | — | — | 0.26 | 100 | 0 | Comparative example |
| 102 | 6.5 | Sodium thiosulfate | 6.4 × 10⁻⁵ | 0.28 | 224 | 0 | The invention |
| 103 | 6.5 | Triethylthiourea | 6.4 × 10⁻⁵ | 0.28 | 239 | 0 | The invention |
| 104 | 6.5 | Triphenylphosphine selenide | 3.2 × 10⁻⁵ | 0.34 | 251 | 0 | The invention |
| 105 | 6.5 | Pentafluorophenyl- | 2.4 × 10⁻⁵ | 0.32 | 273 | 0 | The invention |
| | | Diphenylphpsphine selenide | | | | | |
| 106 | 6.5 | Bis(N-methyl-N- | 2.8 × 10⁻⁵ | 0.28 | 339 | 0 | The invention |
| | | Phenylcarbamoyl) telluride | | | | | |
| 107 | 6.5 | n-butyl-di-i-propylphosphine | 6.4 × 10⁻⁵ | 0.30 | 288 | 0 | The invention |
| | | telluride | | | | | |
| 108 | | Sodium thiosulfate | 2.4 × 10⁻⁵ | 0.42 | 407 | 0 | The invention |
| | | Chloroauric acid | 1.0 × 10⁻⁵ | | | | |
| | | Potassium thiocyanate | 2.0 × 10⁻⁵ | | | | |
| 109 | 6.5 | Dimethylamine borane | 2.0 × 10⁻⁶ | 0.31 | 257 | 0 | The invention |
| 110 | 6.5 | Dimethylamine borane | 2.0 × 10⁻⁶ | 0.34 | 368 | 0 | The invention |
| | | Bis(N-methyl-N- | 2.8 × 10⁻⁵ | | | | |
| | | phenylcarbamoyl) telluride | | | | | |
| 111 | 9.0 | — | — | 0.25 | 62 | 0 | Comparative example |
| 112 | 9.0 | Bis(N-methyl-N- | 6.4 × 10⁻⁵ | 0.26 | 201 | 0 | The invention |
| | | phenylcarbamoyl) telluride | | | | | |
| 113 | 6.5 | Dimethylamine borane | 1.0 × 10⁻⁶ | 0.30 | 360 | 0 | The invention |
| | | Bis(N-methyl-N- | 2.8 × 10⁻⁵ | | | | |
| | | phenylcarbamoyl) telluride | | | | | |

The obtained results are shown in Table 8.

The relative sensitivity is the ratio of inverse number of an exposure amount at which an optical density that was the sum of fogging level and 0.2 was obtained to that of Sample 101. The larger the ratio, the higher the sensitivity. Unlike Samples 101 to 112, Sample 113 included an emulsion which had been subjected to reduction sensitization with dimethylamine boran and then tellurium sensitization at the time of preparation of epitaxial portions of silver bromide.

In evaluation of image storability, the fogging density of the Dmin area of a thermally developed sample was measured immediately after development. After the sample was exposed to light from a fluorescent lamp having illumination of 850 Lux for three days under environment of 40° C. and relative humidity of 50%, the fogging density of the Dmin area was measured, and increase in fogging density was obtained.

As is clear from Table 8, it was found that a sample containing an emulsion which had been subjected to chemical sensitization at a low pAg of 6.5 showed significantly increased sensitivity. On the other hand, a sample containing an emulsion which had been subjected to chemical sensitization at pAg of 9.0 showed somewhat increased sensitivity, which was relatively unsatisfactory. As is clear from Table 8, tellurium sensitization is the most preferable of calcogen sensitizations, and gold-calcogen sensitization results in considerable sensitization but in a relatively high fogging level. A more preferable result was obtained by combining reduction sensitization and calcogen sensitization (tellurium sensitization). Further, the grains having a high silver iodide content of the invention showed excellent image storability after development. It was difficult to predict from conventional photosensitive materials which are processed by a wet method that a photothermographic material containing silver halide which has a high silver iodide content and having very high sensitivity and excellent image storability can be obtained. Further, samples 101 and 111 had somewhat yellowish color tone after thermal development. However, samples which had been subjected to chemical sensitization recited in the invention showed an unexpected preferable effect in that yellowish tone decreases and darkness increases, as the degree of sensitization is increased.

### Example 9

One mol of an emulsion containing silver iodide tabular grains was prepared in the same manner as the preparation of the silver halide emulsion A in Example 8 and pH of the emulsion was adjusted at 5.9. Then, the emulsion was divided in two portions to prepare silver halide dispersions having pAg of 5.6 and pAg 9.0, respectively. After each of these silver halide emulsions was divided into small portions, the temperature of these portions was raised to 56° C. Then, chemical sensitizers shown in Table 9 were added to the portions and the resultant mixtures were aged for 95 minutes to obtain emulsions 120 to 126. Thereafter, coated samples were formed and subjected to sensitometry in the same manner as in Example 8, except that the emulsions 120 to 126 were used. Results shown in Table 9 were obtained. Relative sensitivity is the ratio of inverse number of an exposure amount at which an optical density that was the sum of fogging level and 0.2 was obtained to that of Sample 120.

TABLE 9

| | | Chemical Sensitizer | | | | | |
|---|---|---|---|---|---|---|---|
| Sample | | | Addition Amount | | Relative | Image | |
| No | PAg | Compound | (mol/mol AgX) | Fogging | Sensitivity | Storability | Remarks |
| 120 | 5.6 | — | — | 0.24 | 100 | 0 | Comparative example |
| 121 | 5.6 | Sodium thiosulfate | 8.2 × 10⁻⁵ | 0.24 | 132 | 0 | The invention |
| 122 | 5.6 | Pentafluorophenyl- | 8.2 × 10⁻⁵ | 0.30 | 162 | 0 | The invention |
| | | Diphenylphpsphine selenide | | | | | |
| 123 | 5.6 | Bis(N-methyl-N- | 4.1 × 10⁻⁵ | 0.25 | 209+ | 0 | The invention |
| | | Phenylcarbamoyl)telluride | | | | | |
| 124 | 5.6 | Dimethylamine borane | 4.0 × 10⁻⁵ | 0.28 | 161 | 0 | The invention |
| 125 | 9.0 | — | — | 0.24 | 81 | 0 | Comparative example |
| 126 | 9.0 | Bis(N-methyl-N- | 6.4 × 10⁻⁵ | 0.24 | 122 | 0 | The invention |
| | | Phenylcarbamoyl)telluride | | | | | |

As is clear from Table 8, thermographic materials of the invention containing silver iodide tabular grains which had been subjected to chemical sensitization at pAg of 5.6 showed significantly increased sensitivity. On the other hand, a sample containing an emulsion which had been subjected to chemical sensitization at pAg of 9.0 showed somewhat increased sensitivity, which was slightly inferior to that of the materials containing the silver iodide tabular grains which had been subjected to chemical sensitization at pAg of 5.6. Further, from comparison of results shown in Table 8 and those in table 9, the degree of sensitization in emulsion A was slightly smaller than that in emulsion B. However, it is an original knowledge of the invention that sufficient sensitization can be achieved in photothermographic materials by chemically sensitizing silver iodide tabular grains.

### Example 10

A coated sample was prepared, exposed to X-rays and thermally developed in the same manner as in Examples 8 and 9 except that no sensitizing dye was added to an emulsion, and that a X-ray regular screens (HI-SCREEN B3 manufactured by Fuji Photo Film Co., Ltd., containing a fluorescent substance CaWO₄ and having a peak emission wavelength of 425 nm) were used as the fluorescent screen.

The result showed that good sensitization could be obtained as in Examples 8 and 9.

### Example 11

A coated sample was prepared, exposed to X-rays and thermally developed in the same manner as in Examples 8 and 9 except that the layer containing the photosensitive silver halide emulsion was formed on only one side of the film support, and that a fluorescent screen for mammography (UM MANMO FINE manufactured by Fuji Photo Film Co., Ltd.) was used as the fluorescent screen. The result showed that good sensitization could be obtained as in Examples 8 and 9.

1. A photothermographic material comprising: a support; and an image-forming layer containing a photosensitive silver halide, a non-photosensitive organic silver salt, a reducing agent for silver ions and a binder on at least one side of the support, wherein the photosensitive silver halide includes tabular grains with an average silver iodide content of 40 mol % or more, an average thickness within a range of 0.001 to 0.5 μm and an average aspect ratio of 2 or more.

2. A photothermographic material according to claim 1, wherein the average thickness of the tabular grains is 0.001 to 0.2 μm.

3. A photothermographic material according to claim 1 or 2, wherein the average thickness of the tabular grains is 0.001 to 0.1 μm.

4. A photothermographic material according to claim 1, wherein the average thickness of the tabular grains is 0.001 to 0.05 μm.

5. A photothermographic material according to claim 1, wherein the tabular grains are formed by a nucleus forming process and a grain growing process, and the grain growing process has adding silver halide fine grains having a size smaller than the average thickness.

6. A photothermographic material according to claim 5, wherein adding the silver halide fine grains having the size smaller than the average thickness in the grain growing process is conducted such that the amount of the silver halide fine particles added are 10 mol % or more of the entire silver amount of the tabular grains.

7. A photothermographic material according to claim 5, wherein the average grain size of the silver halide fine grains added in the grain growing process is 0.0005 to 0.04 μm.

8. A photothermographic material according to claim 7, wherein the average grain size of the silver halide fine grains added in the grain growing process is 0.0005 to 0.025 μm.

9. A photothermographic material according to claim 1, wherein the average aspect ratio of the tabular grains is 5 to 70.

10. A photothermographic material according to claim 1, wherein the average projected area equivalent diameter of the tabular grains is 0.1 to 5.0 μm, and the variation coefficient of projected area equivalent diameters is 25% or less.

11. A photothermographic material according to claim 1, wherein the average silver iodide content of the photosensitive silver halide is 80 mol % or more.

12. A photothermographic material according to claim 11, wherein the average silver iodide content of the photosensitive silver halide is 90 mol % or more.

13. A photothermographic material according to claim 1, wherein the photosensitive silver halide has an epitaxial junction.

14. A photothermographic material according to claim 1, further comprising a compound capable of substantially reducing visible light absorption derived from the photosensitive silver halide after thermal development.

15. A photothermographic material according to claim 14, wherein the compound capable of substantially reducing visible light absorption is a silver iodide complex-forming agent.

16. A photothermographic material according to claim 1, wherein the image-forming layer is disposed on one side of the support.

17. A photothermographic material according to claim 1, wherein the image-forming layer is disposed on both sides of the support.

18. A method for forming an image on the photothermographic material according to claim 1, the method comprising:
disposing the photothermographic material between a pair of X-ray intensifying screens to obtain an assembly for image formation;
arranging a subject between the assembly and an X-ray source;
irradiating the subject with X-rays having an energy level in a range of 25 kVp to 125 kVp;
removing the photothermographic material from the assembly; and
heating the removed photothermographic material at a temperature in a range of 90° C. to 180° C.

19. A photosensitive silver halide emulsion according to claim 1, comprising: tabular grains having an average silver iodide content of 40 mol % or more, wherein at least a part of the tabular grains, the entire projected area of which part corresponds to 50% or more of the entire projected area of all the tabular grains, has an aspect ratio of 2 or more, and the average thickness of the tabular grains is within a range from 20 nm less than to 20 nm more than a thickness at which reflectance becomes maximum in a wavelength range in which the silver halide emulsion has sensitivity.

20. A photothermographic material according to claim 1, comprising: a support; and an image-forming layer containing a photosensitive silver halide, a non-photosensitive organic silver salt, a reducing agent for silver ions and a binder on at least one side of the support, wherein the photosensitive silver halide includes tabular grains, has a silver iodide content of 40 mol % or more, and has been chemically sensitized by at least one of calcogen sensitization, gold-calcogen sensitization and reduction sensitization.
